(19) United States
(12) Patent Application Publication
(10) Pub. No.: US 2021/0112839 A1
(43) Pub. Date: Apr. 22, 2021

(54) NATURAL SWEETENER COMPOSITIONS

(71) Applicant: Sensorygen, Inc., South Pasadena, CA (US)

(72) Inventors: Anandasankar RAY, Riverside, CA (US); Sean Michael BOYLE, Sunnyvale, CA (US)

(21) Appl. No.: 17/136,523

(22) Filed: Dec. 29, 2020

Related U.S. Application Data
(63) Continuation of application No. 15/815,150, filed on Nov. 16, 2017, now abandoned.
(60) Provisional application No. 62/422,975, filed on Nov. 16, 2016.

(51) Int. Cl. A23L 27/30; A23L 33/125; A23L 33/17; A23L 2/60

(52) U.S. Cl. CPC A23L 27/31; A23L 27/34; A23L 2/60; A23L 33/17; A23L 33/125

(57) ABSTRACT

The invention provides improved natural sweetener compositions comprising certain isolated compounds and their derivatives. The present invention also includes ingestible compositions comprising the present compounds and methods of sweetening the sweet taste of consumable materials.

### CROSS-REFERENCE TO A RELATED APPLICATION

This application is a continuation application of co-pending U.S. patent application Ser. No. 15/815,150, filed Nov. 16, 2017; which claims the priority benefit of U.S. Provisional Application Ser. No. 62/422,975, filed Nov. 16, 2016, all of which are incorporated herein by reference in their entirety.

### BACKGROUND OF INVENTION

Living things use sensory systems to detect important information about the environment in which they live. Taste is a particularly important sensory system, and is one of the most sophisticated forms of chemically-triggered sensations found throughout the animal kingdom.

Mammals are believed to have five basic taste modalities: sweet, bitter, sour, salty, and umami. The pleasant taste associated with sweetness is important in industries that produce consumable materials. Natural caloric sugars, such as sucrose, fructose, and glucose, for example, are heavily utilized by the beverage, food, pharmaceutical, and oral hygienic/cosmetic industries. However, many consumers are required to control or reduce the sugar and calorie content of their diets due to health concerns like obesity, diabetes, and heart disease. Thus, there is a continuing need in the market to provide alternative, non-caloric or low-caloric sweeteners with sugar-like taste for consumers who need or desire to follow calorie-conscious lifestyles.

One option for addressing this need is the use of natural high-potency sweeteners (NHPS). Because these sweeteners are many times sweeter than sucrose, for example, much less of the sweetener is required to replace the sugar; however, these sweeteners often possess taste qualities that vary from those of natural sugars. For example, certain sweetening compositions have different temporal profiles, maximal responses, flavor profiles, mouthfeel, and/or adaptation behaviors from those of sugar. In addition, high-potency sweeteners generally exhibit bitter, metallic, cooling, astringent, or licorice-like aftertastes, and/or diminishing sweetness on iterative tasting. These properties can be undesirable for consumers.

Thus, there is a need for new, improved compositions and methods for sweetening the taste of consumable materials, while lowering calorie content and retaining the desirable characteristics of caloric sugar.

### BRIEF SUMMARY

The present invention provides isolated compounds, ingestible compositions containing these compounds, and methods for preparing such ingestible compositions, to help meet the need for improved, consumer-friendly, low-calorie sweetened products.

Further provided are improved methods for activating a sweet taste receptor.

The present invention further provides improved methods of sweetening an ingestible composition, such as a food, beverage, or pharmaceutical product.

Further provided are sweetener compositions with more sugar-like temporal and/or flavor profiles comprising one or more isolated compounds from Table 1. The sweetener composition can further comprise at least one sweet taste improving composition selected from the group consisting of carbohydrates, polyols, amino acids, other sweet taste improving additives, and combinations thereof.

An additional embodiment provides a method of sweetening an ingestible composition by combining one or more of said sweetening compositions with the ingestible composition. Further embodiments can comprise a method of sweetening an ingestible composition so that the ingestible composition has improved sugar-like characteristics.

Another embodiment provides an ingestible composition sweetened using the sweetener composition. The ingestible composition can be reduced calorie. According to particular embodiments, the ingestible composition to be sweetened is selected from the group consisting of beverage, food, pharmaceutical, tobacco, nutraceutical, oral hygienic/cosmetic product, and the like.

### DETAILED DISCLOSURE

The present invention provides isolated compounds, ingestible compositions containing these compounds, and methods for preparing such ingestible compositions, to help meet the need for improved, consumer-friendly, low-calorie sweetened products.

The present invention further provides improved methods of sweetening an ingestible composition, such as a food, beverage, or pharmaceutical product.

The compounds of the invention include all stereochemical forms of the compound, including geometric isomers (i.e., E, Z) and optical isomers (i.e., R, S). Single stereochemical isomers as well as enantiomeric and diastereomeric mixtures of the present compounds are specifically contemplated. The compounds may also exist in several tautomeric forms. The term “tautomer” as used herein refers to isomers that change into one another with great ease such that they can exist together in equilibrium. Accordingly, the chemical structures depicted herein encompass all possible tautomeric forms of the illustrated compounds. Additionally, unless otherwise stated, formulas depicted herein are also meant to include compounds that differ only in the presence of one or more isotopically enriched atoms.

Further included within the scope of the present invention are various forms and derivatives of the exemplified compounds. Such forms include, but are not limited to, unsolvated, solvated, and hydrated forms. Further, derivative forms include, but are not limited to, acylated derivatives, alkylated derivatives, amidated derivatives, aminated derivatives, esterified derivatives, and other like derivatives. Furthermore, the compounds may exist in multiple crystalline or amorphous forms. In general, all physical forms are contemplated herein and are within the scope of the present invention.

### Selected Definitions

As used herein, the phrases “sugar-like characteristic,” “sugar-like taste,” “sugar-like sweet,” “sugary,” and “sugar-like” are synonymous. Sugar-like characteristics include any characteristic similar to that of sucrose and include, but are not limited to, maximal response, flavor profile, temporal profile, adaptation behavior, mouthfeel, concentration/response function, tastant/and flavor/sweet taste interactions, spatial pattern selectivity, and temperature effects. These characteristics are dimensions in which the taste of sucrose is different from the tastes of NHPSs. Of these, however, the flavor profile and temporal profile are particularly important. In a single tasting of a sweet food or beverage, differences (1) in the attributes that constitute a sweetener's flavor profile and (2) in the rates of sweetness onset and dissipation, which constitute a sweetener's temporal profile, between those observed for sucrose and for a NHPS can be noted. Desirable embodiments of this invention exhibit a more sugar-like temporal profile, sugar-like flavor profile, or both, than compositions comprising a sweetener composition, but without a sweet taste improving composition.

A suitable composition to be sweetened can be any material suitable for sweetening with a sweetener and desirably is an orally ingestible composition. As used herein, an “ingestible composition” includes any substance that, either alone or together with another substance, can be ingested orally, whether intended for consumption or not. Ingestible compositions include, for example, “food or beverage products,” “pharmaceuticals,” as well as “non-edible products.” By “food or beverage products,” it is meant any edible product intended for consumption by humans or animals, including solids, semi-solids, and liquids (e.g., beverages). The term “non-edible products” or “non-comestible composition” includes any product or composition that can be taken orally by humans or animals for purposes other than consumption as food or beverage. For example, non-edible products and noncomestible compositions include pharmaceuticals and over the counter medications, oral care products such as dentifrices and mouthwashes, cosmetic products such as sweetened lip balms and other personal care products.

An “ingestibly acceptable carrier or excipient” is a medium and/or composition that is used to prepare a desired form of an inventive compound of the subject invention, in order to administer the compound. The medium and/or composition may be in any form depending on the intended use of a product, e.g., solid, semi-solid, liquid, paste, gel, cream, foamy material, suspension, solution, or any combination thereof (such as a liquid containing solids). Ingestibly acceptable carriers include many common food ingredients, such as water at neutral, acidic, or basic pH; fruit or vegetable juices; vinegar; marinades; beer; wine; natural water/fat emulsions such as milk or condensed milk; edible oils and shortenings; fatty acids and their alkyl esters; low molecular weight oligomers of propylene glycol; glyceryl esters of fatty acids; and dispersions or emulsions of such hydrophobic substances in aqueous media; salts such as sodium, calcium or potassium chloride; wheat flours; solvents such as ethanol; solid edible diluents such as vegetable powders or flours; other liquid vehicles; dispersion or suspension aids; surface active agents; isotonic agents; thickening or emulsifying agents; preservatives; solid binders; lubricants and the like.

The terms “isolated,” and “purified,” refer to material that is substantially or essentially free from components that normally accompany the compound as found in its native state. Purity and homogeneity are typically determined using analytical chemistry techniques. Particularly, in preferred embodiments, the compound is at least 85% pure, more preferably at least 90% pure, more preferably at least 95% pure, and most preferably at least 99% pure.

According to the present invention, a “chemosensory receptor” can be any receptor associated with chemosensory sensation or chemosensory ligand triggered signal transduction, e.g., via taste receptors or taste-related receptors expressed in taste buds or internal organs of the body, such as in the gastrointestinal tract, etc. In one embodiment, a chemosensory receptor is a receptor that belongs to the 7-transmembrane receptor superfamily or G protein-coupled receptors (GPCRs). In another embodiment, a chemosensory receptor is a receptor carrying out signal transduction via one or more G proteins. In yet another embodiment, a chemosensory receptor is a receptor that belongs to family C or class C of GPCRs. In yet another embodiment, a chemosensory receptor is a receptor that belongs to the T1R family. In yet another embodiment, a chemosensory receptor is a receptor of T1R1, T1R2, T1R3, or their equivalents or variants or a combination thereof. In still another embodiment, a chemosensory receptor is a hetero-dimer of T1R2 and T1R3, or their equivalent or variant.

“Activation” of a particular receptor, preferably a chemosensory, e.g., the T1R2/T1R3 receptor, refers to a changes in Ca influx, or changes in cAMP, or increase in action potential frequency in a cell where the TAS1R2 and TAS1R3 proteins are expressed upon application of a chemical stimulus. Typically the “activation” will be specific to a particular ligand, i.e., it will not enhance the activation of a chemosensory receptor by chemosensory ligands other than the particular chemosensory ligand, or ligands closely related thereto.

### Compounds of the Current Invention

In specific embodiments, the present invention provides natural sweetener compounds as shown in Table 1, as well as derivatives of the compounds exemplified in Table 1. In preferred embodiments, these compounds are isolated or purified. Any combination of sweetening compounds can be contemplated, as long as the combined effect does not adversely affect the taste of the sweetener composition or the ingestible composition sweetened by the sweetener composition.

The materials used in preparing the compounds of the invention, e.g., the various structural subclasses and species of the compounds or the synthetic precursors of the present compounds, are known compounds, or can be synthesized by known methods described in the literature, or are commercially available from various sources well known to those of ordinary skill in the art. These sources can be, for example, Sigma-Aldrich Corporation of St. Louis, Mo. USA and their subsidiaries Fluka and Riedel-de Haen, at their various other worldwide offices, and other well-known chemical suppliers such as Fisher Scientific, TCI America of Philadelphia, Pa., ChemDiv of San Diego, Calif., Chembridge of San Diego, Calif., Asinex of Moscow, Russia, SPECS/BIOSPECS of the Netherlands, Maybridge of Cornwall, England, Acros, TimTec of Russia, Comgenex of South San Francisco, Calif., and ASDI Biosciences of Newark, Del.

The skilled artisan in the art of organic chemistry can readily carry out the synthesis of many starting materials and subsequent manipulations without further direction. These include, for example, reduction of carbonyl compounds to their corresponding alcohols; oxidations; acylations; aromatic substitutions; both electrophilic and nucleophilic; etherifications; esterification; saponification; nitrations; hydrogenations; reductive animation and the like. These manipulations are discussed in standard texts such as March's Advanced Organic Chemistry (3d Edition, 1985, Wiley-Interscience, New York), Feiser and Feiser's Reagents for Organic Synthesis, and in the various volu\acute{m}es and editions oï Methoden der Organischen Chemie (Houben-Weyl), and the like. Many general methods for preparation of materials comprising variously substituted heterocyclic, hetereoaryl, and aryl rings (the precursors of Ar, hAr1, and/or hAr2) can be found in Methoden der Organischen Chemie (Houben-Weyl), whose various volumes and editions are available from Georg Thieme Verlag, Stuttgart. The entire disclosures of the treatises recited above are hereby incorporated by reference in their entireties for their teachings regarding methods for synthesizing organic compounds and their precursors.

The skilled artisan will also readily appreciate that certain reactions are best carried out when other functionality is masked or protected in the molecule, thus avoiding any undesirable side reactions and/or increasing the yield of the reaction. Often the skilled artisan utilizes protecting groups to accomplish such increased yields or to avoid the undesired reactions. These reactions are found in the literature and are also well within the scope of the skilled artisan. Examples of many of these manipulations can be found for example in T. Greene and P. Wuts, Protecting Groups in Organic Synthesis, 3r Ed., John Wiley & Sons (1999).

### Use of the Compounds of the Subject Invention to Sweeten Consumable Products

The ingestible compositions of the subject invention comprise a sweetenable orally ingestible composition, at least one sweetening compound, and optionally, at least one sweet taste improving composition selected from the group consisting of carbohydrates, polyols, amino acids, other sweet taste improving additives, and combinations thereof.

The compounds or combination of compounds selected from Table 1 should preferably be comestibly acceptable, e.g., deemed suitable for consumption in food or drink, from the perspective of giving the comestible compositions an improved and/or pleasing sweet taste, and are not toxic and do not cause unpleasant or undesirable pharmacological or toxicological effects on a human or other animal at the typical concentrations they are employed as flavoring agents for the comestible compositions.

One of the methods of demonstrating that a flavorant compound is comestibly acceptable is to have the compound tested and/or evaluated by an Expert Panel of the Flavor and Extract Manufacturers Association (FEMA) and declared as to be “Generally Recognized As Safe” (“GRAS”). The FEMA/GRAS evaluation process for flavorant compounds is complex but well known to those of ordinary skill in the food product preparation arts, as is discussed by Smith, et al. in an article entitled “GRAS Flavoring Substances 21,” Food Technology, 57(5), pgs 46-59, May 2003, the entire contents of which are hereby incorporated herein by reference.

In addition to the FEMA expert panel, an independent, qualified panel of experts in pertinent scientific disciplines may be formed by the manufacturer to evaluate the safety of a specific compound for GRAS status. This process is known as a “self-determination of GRAS status.”

Another method of demonstrating that a flavorant compound is comestibly acceptable is to obtain favorable review by the WHO/FAO Joint Expert Committee on Food Additives, or JECFA. There are also other evaluation methods, such as independent review by the regulatory agency, which are generally known to those of ordinary skill in the food product preparation arts.

The sweetener compositions can be formulated so that they are delivered as a dry powder or a liquid suspension. In one embodiment, the sweetening composition is formulated as a liquid or as a paste at the time of preparation. In other embodiments the composition is formulated as a dry powder with one or more liquid media, typically water, and/or binders, added at a later time but prior to mixing with the other food ingredients.

In an embodiment, the sweetening composition is formulated using an ingestibly acceptable carrier or excipient in order to administer the composition in a dispersed/diluted form, so that the biological effectiveness of the composition is maximized.

In further embodiments, the sweetening composition can be low-calorie or calorie-free. Those of ordinary skill in the art should appreciate that the sweetening composition can be customized to obtain a desired calorie content. For example, a low-caloric or non-caloric sweetening composition and/or other caloric additives can be combined with a caloric natural sweetener to produce a sweetener composition with a preferred calorie content. Additionally, because a lower concentration of sweetener composition is required to sweeten an ingestible composition to a desired level, calorie content can be reduced.

A sweetener composition can optionally be combined with a sweet taste improving composition prior to being added to the orally ingestible composition. As used herein, the phrase “sweet taste improving composition” includes any composition which imparts a more sugar-like temporal profile or sugar-like flavor profile or both to a NHPS. Examples of sweet taste improving compositions include, but are not limited to, carbohydrates, polyols, amino acids, and other sweet taste improving taste additives imparting such sugar-like characteristics. For example, a sweetener composition can be in a pure, diluted, or concentrated form as a liquid (e.g., solution), solid (e.g., powder, chunk, pellet, grain, block, crystalline, or the like), suspension, gas state, or combinations thereof may be contacted with the sweet taste improving composition which may be in a pure, diluted, or concentrated form as a liquid (e.g., solution), solid (e.g., powder, chunk, pellet, grain, block, crystalline, or the like), suspension, gas state, or combinations thereof before both are contacted with an orally ingestible composition. In yet another embodiment, when there are more than one sweetener compositions or more than one sweet taste improving composition, each component of the sweetened composition and sweet taste improving composition may be added simultaneously, in an alternating pattern, in a random pattern, or any other pattern which will not adversely affect the taste of the orally ingestible composition.

As used herein, the phrase “sweet taste improving additive” means any material that imparts a more sugar-like temporal profile or sugar-like flavor profile or both to a NHPS. Suitable sweet taste improving additives useful in embodiments of this invention include amino acids and their salts, polyamino acids and their salts, peptides, sugar acids and their salts, nucleotides and their salts, organic acids, inorganic acids, organic salts including organic acid salts and organic base salts, inorganic acid salts (e.g., sodium chloride, potassium chloride, magnesium chloride), bitter compounds, flavorants and flavoring ingredients, astringent compounds, polymers, proteins or protein hydrolysates, surfactants, emulsifiers, flavonoids, alcohols, and synthetic sweeteners.

The sweet taste improving compositions also may be in salt form which may be obtained using standard procedures well known in the art. The term “salt” also refers to complexes that retain the desired chemical activity of the sweet taste improving compositions of the present invention and are safe for human or animal consumption in a generally acceptable range. Alkali metal (for example, sodium or potassium) or alkaline earth metal (for example calcium or magnesium) salts also can be made. Salts also may include combinations of alkali and alkaline earth metals. Non-limiting examples of such salts are (a) acid addition salts formed with inorganic acids and salts formed with organic acids; (b) base addition salts formed with metal cations such as calcium, bismuth, barium, magnesium, aluminum, copper, cobalt, nickel, cadmium, sodium, potassium, and the like, or with a cation formed from ammonia, N,N-dibenzylethylenediamine, D-glucosamine, tetraethylammonium, or ethylenediamine; or (c) combinations of (a) and (b). Thus, any salt forms which may be derived from the sweet taste improving compositions may be used with the embodiments of the present invention as long as the salts of the sweet taste improving additives do not adversely affect the taste of NHPSs or the orally ingestible compositions which comprises NHPSs. The salt forms of the additives can be added to the NHPS sweetener composition in the same amounts as their acid or base forms.

One of ordinary skill in the art may combine at least one sweetener composition with the optional at least one sweet taste improving composition in any manner which does not materially or adversely affect the taste of the orally ingestible composition. For example, a sweetener composition may be added to the orally ingestible composition before the sweet taste improving composition. In another example, a sweetener composition may be added to the orally ingestible composition after the sweet taste improving composition. In yet another example, a sweetener composition may be added to the orally ingestible composition simultaneously with the sweet taste improving composition.

It is contemplated that the combination of at least one sweetener composition to at least one sweet taste improving composition may be carried out in any pH range that does not materially or adversely affect the taste of a sweetener composition or the orally ingestible composition which comprises a sweetener composition. The pH can be, for example, from about 2.5 to about 9.0; from about 2.5 to about 8.0; from about 2.8 to about 7.5; from about 3.0 to about 7, and from about 3.5 to about 7.

An additional embodiment provides a method of sweetening an ingestible composition by adding one or more of said sweetener compositions to the ingestible composition in an amount that increases the sweetness level above that without the sweetener composition. The method can further be used to produce a reduced-calorie ingestible composition. As indicated previously, those of ordinary skill in the art should appreciate that the sweetener composition can be customized to obtain a desired calorie content.

As noted above, ingestible compositions that comprise the compounds of the present invention can be prepared by means of conventional mixing, dissolving, granulating the ingredients into various forms comprising solid, semi-solid, and liquid ingestible compositions, such as food materials. Various additives may be mixed, ground, or granulated with the compositions of this invention to form suitable, compositions. The sweetening compositions can be formulated so that they are delivered as a dry powder or a liquid suspension. In one embodiment, the sweetening composition is formulated as a liquid or as a paste at the time of preparation. In other embodiments the sweetening composition is formulated as a dry powder with one or more liquid media, typically water, and/or binders, added at a later time but prior to mixing with the other ingestible ingredients.

Generally, the amount of sweetener present in a sweetened composition varies widely depending on the particular type of sweetened ingestible composition and its desired sweetness. Those of ordinary skill in the art can readily discern the appropriate amount of sweetener to put in the ingestible composition. In a particular embodiment, the at least one sweetener composition is present in the ingestible composition in an amount in the range of about 1 to about 5,000 ppm of the ingestible composition, and the optional at least one sweet taste improving composition is present in the ingestible composition in an amount in the range of about 0.1 to about 100,000 ppm of the ingestible composition.

The desired weight ratio of the sweetener composition to sweet taste improving composition(s) will depend on the particular compound(s), and the sweetness and other characteristics desired in the final product or orally ingestible composition. NHPSs vary greatly in their potency, ranging from about 30 times more potent than sucrose to about 8,000 times more potent than sucrose on a weight basis. In general, the weight ratio of the NHPS to sweet taste improving composition may for example range from between 10,000:1 to about 1:10,000; a further non-limiting example may range from about 9,000:1 to about 1:9,000; yet another example may range from about 8,000:1 to about 1:8,000; a further example may range from about 7,000:1 to about 1:7,000; another example may range from about 6,000:1 to about 1:6000; in yet another example may range from about 5,000:1 to about 1:5,000; in yet another example may range from about 4,000:1 to about 1:4,000; in yet another example may range from about 3,000:1 to about 1:3,000; in yet another example may range from about 2,000:1 to about 1:2,000; in yet another example may range from about 1,500:1 to about 1:1,500; in yet another example may range from about 1,000:1 to about 1:1,000; in yet another example may range from about 900:1 to about 1:900; in yet another example may range from about 800:1 to about 1:800; in yet another example may range from about 700:1 to about 1:700; in yet another example may range from about 600:1 to about 1:600; in yet another example may range from about 500:1 to about 1:500; in yet another example may range from about 400:1 to about 1:400; in yet another example may range from about 300:1 to about 1:300; in yet another example may range from about 200:1 to about 1:200; in yet another example may range from about 150:1 to about 1:150; in yet another example may range from about 100:1 to about 1:100; in yet another example may range from about 90:1 to about 1:90; in yet another example may range from about 80:1 to about 1:80; in yet another example may range from about 70:1 to about 1:70; in yet another example may range from about 60:1 to about 1:60; in yet another example may range from about 50:1 to about 1:50; in yet another example may range from about 40:1 to about 1:40; in yet another example may range from about 30:1 to about 1:30; in yet another example may range from about 20:1 to about 1:20; in yet another example may range from about 15:1 to about 1:15; in yet another example may range from about 10:1 to about 1:10; in yet another example may range from about 9:1 to about 1:9; in yet another example may range from about 8:1 to about 1:8; in yet another example may range from about 7:1 to about 1:7; in yet another example may range from about 6:1 to about 1:6; in yet another example may range from about 5:1 to about 1:5; in yet another example may range from about 4:1 to about 1:4; in yet another example may range from about 3:1 to about 1:3; in yet another example may range from about 2:1 to about 1:2; and in yet another example may be about 1:1; depending on the particular NHPS selected.

### Noncomestible Products

In certain embodiments, a compound of the present invention is added to a noncomestible composition or non-edible product, such as a pharmaceutical product, over the counter (OTC) product, oral care product, cosmetic product such as sweetened lip balms, or other personal care product.

Over the counter (OTC) product and oral care product refer to products for household and/or personal use that may be sold without a prescription and/or without a visit to a medical professional. Examples of OTC products include, but are not limited to, vitamins and dietary supplements; topical analgesics and/or anesthetics; cough, cold and allergy remedies; antihistamines and/or allergy remedies; and combinations thereof.

Vitamins and dietary supplements include, but are not limited to, vitamins, dietary supplements, tonics/bottled nutritive drinks, child-specific vitamins, dietary supplements, and any other such products.

Topical analgesics and/or anesthetics include any topical creams/ointments/gels used to alleviate superficial or deep-seated aches and pains, e.g., muscle pain; teething gel; patches with analgesic ingredient; and combinations thereof.

Cough, cold and allergy remedies include, but are not limited to, decongestants; cough remedies; pharyngeal preparations; medicated confectioneries; antihistamines and child-specific cough, cold and allergy remedies; and combination products.

Antihistamines and/or allergy remedies include, but are not limited to, any systemic treatments for hay fever, nasal allergies, and insect bites and stings.

Examples of oral care products include, but are not limited to mouth cleaning strips, toothpaste, toothbrushes, mouthwashes/dental rinses, denture care, mouth fresheners at-home teeth whiteners, dentifrices, and dental floss.

### Comestible Products

In additional embodiments, the present compounds are added to food or beverage products or formulations. Examples of food and beverage products or formulations include, but are not limited to sweet coatings, frostings, or glazes for comestible products or any entity included in the Soup category, the Dried Processed Food category, the Beverage category, the Ready Meal category, the Canned or Preserved Food category, the Frozen Processed Food category, the Chilled Processed Food category, the Snack Food category, the Baked Goods category, the Confectionary category, the Dairy Product category, the Ice Cream category, the Meal Replacement category, the Pasta and Noodle category, and the Sauces, Dressings, Condiments category, the Baby Food category, and/or the Spreads category.

In general, the Soup category refers to canned/preserved, dehydrated, instant, chilled, UHT and frozen soup. For the purpose of this definition soup(s) means a food prepared from meat, poultry, fish, vegetables, grains, fruit and other ingredients, cooked in a liquid that may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

The Dehydrated and Culinary Food Category means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

The Beverage category means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes alcoholic drinks, soft drinks, sports drinks, isotonic beverages, and hot drinks. Alcoholic drinks include, but are not limited to beer, cider/perry, FABs, wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

The Snack Food category refers to any food that can be a light informal meal including, but not limited to, sweet and savory snacks and snack bars. Examples of snack food include, but are not limited to, fruit snacks, chips/crisps, extruded snacks, tortilla/corn chips, popcorn, pretzels, nuts and other sweet and savory snacks. Examples of snack bars include, but are not limited to, granola/muesli bars, breakfast bars, energy bars, fruit bars and other snack bars.

The Baked Goods category refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof.

The Ice Cream category refers to frozen dessert containing cream and sugar and flavoring. Examples of ice cream include, but are not limited to: impulse ice cream; take-home ice cream; frozen yoghurt and artisanal ice cream; soy, oat, bean (e.g., red bean and mung bean), and rice-based ice creams.

The Confectionary category refers to edible product that is sweet to the taste. Examples of confectionary include, but are not limited to, candies, gelatins, chocolate confectionery, sugar confectionery, gum, and the likes and any combination products.

The Meal Replacement category refers to any food intended to replace the normal meals, particularly for people having health or fitness concerns. Examples of meal replacement include, but are not limited to, slimming products and convalescence products.

The Ready Meal category refers to any food that can be served as a meal without extensive preparation or processing. The ready meal includes products that have had recipe “skills” added to them by the manufacturer, resulting in a high degree of readiness, completion and convenience. Examples of ready meals include, but are not limited to canned/preserved, frozen, dried, chilled ready meals; dinner mixes; frozen pizza; chilled pizza; and prepared salads.

The Pasta and Noodle category includes any pastas and/or noodles including, but not limited to canned, dried and chilled/fresh pasta; and plain, instant, chilled, frozen and snack noodles.

The Canned/Preserved Food category includes, but is not limited to, canned/preserved meat and meat products, fish/seafood, vegetables, tomatoes, beans, fruit, ready meals, soup, pasta, and other canned/preserved foods.

The Frozen Processed Food category includes, but is not limited to, frozen processed red meat, processed poultry, processed fish/seafood, processed vegetables, meat substitutes, processed potatoes, bakery products, desserts, ready meals, pizza, soup, noodles, and other frozen food.

The Dried Processed Food category includes, but is not limited to, rice, dessert mixes, dried ready meals, dehydrated soup, instant soup, dried pasta, plain noodles, and instant noodles. The Chill Processed Food category includes, but is not limited to, chilled processed meats, processed fish/seafood products, lunch kits, fresh cut fruits, ready meals, pizza, prepared salads, soup, fresh pasta and noodles.

The Sauces, Dressings and Condiments category includes, but is not limited to, tomato pastes and purees, bouillon/stock cubes, herbs and spices, monosodium glutamate (MSG), table sauces, soy based sauces, pasta sauces, wet/cooking sauces, dry sauces/powder mixes, ketchup, mayonnaise, mustard, salad dressings, vinaigrettes, dips, pickled products, and other sauces, dressings and condiments.

The Baby Food category includes, but is not limited to, milk- or soybean-based formula; and prepared, dried and other baby food.

The Spreads category includes, but is not limited to, jams and preserves, honey, chocolate spreads, nut based spreads, and yeast based spreads.

The Dairy Product category generally refers to edible product produced from mammal's milk. Examples of dairy product include, but are not limited to, drinking milk products, cheese, yoghurt and sour milk drinks, and other dairy products.

There are no restrictions on the type of ingestible compositions encompassed by embodiments of this invention as long as they are safe for human consumption when used in a generally acceptable range. These compositions include food, beverage, pharmaceutical, tobacco, nutraceutical, oral hygienic/cosmetic products, and the like. Non-limiting examples of these products include non-carbonated and carbonated beverages such as colas, ginger ales, root beers, ciders, fruit-flavored soft drinks (e.g., citrus-flavored soft drinks such as lemon-lime or orange), powdered soft drinks (e.g., cola, juice, tea, water, coffee), and the like; fruit juices originating in fruits or vegetables, fruit juices including squeezed juices or the like, fruit juices containing fruit particles, fruit beverages, fruit juice beverages, beverages containing fruit juices, beverages with fruit flavorings, vegetable juices, juices containing vegetables, and mixed juices containing fruits and vegetables; sport drinks, energy drinks, near water and the like drinks (e.g., water with natural or artificial flavorants); tea type or favorite type beverages such as coffee, cocoa, black tea, green tea, oolong tea and the like; beverages containing milk components such as milk beverages, coffee containing milk components, café au lait, milk tea, fruit milk beverages, drinkable yogurt, lactic acid bacteria beverages or the like; dairy products; bakery products; desserts such as yogurt, jellies, drinkable jellies, puddings, Bavarian cream, blancmange, cakes, brownies, mousse and the like, sweetened food products eaten at tea time or following meals; frozen foods; cold confections, e.g. types of ice cream such as ice cream, ice milk, lacto-ice and the like (food products in which sweeteners and various other types of raw materials are added to milk products, and the resulting mixture is agitated and frozen), and ice confections such as sherbets, dessert ices and the like (food products in which various other types of raw materials are added to a sugary liquid, and the resulting mixture is agitated and frozen); ice cream; general confections, e. g., baked confections or steamed confections such as cakes, crackers, biscuits, buns with bean jam filling and the like; rice cakes and snacks; table top products; general sugar confections such as chewing gum (e.g. including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans and the like; sauces including fruit flavored sauces, chocolate sauces and the like; edible gels; crémes including butter cremes, flour pastes, whipped cream and the like; jams including strawberry jam, marmalade and the like; breads including sweet breads and the like or other starch products; spice; general condiments including seasoned soy sauce used on roasted meats, roast fowl, barbecued meat and the like, as well as tomato catsup, sauces, noodle broth and the like; processed agricultural products, livestock products or seafood; processed meat products such as sausage and the like; retort food products, pickles, preserves boiled in soy sauce, delicacies, side dishes; snacks such as potato chips, cookies, or the like; cereal products; drugs or quasi-drugs that are administered orally or used in the oral cavity (e.g., vitamins, cough syrups, cough drops, chewable medicine tablets, amino acids, bitter-tasting agents, acidulants or the like), wherein the drug may be in solid, liquid, gel, or gas form such as a pill, tablet, spray, capsule, syrup, drop, troche agent, powder, and the like; personal care products such as other oral compositions used in the oral cavity such as mouth freshening agents, gargling agents, mouth rinsing agents, toothpaste, tooth polish, dentrifices, mouth sprays, teeth-whitening agent and the like; dietary supplements; tobacco products including smoke and smokeless tobacco products such as snuff, cigarette, pipe and cigar tobacco, and all forms of tobacco such as shredded filler, leaf, stem, stalk, homogenized leaf cured, reconstituted binders and reconstituted tobacco from tobacco dust, fines or ether sources in sheet, pellet or other forms, tobacco substitutes formulated from non-tobacco materials, dip or chewing tobacco; animal feed; nutraceutical products, which includes any food or part of a food that may provide medicinal or health benefits, including the prevention and treatment of disease (e.g., cardiovascular disease and high cholesterol, diabetes, osteoporosis, inflammation, or autoimmune disorders), non-limiting examples of nutraceuticals include naturally nutrient-rich or medicinally active food, such as garlic, soybeans, antioxidants, phytosterols and phytostanols and their esters, fibers, glucosamine, chondroitin sulfate, ginseng, ginko, Echinacea, or the like; other nutrients that provide health benefits, such as amino acids, vitamins, minerals, carotenoids, dietary fiber, fatty acids such as omega-3 or omega-6 fatty acids, DHA, EPA, or ALA which can be derived from plant or animal sources (e.g., salmon and other cold-water fish or algae), flavonoids, phenols, polyphenols (e.g., catechins, proanthocyanidins, procyanidins, anthocyanins, quercetin, resveratrol, isoflavones, curcumin, punicalagin, ellagitannin, citrus flavonoids such as hesperidin and naringin, and chlorogenic acid), polyols, prebiotics/probiotics, phytoestrogens, sulfides/thiols, policosanol, saponin, rubisco peptide, appetite suppressants, hydration agents, autoimmune agents, C-reactive protein reducing agents, or anti-inflammatory agents; or any other functional ingredient that is beneficial to the treatment of specific diseases or conditions, such as diabetes, osteoporosis, inflammation, or high cholesterol levels in the blood.

### Tabletop Formulation

In a particular embodiment of the present invention, the sweetener composition comprises a tabletop sweetener comprising at least one sweetener composition in combination with at least one bulking agent and optionally at least one sweet taste improving composition and/or anti-caking agent with improved temporal and/or flavor profile.

In accordance with particular embodiments, suitable “bulking agents” include maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, and mixtures thereof. Additionally, in accordance with still other embodiments of the invention, granulated sugar (sucrose) or other caloric sweeteners such as crystalline fructose, other carbohydrates, or sugar alcohol can be used as a bulking agent due to their provision of good content uniformity without the addition of significant calories. In one embodiment, a bulking agent may be used as a sweet taste improving composition.

As used herein the phrase “anti-caking agent” and “flow agent” refer to any composition which prevents, reduces, inhibits, or suppresses at least one natural and/or synthetic high-potency sweetener molecule from attaching, binding, or contacting to another natural and/or synthetic high-potency sweetener molecule. Alternatively, anti-caking agent may refer to any composition which assists in content uniformity and uniform dissolution. In accordance with particular embodiments, non-limiting examples of anti-caking agents include cream of tartar, calcium silicate, silicon dioxide, microcrystalline cellulose (Avicel, FMC BioPolymer, Philadelphia, Pa.), and tricalcium phosphate. In one embodiment, the anti-caking agents are present in the tabletop functional sweetener composition in an amount from about 0.001 to about 3% by weight of the tabletop functional sweetener composition.

Tabletop sweetener compositions are embodied and packaged in numerous different forms and it is intended that the tabletop sweetener compositions of the present invention may be of any form known in the art. In accordance with particular embodiments, non-limiting examples include powder form, granular form, packets, tablets, sachets, pellets, cubes, solids, and liquids.

In an embodiment, a tabletop sweetener composition comprises a single-serving (portion control) packet comprising a dry-blend of a functional sweetener formulation. Dry-blend formulations generally may comprise powder or granules. Although the tabletop sweetener composition may be in a packet of any size, an illustrative non-limiting example of conventional portion control tabletop sweetener packets are approximately 2.5 by 1.5 inches and hold approximately 1 gram of a sweetener composition having a sweetness equivalent to 2 teaspoons of granulated sugar (\tilde{ }8 g). The amount of sweetener composition in a dry-blend tabletop formulation will vary due to the varying potency of different sweetener compositions. In a particular embodiment, a dry-blend tabletop formulation may comprise a sweetener composition in an amount from about 1% (w/w) to about 10% (w/w) of the tabletop composition.

Solid tabletop sweetener composition embodiments include cubes and tablets. A non-limiting example of conventional cubes are equivalent in size to a standard cube of granulated sugar, which is approximately 2.2×2.2×2.2 cm3 and weigh approximately 8 g. In one embodiment, a solid tabletop sweetener is in the form of a tablet or any other form known to those skilled in the art.

A tabletop sweetener composition also may be embodied in the form of a liquid, wherein the sweetener composition is combined with a liquid carrier. Suitable non-limiting examples of carrier agents for liquid tabletop functional sweeteners include water, alcohol, polyol, glycerin base or citric acid base dissolved in water, and mixtures thereof. Due to the varying potencies of the different high-potency sweeteners, the amount of high-potency sweetener in a liquid tabletop NHPS formulation will also vary. The sweetness equivalent of a tabletop sweetener composition for any of the forms described herein or known in the art may be varied to obtain a desired sweetness profile. For example, a tabletop sweetener composition may comprise a sweetness comparable to that of an equivalent amount of standard sugar. In another embodiment, the tabletop sweetener composition may comprise a sweetness of up to 100 times that of an equivalent amount of sugar. In another embodiment, the tabletop sweetener composition may comprise a sweetness of up to 90 times, 80 times, 70 times, 60 times, 50 times, 40 times, 30 times, 20 times, 10 times, 9 times, 8 times, 7 times, 6 times, 5 times, 4 times, 3 times, and 2 times that of an equivalent amount of sugar.

In one embodiment, the tabletop sweetener composition can also be formulated for targeted uses, for example, in beverage, food, pharmaceutical, cosmetics, herbal/vitamins, tobacco, and in any other products which may be sweetened. For example, a tabletop sweetener composition for baking may be formulated having additional protecting agents such as encapsulants. Other forms will be readily apparent to those skilled in the tabletop sweetener art.

Commonly used methods for making powder or granulated sweetener composition formulations for packets include fluid bed agglomeration processes. Other methods for making tabletop sweetener compositions are well known to those of ordinary skill in the art.

Those skilled in the art appreciate that the amount of sweetener composition and amount and types of sweet taste improving composition, bulking agent, and/or anti-caking agent can be modified in order to tailor the taste of the tabletop sweetener composition to a desired profile and end use.

Having now generally described the invention, the same will be more readily understood by reference to the following examples, which are provided by way of illustration and are not intended as limiting. It is understood that various modifications and changes can be made to the herein disclosed exemplary embodiments without departing from the spirit and scope of the invention.

### EXAMPLES

### Example 1

### Sensory Evaluation of Sugar-Like Taste

Desirable embodiments of this invention exhibit a more sugar-like temporal and/or flavor profile, than ingestible compositions without the present sweetener composition. Whether or not a characteristic is more sugar-like is determined by an expert sensory panel who taste compositions comprising sugar and compositions comprising a NHPS, both with and without a sweet taste improving composition, and provide their impression as to the similarities of the characteristics of compositions comprising a NHPS, both with and without a sweet taste improving composition, with those comprising sugar.

A panel of assessors is used to measure the reduction of sweetness linger. The panel of assessors (generally 8 to 12 individuals) is trained to evaluate sweetness perception and measure sweetness at several time points from when the sample is initially taken into the mouth until 3 minutes after it has been expectorated. Using statistical analysis, the results are compared between samples containing additives and samples that do not contain additives. A decrease in score for a time point measured after the sample has cleared the mouth indicates there has been a reduction in sweetness perception.

The panel of assessors may be trained using procedures well known to those of ordinary skill in the art. In a particular embodiment, the panel of assessors may be trained using the Spectrum M Descriptive Analysis Method (Meilgaard et al, Sensory Evaluation Techniques, 3° edition, Chapter 11). Desirably, the focus of training should be the recognition of and the measure of the basic tastes; specifically, sweet. In order to ensure accuracy and reproducibility of results, each assessor should repeat the measure of the reduction of sweetness linger about three to about five times per sample, taking at least a five minute break between each repetition and/or sample and rinsing well with water to clear the mouth.

Generally, the method of measuring sweetness comprises taking a 10 mL sample into the mouth, holding the sample in the mouth for 5 seconds and gently swirling the sample in the mouth, rating the sweetness intensity perceived at 5 seconds, expectorating the sample (without swallowing following expectorating the sample), rinsing with one mouthful of water (e.g., vigorously moving water in mouth as if with mouth wash) and expectorating the rinse water, rating the sweetness intensity perceived immediately upon expectorating the rinse water, waiting 45 seconds and, while waiting those 45 seconds, identifying the time of maximum perceived sweetness intensity and rating the sweetness intensity at that time (moving the mouth normally and swallowing as needed), rating the sweetness intensity after another 10 seconds, rating the sweetness intensity after another 60 seconds (cumulative 120 seconds after rinse), and rating the sweetness intensity after still another 60 seconds (cumulative 180 seconds after rinse). Between samples take a 5 minute break, rinsing well with water to clear the mouth.

### Example 2

### Sensory Evaluation of Sweetness Intensity

An exemplary method of sensory evaluation is provided in the following protocol, similar to that described hereinabove. In this test protocol, none of the samples were swallowed. All samples were expectorated and the mouth was rinsed with water after the tasting. In step 1, the 10% sucrose control sample was tasted by distributing ca. 10 mL of sample quickly throughout the oral cavity, wherein the maximal “Sweetness Intensity” was measured. This intensity is defined as a 10 on a 0-15 scale where 0 is defined as no perceptible sweetness and 15, the sweetness of 15% sucrose. Immediately upon sensing maximal sweetness, the sample was expectorated, the mouth was rinsed with water and the rate of sweetness decay (“Sweetness Linger”) was measured, where attention was focused on the sweetness 3-4 min after the water rinse. The sweetness linger was rated by a panel of experts in the sensory evaluation of foods and beverages using the following scale: 0=no sweetness linger, 1=very slight sweetness linger, 2=slight sweetness linger, 3=moderate sweetness linger, 4=moderately high sweetness linger, 5=high sweetness linger. After sample tasting was complete, a salty oyster cracker was chewed followed by a water rinse, and at least 5 minutes followed before tasting the next sample.

The “Sweetness Linger” rating for sucrose observed by this protocol was defined as 0. Experimental samples were tasted by the same protocol, always allowing sufficient time between samples to ensure re-equilibration of the sensory system. Re-tasting of control samples during the course of the experiment was allowed and encouraged.

The comparison taste test was performed between two controls and addition of sweet taste improving additive on the onset and/or sweetness linger.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

TABLE 1

| SMILES | Source |
|---|---|
| C/C(═C\CC/C(═C/CC/C(═C/CO)C)C)CCC[C@@](C)(CCC[C@@](C)(CCC[C@@](C)(CCC[C@@] | Natural |
| (C)(CCC[C@@]1(CC[C@@H](O1)[C@](C)(C)O)C)O)O)O)O | |
| C/C(═C\CC/C(═C/CC/C(═C/CO)C)C)CCC[C@](C)(CCC[C@@](C)(CCC[C@@](C)(CCC[C@@](C) | Natural |
| (CCC[C@@]1(CC[C@@H](O1)[C@](C)(C)O)C)O)O)O)O | |
| C/C(═C\CC/C(═C/CC/C(═C/CO)C)C)CCC[C@@](C)(CCC[C@](C)(CCC[C@@](C)(CCC[C@@](C) | Natural |
| (CCC[C@@]1(CC[C@@H](O1)[C@](C)(C)O)C)O)O)O)O | |
| C/C(═C\CC/C(═C/CC/C(═C/CO)C)C)CCC[C@](C)(CCC[C@](C)(CCC[C@@](C)(CCC[C@@](C) | Natural |
| (CCC[C@@]1(CC[C@@H](O1)[C@](C)(C)O)C)O)O)O)O | |
| CC1═C([C@](C[C@H](C1)O)(C)C)/C═C/C(═C/C═C/C(═C/C═C/C═C(\C)/C═C/C═C(\C)/C═C/[C@ | Natural |
| @H]1C(═C[C@](C[C@]1(C)C)(C)O)C)C)C | |
| CC1═C[C@](C[C@@]([C@@H]1/C═C/C(═C/C═C/C(═C/C═C/C═C(\C)/C═C/C═C(\C)/C═C/[C@@] | Natural |
| 12[C@@](O1)(C[C@H](C[C@@]2(C)C)O)C)C)C)(C)C)(C)O | |
| CC1═C[C@](C[C@@]([C@@H]1/C═C/C(═C/C═C/C(═C/C═C/C═C(\C)/C═C/C═C(\C)/C═C/[C@]12 | Natural |
| [C@](O1)(C[C@H](C[C@]2(C)C)O)C)C)C)(C)C)(C)O | |
| CC1═C([C@@](C[C@@H](C1)O)(C)C)/C═C/C(═C/C═C/C(═C/C═C/C═C(\C)/C═C/C═C(\C)/C═C/ | Natural |
| [C@H]1C(═C[C@@H](C[C@]1(C)C)O)C)C)C | |
| CC1═C([C@@](C[C@@H](C1)O)(C)C)/C═C/C(═C/C═C/C(═C/C═C/C═C(\C)/C═C/C═C(\C)/C═C/ | Natural |
| [C@@H]1C(═C[C@@H](C[C@@]1(C)C)O)C)C)C | |
| CC1═C([C@@](C[C@@H](C1)O)(C)C)/C═C/C(═C/C═C/C(═C/C═C/C═C(/C═C/C═C(/C═C/C1═C(C | Natural |
| [C@H](C[C@]1(C)C)O)C)C)C)C)C | |
| CC1═C([C@@](C[C@@H](C1)O)(C)C)/C═C/C(═C/C═C/C(═C/C═C/C═C(\C)/C═C/C═C(\C)/C═C/C═ | Natural |
| C(\C)CC/C═C(\C)C)C)C | |
| CC1═CC(═O)C[C@@](C\1═C/C═C(/C═C/C═C(/C═C/C═C/C(═C/C═C/C(═C/C═C/1[C@](CC(═O)C═ | Natural |
| C1C)(C)C)C)C)C)C)(C)C | |
| C/C(═C\C═C\C═C(\C═C\C═C(\C═C\[C@@]12O[C@@]1(C[C@H](C[C@]2(C)C)O)C)C)C)/C═C/C═ | Natural |
| C(/C═C/[C@@]12O[C@@]1(C[C@H](C[C@]2(C)C)O)C)C | |
| C/C(═C\C═C\C═C(\C═C\C═C(\C═C\[C@]12O[C@]1(C[C@H](C[C@@]2(C)C)O)C)C)C)/C═C/C═C | Natural |
| (/C═C/[C@@]12O[C@@]1(C[C@H](C[C@]2(C)C)O)C)C | |
| CC1═C([C@](CCC1)(C)C)/C═C/C(═C/C═C/C(═C/C═C/C═C(\C)/C═C/C═C(\C)/C═C/C1═C(C[C@H] | Natural |
| (C[C@]1(C)C)O)C)C)C | |
| CC1═C([C@](CCC1)(C)C)/C═C/C(═C/C═C/C(═C/C═C/C═C(\C)/C═C/C═C(\C)/C═C/C1═C(C[C@@ | Natural |
| H](C[C@@]1(C)C)O)C)C)C | |
| CC(═O)N[C@@H]1[C@@H]([C@@H]([C@@H](O[C@@H]1O[C@@](C)(C)[C@@H]1CC[C@@] | Natural |
| 2(C═C(CC[C@@H]2O1)[C@@H]1CC[C@@H]2[C@@]1(C[C@@H]([C@@H]1[C@@]2(CC[C | |
| @@H](O1)[C@@](C)(C)O)C)O)C)C)CO)O)O | |
| CC(═O)N[C@H]1[C@@H]([C@@H]([C@@H](O[C@@H]1O[C@@](C)(C)[C@@H]1CC[C@@]2 | Natural |
| (C═C(CC[C@@H]2O1)[C@@H]1CC[C@@H]2[C@@]1(C[C@@H]([C@@H]1[C@@]2(CC[C@ | |
| @H](O1)[C@@](C)(C)O)C)O)C)C)CO)O)O | |
| CC(═O)N[C@@H]1[C@H]([C@@H]([C@@H](O[C@@H]1O[C@@](C)(C)[C@@H]1CC[C@@]2 | Natural |
| (C═C(CC[C@@H]2O1)[C@@H]1CC[C@@H]2[C@@]1(C[C@@H]([C@@H]1[C@@]2(CC[C@ | |
| @H](O1)[C@@](C)(C)O)C)O)C)C)CO)O)O | |
| CC(═O)N[C@H]1[C@H]([C@@H]([C@@H](O[C@@H]1O[C@](C)(C)[C@@H]1CC[C@@]2(C═ | Natural |
| C(CC[C@@H]2O1)[C@@H]1CC[C@@H]2[C@@]1(C[C@@H]([C@@H]1[C@@]2(CC[C@@H] | |
| (O1)[C@@](C)(C)O)C)O)C)C)CO)O)O | |
| CC(═O)N[C@@H]1[C@@H]([C@@H]([C@@H](O[C@@H]1O[C@@](C)(C)[C@@H]1CC[C@@] | Natural |
| 2(C═C(CC[C@@H]2O1)[C@@H]1CC[C@@H]2[C@@]1(C[C@@H]([C@@H]1[C@@]2(CC[C | |
| @@H](O1)[C@](C)(C)O)C)O)C)C)COC)O)O | |
| CC(═O)N[C@H]1[C@@H]([C@@H]([C@@H](O[C@@H]1O[C@@](C)(C)[C@@H]1CC[C@@]2 | Natural |
| (C═C(CC[C@@H]2O1)[C@@H]1CC[C@@H]2[C@@]1(C[C@@H]([C@@H]1[C@@]2(CC[C@ | |
| @H](O1)[C@](C)(C)O)C)O)C)C)COC)O)O | |
| CC(═O)N[C@@H]1[C@H]([C@@H]([C@@H](O[C@@H]1O[C@@](C)(C)[C@@H]1CC[C@@]2 | Natural |
| (C═C(CC[C@@H]2O1)[C@@H]1CC[C@@H]2[C@@]1(C[C@@H]([C@@H]1[C@@]2(CC[C@ | |
| @H](O1)[C@](C)(C)O)C)O)C)C)COC)O)O | |
| CC(═O)N[C@H]1[C@H]([C@@H]([C@@H](O[C@@H]1O[C@](C)(C)[C@@H]1CC[C@@]2(C═ | Natural |
| C(CC[C@@H]2O1)[C@@H]1CC[C@@H]2[C@@]1(C[C@@H]([C@@H]1[C@@]2(CC[C@@H] | |
| (O1)[C@](C)(C)O)C)O)C)C)COC)O)O | |
| C[C@@]12CC[C@H]([C@@]([C@H]1CCC(═C)[C@H]2C/C═C/1[C@@H](COC1═O)OC(═O)/C(═ | Natural |
| C/CO)[C@@H](C[C@@H]1C(═C)CC[C@H]2[C@]1(CC[C@H]([C@@]2(C)CO)O)C)O)(C)CO)O | |
| C[C@@]12CC[C@H]([C@@]([C@H]1CCC(═C)[C@H]2C/C═C/1[C@H](COC1═O)OC(═O)/C(═C/ | Natural |
| CO)[C@@H](C[C@@H]1C(═C)CC[C@H]2[C@]1(CC[C@H]([C@@]2(C)CO)O)C)O)(C)CO)O | |
| C[C@@]12CC[C@H]([C@@]([C@H]1CCC(═C)[C@H]2C/C═C/1[C@@H](COC1═O)OC(═O)/C(═ | Natural |
| C/CO)[C@H](C[C@@H]1C(═C)CC[C@H]2[C@]1(CC[C@H]([C@@]2(C)CO)O)C)O)(C)CO)O | |
| C[C@@]12CC[C@H]([C@@]([C@H]1CCC(═C)[C@H]2C/C═C/1[C@H](COC1═O)OC(═O)/C(═C/ | Natural |
| CO)[C@H](C[C@@H]1C(═C)CC[C@H]2[C@]1(CC[C@H]([C@@]2(C)CO)O)C)O)(C)CO)O | |
| C/C(═C\CC/C(═C/CO)C)CC[C@@H]([C@@](C)(CCC[C@@](C)(CCC[C@@](C)(CCC[C@@](C) | Natural |
| (CCC[C@@](C)(CCC[C@@](C)(CCC[C@@](C)(C)O)O)O)O)O)O)O)O | |
| C/C(═C\CC/C(═C/CO)C)CC[C@H]([C@@](C)(CCC[C@@](C)(CCC[C@@](C)(CCC[C@@](C)(C | Natural |
| CC[C@@](C)(CCC[C@@](C)(CCC[C@@](C)(C)O)O)O)O)O)O)O)O | |
| C/C(═C\CC/C(═C/CO)C)CC[C@@H]([C@](C)(CCC[C@@](C)(CCC[C@@](C)(CCC[C@@](C)(C | Natural |
| CC[C@@](C)(CCC[C@@](C)(CCC[C@@](C)(C)O)O)O)O)O)O)O)O | |
| C/C(═C\CC/C(═C/CO)C)CC[C@H]([C@](C)(CCC[C@@](C)(CCC[C@@](C)(CCC[C@@](C)(CC | Natural |
| C[C@@](C)(CCC[C@@](C)(CCC[C@@](C)(C)O)O)O)O)O)O)O)O | |
| CC(═O)O[C@@H]1C[C@@]2([C@@H]3CC═C4[C@@H]([C@@]3(CC[C@@]2([C@@H]1[C@@] | Natural |
| (C)(C(═O)CC[C@](C)(C)O)O)C)C)C[C@@H]([C@@H]([C@]4(C)C)O)O[C@@H]1[C@@H]([C | |
| @@H]([C@@H]([C@@H](O1)CO)O)O)O)C | |
| CC(═O)O[C@H]1C[C@@]2([C@@H]3CC═C4[C@@H]([C@@]3(CC[C@@]2([C@@H]1[C@@] | Natural |
| (C)(C(═O)CC[C@](C)(C)O)O)C)C)C[C@@H]([C@@H]([C@]4(C)C)O)O[C@@H]1[C@@H]([C@ | |
| @H]([C@@H]([C@@H](O1)CO)O)O)O)C | |
| CC(═O)O[C@@H]1C[C@]2([C@@H]3CC═C4[C@@H]([C@@]3(CC[C@@]2([C@@H]1[C@@] | Natural |
| (C)(C(═O)CC[C@](C)(C)O)O)C)C)C[C@@H]([C@@H]([C@]4(C)C)O)O[C@@H]1[C@@H]([C@ | |
| @H]([C@@H]([C@@H](O1)CO)O)O)O)C | |
| CC(═O)O[C@H]1C[C@]2([C@@H]3CC═C4[C@@H]([C@@]3(CC[C@@]2([C@@H]1[C@@](C) | Natural |
| (C(═O)CC[C@](C)(C)O)O)C)C)C[C@@H]([C@@H]([C@]4(C)C)O)O[C@@H]1[C@@H]([C@@ | |
| H]([C@@H]([C@@H](O1)CO)O)O)O)C | |
| C/C(═C\CC[C@@](C)(CCC[C@@](C)(CCC[C@@](C)(CCC[C@@](C)(CCC[C@@](C)(CCC[C@ | Natural |
| @](C)(CCC/C(═C/CC/C(═C/CO)C)C)O)O)O)O)O)O)C | |
| C/C(═C\CC[C@](C)(CCC[C@@](C)(CCC[C@@](C)(CCC[C@@](C)(CCC[C@@](C)(CCC[C@@] | Natural |
| (C)(CCC/C(═C/CC/C(═C/CO)C)C)O)O)O)O)O)O)C | |
| C/C(═C\CC[C@@](C)(CCC[C@](C)(CCC[C@@](C)(CCC[C@@](C)(CCC[C@@](C)(CCC[C@@] | Natural |
| (C)(CCC/C(═C/CC/C(═C/CO)C)C)O)O)O)O)O)O)C | |
| C/C(═C\CC[C@](C)(CCC[C@](C)(CCC[C@@](C)(CCC[C@@](C)(CCC[C@@](C)(CCC[C@@](C) | Natural |
| (CCC/C(═C/CC/C(═C/CO)C)C)O)O)O)O)O)O)C | |
| C/C(═C\CC[C@@](C)(CCC[C@@](C)(CCC[C@@](C)(CCC[C@@](C)(CCC[C@@](C)(CCC[C@ | Natural |
| @](C)([C@@H](CC/C(═C/CC/C(═C/CO)C)C)O)O)O)O)O)O)O)C | |
| C/C(═C\CC[C@](C)(CCC[C@@](C)(CCC[C@@](C)(CCC[C@@](C)(CCC[C@@](C)(CCC[C@@] | Natural |
| (C)([C@@H](CC/C(═C/CC/C(═C/CO)C)C)O)O)O)O)O)O)O)C | |
| C/C(═C\CC[C@@](C)(CCC[C@](C)(CCC[C@@](C)(CCC[C@@](C)(CCC[C@@](C)(CCC[C@@] | Natural |
| (C)([C@@H](CC/C(═C/CC/C(═C/CO)C)C)O)O)O)O)O)O)O)C | |
| C/C(═C\CC[C@](C)(CCC[C@](C)(CCC[C@@](C)(CCC[C@@](C)(CCC[C@@](C)(CCC[C@@](C) | Natural |
| ([C@@H](CC/C(═C/CC/C(═C/CO)C)C)O)O)O)O)O)O)O)C | |
| C/C(═C\CC[C@@](C)(CCC[C@@](C)(CCC[C@@](C)(CCC[C@@](C)(CCC[C@@](C)(CCC/C(═ | Natural |
| C/CC/C(═C/CC/C(═C/CO)C)C)C)O)O)O)O)O)C | |
| C/C(═C\CC[C@](C)(CCC[C@@](C)(CCC[C@@](C)(CCC[C@@](C)(CCC[C@@](C)(CCC/C(═C/ | Natural |
| CC/C(═C/CC/C(═C/CO)C)C)C)O)O)O)O)O)C | |
| C/C(═C\CC[C@@](C)(CCC[C@](C)(CCC[C@@](C)(CCC[C@@](C)(CCC[C@@](C)(CCC/C(═C/ | Natural |
| CC/C(═C/CC/C(═C/CO)C)C)C)O)O)O)O)O)C | |
| C/C(═C\CC[C@](C)(CCC[C@](C)(CCC[C@@](C)(CCC[C@@](C)(CCC[C@@](C)(CCC/C(═C/CC | Natural |
| /C(═C/CC/C(═C/CO)C)C)C)O)O)O)O)O)C | |
| CC1═CCC[C@]([C@H]1/C(═C/C(═C/C═C/C═C/C(═C/C═C/C═C(\C)/C═C/C═C(\C)/C═C/C(═O)[C@ | Natural |
| @](C)(C)CCCCCC(═O)C)C)C)C)(C)C | |
| CCCCCC(═O)O[C@@H]1C[C@]2([C@@H](CC═C2[C@]2([C@H]1[C@]1(C═CC(═O)[C@@]([C | Natural |
| @@H]1C[C@H]2OC(═O)C)(C)C)C)C)[C@@H]1C[C@H](O[C@@H]1OC(═O)C)[C@H]1[C@](O1) | |
| (C)C)C | |
| C[C@H](CC[C@H]([C@@](C)(C)O)O)[C@H]1[C@H](C[C@@]2([C@@]1(CC[C@]13[C@H]2C | Natural |
| [C@@H]([C@@H]2[C@]1(C3)CC[C@@H]([C@]2(C)C)O[C@H]1[C@@H]([C@H]([C@@H](CO | |
| 1)O)O)O)OC(═O)C)C)C)O | |
| C/C(═C\CC[C@@](C)(C═C)O[C@H]1[C@@H]([C@H]([C@@H]([C@H](O1)CO)O)O)O[C@H]1 | Natural |
| [C@@H]([C@H]([C@@H]([C@H](O1)CO)O)O)O)CC/C═C(\C)C[C@@H](/C═C(\C)C(═O)[O—])O | |
| C/C(═C\CC[C@](C)(C═C)O[C@H]1[C@@H]([C@H]([C@@H]([C@H](O1)CO)O)O)O[C@H]1[C | Natural |
| @@H]([C@H]([C@@H]([C@H](O1)CO)O)O)O)CC/C═C(\C)C[C@@H](/C═C(\C)C(═O)[O—])O | |
| C/C(═C\CC[C@@](C)(C═C)O[C@H]1[C@@H]([C@H]([C@@H]([C@H](O1)CO)O)O)O[C@H]1 | Natural |
| [C@@H]([C@H]([C@@H]([C@H](O1)CO)O)O)O)CC/C═C(\C)C[C@H](/C═C(\C)C(═O)[O—])O | |
| C/C(═C\CC[C@](C)(C═C)O[C@H]1[C@@H]([C@H]([C@@H]([C@H](O1)CO)O)O)O[C@H]1[C | Natural |
| @@H]([C@H]([C@@H]([C@H](O1)CO)O)O)O)CC/C═C(\C)C[C@H](/C═C(\C)C(═O)[O—])O | |
| CC1═C([C@@](CCC1)(C)C)/C═C/C(═C/C═C/C(═C/C═C/C═C(\C)/C═C/C═C(\C)/C═C/C═C(\C)/C═ | Natural |
| C/C═C(\C)C)C)C | |
| CC(═O)O[C@@H]1C[C@@H]2[C@]3(CC[C@@H]([C@@]([C@@H]3CC[C@]2([C@]2([C@@H] | Natural |
| 1[C@@](CC2)([C@@]1(CC[C@@H](O1)[C@@](C)(C)O)C)O)C)C)(C)C)OC(═O)CC(═O)[O—])C | |
| CC(═O)O[C@@H]1C[C@H]2[C@]3(CC[C@@H]([C@@]([C@@H]3CC[C@]2([C@]2([C@@H]1 | Natural |
| [C@@](CC2)([C@@]1(CC[C@@H](O1)[C@@](C)(C)O)C)O)C)C)(C)C)OC(═O)CC(═O)[O—])C | |
| CC(═O)O[C@@H]1C[C@@H]2[C@]3(CC[C@H]([C@]([C@@H]3CC[C@]2([C@]2([C@@H]1[C | Natural |
| @@](CC2)([C@@]1(CC[C@@H](O1)[C@@](C)(C)O)C)O)C)C)(C)C)OC(═O)CC(═O)[O—])C | |
| CC(═O)O[C@@H]1C[C@H]2[C@]3(CC[C@H]([C@@]([C@@H]3CC[C@]2([C@]2([C@@H]1[C | Natural |
| @@](CC2)([C@@]1(CC[C@@H](O1)[C@@](C)(C)O)C)O)C)C)(C)C)OC(═O)CC(═O)[O—])C | |
| CC(═O)O[C@@](C)(C)CCC(═O)[C@@](C)([C@@H]1[C@@H](C[C@@]2([C@@]1(CC(═O)[C@ | Natural |
| @]1([C@H]2CC═C2[C@H]1C[C@@H](C(═O)[C@@]2(C)C)O[C@H]1[C@@H]([C@H]([C@@H] | |
| ([C@H](O1)CO)O)O)O)C)C)C)O)O | |
| CC(═O)O[C@@](C)(C)CCC(═O)[C@@](C)([C@H]1[C@@H](C[C@@]2([C@@]1(CC(═O)[C@@] | Natural |
| 1([C@H]2CC═C2[C@H]1C[C@@H](C(═O)[C@@]2(C)C)O[C@H]1[C@@H]([C@H]([C@@H] | |
| ([C@H](O1)CO)O)O)O)C)C)C)O)O | |
| CC/C═C\C/C═C\C/C═C\CCCCCCCC(═O)OC[C@H](CO[C@H]1[C@@H]([C@H]([C@H]([C@H] | Natural |
| (O1)CO)O)O)O)OC(═O)CCCCCCC/C═C\C/C═C\C/C═C\CC | |
| C[C@@]12CC[C@@H](C[C@@H]1CC[C@@H]1[C@@H]2CC[C@@]2([C@@]1(CCC\2═C\1CC | Natural |
| (═O)OC1)O)C)O[C@@H]1[C@@H]([C@@H]([C@@H]([C@@H](O1)CO)O)O[C@@H]1[C@@H] | |
| ([C@@H]([C@@H]([C@@H](O1)CO)O)O)O)O | |
| C[C@]12CC[C@@H](C[C@@H]1CC[C@@H]1[C@@H]2CC[C@@]2([C@@]1(CCC\2═C\1CC(═ | Natural |
| O)OC1)O)C)O[C@@H]1[C@@H]([C@@H]([C@@H]([C@@H](O1)CO)O)O[C@@H]1[C@@H] | |
| ([C@@H]([C@@H]([C@@H](O1)CO)O)O)O)O | |
| C[C@@]12CC[C@H](C[C@@H]1CC[C@@H]1[C@@H]2CC[C@@]2([C@@]1(CCC\2═C\1CC(═ | Natural |
| O)OC1)O)C)O[C@@H]1[C@@H]([C@@H]([C@@H]([C@@H](O1)CO)O)O[C@@H]1[C@@H] | |
| ([C@@H]([C@@H]([C@@H](O1)CO)O)O)O)O | |
| C[C@]12CC[C@H](C[C@@H]1CC[C@@H]1[C@@H]2CC[C@@]2([C@@]1(CCC\2═C\1CC(═O) | Natural |
| OC1)O)C)O[C@@H]1[C@@H]([C@@H]([C@@H]([C@@H](O1)CO)O)O[C@@H]1[C@@H]([C | |
| @@H]([C@@H]([C@@H](O1)CO)O)O)O)O | |
| CC1═C([C@@](CCC1)(C)C)/C═C/C(═C/C═C/C(═C/C═C/C═C(/C═C/C═C(/C═C/C1═C(CCC[C@@] | Natural |
| 1(C)C)C)C)C)C)C | |
| CC1═C([C@@](CCC1)(C)C)/C═C/C(═C\C═C/C(═C/C═C/C═C(/C═C\C═C(/C═C/C1═C(CCC[C@@] | Natural |
| 1(C)C)C)C)C)C)C | |
| C[C@@H]1[C@@H](C[C@@]2(CC[C@@]3(C(═CC[C@@H]4[C@@]3(CC[C@@H]3[C@@]4(C | Natural |
| [C@@H]([C@@H]([C@@]3(C)C(═O)[O—])OC(═O)C)O)C)C)[C@@H]2[C@@]1(C)O)C)C(═O)[O—]) | |
| O[C@@H]1[C@@ H]([C@@H]([C@@H]([C@@H](O1)CO)O)O)O | |
| C[C@H]1[C@@H](C[C@@]2(CC[C@@]3(C(═CC[C@@H]4[C@@]3(CC[C@@H]3[C@@]4(C[C | Natural |
| @@H]([C@@H]([C@@]3(C)C(═O)[O—])OC(═O)C)O)C)C)[C@@H]2[C@@]1(C)O)C)C(═O)[O—]) | |
| O[C@@H]1[C@@H] ([C@@H]([C@@H]([C@@H](O1)CO)O)O)O | |
| C[C@@H]1[C@H](C[C@@]2(CC[C@@]3(C(═CC[C@@H]4[C@@]3(CC[C@@H]3[C@@]4(C[C | Natural |
| @@H]([C@@H]([C@@]3(C)C(═O)[O—])OC(═O)C)O)C)C)[C@@H]2[C@@]1(C)O)C)C(═O)[O—]) | |
| O[C@@H]1[C@@H] ([C@@H]([C@@H]([C@@H](O1)CO)O)O)O | |
| C[C@H]1[C@H](C[C@@]2(CC[C@@]3(C(═CC[C@@H]4[C@@]3(CC[C@@H]3[C@@]4(C[C@ | Natural |
| @H]([C@@H]([C@@]3(C)C(═O)[O—])OC(═O)C)O)C)C)[C@@H]2[C@@]1(C)O)C)C(═O)[O—]) | |
| O[C@@H]1[C@@H] ([C@@H]([C@@H]([C@@H](O1)CO)O)O)O | |
| C[C@H](CCC(═C)[C@@H](C)C)[C@H]1CC[C@@]2([C@@]1(CC[C@]13[C@H]2CC[C@@H]2 | Natural |
| [C@]1(C3)CC[C@@H]([C@@]2(C)C)OC(═O)/C═C/c1ccc(c(c1)OC)O)C)C | |
| C[C@@H](C[C@@H]([C@@H]([C@](C)(C)O)O)O)[C@@H]1CC[C@@]2([C@@]1(CC[C@@]13 | Natural |
| [C@@H]2CC[C@@H]2[C@@]1(C3)[C@@H](C[C@@H]([C@@]2(C)C(═O)O[C@@H]1[C@@H] | |
| ([C@@H]([C@@H]([C@@H](O1)CO)O)O)O)O)O)C)C | |
| C[C@H](C[C@@H]([C@@H]([C@](C)(C)O)O)O)[C@@H]1CC[C@@]2([C@@]1(CC[C@@]13 | Natural |
| [C@@H]2CC[C@@H]2[C@@]1(C3)[C@@H](C[C@@H]([C@@]2(C)C(═O)O[C@@H]1[C@@H] | |
| ([C@@H]([C@@H]([C@@H](O1)CO)O)O)O)O)O)C)C | |
| C[C@@H](C[C@H]([C@@H]([C@](C)(C)O)O)O)[C@@H]1CC[C@@]2([C@@]1(CC[C@@]13 | Natural |
| [C@@H]2CC[C@@H]2[C@@]1(C3)[C@@H](C[C@@H]([C@@]2(C)C(═O)O[C@@H]1[C@@H] | |
| ([C@@H]([C@@H]([C@@H](O1)CO)O)O)O)O)O)C)C | |
| C[C@H](C[C@H]([C@@H]([C@](C)(C)O)O)O)[C@@H]1CC[C@@]2([C@@]1(CC[C@@]13[C | Natural |
| @@H]2CC[C@@H]2[C@@]1(C3)[C@@H](C[C@@H]([C@@]2(C)C(═O)O[C@@H]1[C@@H] | |
| ([C@@H]([C@@H]([C@@H](O1)CO)O)O)O)O)O)C)C | |
| C[C@@]12CC[C@@H](C[C@@H]1CC[C@@H]1[C@@H]2CC[C@@]2([C@@]1(CCC\2═C\1CC | Natural |
| (═O)OC1)O)C)O[C@@H]1[C@@H]([C@@H]([C@@H]([C@@H](O1)CO)O)O)O[C@@H]1[C@ | |
| @H]([C@@H]([C@@H]([C@@H](O1)CO)O)O)O | |
| C[C@]12CC[C@@H](C[C@@H]1CC[C@@H]1[C@@H]2CC[C@@]2([C@@]1(CCC\2═C\1CC(═ | Natural |
| O)OC1)O)C)O[C@@H]1[C@@H]([C@@H]([C@@H]([C@@H](O1)CO)O)O)O[C@@H]1[C@@ | |
| H]([C@@H]([C@@H]([C@@H](O1)CO)O)O)O | |
| C[C@@]12CC[C@H](C[C@@H]1CC[C@@H]1[C@@H]2CC[C@@]2([C@@]1(CCC\2═C\1CC(═ | Natural |
| O)OC1)O)C)O[C@@H]1[C@@H]([C@@H]([C@@H]([C@@H](O1)CO)O)O)O[C@@H]1[C@@ | |
| H]([C@@H]([C@@H]([C@@H](O1)CO)O)O)O | |
| C[C@]12CC[C@H](C[C@@H]1CC[C@@H]1[C@@H]2CC[C@@]2([C@@]1(CCC\2═C\1CC(═O) | Natural |
| OC1)O)C)O[C@@H]1[C@@H]([C@@H]([C@@H]([C@@H](O1)CO)O)O)O[C@@H]1[C@@H] | |
| ([C@@H]([C@@H]([C@@H](O1)CO)O)O)O | |
| C[C@]12CC[C@@H](C[C@@H]1CC[C@@H]1[C@@H]2CC[C@]2([C@@]1(CC[C@@H]2C1═C | Natural |
| C(═O)OC1)O)C)O[C@@H]1[C@@H]([C@@H]([C@@H]([C@@H](O1)CO)O)O)O[C@@H]1[C@ | |
| @H]([C@@H]([C@@H]([C@@H](O1)CO)O)O)O | |
| C[C@]12CC[C@@H](C[C@@H]1CC[C@@H]1[C@H]2CC[C@]2([C@@]1(CC[C@@H]2C1═CC | Natural |
| (═O)OC1)O)C)O[C@@H]1[C@@H]([C@@H]([C@@H]([C@@H](O1)CO)O)O)O[C@@H]1[C@@ | |
| H]([C@@H]([C@@H]([C@@H](O1)CO)O)O)O | |
| C[C@]12CC[C@@H](C[C@@H]1CC[C@@H]1[C@@H]2CC[C@]2([C@@]1(CC[C@@H]2C1═C | Natural |
| C(═O)OC1)O)C)O[C@H]1[C@@H]([C@@H]([C@@H]([C@@H](O1)CO)O)O)O[C@@H]1[C@@ | |
| H]([C@@H]([C@@H]([C@@H](O1)CO)O)O)O | |
| C[C@]12CC[C@@H](C[C@@H]1CC[C@@H]1[C@H]2CC[C@]2([C@@]1(CC[C@@H]2C1═CC | Natural |
| (═O)OC1)O)C)O[C@H]1[C@@H]([C@@H]([C@@H]([C@@H](O1)CO)O)O)O[C@@H]1[C@@H] | |
| ([C@@H]([C@@H]([C@@H](O1)CO)O)O)O | |
| CC(═O)N[C@@H]1[C@H]([C@@H]([C@H](O[C@H]1O[C@H]1CC[C@]2([C@H]([C@]1(C)C)C | Natural |
| C[C@@]1([C@@H]2CC═C2[C@]1(C[C@H]([C@@]1([C@@H]2C[C@@](CC1)(C)C)C(═O)[O—]) | |
| O)C)C)C)CO)O)O | |
| CC(═O)N[C@@H]1[C@@H]([C@@H]([C@@H](O[C@@H]1O[C@@H]1CC[C@@]2([C@@H] | Natural |
| ([C@@]1(C)C)CC[C@@]1([C@@H]2CC═C2[C@@]1(C[C@@H]([C@@]1([C@@H]2C[C@@](CC | |
| 1)(C)C)C(═O)[O—])O)C)C)C)CO)O)O | |
| CC(═O)N[C@H]1[C@@H]([C@@H]([C@@H](O[C@@H]1O[C@@H]1CC[C@@]2([C@@H]([C | Natural |
| @@]1(C)C)CC[C@@]1([C@@H]2CC═C2[C@@]1(C[C@@H]([C@@]1([C@@H]2C[C@@](CC1) | |
| (C)C)C(═O)[O—])O)C)C)C)CO)O)O | |
| CC(═O)N[C@@H]1[C@H]([C@@H]([C@@H](O[C@@H]1O[C@@H]1CC[C@@]2([C@@H]([C | Natural |
| @@]1(C)C)CC[C@@]1([C@@H]2CC═C2[C@@]1(C[C@@H]([C@@]1([C@@H]2C[C@@](CC1) | |
| (C)C)C(═O)[O—])O)C)C)C)CO)O)O | |
| CC(═O)N[C@H]1[C@H]([C@@H]([C@@H](O[C@@H]1O[C@@H]1CC[C@@]2([C@@H]([C@ | Natural |
| @]1(C)C)CC[C@@]1([C@@H]2CC═C2[C@@]1(C[C@@H]([C@@]1([C@@H]2C[C@@](CC1) | |
| (C)C)C(═O)[O—])O)C)C)C)CO)O)O | |
| CC(═O)N[C@@H]1[C@H]([C@@H]([C@H](O[C@H]1O[C@H]1CC[C@]2([C@@H]([C@@]1(C) | Natural |
| C)CC[C@@]1([C@@H]2CC═C2[C@]1(C[C@H]([C@@]1([C@@H]2C[C@@](CC1)(C)C)C(═O) | |
| [O—])O)C)C)C)CO)O)O | |
| CC(═O)N[C@@H]1[C@H]([C@@H]([C@H](O[C@H]1O[C@H]1CC[C@]2([C@@H]([C@@]1(C) | Natural |
| C)CC[C@@]1([C@H]2CC═C2[C@]1(C[C@H]([C@@]1([C@@H]2C[C@@](CC1)(C)C)C(═O)[O—]) | |
| O)C)C)C)CO)O)O | |
| CC(═O)N[C@@H]1[C@H]([C@@H]([C@H](O[C@H]1O[C@H]1CC[C@]2([C@H]([C@]1(C)C)C | Natural |
| C[C@@]1([C@H]2CC═C2[C@]1(C[C@H]([C@@]1([C@@H]2C[C@@](CC1)(C)C)C(═O)[O—]) | |
| O)C)C)C)CO)O)O | |
| C[C@@]12CC[C@@H](CC1═CC[C@@H]1[C@@H]2CC[C@@]2([C@@]1(CCC\2═C\1CC(═O)O | Natural |
| C1)O)C)O[C@@H]1[C@@H]([C@@H]([C@@H]([C@@H](O1)CO)O)O[C@@H]1[C@@H]([C@ | |
| @H]([C@@H]([C@@H](O1)CO)O)O)O)O | |
| C[C@]12CC[C@@H](CC1═CC[C@@H]1[C@@H]2CC[C@@]2([C@@]1(CCC\2═C\1CC(═O)OC1) | Natural |
| O)C)O[C@@H]1[C@@H]([C@@H]([C@@H]([C@@H](O1)CO)O)O[C@@H]1[C@@H]([C@@ | |
| H]([C@@H]([C@@H](O1)CO)O)O)O)O | |
| C[C@@]12CC[C@H](CC1═CC[C@@H]1[C@@H]2CC[C@@]2([C@@]1(CCC\2═C\1CC(═O)OC1) | Natural |
| O)C)O[C@@H]1[C@@H]([C@@H]([C@@H]([C@@H](O1)CO)O)O[C@@H]1[C@@H]([C@@ | |
| H]([C@@H]([C@@H](O1)CO)O)O)O)O | |
| C[C@]12CC[C@H](CC1═CC[C@@H]1[C@@H]2CC[C@@]2([C@@]1(CCC\2═C\1CC(═O)OC1) | Natural |
| O)C)O[C@@H]1[C@@H]([C@@H]([C@@H]([C@@H](O1)CO)O)O[C@@H]1[C@@H]([C@@H] | |
| ([C@@H]([C@@H](O1)CO)O)O)O)O | |
| C[C@@H]1[C@@H)([C@@H)([C@@H]([C@@H](O1)O[C@@H]1[C@@H](O[C@H]([C@@H] | Natural |
| ([C@@H]1O)O)O[C@@H]1C[C@H]2CC[C@@H]3[C@@H]([C@]2([C@@H](C1)O)C)CC[C@]1 | |
| ([C@@]3(CC[C@@H]1C1═CC(═O)OC1)O)C)CO)O)OC)O | |
| C[C@H]1[C@@H]([C@@H]([C@@H]([C@@H](O1)O[C@@H]1[C@@H](O[C@H]([C@@H]([C | Natural |
| @@H]1O)O)O[C@@H]1C[C@H]2CC[C@@H]3[C@@H]([C@]2([C@@H](C1)O)C)CC[C@]1([C | |
| @@]3(CC[C@@H]1C1═CC(═O)OC1)O)C)CO)O)OC)O | |
| C[C@@H]1[C@H]([C@@H]([C@@H]([C@@H](O1)O[C@@H]1[C@@H](O[C@H]([C@@H]([C | Natural |
| @@H]1O)O)O[C@@H]1C[C@H]2CC[C@@H]3[C@@H]([C@]2([C@@H](C1)O)C)CC[C@]1([C | |
| @@]3(CC[C@@H]1C1═CC(═O)OC1)O)C)CO)O)OC)O | |
| C[C@H]1[C@H]([C@@H]([C@@H]([C@@H](O1)[C@@H]1[C@@H](O[C@H]([C@@H]([C@ | Natural |
| @H]1O)O)O[C@@H]1C[C@H]2CC[C@@H]3[C@@H]([C@]2([C@@H](C1)O)C)CC[C@]1([C@ | |
| @]3(CC[C@@H]1C1═CC(═O)OC1)O)C)CO)O)OC)O | |
| C[C@H](CC/C═C(\C)C)[C@H]1CC[C@@]2([C@@]1(CC[C@]13[C@H]2CC[C@H]2[C@]1(C3)C | Natural |
| C[C@@H]([C@]2(C)C)OC(═O)/C═C/c1ccc(c(c1)OC)O)C)C | |
| CCCCC[C@@H](C[C@@H](CC(═O)O[C@@H](CCCCC)C[C@@H](CC(═O)[O—]) | Natural |
| O[C@@H]1[C@@H]([C@@H]([C@@H]([C@@H](O1)CO)O)O)O)O)O[C@@H]1[C@@H]([C | |
| @@H]([C@@H]([C@@H](O1)CO)O)O)O | |
| CCCCC[C@H](C[C@@H](CC(═O)O[C@@H](CCCCC)C[C@@H](CC(═O)[O—]) | Natural |
| O[C@@H]1[C@@H]([C@@H]([C@@H]([C@@H](O1)CO)O)O)O)O)O[C@@H]1[C@@H]([C | |
| @@H]([C@@H]([C@@H](O1)CO)O)O)O | |
| CCCCC[C@@H](C[C@H](CC(═O)O[C@@H](CCCCC)C[C@@H](CC(═O)[O—]) | Natural |
| O[C@@H]1[C@@H]([C@@H]([C@@H]([C@@H](O1)CO)O)O)O)O)O[C@@H]1[C@@H]([C | |
| @@H]([C@@H]([C@@H](O1)CO)O)O)O | |
| CCCCC[C@H](C[C@H](CC(═O)O[C@@H](CCCCC)C[C@@H](CC(═O)[O—]) | Natural |
| O[C@@H]1[C@@H]([C@@H] | |
| ([C@@H]([C@@H](O1)CO)O)O)O)O)O[C@@H]1[C@@H]([C@@H]([C@@H]([C@@H](O1)C | |
| O)O)O)O | |
| CCCCOc1ccc(cc1)NC(═O)[C@]([C@@]([C@]([C@]([C@]([C@]([C@@]([C@](F)(F)F)(F)F)(F)F) | Natural |
| (F)F)(F)F)(F)F)(F)F)(F)F | |
| CC(═O)O[C@@](C)(C)/C═C/C(═O)[C@@](C)([C@@H]1[C@@H](C[C@@]2([C@@]1(CC(═O)[C | Natural |
| @@]1([C@H]2CC═C2[C@H]1C[C@@H](C(═O)[C@@]2(C)C)O[C@H]1[C@@H]([C@H]([C@@ | |
| H]([C@H](O1)CO)O)O)O)C)C)C)O)O | |
| CC(═O)O[C@@](C)(C)/C═C/C(═O)[C@@](C)([C@H]1[C@@H](C[C@@]2([C@@]1(CC(═O)[C@ | Natural |
| @]1([C@H]2CC═C2[C@H]1C[C@@H](C(═O)[C@@]2(C)C)O[C@H]1[C@@H]([C@H]([C@@H] | |
| ([C@H](O1)CO)O)O)O)C)C)C)O)O | |
| c1cc(ccc1CCCC[C@@H](CCc1ccc(cc1)O)O[C@H]1[C@@H]([C@H]([C@@H]([C@H](O1)CO[C | Natural |
| @@H]1[C@@H]([C@](CO1)(CO)O)O)O)O)O[C@@H]1[C@@H]([C@](CO1)(CO)O)O)O | |
| c1cc(ccc1CCCC[C@H](CCc1ccc(cc1)O)O[C@H]1[C@@H]([C@H]([C@@H]([C@H](O1)CO[C@ | Natural |
| @H]1[C@@H]([C@](CO1)(CO)O)O)O)O)O[C@@H]1[C@@H]([C@](CO1)(CO)O)O)O | |
| C[C@@H](CC[C@@H]([C@@](C)(C)O)O)[C@@H]1CC[C@@]2([C@@]1([C@@H](CC1═C2CC | Natural |
| [C@@H]2[C@@]1(C[C@@H]([C@@H]([C@@]2(C)C)O)OC(═O)C[C@@](C)(CC(═O)[O—]) | |
| O)C)O)C)C | |
| C[C@H](CC[C@@H]([C@@](C)(C)O)O)[C@@H]1CC[C@@]2([C@@]1([C@@H](CC1═C2CC[C | Natural |
| @@H]2[C@@]1(C[C@@H]([C@@H]([C@@]2(C)C)O)OC(═O)C[C@@](C)(CC(═O)[O—]) | |
| O)C)O)C)C | |
| C[C@@H](CC[C@H]([C@@](C)(C)O)O)[C@@H]1CC[C@@]2([C@@]1([C@@H](CC1═C2CC[C | Natural |
| @@H]2[C@@]1(C[C@@H]([C@@H]([C@@]2(C)C)O)OC(═O)C[C@@](C)(CC(═O)[O—]) | |
| O)C)O)C)C | |
| C[C@H](CC[C@H]([C@@](C)(C)O)O)[C@@H]1CC[C@@]2([C@@]1([C@@H](CC1═C2CC[C@ | Natural |
| @H]2[C@@]1(C[C@@H]([C@@H]([C@@]2(C)C)O)OC(═O)C[C@@](C)(CC(═O)[O—]) | |
| O)C)O)C)C | |
| C[C@@](C)(C)c1ccc(cc1)OC(═O)[C@@]([C@@]([C@@]([C@]([C@@]([C@]([C@]([C@](F)(F)F) | Natural |
| (F)F)(F)F)(F)F)(F)F)(F)F)(F)F)(F)F | |
| CCCCCC(═O)O[C@H]1[C@H]([C@@H]([C@H](O[C@H]1OC[C@@H]([C@@H](CO)O)O)COC | Natural |
| (═O)C)OC(═O)C)OC(═O)CCCCCCCCCCCCCO | |
| C[C@@H](CC[C@@H]([C@](C)(C)O)O)[C@@H]1CC[C@@]2([C@@]1(CC[C@@]13[C@@H]2 | Natural |
| CC[C@@H]2[C@@]1(C3)[C@@H](C[C@@H]([C@@]2(C)C(═O)O[C@@H]1[C@@H]([C@@H] | |
| ([C@@H]([C@@H](O1)CO)O)O)O)O)O)C)C | |
| C[C@H](CC[C@@H]([C@](C)(C)O)O)[C@@H]1CC[C@@]2([C@@]1(CC[C@@]13[C@@H]2C | Natural |
| C[C@@H]2[C@@]1(C3)[C@@H](C[C@@H]([C@@]2(C)C(═O)O[C@@H]1[C@@H]([C@@H] | |
| ([C@@H]([C@@H](O1)CO)O)O)O)O)O)C)C | |
| C[C@@H](CC[C@H]([C@](C)(C)O)O)[C@@H]1CC[C@@]2([C@@]1(CC[C@@]13[C@@H]2C | Natural |
| C[C@@H]2[C@@]1(C3)[C@@H](C[C@@H]([C@@]2(C)C(═O)O[C@@H]1[C@@H]([C@@H] | |
| ([C@@H]([C@@H](O1)CO)O)O)O)O)O)C)C | |
| C[C@H](CC[C@H]([C@](C)(C)O)O)[C@@H]1CC[C@@]2([C@@]1(CC[C@@]13[C@@H]2CC | Natural |
| [C@@H]2[C@@]1(C3)[C@@H](C[C@@H]([C@@]2(C)C(═O)O[C@@H]1[C@@H]([C@@H]([C | |
| @@H]([C@@H](O1)CO)O)O)O)O)O)C)C | |
| Cc1cc(cc(c1C(═O)N[C@@H](C)C(═O)[O—])O)OC(═O)c1c(cc(cc1O[C@H]1[C@@H]([C@H] | Natural |
| ([C@@H]([C@H](O1)CO)O)O)O)OC(═O)c1c(cc(cc1OC)OC)C)C | |
| Cc1cc(cc(c1C(═O)N[C@H](C)C(═O)[O—]) | Natural |
| O)OC(═O)c1c(cc(cc1O[C@H]1[C@@H]([C@H]([C@@H] | |
| ([C@H](O1)CO)O)O)O)OC(═O)c1c(cc(cc1OC)OC)C)C | |
| C/C(═C\CC[C@@](C)(C═C)O[C@H]1[C@@H]([C@H]([C@@H]([C@H](O1)CO)OC(═O)/C(═C/C | Natural |
| C[C@@](C)(C═C)O)C)OC(═O)/C(═C/CC[C@@](C)(C═C)O)C)O)C(═O)[O—] | |
| C/C(═C\CC[C@](C)(C═C)O[C@H]1[C@@H]([C@H]([C@@H]([C@H](O1)CO)OC(═O)/C(═C/CC | Natural |
| [C@@](C)(C═C)O)C)OC(═O)/C(═C/CC[C@@](C)(C═C)O)C)O)C(═O)[O—] | |
| C/C(═C\CC[C@@](C)(C═C)O[C@H]1[C@@H]([C@H]([C@@H]([C@H](O1)CO)OC(═O)/C(═C/C | Natural |
| C[C@](C)(C═C)O)C)OC(═O)/C(═C/CC[C@@](C)(C═C)O)C)O)C(═O)[O—] | |
| C/C(═C\CC[C@](C)(C═C)O[C@H]1[C@@H]([C@H]([C@@H]([C@H](O1)CO)OC(═O)/C(═C/CC | Natural |
| [C@](C)(C═C)O)C)OC(═O)/C(═C/CC[C@@](C)(C═C)O)C)O)C(═O)[O—] | |
| C/C═C(\C)C(═O)O[C@@H]1C[C@]2([C@@H](CC═C2[C@]2([C@H]1[C@]1(C═CC(═O)[C@@] | Natural |
| ([C@@H]1C[C@H]2OC(═O)C)(C)C)C)C)[C@@H]1C[C@H](O[C@@H]1OC(═O)C)[C@H]1[C@] | |
| (O1)(C)C)C | |
| C[C@@H]([C@@H]1CC[C@@]2([C@@]1(CC[C@@]13[C@@H]2CC[C@@H]2[C@@]1(C3)[C | Natural |
| @@H](C[C@@H]([C@@]2(C)C(═O)O[C@@H]1[C@@H]([C@@H]([C@@H]([C@@H](O1)CO) | |
| O)O)O)O)O)C)C)[C@@H](C[C@@H]([C@](C)(C)O)O)O | |
| C[C@H]([C@@H]1CC[C@@]2([C@@]1(CC[C@@]13[C@@H]2CC[C@@H]2[C@@]1(C3)[C@ | Natural |
| @H](C[C@@H]([C@@]2(C)C(═O)O[C@@H]1[C@@H]([C@@H]([C@@H]([C@@H](O1)CO)O) | |
| O)O)O)O)C)C)[C@@H](C[C@@H]([C@](C)(C)O)O)O | |
| C[C@@H]([C@H]1CC[C@@]2([C@@]1(CC[C@@]13[C@@H]2CC[C@@H]2[C@@]1(C3)[C@ | Natural |
| @H](C[C@@H]([C@@]2(C)C(═O)O[C@@H]1[C@@H]([C@@H]([C@@H]([C@@H](O1)CO)O) | |
| O)O)O)O)C)C)[C@@H](C[C@@H]([C@](C)(C)O)O)O | |
| C[C@H]([C@H]1CC[C@@]2([C@@]1(CC[C@@]13[C@@H]2CC[C@@H]2[C@@]1(C3)[C@@ | Natural |
| H](C[C@@H]([C@@]2(C)C(═O)O[C@@H]1[C@@H]([C@@H]([C@@H]([C@@H](O1)CO)O)O) | |
| O)O)O)C)C)[C@@H](C[C@@H]([C@](C)(C)O)O)O | |
| COc1ccc(cc1OC)/C═C/C(═O)OC[C@@H]1[C@H]([C@@H]([C@H]([C@@H](O1)O[C@@H](CC | Natural |
| CCc1ccc(c(c1)O)O)CCc1ccc(c(c1)O)O)O)O)O | |
| COc1ccc(cc1OC)/C═C/C(═O)OC[C@@H]1[C@H]([C@@H]([C@H]([C@@H](O1)O[C@H](CCCC | Natural |
| c1ccc(c(c1)O)O)CCc1ccc(c(c1)O)O)O)O)O | |
| C/C(═C\CC[C@@](C)([C@H]1CC[C@@]2([C@@H]1[C@@H](C[C@H]1[C@]2(C[C@@H]([C@ | Natural |
| @H]2[C@@]1(CC[C@@H]([C@@]2(C)C)O)C)O[C@H]1[C@@H]([C@H]([C@@H]([C@H](O1) | |
| CO)O)O)O)C)O)C)O)C | |
| COc1ccc(cc1OC)/C═C/C(═O)OC[C@@H]1[C@H]([C@@H]([C@H]([C@@H](O1)O[C@@H](CCc | Natural |
| 1ccc(c(c1)O)O)CC(═O)CCc1ccc(c(c1)O)O)O)O)O | |
| COc1ccc(cc1OC)/C═C/C(═O)OC[C@@H]1[C@H]([C@@H]([C@H]([C@@H](O1)O[C@H](CCc1c | Natural |
| cc(c(c1)O)O)CC(═O)CCc1ccc(c(c1)O)O)O)O)O | |
| C[C@@]1(CCC[C@@]2([C@@H]1CCC(═C)[C@@H]2CCC1═CCOC1═O)C)CO[C@@H]1[C@@ | Natural |
| H]([C@@H]([C@@H]([C@@H](O1)COC(═O)CC(═O)[O—])O)O)O | |
| C[C@]1(CCC[C@@]2([C@@H]1CCC(═C)[C@@H]2CCC1═CCOC1═O)C)CO[C@@H]1[C@@H] | Natural |
| ([C@@H]([C@@H]([C@@H](O1)COC(═O)CC(═O)[O—])O)O)O | |
| C[C@@]1(CCC[C@]2([C@@H]1CCC(═C)[C@@H]2CCC1═CCOC1═O)C)CO[C@@H]1[C@@H] | Natural |
| ([C@@H]([C@@H]([C@@H](O1)COC(═O)CC(═O)[O—])O)O)O | |
| C[C@]1(CCC[C@]2([C@@H]1CCC(═C)[C@@H]2CCC1═CCOC1═O)C)CO[C@@H]1[C@@H] | Natural |
| ([C@@H]([C@@H]([C@@H](O1)COC(═O)CC(═O)[O—])O)O)O | |
| CCC(═O)/C(═C/[C@@H](C)C[C@@H](C)[C@@H]1[C@@H]([C@@H]([C@@H](C═C[C@@H] | Natural |
| (CCCC═C([C@@H]2C(═CC[C@@](O2)(CC(═O)O1)O)C)C)O[C@@H]1C[C@@H]([C@@H]([C@ | |
| @H](O1)C)O)OC(═O)N)C)O)C)C | |
| CCC(═O)/C(═C/[C@H](C)C[C@@H](C)[C@@H]1[C@@H]([C@@H]([C@@H](C═C[C@@H](C | Natural |
| CCC═C([C@@H]2C(═CC[C@@](O2)(CC(═O)O1)O)C)C)O[C@@H]1C[C@@H]([C@@H]([C@@ | |
| H](O1)C)O)OC(═O)N)C)O)C)C | |
| CCC(═O)/C(═C/[C@@H](C)C[C@H](C)[C@@H]1[C@@H]([C@@H]([C@@H](C═C[C@@H](C | Natural |
| CCC═C([C@@H]2C(═CC[C@@](O2)(CC(═O)O1)O)C)C)O[C@@H]1C[C@@H]([C@@H]([C@@ | |
| H](O1)C)O)OC(═O)N)C)O)C)C | |
| CCC(═O)/C(═C/[C@H](C)C[C@H](C)[C@@H]1[C@@H]([C@@H]([C@@H](C═C[C@@H](CCC | Natural |
| C═C([C@@H]2C(═CC[C@@](O2)(CC(═O)O1)O)C)C)O[C@@H]1C[C@@H]([C@@H]([C@@H] | |
| (O1)C)O)OC(═O)N)C)O)C)C | |
| CCCC(═O)O[C@H]1[C@H]([C@@H]([C@H](O[C@H]1OC[C@@H]([C@@H](CO)O)O)COC(═O) | Natural |
| C)OC(═O)C)OC(═O)CCCCCCCCCCCCCO | |
| C[C@]12CC[C@@H]([C@@]([C@@H]1CC[C@@]1([C@@H]2CC═C2[C@]1(CC[C@@]1([C@ | Natural |
| @H]2C[C@@](CC1)(C)C)C(═O)[O—]) | |
| C)C)(C)CO)O[C@H]1[C@@H]([C@H]([C@@H]([C@H](O1)C(═O)[O—])O)O)O | |
| C[C@]12CC[C@@H]([C@]([C@@H]1CC[C@@]1([C@@H]2CC═C2[C@]1(CC[C@@]1([C@@H] | Natural |
| 2C[C@@](CC1)(C)C)C(═O)[O—]) | |
| C)C)(C)CO)O[C@H]1[C@@H]([C@H]([C@@H]([C@H](O1)C(═O)[O—])O)O)O | |
| C[C@]12CC[C@@H]([C@@H]([C@H]1CC[C@@]1([C@@H]2CC═C2[C@]1(CC[C@@]1([C@@H] | Natural |
| 2C[C@@](CC1)(C)C)C(═O)[O—]) | |
| C)C)(C)CO)O[C@H]1[C@@H]([C@H]([C@@H]([C@H](O1)C(═O)[O—])O)O)O | |
| C[C@]12CC[C@@H]([C@]([C@H]1CC[C@@]1([C@@H]2CC═C2[C@]1(CC[C@@]1([C@@H]2 | Natural |
| C[C@@](CC1)(C)C)C(═O)[O—]) | |
| C)C)(C)CO)O[C@H]1[C@@H]([C@H]([C@@H]([C@H](O1)C(═O)[O—])O)O)O | |
| C[C@H](C[C@H]([C@H]1[C@](O1)(C)C)OC(═O)C)[C@H]1C(═O)[C@@H]([C@@]2([C@@]1(C | Natural |
| C[C@]13[C@H]2CC[C@@H]2[C@]1(C3)CC[C@@H]([C@]2(C)C)O[C@H]1[C@@H]([C@H]([C | |
| @H](CO1)O)O)O)C)C)O | |
| C[C@H](C[C@H]([C@H]1[C@](O1)(C)C)OC(═O)C)[C@H]1C(═O)[C@@H]([C@@]2([C@@]1(C | Natural |
| C[C@]13[C@H]2CC[C@H]2[C@]1(C3)CC[C@@H]([C@]2(C)C)O[C@H]1[C@@H]([C@H]([C@ | |
| H](CO1)O)O)O)C)C)O | |
| C[C@@H]1CC[C@@]2(CC[C@@]3(C(═CC[C@H]4[C@]3(CC[C@H]3[C@@]4(C[C@H]([C@@ | Natural |
| H]([C@@]3(COC(═O)C)COC(═O)C)OC(═O)C)OC(═O)C)C)C)[C@H]2[C@]1(C)O)C)C | |
| CC1═C[C@@H]([C@H]([C@@H](C1)c1ccc(cc1O)O)C(═O)c1ccc(c(c1O)C/C═C(\C)C)O)c1c(cc(c2c | Natural |
| 1oc(c(c2═O)C/C═C(\C)C)c1ccc(cc1O)O)O)O | |
| C[C@]12CC[C@@H]([C@@]([C@@H]1CC[C@@]1([C@@H]2CC═C2[C@]1(CC[C@@]1([C@H] | Natural |
| 2C[C@@](CC1)(C)C)C(═O)[O—]) | |
| C)C)(C)C)O[C@H]1[C@@H]([C@H]([C@@H]([C@H](O1)C(═O)[O—])O)O)O | |
| C[C@]12CC[C@@H]([C@@]([C@@H]1CC[C@@]1([C@@H]2CC═C2[C@]1(CC[C@@]1([C@ | Natural |
| @H]2C[C@@](CC1)(C)C)C(═O)[O—]) | |
| C)C)(C)C)O[C@H]1[C@@H]([C@H]([C@@H]([C@H](O1)C(═O)[O—])O)O)O | |
| C[C@]12CC[C@@H]([C@]([C@H]1CC[C@@]1([C@@H]2CC═C2[C@]1(CC[C@@]1([C@@H]2 | Natural |
| C[C@@](CC1)(C)C)C(═O)[O—]) | |
| C)C)(C)C)O[C@H]1[C@@H]([C@H]([C@@H]([C@H](O1)C(═O)[O—])O)O)O | |
| C[C@]12CC[C@@H]([C@@]([C@@H]1CC[C@@]1([C@H]2CC═C2[C@]1(CC[C@@]1([C@@H] | Natural |
| 2C[C@@](CC1)(C)C)C(═O)[O—]) | |
| C)C)(C)C)O[C@H]1[C@@H]([C@H]([C@@H]([C@H](O1)C(═O)[O—])O)O)O | |
| C[C@]12CC[C@@H]([C@]([C@H]1CC[C@@]1([C@H]2CC═C2[C@]1(CC[C@@]1([C@@H]2C | Natural |
| [C@@](CC1)(C)C)C(═O)[O—]) | |
| C)C)(C)C)O[C@H]1[C@@H]([C@H]([C@@H]([C@H](O1)C(═O)[O—])O)O)O | |
| CCCCCC(═O)O[C@@H]1C[C@]2([C@@H](CC═C2[C@]2([C@H]1[C@]1(C═CC(═O)[C@@]([C | Natural |
| @@H]1C[C@H]2O)(C)C)C)C)[C@@H]1C[C@H](O[C@@H]1OC(═O)C)[C@H]1[C@](O1)(C)C) | |
| C | |
| CCCCC[C@@H](C[C@@H](CC(═O)O[C@@H](CCCCC)C[C@@H](CC(═O)O[C@@H](CCCCC) | Natural |
| C[C@@H](CC(═O)O[C@@H](CCCCC)C[C@@H](CC(═O)[O—])O)O)O)O)O | |
| CCCCC[C@H](C[C@@H](CC(═O)O[C@@H](CCCCC)C[C@@H](CC(═O)O[C@@H](CCCCC)C | Natural |
| [C@@H](CC(═O)O[C@@H](CCCCC)C[C@@H](CC(═O)[O—])O)O)O)O)O | |
| CCCCC[C@@H](C[C@H](CC(═O)O[C@@H](CCCCC)C[C@@H](CC(═O)O[C@@H](CCCCC)C | Natural |
| [C@@H](CC(═O)O[C@@H](CCCCC)C[C@@H](CC(═O)[O—])O)O)O)O)O | |
| CCCCC[C@H](C[C@H](CC(═O)O[C@@H](CCCCC)C[C@@H](CC(═O)O[C@@H](CCCCC)C[C | Natural |
| @@H](CC(═O)O[C@@H](CCCCC)C[C@@H](CC(═O)[O—])O)O)O)O)O | |
| C[C@H](C)[C@@H]1[C@@H]([C@@H]([C@@H]2[C@@]1(CC[C@@]1([C@@]2(CC═C2[C@ | Natural |
| @H]1CC[C@@H]1[C@@]2(C[C@@H]([C@@H]([C@@]1(C)C)O[C@@H]1[C@@H]([C@@H] | |
| ([C@@H]([C@@H](O1)CO)O)O)O)OC(═O)C)C)C)C)C)O)O | |
| C[C@@H](C)[C@H]1[C@@H]([C@@H]([C@@H]2[C@@]1(CC[C@@]1([C@@]2(CC═C2[C@ | Natural |
| @H]1CC[C@@H]1[C@@]2(C[C@@H]([C@@H]([C@@]1(C)C)O[C@@H]1[C@@H]([C@@H] | |
| ([C@@H]([C@@H](O1)CO)O)O)O)OC(═O)C)C)C)C)C)O)O | |
| C[C@H](C)[C@@H]1[C@H]([C@@H]([C@@H]2[C@@]1(CC[C@@]1([C@@]2(CC═C2[C@@H] | Natural |
| 1CC[C@@H]1[C@@]2(C[C@@H]([C@@H]([C@@]1(C)C)O[C@@H]1[C@@H]([C@@H]([C@ | |
| @H]([C@@H](O1)CO)O)O)O)OC(═O)C)C)C)C)C)O)O | |
| C[C@@H](C)[C@H]1[C@H]([C@@H]([C@@H]2[C@@]1(CC[C@@]1([C@@]2(CC═C2[C@@H] | Natural |
| 1CC[C@@H]1[C@@]2(C[C@@H]([C@@H]([C@@]1(C)C)O[C@@H]1[C@@H]([C@@H]([C@ | |
| @H]([C@@H](O1)CO)O)O)O)OC(═O)C)C)C)C)C)O)O | |
| C/C(═C\CC/C(═C/C[C@@H](/C(═C/CC[C@]1([C@@H](/C(═C(/C)OC)CC[C@]1(C)O)CCCO)C)C) | Natural |
| OC(═O)C)C)C | |
| C[C@@]12CC[C@]3(CC[C@](C[C@H]3C1═CC[C@H]1[C@]2(C[C@H]([C@@H]2[C@@]1(C[C | Natural |
| @H]([C@@H]([C@@]2(C)CO)O)O)C)O)C)(C)C)C(═O)O[C@H]1[C@@H]([C@H]([C@@H]([C@ | |
| H](O1)CO)O)O)O | |
| C[C@@]12CC[C@]3(CC[C@](C[C@@H]3C1═CC[C@@H]1[C@]2(C[C@H]([C@@H]2[C@@]1 | Natural |
| (C[C@H]([C@@H]([C@@]2(C)CO)O)O)C)O)C)(C)C)C(═O)O[C@H]1[C@@H]([C@H]([C@@H] | |
| ([C@H](O1)CO)O)O)O | |
| C[C@@]12CC[C@]3(CC[C@](C[C@H]3C1═CC[C@@H]1[C@]2(C[C@H]([C@@H]2[C@@]1(C | Natural |
| [C@H]([C@@H]([C@@]2(C)CO)O)O)C)O)C)(C)C)C(═O)O[C@H]1[C@@H]([C@H]([C@@H]([C | |
| @H](O1)CO)O)O)O | |
| C[C@@]12CC[C@]3(CC[C@](C[C@@H]3C1═CC[C@H]1[C@]2(C[C@H]([C@@H]2[C@@]1(C | Natural |
| [C@H]([C@@H]([C@@]2(C)CO)O)O)C)O)C)(C)C)C(═O)O[C@H]1[C@@H]([C@H]([C@@H]([C | |
| @H](O1)CO)O)O)O | |
| C[C@@H](CCCCC[C@@H](CCCCCCCCCCC[C@@H](CC(═O)OC)O[C@@H]1[C@@H]([C@@ | Natural |
| H]([C@@H]([C@@H](O1)CO)O)O)O)O[C@@H]1[C@@H]([C@@H]([C@@H]([C@@H](O1)CO) | |
| O)O)O)O | |
| C[C@H](CCCCC[C@@H](CCCCCCCCCCC[C@@H](CC(═O)OC)O[C@@H]1[C@@H]([C@@H] | Natural |
| ([C@@H]([C@@H](O1)CO)O)O)O)O[C@@H]1[C@@H]([C@@H]([C@@H]([C@@H](O1)CO)O) | |
| O)O)O | |
| C[C@@H](CCCCC[C@H](CCCCCCCCCCC[C@@H](CC(═O)OC)O[C@@H]1[C@@H]([C@@H] | Natural |
| ([C@@H]([C@@H](O1)CO)O)O)O)O[C@@H]1[C@@H]([C@@H]([C@@H]([C@@H](O1)CO)O) | |
| O)O)O | |
| C[C@H](CCCCC[C@H](CCCCCCCCCCC[C@@H](CC(═O)OC)O[C@@H]1[C@@H]([C@@H] | Natural |
| ([C@@H]([C@@H](O1)CO)O)O)O)O[C@@H]1[C@@H]([C@@H]([C@@H]([C@@H](O1)CO)O) | |
| O)O)O | |
| CC[C@@H](C)C(═O)O[C@H]1CC(═C2[C@H]([C@@H]([C@@]3(CC[C@@H](C(═C)[C@H]3[C | Natural |
| @@H]([C@H]1[C@]2(C)C)OC(═O)C)OC(═O)C)C)OC(═O)C)OC(═O)C)C | |
| CC[C@H](C)C(═O)O[C@H]1CC(═C2[C@H]([C@@H]([C@@]3(CC[C@@H](C(═C)[C@H]3[C@ | Natural |
| @H]([C@H]1[C@]2(C)C)OC(═O)C)OC(═O)C)C)OC(═O)C)OC(═O)C)C | |
| C[C@@H]1CC[C@@]2(CC[C@@]3(C(═CC[C@H]4[C@]3(CC[C@@H]3[C@@]4(C[C@H]([C@ | Natural |
| @H]([C@@]3(CO)CO)O)O)C)C)[C@H]2[C@]1(C)O)C)C(═O)O[C@H]1[C@@H]([C@H]([C@@ | |
| H]([C@H](O1)CO)O)O)O | |
| CCCCCCCCCCCC[C@H]([C@H]1CC[C@@H](O1)[C@@H](CC[C@@H](C[C@@H](CCCCC[C | Natural |
| @H](CC1═C[C@@H](OC1═O)C)O)O)O)O)O | |
| CC1═CC[C@@H](OC1═O)[C@@H](C)[C@@H]1CC[C@@]2([C@@]1(CC[C@@]13[C@@H]2C | Natural |
| C[C@@H]2[C@@]1(C3)CC[C@@H]([C@@]2(C)C(═O)[O—]) | |
| O[C@@H]1[C@@H]([C@@H]([C@@H]([C@@H](O1) CO)O)O)O)C)C | |
| CC1═CC[C@H](OC1═O)[C@@H](C)[C@@H]1CC[C@@]2([C@@]1(CC[C@@]13[C@@H]2CC | Natural |
| [C@@H]2[C@@]1(C3)CC[C@@H]([C@@]2(C)C(═O)[O—]) | |
| O[C@@H]1[C@@H]([C@@H]([C@@H] ([C@@H](O1)CO)O)O)O)C)C | |
| CC1═CC[C@@H](OC1═O)[C@H](C)[C@@H]1CC[C@@]2([C@@]1(CC[C@@]13[C@@H]2CC | Natural |
| [C@@H]2[C@@]1(C3)CC[C@@H]([C@@]2(C)C(═O)[O—]) | |
| O[C@@H]1[C@@H]([C@@H]([C@@H] ([C@@H](O1)CO)O)O)O)C)C | |
| CC1═CC[C@H](OC1═O)[C@H](C)[C@@H]1CC[C@@]2([C@@]1(CC[C@@]13[C@@H]2CC[C | Natural |
| @@H]2[C@@]1(C3)CC[C@@H]([C@@]2(C)C(═O)[O—]) | |
| O[C@@H]1[C@@H]([C@@H]([C@@H] ([C@@H](O1)CO)O)O)O)C)C | |
| C[C@@H](C)c1c2c(cc(c1O)c1cc3c(c(c1O)[C@@H](C)C)CC[C@H]1[C@@]3(CCC[C@]1(C)C)C) | Natural |
| [C@]1(CCC[C@]([C@H]1CC2)(C)C)C | |
| C[C@@]12CC[C@]3(CC[C@]([C@H]([C@@H]3C1═CC[C@@H]1[C@]2(C[C@H]([C@@H]2[C | Natural |
| @@]1(C[C@H]([C@@H]([C@@]2(C)CO)O)O)C)O)C)O)(C)C)C(═O)O[C@H]1[C@@H]([C@H] | |
| ([C@@H]([C@H](O1)CO)O)O)O | |
| C[C@@]12CC[C@]3(CC[C@]([C@H]([C@H]3C1═CC[C@@H]1[C@]2(C[C@H]([C@@H]2[C@ | Natural |
| @]1(C[C@H]([C@@H]([C@@]2(C)CO)O)O)C)O)C)O)(C)C)C(═O)O[C@H]1[C@@H]([C@H]([C | |
| @@H]([C@H](O1)CO)O)O)O | |
| C[C@@]12CC[C@]3(CC[C@]([C@H]([C@@H]3C1═CC[C@H]1[C@]2(C[C@H]([C@@H]2[C@ | Natural |
| @]1(C[C@H]([C@@H]([C@@]2(C)CO)O)O)C)O)C)O)(C)C)C(═O)O[C@H]1[C@@H]([C@H]([C | |
| @@H]([C@H](O1)CO)O)O)O | |
| C[C@@]12CC[C@]3(CC[C@]([C@H]([C@H]3C1═CC[C@H]1[C@]2(C[C@H]([C@@H]2[C@@] | Natural |
| 1(C[C@H]([C@@H]([C@@]2(C)CO)O)O)C)O)C)O)(C)C)C(═O)O[C@H]1[C@@H]([C@H]([C@ | |
| @H]([C@H](O1)CO)O)O)O | |
| C[C@@]12CC[C@]3(CC[C@]([C@H]([C@H]3C1═CC[C@@H]1[C@]2(C[C@H]([C@@H]2[C@ | Natural |
| @]1(C[C@H]([C@@H]([C@@]2(C)C)O)O)C)O)C)O)(C)C)C(═O)O[C@H]1[C@@H]([C@H]([C@ | |
| @H]([C@H](O1)CO)O)O)O | |
| C[C@@]12CC[C@]3(CC[C@]([C@H]([C@H]3C1═CC[C@H]1[C@]2(C[C@H]([C@@H]2[C@@] | Natural |
| 1(C[C@H]([C@@H]([C@@]2(C)C)O)O)C)O)C)O)(C)C)C(═O)O[C@H]1[C@@H]([C@H]([C@@ | |
| H]([C@H](O1)CO)O)O)O | |
| C[C@@]12CC[C@]3(CC[C@]([C@H]([C@H]3C1═CC[C@@H]1[C@]2(C[C@H]([C@H]2[C@@] | Natural |
| 1(C[C@H]([C@@H]([C@]2(C)C)O)O)C)O)C)O)(C)C)C(═O)O[C@H]1[C@@H]([C@H]([C@@H] | |
| ([C@H](O1)CO)O)O)O | |
| C[C@@]12CC[C@]3(CC[C@]([C@H]([C@H]3C1═CC[C@H]1[C@]2(C[C@H]([C@H]2[C@@]1 | Natural |
| (C[C@H]([C@@H]([C@]2(C)C)O)O)C)O)C)O)(C)C)C(═O)O[C@H]1[C@@H]([C@H]([C@@H] | |
| ([C@H](O1)CO)O)O)O | |
| C[C@@]12CC[C@@H]([C@]([C@@H]1CCC1═C[C@@]([C@@H](C[C@H]21)O[C@H)1[C@@ | Natural |
| H]([C@H]([C@@H]([C@H](O1)CO)O)O)O)(C)C═C)(C)C)O[C@H]1[C@@H]([C@H]([C@@H](O | |
| 1)CO)O)O | |
| C[C@@]12CC[C@@H]([C@]([C@H]1CCC1═C[C@@]([C@@H](C[C@H]21)O[C@H]1[C@@H] | Natural |
| ([C@H]([C@@H]([C@H](O1)CO)O)O)O)(C)C═C)(C)C)O[C@H]1[C@@H]([C@H]([C@@H](O1) | |
| CO)O)O | |
| C[C@@]12CC[C@@H]([C@]([C@@H]1CCC1═C[C@]([C@@H](C[C@H]21)O[C@H]1[C@@H] | Natural |
| ([C@H]([C@@H]([C@H](O1)CO)O)O)O)(C)C═C)(C)C)O[C@H]1[C@@H]([C@H]([C@@H](O1) | |
| CO)O)O | |
| C[C@@]12CC[C@@H]([C@]([C@H]1CCC1═C[C@]([C@@H](C[C@H]21)O[C@H]1[C@@H] | Natural |
| ([C@H]([C@@H]([C@H](O1)CO)O)O)O)(C)C═C)(C)C)O[C@H]1[C@@H]([C@H]([C@@H](O1)C | |
| O)O)O | |
| CCCCCC[C@@H]1[C@H](C[C@H](C[C@H](C[C@H](C[C@H](C[C@@H](C[C@@H](C(═CC═ | Natural |
| CC═CC═CC═C[C@@H]([C@H](OC1═O)C)O)C)O)O)O)O)O)O)O | |
| CCCCCC[C@@H]1[C@H](C[C@H](C[C@H](C[C@H](C[C@H](C[C@H](C[C@@H](C(═CC═CC═ | Natural |
| CC═CC═C[C@@H]([C@H](OC1═O)C)O)C)O)O)O)O)O)O)O | |
| C[C@](C)(C)C[C@](C)(C)c1ccc(cc1)OC(═O)[C@@]([C@](F)(F)F)(O[C@]([C@]([C@](F)(F)F)(F) | Natural |
| F)(F)F)F | |
| C[C@](C)(C)C[C@](C)(C)c1ccc(cc1)OC(═O)[C@]([C@](F)(F)F)(O[C@]([C@]([C@](F)(F)F)(F)F) | Natural |
| (F)F)F | |
| C[C@@H](CCCCCCCCC[C@@H](Cc1cc(cc(c1C(═O)[O—])O)O)OC(═O)C)OC(═O)C | Natural |
| C[C@H](CCCCCCCCC[C@@H](Cc1cc(cc(c1C(═O)[O—])O)O)OC(═O)C)OC(═O)C | Natural |
| C[C@@H](CCCCCCCCC[C@H](Cc1cc(cc(c1C(═O)[O—])O)O)OC(═O)C)OC(═O)C | Natural |
| C[C@H](CCCCCCCCC[C@H](Cc1cc(cc(c1C(═O)[O—])O)O)OC(═O)C)OC(═O)C | Natural |
| c1cc(ccc1/C═C/C(═O)OC[C@@H]1[C@@H]([C@@H]([C@@H]([C@@H](O1)Oc1cc(c2c(c1)O[C | Natural |
| @@H](CC2═O)c1ccc(cc1)O)O)OC(═O)/C═C/c1ccc(cc1)O)O)O)O | |
| c1cc(ccc1/C═C/C(═O)OC[C@H]1[C@@H]([C@@H]([C@@H]([C@@H](O1)Oc1cc(c2c(c1)O[C@ | Natural |
| @H](CC2═O)c1ccc(cc1)O)O)OC(═O)/C═C/c1ccc(cc1)O)O)O)O | |
| c1cc(ccc1/C═C/C(═O)OC[C@@H]1[C@H]([C@@H]([C@@H]([C@@H](O1)Oc1cc(c2c(c1)O[C@ | Natural |
| @H](CC2═O)c1ccc(cc1)O)O)OC(═O)/C═C/c1ccc(cc1)O)O)O)O | |
| c1cc(ccc1/C═C/C(═O)OC[C@H]1[C@H]([C@@H]([C@@H]([C@@H](O1)Oc1cc(c2c(c1)O[C@@ | Natural |
| H](CC2═O)c1ccc(cc1)O)O)OC(═O)/C═C/c1ccc(cc1)O)O)O)O | |
| Cc1cc(c(c(c1)C)OC(═O)[C@@]([C@@]([C@@]([C@]([C@@]([C@]([C@]([C@](F)(F)F)(F)F)(F)F) | Natural |
| (F)F)(F)F)(F)F)(F)F)(F)F)C | |
| CC(═O)O[C@](C)(C)/C═C/C(═O)[C@@](C)([C@H]1[C@@H](C[C@@]2([C@@]1(CC(═O)[C@@] | Natural |
| 1([C@H]2CC═C2[C@H]1C═C(C(═O)[C@]2(C)C)O[C@H]1[C@@H]([C@H]([C@@H]([C@H](O | |
| 1)CO)O)O)O)C)C)C)O)O | |
| CC(═O)O[C@](C)(C)/C═C/C(═O)[C@@](C)([C@H]1[C@H](C[C@@]2([C@@]1(CC(═O)[C@@]1 | Natural |
| ([C@H]2CC═C2[C@H]1C═C(C(═O)[C@]2(C)C)O[C@H]1[C@@H]([C@H]([C@@H]([C@H](O1) | |
| CO)O)O)O)C)C)C)O)O | |
| CCOc1ccc(cc1)NC(═O)[C@@]([C@@]([C@@]([C@]([C@@]([C@]([C@]([C@](F)(F)F)(F)F)(F)F) | Natural |
| (F)F)(F)F)(F)F)(F)F)(F)F | |
| C[C@@]12CC[C@@H]([C@@]1(CC[C@@]13[C@@H]2CC[C@@H]2[C@@]1(C3)[C@@H](C | Natural |
| [C@@H]([C@@]2(C)C(═O)O[C@@H]1[C@@H]([C@@H]([C@@H]([C@@H](O1)CO)O)O)O)O) | |
| O)C)[C@@]1(CC[C@@H](O1)[C@](C)(C)O)C | |
| C[C@]12CC[C@@H]([C@@]1(CC[C@@]13[C@@H]2CC[C@@H]2[C@@]1(C3)[C@@H](C[C | Natural |
| @@H]([C@@]2(C)C(═O)O[C@@H]1[C@@H]([C@@H]([C@@H]([C@@H](O1)CO)O)O)O)O)O) | |
| C)[C@@]1(CC[C@@H](O1)[C@](C)(C)O)C | |
| C[C@@]12CC[C@H]([C@@]1(CC[C@@]13[C@@H]2CC[C@@H]2[C@@]1(C3)[C@@H](C[C | Natural |
| @@H]([C@@]2(C)C(═O)O[C@@H]1[C@@H]([C@@H]([C@@H]([C@@H](O1)CO)O)O)O)O)O) | |
| C)[C@@]1(CC[C@@H](O1)[C@](C)(C)O)C | |
| C[C@]12CC[C@H]([C@@]1(CC[C@@]13[C@@H]2CC[C@@H]2[C@@]1(C3)[C@@H](C[C@ | Natural |
| @H]([C@@]2(C)C(═O)O[C@@H]1[C@@H]([C@@H]([C@@H]([C@@H](O1)CO)O)O)O)O)O)C) | |
| [C@@]1(CC[C@@H](O1)[C@](C)(C)O)C | |
| C[C@@H]1C[C@@H](O[C@@]2([C@H]1[C@]1(CC[C@@]34C[C@]53CC[C@@H]([C@@]([C | Natural |
| @@H]5CC═C4[C@@]1([C@H]2O)C)(C)C)O[C@@H]1[C@@H]([C@H]([C@@H](CO1)O)O)O)C) | |
| O)[C@@H]([C@@](C)(C)O)OC(═O)C | |
| C[C@@H]1C[C@@H](O[C@@]2([C@H]1[C@]1(CC[C@@]34C[C@]53CC[C@@H]([C@]([C@ | Natural |
| H]5CC═C4[C@@]1([C@H]2O)C)(C)C)O[C@@H]1[C@@H]([C@H]([C@@H](CO1)O)O)O)C)O) | |
| [C@@H]([C@@](C)(C)O)OC(═O)C | |
| C[C@@H]1C[C@@H](O[C@@]2([C@H]1[C@]1(CC[C@@]34C[C@]53CC[C@@H]([C@@]([C | Natural |
| @@H]5CC═C4[C@@]1([C@H]2O)C)(C)C)O[C@H]1[C@@H]([C@H]([C@@H](CO1)O)O)O)C) | |
| O)[C@@H]([C@@](C)(C)O)OC(═O)C | |
| C[C@@H]1C[C@@H](O[C@@]2([C@H]1[C@]1(CC[C@@]34C[C@]53CC[C@@H]([C@]([C@ | Natural |
| H]5CC═C4[C@@]1([C@H]2O)C)(C)C)O[C@H]1[C@@H]([C@H]([C@@H](CO1)O)O)O)C)O)[C | |
| @@H]([C@@](C)(C)O)OC(═O)C | |
| COc1ccc(cc1OC)/C═C/C(═O)OC[C@@H]1[C@H]([C@@H]([C@H]([C@@H](O1)O[C@@H](CCc | Natural |
| 1ccc(cc1)O)CC(═O)CCc1ccc(cc1)O)O)O)O | |
| COc1ccc(cc1OC)/C═C/C(═O)OC[C@@H]1[C@H]([C@@H]([C@H]([C@@H](O1)O[C@H](CCc1c | Natural |
| cc(cc1)O)CC(═O)CCc1ccc(cc1)O)O)O)O | |
| C[C@H]1C[C@H]([C@@]23[C@@H]([C@@]1(C)C/C═C(\C)C═C)C[C@@H](C═C2[C@@H](C | Natural |
| [C@H]3OC(═O)C)OC(═O)C)OC(═O)C)OC(═O)/C═C/c1ccccc1 | |
| CC(═O)O[C@H]1[C@@H]2[C@@](CC[C@]2([C@]2([C@@H](C1)[C@@]1([C@@H]([C@@] | Natural |
| ([C@@H](CC1)OC(═O)CC(═O)[O—]) | |
| (C)C)CC2)C)C)C)(O)[C@]1(O[C@@H](CC1)[C@@](O)(C)C)C | |
| CC(═O)O[C@H]1[C@H]2[C@@)(CC[C@]2([C@]2([C@@H](C1)[C@@]1([C@@H]([C@@]([C | Natural |
| @@H](CC1)OC(═O)CC(═O)[O—])(C)C)CC2)C)C)C)(O)[C@]1(O[C@@H](CC1)[C@@](O)(C)C)C | |
| CC(═O)O[C@H]1[C@@H]2[C@](CC[C@]2([C@]2([C@@H](C1)[C@@]1([C@@H]([C@@]([C | Natural |
| @@H](CC1)OC(═O)CC(═O)[O—])(C)C)CC2)C)C)C)(O)[C@]1(O[C@@H](CC1)[C@@](O)(C)C)C | |
| CC(═O)O[C@H]1[C@H]2[C@](CC[C@]2([C@]2([C@@H](C1)[C@@]1([C@@H]([C@@]([C@ | Natural |
| @H](CC1)OC(═O)CC(═O)[O—])(C)C)CC2)C)C)C)(O)[C@]1(O[C@@H](CC1)[C@@](O)(C)C)C | |
| c1cc(ccc1/C═C/C(═O)OC[C@@H]1[C@H]([C@@H]([C@H]([C@@H](O1)Oc1cc(c2c(c1)O[C@@ | Natural |
| H](CC2═O)c1ccc(cc1)O)O)O)OC(═O)/C═C/c1ccc(cc1)O)O)O | |
| c1cc(ccc1/C═C/C(═O)OC[C@@H]1[C@H]([C@@H]([C@H]([C@@H](O1)Oc1cc(c2c(c1)O[C@H] | Natural |
| (CC2═O)c1ccc(cc1)O)O)O)OC(═O)/C═C/c1ccc(cc1)O)O)O | |
| C[C@]1([C@H]([C@@H]2[C@@](CC[C@@]3(C2═CC[C@@H]2[C@]3(CC[C@@H]3[C@@]2(C | Natural |
| [C@H]([C@@H]([C@@]3(C)C)O)O)C)C)C)(CC1)C(═O)O[C@@H]1O[C@@H]([C@H]([C@@H] | |
| ([C@H]1O)O)O)CO)O)C | |
| C[C@]1([C@H]([C@@H]2[C@@](CC[C@@]3(C2═CC[C@H]2[C@]3(CC[C@@H]3[C@@]2(C[C | Natural |
| @H]([C@@H]([C@@]3(C)C)O)O)C)C)C)(CC1)C(═O)O[C@@H]1O[C@@H]([C@H]([C@@H] | |
| ([C@H]1O)O)O)CO)O)C | |
| Cc1cc(cc(c1C)C)NC(═O)[C@@]([C@@]([C@@]([C@]([C@@]([C@]([C@]([C@](F)(F)F)(F)F)(F) | Natural |
| F)(F)F)(F)F)(F)F)(F)F)(F)F | |
| C[C@@H]1CC[C@@]2(CC[C@@]3(C(═CC[C@@H]4[C@]3(CC[C@@H]3[C@@]4(C[C@H]([C | Natural |
| @@H]([C@@]3(C)C)O)O)C)C)[C@@H]2[C@]1(C)O)C)C(═O)O[C@H]1[C@@H]([C@H]([C@@ | |
| H]([C@H](O1)CO)O)O)O | |
| C[C@@H]1CC[C@@]2(CC[C@@]3(C(═CC[C@H]4[C@]3(CC[C@@H]3[C@@]4(C[C@H]([C@ | Natural |
| @H]([C@@]3(C)C)O)O)C)C)[C@@H]2[C@]1(C)O)C)C(═O)O[C@H]1[C@@H]([C@H]([C@@H] | |
| ([C@H](O1)CO)O)O)O | |
| C[C@@H]1CC[C@@]2(CC[C@@]3(C(═CC[C@@H]4[C@]3(CC[C@H]3[C@@]4(C[C@H]([C@ | Natural |
| @H]([C@@]3(C)C)O)O)C)C)[C@@H]2[C@]1(C)O)C)C(═O)O[C@H]1[C@@H]([C@H]([C@@H] | |
| ([C@H](O1)CO)O)O)O | |
| C[C@@H]1CC[C@@]2(CC[C@@]3(C(═CC[C@H]4[C@]3(CC[C@H]3[C@@]4(C[C@H]([C@@ | Natural |
| H]([C@]3(C)C)O)O)C)C)[C@@H]2[C@]1(C)O)C)C(═O)O[C@H]1[C@@H]([C@H]([C@@H]([C | |
| @H](O1)CO)O)O)O | |
| C[C@H](CCC[C@H](C)C)[C@H]1CC[C@@H]2[C@@]1(CC[C@@H]1[C@@H]2CC═C2[C@@]1 | Natural |
| (CC[C@@H](C2)OC(═O)/C═C/C═C/c1ccccc1)C)C | |
| CC(═O)[C@@H]1CC[C@@H]2[C@@]1(CC[C@@H]1[C@@H]2CC═C2[C@@]1(CC[C@@H](C2) | Natural |
| O[C@H]1[C@@H]([C@H]([C@@H]([C@H](O1)CO)O)O)O[C@H]1[C@@H]([C@H]([C@@H] | |
| ([C@H](O1)CO)O)O)O)C)C | |
| CC(═O)[C@H]1CC[C@@H]2[C@@]1(CC[C@@H]1[C@@H]2CC═C2[C@@]1(CC[C@@H](C2) | Natural |
| O[C@H]1[C@@H]([C@H]([C@@H]([C@H](O1)CO)O)O)O[C@H]1[C@@H]([C@H]([C@@H] | |
| ([C@H](O1)CO)O)O)O)C)C | |
| CC(═O)[C@@H]1CC[C@H]2[C@@]1(CC[C@@H]1[C@@H]2CC═C2[C@@]1(CC[C@@H](C2) | Natural |
| O[C@H]1[C@@H]([C@H]([C@@H]([C@H](O1)CO)O)O)O[C@H]1[C@@H]([C@H]([C@@H] | |
| ([C@H](O1)CO)O)O)O)C)C | |
| CC(═O)[C@H]1CC[C@H]2[C@@]1(CC[C@@H]1[C@@H]2CC═C2[C@@]1(CC[C@@H](C2)O | Natural |
| [C@H]1[C@@H]([C@H]([C@@H]([C@H](O1)CO)O)O)O[C@H]1[C@@H]([C@H]([C@@H]([C | |
| @H](O1)CO)O)O)O)C)C | |
| CCCCCCCCCC(═O)O[C@@H]1[C@@H]([C@@H]([C@@H](O[C@@H]1O[C@@]1([C@@H] | Natural |
| ([C@@H]([C@@H](O1)CO)O)OC(═O)C[C@H](C)C)CO)CO)OC(═O)[C@H](C)C)OC(═O)[C@@H] | |
| (C)C | |
| CCCCCCCCCC(═O)O[C@H]1[C@@H]([C@@H]([C@@H](O[C@@H]1O[C@@]1([C@@H]([C | Natural |
| @@H]([C@@H](O1)CO)O)OC(═O)C[C@H](C)C)CO)CO)OC(═O)[C@H](C)C)OC(═O)[C@@H] | |
| (C)C | |
| CCCCCCCCCC(═O)O[C@@H]1[C@H]([C@@H]([C@@H](O[C@@H]1O[C@@]1([C@@H]([C | Natural |
| @@H]([C@@H](O1)CO)O)OC(═O)C[C@H](C)C)CO)CO)OC(═O)[C@H](C)C)OC(═O)[C@@H] | |
| (C)C | |
| CCCCCCCCCC(═O)O[C@H]1[C@H]([C@@H]([C@@H](O[C@@H]1O[C@@]1([C@@H]([C@ | Natural |
| @H]([C@@H](O1)CO)O)OC(═O)C[C@H](C)C)CO)CO)OC(═O)[C@H](C)C)OC(═O)[C@@H](C) | |
| C | |
| C[C@@]12CC[C@@H]3[C@@]([C@@H]1CC═C1[C@]2(C[C@@H]([C@@]2([C@@H]1C[C@ | Natural |
| @](CC2)(C)C)O)O)C)(C[C@@H]([C@@H]([C@@]3(C)CO)O[C@H]1[C@@H]([C@H]([C@@H] | |
| ([C@H](O1)CO)O)O)O)O)C | |
| C[C@@]12CC[C@H]3[C@@]([C@@H]1CC═C1[C@]2(C[C@@H]([C@@]2([C@@H]1C[C@@] | Natural |
| (CC2)(C)C)O)O)C)(C[C@@H]([C@@H]([C@@]3(C)CO)O[C@H]1[C@@H]([C@H]([C@@H]([C | |
| @H](O1)CO)O)O)O)O)C | |
| C[C@@]12CC[C@@H]3[C@@]([C@H]1CC═C1[C@]2(C[C@@H]([C@@]2([C@@H]1C[C@@] | Natural |
| (CC2)(C)C)O)O)C)(C[C@@H]([C@@H]([C@@]3(C)CO)O[C@H]1[C@@H]([C@H]([C@@H]([C | |
| @H](O1)CO)O)O)O)O)C | |
| C[C@@]12CC[C@H]3[C@@]([C@H]1CC═C1[C@]2(C[C@@H]([C@@]2([C@@H]1C[C@@](C | Natural |
| C2)(C)C)O)O)C)(C[C@@H]([C@@H]([C@@]3(C)CO)O[C@H]1[C@@H]([C@H]([C@@H]([C@ | |
| H](O1)CO)O)O)O)O)C | |
| C[C@@]12CC[C@H]3[C@@]([C@@H]1CC═C1[C@]2(CC[C@@]2([C@@H]1C[C@@](CC2)(C) | Natural |
| C)C(═O)[O—])C)(C[C@H]([C@@H]([C@@]3(C)C)OC(═O)/C═C/c1ccc(cc1)O)O)C | |
| C[C@@]12CC[C@H]3[C@@]([C@H]1CC═C1[C@]2(CC[C@@]2([C@H]1C[C@@](CC2)(C)C)C | Natural |
| (═O)[O—])C)(C[C@H]([C@@H]([C@]3(C)C)OC(═O)/C═C/c1ccc(cc1)O)O)C | |
| Cc1cc(c(c(c1)C)NC(═O)[C@@]([C@@]([C@@]([C@]([C@@]([C@]([C@]([C@](F)(F)F)(F)F)(F)F) | Natural |
| (F)F)(F)F)(F)F)(F)F)(F)F)C | |
| C[C@@H](CCCC[C@@H]([C@@H](CO)C(═O)O[C@@H](CCCC[C@@H](C)C/C(═C/C(═C/C(═ | Natural |
| O)[O—])C)C)[C@@H](CO)C(═O)[O—])O)C/C(═C/C(═C/C(═O)[O—])C)C | |
| C[C@H](CCCC[C@@H]([C@@H](CO)C(═O)O[C@@H](CCCC[C@@H](C)C/C(═C/C(═C/C(═O) | Natural |
| [O—])C)C)[C@@H](CO)C(═O)[O—])O)C/C(═C/C(═C/C(═O)[O—])C)C | |
| C[C@@H](CCCC[C@H]([C@@H](CO)C(═O)O[C@@H](CCCC[C@@H](C)C/C(═C/C(═C/C(═O) | Natural |
| [O—])C)C)[C@@H](CO)C(═O)[O—])O)C/C(═C/C(═C/C(═O)[O—])C)C | |
| C[C@H](CCCC[C@H]([C@@H](CO)C(═O)O[C@@H](CCCC[C@@H](C)C/C(═C/C(═C/C(═O)[O—]) | Natural |
| C)C)[C@@H](CO)C(═O)[O—])O)C/C(═C/C(═C/C(═O)[O—])C)C | |
| CC(═O)OC[C@]1([C@@H]2CC[C@@]3([C@@H]([C@]2(CC[C@@H]1OC(═O)C)C)CC═C1[C@] | Natural |
| 3(CC[C@@]2([C@@H]1[C@@H]([C@@](CC2)(C)C)O)C(═O)OC)C)C)COC(═O)C | |
| C[C@@H]1CC[C@@]2(CC[C@@]3(C(═CC[C@@H]4[C@@]3(CC[C@@H]3[C@@]4(C[C@@H] | Natural |
| ([C@@H]([C@@]3(C)C(═O)[O—]) | |
| O)O)C)C)[C@@H]2[C@@]1(C)O)C)C(═O)O[C@@H]1[C@@H]([C@@H] | |
| ([C@@H]([C@@H](O1)CO)O)O)O | |
| C[C@H]1CC[C@@]2(CC[C@@]3(C(═CC[C@@H]4[C@@]3(CC[C@@H]3[C@@]4(C[C@@H] | Natural |
| ([C@@H]([C@@]3(C)C(═O)[O—]) | |
| O)O)C)C)[C@@H]2[C@@]1(C)O)C)C(═O)O[C@@H]1[C@@H]([C@@H]([C@@H] | |
| ([C@@H](O1)CO)O)O)O | |
| C[C@@H]1CC[C@]2(CC[C@@]3(C(═CC[C@@H]4[C@@]3(CC[C@@H]3[C@@]4(C[C@@H] | Natural |
| ([C@@H]([C@@]3(C)C(═O)[O—]) | |
| O)O)C)C)[C@@H]2[C@@]1(C)O)C)C(═O)O[C@@H]1[C@@H]([C@@H]([C@@H] | |
| ([C@@H](O1)CO)O)O)O | |
| C[C@H]1CC[C@]2(CC[C@@]3(C(═CC[C@@H]4[C@@]3(CC[C@@H]3[C@@]4(C[C@@H]([C | Natural |
| @@H]([C@@]3(C)C(═O)[O—]) | |
| O)O)C)C)[C@@H]2[C@@]1(C)O)C)C(═O)O[C@@H]1[C@@H]([C@@H]([C@@H] | |
| ([C@@H](O1)CO)O)O)O | |
| C[C@@H]1CC[C@@]2(CC[C@@]3(C(═CC[C@@H]4[C@]3(CC[C@@H]3[C@@]4(C[C@H]([C | Natural |
| @@H]([C@]3(C)C(═O)[O—]) | |
| O)O)C)C)[C@@H]2[C@]1(C)O)C)C(═O)O[C@H]1[C@@H]([C@H]([C@@H]([C@H] | |
| (O1)CO)O)O)O | |
| C[C@@H]1CC[C@@]2(CC[C@@]3(C(═CC[C@H]4[C@]3(CC[C@@H]3[C@@]4(C[C@H]([C@ | Natural |
| @H]([C@]3(C)C(═O)[O—]) | |
| O)O)C)C)[C@@H]2[C@]1(C)O)C)C(═O)O[C@H]1[C@@H]([C@H]([C@@H]([C@H] | |
| (O1)CO)O)O)O | |
| C[C@@H]1CC[C@@]2(CC[C@@]3(C(═CC[C@@H]4[C@]3(CC[C@H]3[C@@]4(C[C@H]([C@ | Natural |
| @H]([C@]3(C)C(═O)[O—]) | |
| O)O)C)C)[C@@H]2[C@]1(C)O)C)C(═O)O[C@H]1[C@@H]([C@H]([C@@H]([C@H] | |
| (O1)CO)O)O)O | |
| C[C@@H]1CC[C@@]2(CC[C@@]3(C(═CC[C@H]4[C@]3(CC[C@H]3[C@@]4(C[C@H]([C@@ | Natural |
| H]([C@]3(C)C(═O)[O—]) | |
| O)O)C)C)[C@@H]2[C@]1(C)O)C)C(═O)O[C@H]1[C@@H]([C@H]([C@@H]([C@H] | |
| (O1)CO)O)O)O | |
| CCCCCCCCCCCC[C@@H]([C@H](CC[C@@H]([C@@H]1CC[C@H](O1)C[C@@H](CCCCC[C | Natural |
| @H](CC1═C[C@@H](OC1═O)C)O)O)O)O)O | |
| C[C@@H]1C[C@@H](Cc2c1c(cc(c2)O)O)O[C@@H]1[C@@H]([C@@H]([C@@H]([C@@H](O1) | Natural |
| COC(═O)/C═C/c1ccc(cc1)O)OC(═O)/C═C/c1ccc(cc1)O)O)O | |
| C[C@H]1C[C@@H](Cc2c1c(cc(c2)O)O)O[C@@H]1[C@@H]([C@@H]([C@@H]([C@@H](O1)C | Natural |
| OC(═O)/C═C/c1ccc(cc1)O)OC(═O)/C═C/c1ccc(cc1)O)O)O | |
| C[C@@H]1C[C@H](Cc2c1c(cc(c2)O)O)O[C@@H]1[C@@H]([C@@H]([C@@H]([C@@H](O1)C | Natural |
| OC(═O)/C═C/c1ccc(cc1)O)OC(═O)/C═C/c1ccc(cc1)O)O)O | |
| C[C@H]1C[C@H](Cc2c1c(cc(c2)O)O)O[C@@H]1[C@@H]([C@@H]([C@@H]([C@@H](O1)CO | Natural |
| C(═O)/C═C/c1ccc(cc1)O)OC(═O)/C═C/c1ccc(cc1)O)O)O | |
| CC(═O)O[C@](C)(C)/C═C/C(═O)[C@@](C)([C@@H]1[C@@H](C[C@@]2([C@@]1(CC(═O)[C@ | Natural |
| @]1([C@@H]2CC═C([C@@H]1CC(═O)[O—])[C@](C)(C)C(═O)[O—])C)C)C)O)O | |
| CC(═O)O[C@](C)(C)/C═C/C(═O)[C@](C)([C@@H]1[C@@H](C[C@@]2([C@@]1(CC(═O)[C@@] | Natural |
| 1([C@@H]2CC═C([C@@H]1CC(═O)[O—])[C@](C)(C)C(═O)[O—])C)C)C)O)O | |
| CC(═O)O[C@](C)(C)/C═C/C(═O)[C@@](C)([C@H]1[C@@H](C[C@@]2([C@@]1(CC(═O)[C@@] | Natural |
| 1([C@@H]2CC═C([C@@H]1CC(═O)[O—])[C@](C)(C)C(═O)[O—])C)C)C)O)O | |
| CC(═O)O[C@](C)(C)/C═C/C(═O)[C@](C)([C@H]1[C@@H](C[C@@]2([C@@]1(CC(═O)[C@@]1 | Natural |
| ([C@@H]2CC═C([C@@H]1CC(═O)[O—])[C@](C)(C)C(═O)[O—])C)C)C)O)O | |
| C[C@@H](CCCC[C@@H]([C@@H](CO)C(═O)[O—]) | Natural |
| O)C/C(═C/C(═C/C(═O)O[C@@H](CCCC[C@@H] (C)C/C(═C/C(═C/C(═O)[O—]) | |
| C)C)[C@@H](CO)C(═O)[O—])C)C | |
| C[C@H](CCCC[C@@H]([C@@H](CO)C(═O)[O—]) | Natural |
| O)C/C(═C/C(═C/C(═O)O[C@@H](CCCC[C@@H] (C)C/C(═C/C(═C/C(═O)[O—]) | |
| C)C)[C@@H](CO)C(═O)[O—])C)C | |
| C[C@@H](CCCC[C@H]([C@@H](CO)C(═O)[O—]) | Natural |
| O)C/C(═C/C(═C/C(═O)O[C@@H](CCCC[C@@H] (C)C/C(═C/C(═C/C(═O)[O—]) | |
| C)C)[C@@H](CO)C(═O)[O—])C)C | |
| C[C@H](CCCC[C@H]([C@@H](CO)C(═O)[O—]) | Natural |
| O)C/C(═C/C(═C/C(═O)O[C@@H](CCCC[C@@H] (C)C/C(═C/C(═C/C(═O)[O—]) | |
| C)C)[C@@H](CO)C(═O)[O—])C)C | |
| C[C@@H]1C[C@@H]([C@@H]([C@@]2([C@@]31[C@@H]([C@@H]([C@H]([C@H]2OC(═O) | Natural |
| C)OC(═O)c1ccccc1)[C@](O3)(C)C)OC(═O)C)COC(═O)C)OC(═O)c1ccccc1)OC(═O)C | |
| C/C(═C\CO[C@H]1[C@@H]([C@H]([C@@H]([C@H](O1)CO)O)O)O)CC[C@@H]1C(═C)CC[C | Natural |
| @H]2[C@]1(CC[C@H]([C@]2(C)CO[C@H]1[C@@H]([C@H]([C@@H]([C@H](O1)CO)O)O)O) | |
| O)C | |
| CCCCCCCCCC[C@H]([C@H]1CC[C@@H](O1)[C@@H](CC[C@@H]([C@@H]1CC[C@@H](O | Natural |
| 1)CCCCCCC[C@@H](CC1═C[C@@H](OC1═O)C)O)O)O)O | |
| COc1cc(cc(c1OC)OC)/C═C/C(═O)OC[C@@H]1[C@H]([C@@H]([C@H]([C@@H](O1)O[C@@H] | Natural |
| (CCc1ccc(cc1)O)CC(═O)CCc1ccc(cc1)O)O)O)O | |
| COc1cc(cc(c1OC)OC)/C═C/C(═O)OC[C@@H]1[C@H]([C@@H]([C@H]([C@@H](O1)O[C@H](C | Natural |
| Cc1ccc(cc1)O)CC(═O)CCc1ccc(cc1)O)O)O)O | |
| CC(═O)O[C@](C)(C)CCC(═O)[C@@](C)([C@@H]1[C@@H](C[C@@]2([C@@]1(CC(═O)[C@@] | Natural |
| 1([C@@H]2CC═C([C@@H]1CC(═O)[O—])[C@@](C)(C)C(═O)[O—])C)C)C)O)O | |
| CC(═O)O[C@](C)(C)CCC(═O)[C@](C)([C@@H]1[C@@H](C[C@@]2([C@@]1(CC(═O)[C@@]1 | Natural |
| ([C@@H]2CC═C([C@@H]1CC(═O)[O—])[C@@](C)(C)C(═O)[O—])C)C)C)O)O | |
| CC(═O)O[C@](C)(C)CCC(═O)[C@@](C)([C@H]1[C@@H](C[C@@]2([C@@]1(CC(═O)[C@@]1 | Natural |
| ([C@@H]2CC═C([C@@H]1CC(═O)[O—])[C@@](C)(C)C(═O)[O—])C)C)C)O)O | |
| CC(═O)O[C@](C)(C)CCC(═O)[C@](C)([C@H]1[C@@H](C[C@@]2([C@@]1(CC(═O)[C@@]1 | Natural |
| ([C@@H]2CC═C([C@@H]1CC(═O)[O—])[C@@](C)(C)C(═O)[O—])C)C)C)O)O | |
| CC[C@@H](CC[C@@H](C)[C@H]1CC[C@@H]2[C@@]1(CC[C@H]1[C@H]2CC═C2[C@@]1(C | Natural |
| C[C@@H](C2)O[C@H]1[C@@H]([C@H]([C@@H]([C@H](O1)CO)O)O)O)C)C)[C@H](C)C | |
| CC[C@H](CC[C@@H](C)[C@H]1CC[C@@H]2[C@@]1(CC[C@H]1[C@H]2CC═C2[C@@]1(CC | Natural |
| [C@@H](C2)O[C@H]1[C@@H]([C@H]([C@@H]([C@H](O1)CO)O)O)O)C)C)[C@@H](C)C | |
| c1cc(c(cc1C[C@@H](C(═O)[O—])OC(═O)[C@@H]1[C@@H]([C@@H]([C@@H]1C(═O)O | Natural |
| [C@@H](Cc1ccc(c(c1)O)O)C(═O)[O—])c1ccc(c(c1)O)O)c1ccc(c(c1)O)O)O)O | |
| c1cc(c(cc1C[C@H](C(═O)[O—])OC(═O)[C@@H]1[C@@H]([C@@H]([C@@H]1C | Natural |
| (═O)O[C@@H](Cc1ccc(c(c1)O)O)C(═O)[O—])c1ccc(c(c1)O)O)c1ccc(c(c1)O)O)O)O | |
| c1cc(c(cc1C[C@@H](C(═O)[O—])OC(═O)[C@H]1[C@@H]([C@@H]([C@@H] | Natural |
| 1C(═O)O[C@@H](Cc1ccc(c(c1)O)O)C(═O)[O—])c1ccc(c(c1)O)O)c1ccc(c(c1)O)O)O)O | |
| c1cc(c(cc1C[C@H](C(═O)[O—])OC(═O)[C@H]1[C@@H]([C@@H]([C@@H]1C(═O)O | Natural |
| [C@@H](Cc1ccc(c(c1)O)O)C(═O)[O—])c1ccc(c(c1)O)O)c1ccc(c(c1)O)O)O)O | |
| CC(═C)[C@@H](CC[C@@](C)([C@@]1(CC[C@@]2([C@@H]1[C@@H](C[C@@H]1[C@@]2(C | Natural |
| C[C@@H]2[C@@]1(CC[C@@H]([C@@]2(C)C)OC(═O)CC(═O)[O—])C)C)OC(═O)C)C)O)O)O | |
| CC(═C)[C@H](CC[C@@](C)([C@@]1(CC[C@@]2([C@@H]1[C@@H](C[C@@H]1[C@@]2(CC | Natural |
| [C@@H]2[C@@]1(CC[C@@H]([C@@]2(C)C)OC(═O)CC(═O)[O—])C)C)OC(═O)C)C)O)O)O | |
| CC(═C)[C@@H](CC[C@](C)([C@@]1(CC[C@@]2([C@@H]1[C@@H](C[C@@H]1[C@@]2(CC | Natural |
| [C@@H]2[C@@]1(CC[C@@H]([C@@]2(C)C)OC(═O)CC(═O)[O—])C)C)OC(═O)C)C)O)O)O | |
| CC(═C)[C@H](CC[C@](C)([C@@]1(CC[C@@]2([C@@H]1[C@@H](C[C@@H]1[C@@]2(CC[C | Natural |
| @@H]2[C@@]1(CC[C@@H]([C@@]2(C)C)OC(═O)CC(═O)[O—])C)C)OC(═O)C)C)O)O)O | |
| C/C(═C\CC[C@@](C)(C═C)O[C@H]1[C@@H]([C@H]([C@@H]([C@H](O1)COC(═O)/C(═C/CC | Natural |
| [C@@](C)(C═C)O)C)O)OC(═O)/C(═C/CC[C@@](C)(C═C)O)C)O)C(═O)[O—] | |
| C/C(═C\CC[C@](C)(C═C)O[C@H]1[C@@H]([C@H]([C@@H]([C@H](O1)COC(═O)/C(═C/CC[C | Natural |
| @@](C)(C═C)O)C)O)OC(═O)/C(═C/CC[C@@](C)(C═C)O)C)O)C(═O)[O—] | |
| C/C(═C\CC[C@@](C)(C═C)O[C@H]1[C@@H]([C@H]([C@@H]([C@H](O1)COC(═O)/C(═C/CC | Natural |
| [C@](C)(C═C)O)C)O)OC(═O)/C(═C/CC[C@@](C)(C═C)O)C)O)C(═O)[O—] | |
| C/C(═C\CC[C@](C)(C═C)O[C@H]1[C@@H]([C@H]([C@@H]([C@H](O1)COC(═O)/C(═C/CC[C | Natural |
| @](C)(C═C)O)C)O)OC(═O)/C(═C/CC[C@@](C)(C═C)O)C)O)C(═O)[O—] | |
| C[C@@H]1CC[C@@H](C[C@@H]1C)OC(═O)[C@@]([C@@]([C@@]([C@]([C@@]([C@]([C@] | Natural |
| ([C@](F)(F)F)(F)F)(F)F)(F)F)(F)F)(F)F)(F)F)(F)F | |
| C[C@H]1CC[C@@H](C[C@@H]1C)OC(═O)[C@@]([C@@]([C@@]([C@]([C@@]([C@]([C@] | Natural |
| ([C@](F)(F)F)(F)F)(F)F)(F)F)(F)F)(F)F)(F)F)(F)F | |
| C[C@@H]1CC[C@H](C[C@@H]1C)OC(═O)[C@@]([C@@]([C@@]([C@]([C@@]([C@]([C@] | Natural |
| ([C@](F)(F)F)(F)F)(F)F)(F)F)(F)F)(F)F)(F)F)(F)F | |
| C[C@H]1CC[C@H](C[C@@H]1C)OC(═O)[C@@]([C@@]([C@@]([C@]([C@@]([C@]([C@]([C | Natural |
| @](F)(F)F)(F)F)(F)F)(F)F)(F)F)(F)F)(F)F)(F)F | |
| c1cc(c(cc1[C@@H]1[C@@H](Cc2c(cc(c(c2O1)[C@H]1c2c(cc(cc2O[C@@H]([C@@H]1O)c1cc(c | Natural |
| (c(c1)O)O)O)O)O)O)O)OC(═O)c1cc(c(c(c1)O)O)O)O)O | |
| C/C(═C\CC/C(═C/CC/C(═C/Cc1c(cc(c2c1C[C@@H](CC2═O)c1ccc(cc1O)O)O)O)C)C)C | Natural |
| C[C@]12CC[C@@H]([C@@]1([C@H](CC1═C2CC[C@@H]2[C@]1(C[C@@H]([C@@H]([C@@] | Natural |
| 2(C)C)OC(═O)C[C@@](C)(CC(═O)NCC(═O)[O—]) | |
| O)O)C)O)C)[C@@H](CC[C@@H]([C@](C)(C)O)O)CO | |
| C[C@]12CC[C@@H]([C@@]1([C@H](CC1═C2CC[C@H]2[C@]1(C[C@@H]([C@@H]([C@]2(C) | Natural |
| C)OC(═O)C[C@@](C)(CC(═O)NCC(═O)[O—]) | |
| O)O)C)O)C)[C@@H](CC[C@@H]([C@](C)(C)O)O)CO | |
| C[C@]12CC[C@@H]([C@@]1([C@H](CC1═C2CC[C@@H]2[C@@]1(C[C@@H]([C@@H]([C@ | Natural |
| @]2(C)C)OC(═O)C[C@@](C)(CC(═O)NCC(═O)[O—]) | |
| O)O)C)O)C)[C@@H](CC[C@@H]([C@](C)(C)O)O)CO | |
| C[C@]12CC[C@@H]([C@@]1([C@H](CC1═C2CC[C@H]2[C@@]1(C[C@@H]([C@@H]([C@@] | Natural |
| 2(C)C)OC(═O)C[C@@](C)(CC(═O)NCC(═O)[O—]) | |
| O)O)C)O)C)[C@@H](CC[C@@H]([C@](C)(C)O)O)CO | |
| Cc1cc(cc(c1)OC(═O)[C@@]([C@@]([C@@]([C@]([C@@]([C@]([C@]([C@](F)(F)F)(F)F)(F)F)(F) | Natural |
| F)(F)F)(F)F)(F)F)(F)F)C | |
| C[C@H]1[C@@H]([C@H]([C@H]([C@@H](O1)O[C@@H]1[C@H]([C@@H]([C@H](O[C@H]1 | Natural |
| Oc1ccc(cc1OC)[C@@H]1[C@@H]2CO[C@@H]([C@@H]2CO1)c1ccc(c(c1)OC)O)COC(═O)C)O) | |
| O)O)O)O | |
| C[C@H]1[C@@H]([C@H]([C@H]([C@@H](O1)O[C@@H]1[C@H]([C@@H]([C@H](O[C@H]1 | Natural |
| Oc1ccc(cc1OC)[C@H]1[C@@H]2CO[C@@H]([C@@H]2CO1)c1ccc(c(c1)OC)O)COC(═O)C)O)O) | |
| O)O)O | |
| C[C@H]1[C@@H]([C@H]([C@H]([C@@H](O1)O[C@@H]1[C@H]([C@@H]([C@H](O[C@H]1 | Natural |
| Oc1ccc(cc1OC)[C@@H]1[C@H]2CO[C@@H]([C@@H]2CO1)c1ccc(c(c1)OC)O)COC(═O)C)O)O) | |
| O)O)O | |
| C[C@H]1[C@@H]([C@H]([C@H]([C@@H](O1)O[C@@H]1[C@H]([C@@H]([C@H](O[C@H]1 | Natural |
| Oc1ccc(cc1OC)[C@H]1[C@H]2CO[C@@H]([C@@H]2CO1)c1ccc(c(c1)OC)O)COC(═O)C)O)O)O) | |
| O)O | |
| CC[C@H](C)C(═O)O[C@H]1CC(═C2[C@H](C[C@@]3(CC[C@@H](C(═C)[C@H]3[C@@H]([C | Natural |
| @H]1[C@]2(C)C)OC(═O)C)OC(═O)C)C)OC(═O)C)C | |
| CC1═C[C@@H]([C@H]([C@@H](C1)c1ccc(cc1O)O)C(═O)c1ccc(cc1O)O)c1c(cc2c(c1O)C(═O)[C | Natural |
| @]1([C@@](O2)(c2ccc(cc2O1)O)O)C/C═C(\C)C)O | |
| C[C@@H]1CC[C@@]2(CC[C@@]3(C(═CC[C@@H]4[C@@]3(CC[C@@H]3[C@@]4(CC[C@@ | Natural |
| H]([C@@]3(C)CO)O)C)C)[C@@H]2[C@@]1(C)O)C)C(═O)O[C@@H]1[C@@H]([C@@H]([C@ | |
| @H]([C@@H](O1)CO)O)O)O | |
| C[C@H]1CC[C@@]2(CC[C@@]3(C(═CC[C@@H]4[C@@]3(CC[C@@H]3[C@@]4(CC[C@@H] | Natural |
| ([C@@]3(C)CO)O)C)C)[C@@H]2[C@@]1(C)O)C)C(═O)O[C@@H]1[C@@H]([C@@H]([C@@H] | |
| ([C@@H](O1)CO)O)O)O | |
| C[C@@H]1CC[C@]2(CC[C@@]3(C(═CC[C@@H]4[C@@]3(CC[C@@H]3[C@@]4(CC[C@@H] | Natural |
| ([C@@]3(C)CO)O)C)C)[C@@H]2[C@@]1(C)O)C)C(═O)O[C@@H]1[C@@H]([C@@H]([C@@H] | |
| ([C@@H](O1)CO)O)O)O | |
| C[C@H]1CC[C@]2(CC[C@@]3(C(═CC[C@@H]4[C@@]3(CC[C@@H]3[C@@]4(CC[C@@H] | Natural |
| ([C@@]3(C)CO)O)C)C)[C@@H]2[C@@]1(C)O)C)C(═O)O[C@@H]1[C@@H]([C@@H]([C@@H] | |
| ([C@@H](O1)CO)O)O)O | |
| CC[C@H](CC[C@@H](C)[C@H]1CC[C@@H]2[C@@]1(CC[C@H]1[C@H]2C═C[C@H]2[C@@] | Natural |
| 1(CC[C@@H](C2)O[C@H]1[C@@H]([C@H]([C@@H]([C@H](O1)CO)O)O)O)C)C)[C@@H](C) | |
| C | |
| C[C@@H](CCCC[C@@H]([C@@H](CO)C(═O)[O—]) | Natural |
| OC(═O)[C@@H](CO)[C@@H](CCCC[C@@](C) (C/C(═C/C(═C/C(═O)[O—]) | |
| C)C)O)O)C/C(═C/C(═C/C(═O)[O—])C)C | |
| C[C@H](CCCC[C@@H]([C@@H](CO)C(═O)[O—]) | Natural |
| OC(═O)[C@@H](CO)[C@@H](CCCC[C@@](C)(C/C (═C/C(═C/C(═O)[O—]) | |
| C)C)O)O)C/C(═C/C(═C/C(═O)[O—])C)C | |
| C[C@@H](CCCC[C@H]([C@@H](CO)C(═O)[O—]) | Natural |
| OC(═O)[C@@H](CO)[C@@H](CCCC[C@@](C)(C/C (═C/C(═C/C(═O)[O—]) | |
| C)C)O)O)C/C(═C/C(═C/C(═O)[O—])C)C | |
| C[C@H](CCCC[C@H]([C@@H](CO)C(═O)[O—]) | Natural |
| OC(═O)[C@@H](CO)[C@@H](CCCC[C@@](C)(C/C (═C/C(═C/C(═O)[O—]) | |
| C)C)O)O)C/C(═C/C(═C/C(═O)[O—])C)C | |
| COc1ccc(cc1OC)[C@@H]1[C@@H]2CO[C@@H]([C@@H]2CO1)c1ccc(c(c1)OC)O[C@@H]1[C | Natural |
| @@H]([C@@H]([C@@H]([C@@H](O1)CO)O[C@@H]1[C@@H]([C@@H]([C@@H]([C@@H] | |
| (O1)CO)O)O)O)O)O | |
| COc1ccc(cc1OC)[C@H]1[C@@H]2CO[C@@H]([C@@H]2CO1)c1ccc(c(c1)OC)O[C@@H]1[C@ | Natural |
| @H]([C@@H]([C@@H]([C@@H](O1)CO)O[C@@H]1[C@@H]([C@@H]([C@@H]([C@@H](O | |
| 1)CO)O)O)O)O)O | |
| COc1ccc(cc1OC)[C@@H]1[C@H]2CO[C@@H]([C@@H]2CO1)c1ccc(c(c1)OC)O[C@@H]1[C@ | Natural |
| @H]([C@@H]([C@@H]([C@@H](O1)CO)O[C@@H]1[C@@H]([C@@H]([C@@H]([C@@H](O | |
| 1)CO)O)O)O)O)O | |
| COc1ccc(cc1OC)[C@H]1[C@H]2CO[C@@H]([C@@H]2CO1)c1ccc(c(c1)OC)O[C@@H]1[C@@H] | Natural |
| ([C@@H]([C@@H]([C@@H](O1)CO)O[C@@H]1[C@@H]([C@@H]([C@@H]([C@@H](O1)C | |
| O)O)O)O)O)O | |
| C/C(═C\CC/C(═C/CC/C(═C/CC[C@]1([C@@H](/C(═C(/C)OC)CC[C@]1(C)O)CCCO)C)C)C)C | Natural |
| C[C@]12CCC[C@@]([C@@H]1C[C@@H](CC2)[C@@](C)(C)O)(C)Oc1cc(cc(c1O)Oc1ccc(cc1)C | Natural |
| C═C)CC═C | |
| C[C@H](CCC(═C)[C@@H](C)C(═O)[O—]) | Natural |
| [C@H]1CC[C@@]2([C@@]1([C@H](CC1═C2CC[C@@H]2[C | |
| @@]1(CC[C@H]([C@]2(C)C)OC(═O)CC(═O)[O—])C)O)C)C | |
| C[C@H](CCC(═C)[C@@H](C)C(═O)[O—]) | Natural |
| [C@H]1CC[C@]2([C@@]1([C@H](CC1═C2CC[C@@H]2[C@ | |
| @]1(CC[C@H]([C@]2(C)C)OC(═O)CC(═O)[O—])C)O)C)C | |
| C[C@H](CCC(═C)[C@@H](C)C(═O)[O—]) | Natural |
| [C@H]1CC[C@@]2([C@@]1([C@H](CC1═C2CC[C@H] 2[C@ | |
| @]1(CC[C@H]([C@@]2(C)C)OC(═O)CC(═O)[O—])C)O)C)C | |
| C[C@H](CCC(═C)[C@@H](C)C(═O)[O—]) | Natural |
| [C@H]1CC[C@]2([C@@]1([C@H](CC1═C2CC[C@H]2[C@ | |
| @]1(CC[C@H]([C@@]2(C)C)OC(═O)CC(═O)[O—])C)O)C)C | |
| C[C@H](CCC[C@H](C)C)[C@H]1CC[C@@H]2[C@@]1(CC[C@@H]1[C@H]2CC═C2[C@@]1 | Natural |
| (CC[C@@H](C2)OC(═O)c1ccc(cc1)[N+](═O)[O—])C)C | |
| C[C@H](CCC[C@H](C)C)[C@H]1CC[C@@H]2[C@@]1(CC[C@H]1[C@H]2CC═C2[C@@]1(CC | Natural |
| [C@@H](C2)OC(═O)c1ccc(cc1)[N+](═O)[O—])C)C | |
| C[C@H](CCC[C@H](C)C)[C@H]1CC[C@H]2[C@@]1(CC[C@H]1[C@H]2CC═C2[C@@]1(CC[C | Natural |
| @@H](C2)OC(═O)c1ccc(cc1)[N+](═O)[O—])C)C | |
| COc1ccc(c(c1)O[C@H]1[C@@H]([C@H]([C@@H]([C@H](O1)CO)O)O)O)[C@@H]1[C@@H] | Natural |
| ([C@@H]([C@@H]1C(═O)[O—])C(═O)[O—])c1ccc(cc1O[C@H]1[C@@H]([C@H]([C@@H] | |
| ([C@H](O1)CO)O)O)O)OC | |
| COc1ccc(c(c1)O[C@H]1[C@@H]([C@H]([C@@H]([C@H](O1)CO)O)O)O)[C@H]1[C@@H]([C | Natural |
| @@H]([C@@H]1C(═O)[O—])C(═O)[O—]) | |
| c1ccc(cc1O[C@H]1[C@@H]([C@H]([C@@H]([C@H](O1)CO)O)O)O)O C | |
| COc1ccc(c(c1)O[C@H]1[C@@H]([C@H]([C@@H]([C@H](O1)CO)O)O)O)[C@@H]1[C@H]([C | Natural |
| @@H]([C@@H]1C(═O)[O—])C(═O)[O—])c1ccc(cc1O[C@H]1[C@@H]([C@H]([C@@H] | |
| ([C@H](O1)CO)O)O)O)OC | |
| COc1ccc(c(c1)O[C@H]1[C@@H]([C@H]([C@@H]([C@H](O1)CO)O)O)O)[C@@H]1[C@@H] | Natural |
| ([C@H]([C@H]1C(═O)[O—])C(═O)[O—]) | |
| c1ccc(cc1O[C@H]1[C@@H]([C@H]([C@@H]([C@H](O1)CO)O)O)O)OC | |
| C[C@H]1[C@@H]([C@H]([C@H]([C@@H](O1)OC[C@@H]1[C@H]([C@@H]([C@H]([C@@H] | Natural |
| (O1)O[C@@H](CCCCc1ccc(cc1)O)CCc1ccc(cc1)O)O)O)O)O)O)O | |
| C[C@H]1[C@@H]([C@H]([C@H]([C@@H](O1)OC[C@@H]1[C@H]([C@@H]([C@H]([C@@H] | Natural |
| (O1)O[C@H](CCCCc1ccc(cc1)O)CCc1ccc(cc1)O)O)O)O)O)O)O | |
| C[C@H]1C[C@H]([C@@]23[C@@H]([C@@]1(C)C/C═C(\C)C═C)C[C@H](C═C2[C@@H](C[C | Natural |
| @H]3OC(═O)C)OC(═O)C)OC(═O)C)OC(═O)c1ccc(cc1)O | |
| C[C@@](O)(CC(═O)O[C@@H]1[C@@H](C[C@](C[C@H]1OC(═O)/C═C/c1cc(c(cc1)O)O)(O)C(═ | Natural |
| O)[O—])OC(═O)/C═C/c1cc(c(cc1)O)O)CC(═O)[O—] | |
| C[C@](O)(CC(═O)O[C@@H]1[C@@H](C[C@](C[C@H]1OC(═O)/C═C/c1cc(c(cc1)O)O)(O)C(═O) | Natural |
| [O—])OC(═O)/C═C/c1cc(c(cc1)O)O)CC(═O)[O—] | |
| C[C@@H]1CC[C@@]2(CC[C@@]3(C(═CC[C@@H]4[C@]3(CC[C@@H]3[C@@]4(CC[C@@H] | Natural |
| ([C@@]3(C)C)O)C)C)[C@H]2[C@H]1C)C(═O)[O—])C(═O)O[C@@H]1[C@H]([C@@H]([C@H] | |
| ([C@@H](O1)CO)O)O)O | |
| COc1cc(ccc1O)/C═C/C(═O)OC[C@@H]1[C@H]([C@@H]([C@](O1)(CO)O[C@@H]1[C@@H] | Natural |
| ([C@H]([C@@H]([C@H](O1)CO)O)O)O)OC(═O)/C═C/c1ccc(c(c1)OC)O)O | |
| CCCCCCCCCCCc1c(cc(cc1O)O)C(═O)O[C@@H](CCC)CCCCCCCc1cc(cc(c1)O[S@@](═O)(═O) | Natural |
| [O—])O[S@@](═O)(═O)[O—] | |
| CCCCCCCCCCCc1c(cc(cc1O)O)C(═O)O[C@H](CCC)CCCCCCCc1cc(cc(c1)O[S@@](═O)(═O)[O—]) | Natural |
| O[S@@](═O)(═O)[O—] | |
| CC[C@@H](C)C(═O)O[C@@H]1[C@H](C(═C)[C@@H]([C@H]2[C@H]([C@](C[C@@]2(C(═O) | Natural |
| [C@@H](C═C[C@@](C1═O)(C)C)C)OC(═O)C)(C)OC(═O)C)OC(═O)C)OC(═O)C)OC(═O)C | |
| CC[C@H](C)C(═O)O[C@@H]1[C@H](C(═C)[C@@H]([C@H]2[C@H]([C@](C[C@@]2(C(═O)[C | Natural |
| @@H](C═C[C@@](C1═O)(C)C)C)OC(═O)C)(C)OC(═O)C)OC(═O)C)OC(═O)C)OC(═O)C | |
| C[C@@H]1CC[C@@]2(CC[C@@]3(C(═CC[C@@H]4[C@]3(CC[C@@H]3[C@@]4(CC[C@@H] | Natural |
| ([C@]3(C)C(═O)[O—]) | |
| O)C)C)[C@@H]2[C@]1(C)O)C)C(═O)O[C@@H]1[C@@H]([C@@H]([C@@H]([C@@H](O1) | |
| CO)O)O)O | |
| C[C@@H]1CC[C@@]2(CC[C@@]3(C(═CC[C@H]4[C@]3(CC[C@@H]3[C@@]4(CC[C@@H] | Natural |
| ([C@]3(C)C(═O)[O—])O)C)C)[C@@H]2[C@]1(C)O)C)C(═O)O[C@@H]1[C@@H] | |
| ([C@@H]([C@@H]([C@@H](O1)CO)O)O)O | |
| C[C@@H]1CC[C@@]2(CC[C@@]3(C(═CC[C@@H]4[C@]3(CC[C@H]3[C@@]4(CC[C@@H] | Natural |
| ([C@]3(C)C(═O)[O—])O)C)C)[C@@H]2[C@]1(C)O)C)C(═O)O[C@@H]1[C@@H] | |
| ([C@@H]([C@@H]([C@@H](O1)CO)O)O)O | |
| C[C@@H]1CC[C@@]2(CC[C@@]3(C(═CC[C@H]4[C@]3(CC[C@H]3[C@@]4(CC[C@@H]([C | Natural |
| @]3(C)C(═O)[O—])O)C)C)[C@@H]2[C@]1(C)O)C)C(═O)O[C@@H]1[C@@H] | |
| ([C@@H]([C@@H]([C@@H](O1)CO)O)O)O | |
| CCCCCCCCCC[C@@H]([C@H]1CC[C@@H](O1)[C@H]1CC[C@@H](O1)[C@@H](CCCCCCC | Natural |
| CCC[C@@H]1C[C@@H](C(═O)O1)CC(═O)C)O)O | |
| C[C@H](C)CC(═O)OC[C@@H]1[C@H]([C@@H]([C@](O1)(COC(═O)C[C@H](C)C)O[C@@H]1 | Natural |
| [C@@H]([C@H]([C@@H]([C@H](O1)CO)O)O)O)OC(═O)C[C@H](C)C)OC(═O)C[C@H](C)C | |
| C[C@H](CCC(═O)[C@@H](C)C)[C@H]1[C@H](C[C@@]2([C@@]1([C@H](C[C@]13[C@H]2C | Natural |
| C[C@@H]2[C@]1(C3)CC[C@@H]([C@@]2(C)C)O[C@H]1[C@@H]([C@H]([C@@H]([C@H](O | |
| 1)CO)O)O)O)O)C)C)O | |
| C/C(═C\C═C\C═C(/C)\C═C\C═C(/C)C(═O)O[C@H]1[C@@H]([C@H]([C@@H]([C@H](O1)CO[C | Natural |
| @H]1[C@@H]([C@H]([C@@H]([C@H](O1)CO)O)O)O)O)O)O)/C═C/C═C(\C)C(═O)[O—] | |
| CC1═CC(═O)C[C@]([C@@H]1CC[C@@H](C)O[C@@H]1[C@@H]([C@@H]([C@@H]([C@@H] | Natural |
| (O1)COC(═O)c1cc(c(c(c1)O)O)O)O)O)O)(C)C | |
| CC1═CC(═O)C[C@]([C@H]1CC[C@@H](C)O[C@@H]1[C@@H]([C@@H]([C@@H]([C@@H] | Natural |
| (O1)COC(═O)c1cc(c(c(c1)O)O)O)O)O)O)(C)C | |
| CC1═CC(═O)C[C@]([C@@H]1CC[C@H](C)O[C@@H]1[C@@H]([C@@H]([C@@H]([C@@H] | Natural |
| (O1)COC(═O)c1cc(c(c(c1)O)O)O)O)O)O)(C)C | |
| CC1═CC(═O)C[C@]([C@H]1CC[C@H](C)O[C@@H]1[C@@H]([C@@H]([C@@H]([C@@H](O1) | Natural |
| COC(═O)c1cc(c(c(c1)O)O)O)O)O)O)(C)C | |
| CCC[C@H](CC[C@H](C)[C@H]1CC[C@@H]2[C@@]1(CC[C@H]1[C@H]2CC═C2[C@@]1(CC | Natural |
| [C@@H](C2)OC(═O)Cc1ccccc1)C)C)[C@H](C)C | |
| CCC[C@H](CC[C@H](C)[C@H]1CC[C@@H]2[C@@]1(CC[C@H]1[C@H]2CC═C2[C@@]1(CC | Natural |
| [C@H](C2)OC(═O)Cc1ccccc1)C)C)[C@H](C)C | |
| CCCCCCCCCCCC[C@@H]([C@@H](CC[C@@H]([C@H]1CC[C@@H](O1)CCCCCCC[C@H](C | Natural |
| C1═C[C@@H](OC1═O)C)O)O)O)O | |
| CCCCCCCCCCCC[C@H]([C@@H](CC[C@@H]([C@H]1CC[C@@H](O1)CCCCCCC[C@H](CC | Natural |
| 1═C[C@@H](OC1═O)C)O)O)O)O | |
| C[C@H](C)CC(═O)OC[C@@H]1[C@H]([C@@H]([C@](O1)(COC(═O)C[C@H](C)C)O[C@@H]1 | Natural |
| [C@@H]([C@H]([C@@H]([C@H](O1)CO)O)O)OC(═O)C[C@H](C)C)O)OC(═O)C[C@H](C)C | |
| CC1═C[C@@H]([C@H]([C@@H](C1)c1ccc(cc1O)O)C(═O)c1ccc(cc1O)O)c1c(cc(c2c1oc(c(c2═O)C/ | Natural |
| C═C(\C)C)c1ccc(cc1O)O)O)O | |
| Cc1cc(c(c(c1)OC(═O)[C@@]([C@@]([C@@]([C@]([C@@]([C@]([C@]([C@](F)(F)F)(F)F)(F)F) | Natural |
| (F)F)(F)F)(F)F)(F)F)(F)F)C)C | |
| C[C@@H]1CC[C@@H](C[C@@H]1C)NC(═O)[C@@]([C@](F)(F)F)(O[C@@]([C@@]([C@@](F) | Natural |
| (F)F)(O[C@@]([C@@]([C@](F)(F)F)(F)F)(F)F)F)(F)F)F | |
| C[C@H]1CC[C@@H](C[C@@H]1C)NC(═O)[C@@]([C@](F)(F)F)(O[C@@]([C@@]([C@@](F) | Natural |
| (F)F)(O[C@@]([C@@]([C@](F)(F)F)(F)F)(F)F)F)(F)F)F | |
| C[C@@H]1CC[C@H](C[C@@H]1C)NC(═O)[C@@]([C@](F)(F)F)(O[C@@]([C@@]([C@@](F) | Natural |
| (F)F)(O[C@@]([C@@]([C@](F)(F)F)(F)F)(F)F)F)(F)F)F | |
| C[C@H]1CC[C@H](C[C@@H]1C)NC(═O)[C@@]([C@](F)(F)F)(O[C@@]([C@@]([C@@](F)(F) | Natural |
| F)(O[C@@]([C@@]([C@](F)(F)F)(F)F)(F)F)F)(F)F)F | |
| C[C@H](CCCCCCCCC[C@@H](Cc1cc(cc(c1C(═O)[O—])O)O)OC(═O)C)O | Natural |
| C[C@@H](CCCCCCCCC[C@@H](Cc1cc(cc(c1C(═O)[O—])O)O)OC(═O)C)O | Natural |
| C[C@H](CCCCCCCCC[C@H](Cc1cc(cc(c1C(═O)[O—])O)O)OC(═O)C)O | Natural |
| C[C@@H](CCCCCCCCC[C@H](Cc1cc(cc(c1C(═O)[O—])O)O)OC(═O)C)O | Natural |
| C[C@]12CC[C@@H]([C@@]1([C@H](CC1═C2CC[C@@H]2[C@]1(C[C@@H]([C@@H]([C@@] | Natural |
| 2(C)C)OC(═O)C[C@@](C)(CC(═O)NCC(═O)OC)O)O)C)O)C)[C@@H](CC[C@@H]([C@@](C) | |
| (C)O)O)CO | |
| C[C@]12CC[C@@H]([C@@]1([C@H](CC1═C2CC[C@H]2[C@]1(C[C@@H]([C@@H]([C@]2(C) | Natural |
| C)OC(═O)C[C@@](C)(CC(═O)NCC(═O)OC)O)O)C)O)C)[C@@H](CC[C@@H]([C@@](C)(C)O) | |
| O)CO | |
| C[C@]12CC[C@@H]([C@@]1([C@H](CC1═C2CC[C@@H]2[C@@]1(C[C@@H]([C@@H]([C@ | Natural |
| @]2(C)C)OC(═O)C[C@@](C)(CC(═O)NCC(═O)OC)O)O)C)O)C)[C@@H](CC[C@@H]([C@@](C) | |
| (C)O)O)CO | |
| C[C@]12CC[C@@H]([C@@]1([C@H](CC1═C2CC[C@H]2[C@@]1(C[C@@H]([C@@H]([C@@] | Natural |
| 2(C)C)OC(═O)C[C@@](C)(CC(═O)NCC(═O)OC)O)O)C)O)C)[C@@H](CC[C@@H]([C@@](C) | |
| (C)O)O)CO | |
| C[C@](CC(═O)OCc1ccc(cc1)O[C@H]1[C@@H]([C@H]([C@@H]([C@H](O1)CO)O)O)O)(CC(═O) | Natural |
| OCc1ccc(cc1)O[C@H]1[C@@H]([C@H]([C@@H]([C@H](O1)CO)O)O)O)O | |
| C[C@@](CC(═O)[O—])(CC(═O)OC[C@@H]1[C@H]([C@@H]([C@H]([C@@H](O1) | Natural |
| Oc1c(═O)c2c(cc(cc2oc1c1ccc(cc1)O)O)O)O[C@H]1[C@@H]([C@](CO1)(CO)O)O)O)O)O | |
| C[C@](CC(═O)[O—]) | Natural |
| (CC(═O)OC[C@@H]1[C@H]([C@@H]([C@H]([C@@H](O1)Oc1c(═O)c2c(cc(cc2o | |
| c1c1ccc(cc1)O)O)O)O[C@H]1[C@@H]([C@](CO1)(CO)O)O)O)O)O | |
| COc1cc(ccc1O[C@H]1[C@@H]([C@H]([C@@H]([C@H](O1)CO)O)O)O)C[C@@H]1CO[C@@H] | Natural |
| ([C@@H]1CO)c1ccc(c(c1)OC)O[C@H]1[C@@H]([C@H]([C@@H]([C@H](O1)CO)O)O)O | |
| COc1cc(ccc1O[C@H]1[C@@H]([C@H]([C@@H]([C@H](O1)CO)O)O)O)C[C@@H]1CO[C@H] | Natural |
| ([C@@H]1CO)c1ccc(c(c1)OC)O[C@H]1[C@@H]([C@H]([C@@H]([C@H](O1)CO)O)O)O | |
| C[C@@](O)(C(═O)O[C@@H]1[C@@H](C[C@@](C[C@H]1OC(═O)/C═C/c1cc(c(cc1)O)O)(O)C(═ | Natural |
| O)OC)OC(═O)/C═C/c1cc(c(cc1)O)O)CC(═O)[O—] | |
| CCCCCCCCCCCCCC[C@@H](C(═O)N[C@@H](CO[C@H]1[C@@H]([C@H]([C@@H]([C@H] | Natural |
| (O1)CO)O)O)O)[C@@H](/C═C/CC/C═C\CCCCCCCCC)O)O | |
| CCCCCCCCCCCCCC[C@H](C(═O)N[C@@H](CO[C@H]1[C@@H]([C@H]([C@@H]([C@H](O | Natural |
| 1)CO)O)O)O)[C@@H](/C═C/CC/C═C\CCCCCCCCC)O)O | |
| CCCCCCCCCCCCCC[C@@H](C(═O)N[C@H](CO[C@H]1[C@@H]([C@H]([C@@H]([C@H](O | Natural |
| 1)CO)O)O)O)[C@@H](/C═C/CC/C═C\CCCCCCCCC)O)O | |
| CCCCCCCCCCCCCC[C@H](C(═O)N[C@H](CO[C@H]1[C@@H]([C@H]([C@@H]([C@H](O1) | Natural |
| CO)O)O)O)[C@@H](/C═C/CC/C═C\CCCCCCCCC)O)O | |
| C[C@@H]1[C@@H]([C@@H](O[C@@H]1c1ccc(c(c1)OC)O[C@@H](C)[C@@H](c1ccc(c(c1)OC) | Natural |
| OC)O)c1ccc(c(c1)OC)O[C@@H](C)[C@@H](c1ccc(c(c1)OC)OC)O)C | |
| C[C@H]1[C@@H]([C@@H](O[C@@H]1c1ccc(c(c1)OC)O[C@@H](C)[C@@H](c1ccc(c(c1)OC) | Natural |
| OC)O)c1ccc(c(c1)OC)O[C@@H](C)[C@@H](c1ccc(c(c1)OC)OC)O)C | |
| C[C@@H]1[C@H]([C@@H](O[C@@H]1c1ccc(c(c1)OC)O[C@@H](C)[C@@H](c1ccc(c(c1)OC) | Natural |
| OC)O)c1ccc(c(c1)OC)O[C@@H](C)[C@@H](c1ccc(c(c1)OC)OC)O)C | |
| C[C@@H]1[C@@H]([C@H](O[C@H]1c1ccc(c(c1)OC)O[C@@H](C)[C@@H](c1ccc(c(c1)OC)OC) | Natural |
| O)c1ccc(c(c1)OC)O[C@@H](C)[C@@H](c1ccc(c(c1)OC)OC)O)C | |
| CC[C@@H](C)C(═O)O[C@H]1C[C@]([C@@]23[C@@H]([C@@H](C[C@@H]([C@@]2([C@H] | Natural |
| 1OC(═O)[C@@H](C)CC)COC(═O)C)OC(═O)c1ccccc1)[C@](O3)(C)C)OC(═O)C)(C)O | |
| CC[C@H](C)C(═O)O[C@H]1C[C@]([C@@]23[C@@H]([C@@H](C[C@@H]([C@@]2([C@H]1 | Natural |
| OC(═O)[C@@H](C)CC)COC(═O)C)OC(═O)c1ccccc1)[C@](O3)(C)C)OC(═O)C)(C)O | |
| CC[C@@H](C)C(═O)O[C@H]1C[C@]([C@@]23[C@@H]([C@@H](C[C@@H]([C@@]2([C@H] | Natural |
| 1OC(═O)[C@H](C)CC)COC(═O)C)OC(═O)c1ccccc1)[C@](O3)(C)C)OC(═O)C)(C)O | |
| CC[C@H](C)C(═O)O[C@H]1C[C@]([C@@]23[C@@H]([C@@H](C[C@@H]([C@@]2([C@H]1 | Natural |
| OC(═O)[C@H](C)CC)COC(═O)C)OC(═O)c1ccccc1)[C@](O3)(C)C)OC(═O)C)(C)O | |
| COc1cc(cc(c1O)OC)[C@@H]1c2c(cc(c(c2OC)O)OC)C═C([C@H]1C(═O)NCCc1ccc(cc1)O)C(═O)N | Natural |
| CCc1ccc(cc1)O | |
| c1cc(c(cc1C[C@@H](C(═O)[O—])OC(═O)[C@H]1[C@@H](c2cc(c(cc2C═C1C(═O)O[C@H](Cc1ccc | Natural |
| (c(c 1)O)O)C(═O)[O—])O)O)c1ccc(c(c1)O)O)O)O | |
| C[C@]12CC[C@@](C[C@@H]1CC[C@@H]1[C@@H]2CC[C@]2([C@@H]1CC[C@@H]2O)C) | Natural |
| (C#C[C@@]1(CC[C@]2([C@H](C1)CC[C@@H]1[C@@H]2CC[C@]2([C@@H]1CC[C@@H]2O) | |
| C)C)O)O | |
| C[C@]12CC[C@](C[C@@H]1CC[C@@H]1[C@@H]2CC[C@]2([C@@H]1CC[C@@H]2O)C)(C# | Natural |
| C[C@@]1(CC[C@]2([C@H](C1)CC[C@@H]1[C@@H]2CC[C@]2([C@@H]1CC[C@@H]2O)C)C) | |
| O)O | |
| C[C@]12CC[C@@](C[C@@H]1CC[C@H]1[C@@H]2CC[C@]2([C@@H]1CC[C@@H]2O)C)(C# | Natural |
| C[C@@]1(CC[C@]2([C@H](C1)CC[C@@H]1[C@@H]2CC[C@]2([C@@H]1CC[C@@H]2O)C)C) | |
| O)O | |
| C[C@]12CC[C@](C[C@@H]1CC[C@H]1[C@@H]2CC[C@]2([C@@H]1CC[C@@H]2O)C)(C#C | Natural |
| [C@@]1(CC[C@]2([C@H](C1)CC[C@@H]1[C@@H]2CC[C@]2([C@@H]1CC[C@@H]2O)C)C)O) | |
| O | |
| CCc1ccc(cc1)OC(═O)[C@@]([C@@]([C@@]([C@]([C@@]([C@]([C@]([C@](F)(F)F)(F)F)(F)F) | Natural |
| (F)F)(F)F)(F)F)(F)F)CF)F | |
| c1cc(c(cc1CCO[C@H]1[C@@H]([C@H]([C@@H]([C@H](O1)CO)OC(═O)/C═C/c1ccc(c(c1)O)O) | Natural |
| O[C@H]1[C@@H]([C@H]([C@@H]([C@H](O1)CO)O)O)O)O)O)O | |
| c1cc(ccc1CCCC[C@@H](CCc1ccc(cc1)O)O[C@H]1[C@@H]([C@H]([C@@H]([C@H](O1)CO[C | Natural |
| @@H]1[C@@H]([C@](CO1)(CO)O)O)O)O)O)O | |
| c1cc(ccc1CCCC[C@H](CCc1ccc(cc1)O)O[C@H]1[C@@H]([C@H]([C@@H]([C@H](O1)CO[C@ | Natural |
| @H]1[C@@H]([C@](CO1)(CO)O)O)O)O)O)O | |
| CC(═O)O[C@@H]1C[C@@H]2[C@](CCC(═O)[C@@]2(C)C)([C@@H]2[C@@]1(C1═CC[C@H] | Natural |
| ([C@@]1(CC2)C)[C@@H]1C[C@@H](O[C@@H]1OC(═O)C)[C@H]1[C@](O1)(C)C)C)C | |
| C[C@@]12CC[C@@H]([C@@H]1CC[C@@]1([C@@H]2CC[C@@H]2[C@@]1(CC[C@@H]1[C | Natural |
| @@]2(CC[C@@H]([C@@]1(C)CO[C@@H]1[C@@H]([C@@H]([C@@H]([C@@H](O1)CO)O)O) | |
| O)O)C)C)C)[C@@](C)(C(═O)[O—])O | |
| C[C@]12CC[C@@H]([C@@H]1CC[C@@]1([C@@H]2CC[C@@H]2[C@@]1(CC[C@@H]1[C@ | Natural |
| @]2(CC[C@@H]([C@@]1(C)CO[C@@H]1[C@@H]([C@@H]([C@@H]([C@@H](O1)CO)O)O) | |
| O)O)C)C)C)[C@@](C)(C(═O)[O—])O | |
| C[C@@]12CC[C@H]([C@@H]1CC[C@@]1([C@@H]2CC[C@@H]2[C@@]1(CC[C@@H]1[C@ | Natural |
| @]2(CC[C@@H]([C@@]1(C)CO[C@@H]1[C@@H]([C@@H]([C@@H]([C@@H](O1)CO)O)O) | |
| O)O)C)C)C)[C@@](C)(C(═O)[O—])O | |
| C[C@]12CC[C@H]([C@@H]1CC[C@@]1([C@@H]2CC[C@@H]2[C@@]1(CC[C@@H]1[C@@] | Natural |
| 2(CC[C@@H]([C@@]1(C)CO[C@@H]1[C@@H]([C@@H]([C@@H]([C@@H](O1)CO)O)O)O)O) | |
| C)C)C)[C@@](C)(C(═O)[O—])O | |
| C[C@H]1[C@@H]([C@H]([C@H]([C@@H](O1)OC[C@@H]1[C@H]([C@@H]([C@H]([C@@H] | Natural |
| (O1)Oc1cc2c(c(═O)cc(o2)c2ccc(cc2)OC)c(c1OC)O)O)O)O)OC(═O)C)OC(═O)C)O | |
| C[C@H]1C[C@]2([C@H]([C@H]1OC(═O)c1ccccc1)[C@H]([C@]1(C[C@@H]3[C@H](C[C@](C3═ | Natural |
| O)(C)C)[C@@]([C@H]2OC(═O)C)([C@@H]1OC(═O)C)C)OC(═O)C)OC(═O)COC(═O)C)O | |
| C[C@H]1C[C@]2([C@H]([C@H]1OC(═O)c1ccccc1)[C@H]([C@@]1(C[C@@H]3[C@H](C[C@] | Natural |
| (C3═O)(C)C)[C@]([C@H]2OC(═O)C)([C@@H]1OC(═O)C)C)OC(═O)C)OC(═O)COC(═O)C)O | |
| C[C@@H](C)CC(═O)O[C@@H]1[C@H]([C@@H]([C@H](O[C@H]1O[C@@H]1C[C@H]([C@H] | Natural |
| 2CC[C@@]34C[C@@H](CC[C@H]3[C@@]2(C1)C)C(═C)[C@@H]4O)C(═O)[O—]) | |
| CO)O[S@](═O)(═O)[O—])O[S@](═O)(═O)[O—] | |
| COc1ccc(cc1O[C@@H]1[C@@H]([C@@H]([C@@H]([C@@H](O1)CO)O)O)O)[C@@H]1[C@@ | Natural |
| H]2CO[C@@H]([C@@H]2CO1)c1cc(c(c(c1)OC)O[C@@H]1[C@@H]([C@@H]([C@@H]([C@@ | |
| H](O1)CO)O)O)O)OC | |
| COc1ccc(cc1O[C@H]1[C@@H]([C@@H]([C@@H]([C@@H](O1)CO)O)O)O)[C@@H]1[C@@H] | Natural |
| 2CO[C@@H]([C@@H]2CO1)c1cc(c(c(c1)OC)O[C@@H]1[C@@H]([C@@H]([C@@H]([C@@H] | |
| (O1)CO)O)O)O)OC | |
| COc1ccc(cc1O[C@@H]1[C@H]([C@@H]([C@@H]([C@@H](O1)CO)O)O)O)[C@@H]1[C@@H] | Natural |
| 2CO[C@@H]([C@@H]2CO1)c1cc(c(c(c1)OC)O[C@@H]1[C@@H]([C@@H]([C@@H]([C@@H] | |
| (O1)CO)O)O)O)OC | |
| COc1ccc(cc1O[C@H]1[C@H]([C@@H]([C@@H]([C@@H](O1)CO)O)O)O)[C@@H]1[C@@H]2 | Natural |
| CO[C@@H]([C@@H]2CO1)c1cc(c(c(c1)OC)O[C@@H]1[C@@H]([C@@H]([C@@H]([C@@H] | |
| (O1)CO)O)O)O)OC | |
| C/C(═C\CC/C(═C\CC/C(═C/COc1c(cc2c(c1O)CN(C2═O)[C@@H](CCC(═O)[O—])C(═O)[O—]) | Natural |
| OC)C)C)C | |
| C/C(═C\CC/C(═C\CC/C(═C/COc1c(cc2c(c1O)CN(C2═O)[C@H](CCC(═O)[O—])C(═O)[O—]) | Natural |
| OC)C)C)C | |
| CC1═C2[C@H]([C@@H]([C@@]3([C@H](C[C@@H]([C@H]([C@H]3[C@@H]([C@@H]([C@]2 | Natural |
| (C)C)C[C@@H]1OC(═O)C)OC(═O)C)CO)OC(═O)C)OC(═O)C)C)OC(═O)C)OC(═O)C | |
| C[C@]12CC[C@@H]([C@@]([C@@H]1CC[C@@]1([C@@H]2CC═C2[C@]1(C[C@H]([C@@]1 | Natural |
| ([C@H]2C[C@@](CC1)(C)C)C(═O)[O—])O)C)C)(C)C(═O)[O—]) | |
| O[C@H]1[C@@H]([C@H]([C@@H](CO1)O)O)O | |
| C[C@]12CC[C@@H]([C@@]([C@H]1CC[C@@]1([C@@H]2CC═C2[C@]1(C[C@H]([C@@]1([C | Natural |
| @H]2C[C@@](CC1)(C)C)C(═O)[O—])O)C)C)(C)C(═O)[O—]) | |
| O[C@H]1[C@@H]([C@H]([C@@H](CO1)O)O)O | |
| C[C@]12CC[C@@H]([C@@]([C@@H]1CC[C@@]1([C@H]2CC═C2[C@]1(C[C@H]([C@@]1([C | Natural |
| @H]2C[C@@](CC1)(C)C)C(═O)[O—])O)C)C)(C)C(═O)[O—]) | |
| O[C@H]1[C@@H]([C@H]([C@@H](CO1)O)O)O | |
| C[C@]12CC[C@@H]([C@@]([C@H]1CC[C@@]1([C@H]2CC═C2[C@]1(C[C@H]([C@@]1([C@ | Natural |
| H]2C[C@@](CC1)(C)C)C(═O)[O—])O)C)C)(C)C(═O)[O—]) | |
| O[C@H]1[C@@H]([C@H]([C@@H](CO1)O)O)O | |
| COc1ccccc1NC(═O)[C@]([C@@]([C@]([C@]([C@]([C@]([C@@]([C@](F)(F)F)(F)F)(F)F)(F)F)(F) | Natural |
| F)(F)F)(F)F)(F)F | |
| CCCCCCCCCC(═O)O[C@@H]1[C@@H]([C@@H]([C@@H](O[C@@H]1O[C@@]1([C@@H] | Natural |
| ([C@@H]([C@@H](O1)CO)O)OC(═O)[C@@H](C)C)CO)CO)OC(═O)[C@@H](C)C)OC(═O)[C@@ | |
| H](C)C | |
| CCCCCCCCCC(═O)O[C@H]1[C@@H]([C@@H]([C@@H](O[C@@H]1O[C@@]1([C@@H]([C | Natural |
| @@H]([C@@H](O1)CO)O)OC(═O)[C@@H](C)C)CO)CO)OC(═O)[C@@H](C)C)OC(═O)[C@@H] | |
| (C)C | |
| CCCCCCCCCC(═O)O[C@@H]1[C@H]([C@@H]([C@@H](O[C@@H]1O[C@@]1([C@@H]([C | Natural |
| @@H]([C@@H](O1)CO)O)OC(═O)[C@@H](C)C)CO)CO)OC(═O)[C@@H](C)C)OC(═O)[C@@H] | |
| (C)C | |
| CCCCCCCCCC(═O)O[C@H]1[C@H]([C@@H]([C@@H](O[C@@H]1O[C@@]1([C@@H]([C@ | Natural |
| @H]([C@@H](O1)CO)O)OC(═O)[C@@H](C)C)CO)CO)OC(═O)[C@@H](C)C)OC(═O)[C@@H] | |
| (C)C | |
| C[C@@]12C[C@H]([C@@H]([C@]1(CC(═O)[C@@]1([C@H]2CC═C2[C@H]1C[C@@H](C(═O) | Natural |
| [C@@]2(C)C)O[C@H]1[C@@H]([C@H]([C@@H]([C@H](O1)CO)O)O)O)C)C)[C@](C)(C(═O)/C═ | |
| C/[C@@](C)(C)O)O)O | |
| C[C@@H]1C[C@@]2([C@@H]([C@@H]1OC(═O)c1ccccc1)C═C([C@@H]([C@@H]([C@@H] | Natural |
| ([C@@](C═C[C@@H]([C@@H]2OC(═O)C)C)(C)C)OC(═O)C)OC(═O)C)O)C)OC(═O)C | |
| Cc1ccc(c(c1C)OC(═O)[C@@]([C@@]([C@@]([C@]([C@@]([C@]([C@]([C@](F)(F)F)(F)F)(F)F) | Natural |
| (F)F)(F)F)(F)F)(F)F)(F)F)C | |
| C[C@](C)([C@@H]1CCC(═CC1)C(═O)OC[C@@H]1[C@H]([C@@H]([C@H]([C@@H](O1)OC | Natural |
| (═O)C1═CC[C@@H](CC1)[C@@](C)(C)O)O)O)O)O | |
| C[C@1(C)([C@H]1CCC(═CC1)C(═O)OC[C@@H]1[C@H]([C@@H]([C@H]([C@@H](O1)OC(═O) | Natural |
| C1═CC[C@@H](CC1)[C@@](C)(C)O)O)O)O)O | |
| C[C@](C)([C@@H]1CCC(═CC1)C(═O)OC[C@@H]1[C@H]([C@@H]([C@H]([C@@H](O1)OC | Natural |
| (═O)C1═CC[C@H](CC1)[C@@](C)(C)O)O)O)O)O | |
| C[C@](C)([C@H]1CCC(═CC1)C(═O)OC[C@@H]1[C@H]([C@@H]([C@H]([C@@H](O1)OC(═O) | Natural |
| C1═CC[C@H](CC1)[C@@](C)(C)O)O)O)O)O | |
| C/C(═C\C[C@@H]1C[C@@]2(C(═C(C(═O)[C@@](C2═O)([C@@]1(C)C)C/C═C(\C)C)C(═O)c1ccc | Natural |
| (c(c1)O)O)O)C[C@H](C/C═C(\C)C)C(═C)C)C | |
| CC1═C([C@@](CCC1)(C)C)/C═C/C(═C/C═C/C(═C/COC(═O)C)C)C | Natural |
| CCCCCCCCCC(═O)O[C@@H]1[C@@H]([C@@H]([C@@H](O[C@@H]1O[C@@]1([C@@H] | Natural |
| ([C@@H]([C@@H](O1)CO)O)OC(═O)[C@H](C)C)CO)COC(═O)[C@H](C)C)O)OC(═O)[C@@H] | |
| (C)C | |
| CCCCCCCCCC(═O)O[C@H]1[C@@H]([C@@H]([C@@H](O[C@@H]1O[C@@]1([C@@H]([C | Natural |
| @@H]([C@@H](O1)CO)O)OC(═O)[C@H](C)C)CO)COC(═O)[C@H](C)C)O)OC(═O)[C@@H](C) | |
| C | |
| CCCCCCCCCC(═O)O[C@@H]1[C@H]([C@@H]([C@@H](O[C@@H]1O[C@@]1([C@@H]([C | Natural |
| @@H]([C@@H](O1)CO)O)OC(═O)[C@H](C)C)CO)COC(═O)[C@H](C)C)O)OC(═O)[C@@H](C) | |
| C | |
| CCCCCCCCCC(═O)O[C@H]1[C@H]([C@@H]([C@@H](O[C@@H]1O[C@@]1([C@@H]([C@ | Natural |
| @H]([C@@H](O1)CO)O)OC(═O)[C@H](C)C)CO)COC(═O)[C@H](C)C)O)OC(═O)[C@@H](C)C | |
| C/C(═C\CC/C(═C/CC/C(═C/Cc1c(cc2c(c1O)CN(C2═O)[C@@H](CCC(═O)[O—])C(═O)[O—]) | Natural |
| O)C)C)C | |
| C/C(═C\CC/C(═C/CC/C(═C/Cc1c(cc2c(c1O)CN(C2═O)[C@H](CCC(═O)[O—])C(═O)[O—])O)C)C)C | Natural |
| C[C@@H](CC/C═C(\C)C(═O)[O—])[C@@H]1C[C@@H]([C@@]2([C@@]1([C@@H] | Natural |
| (C[C@@]13[C@@H]2CC[C@@H]2[C@@]1(C3)CC[C@@H]([C@@]2(C)C)O[C@@H]1[C@@H] | |
| ([C@@H]([C@@H](CO1)O)O)O)O)C)C)O | |
| C[C@H](CC/C═C(\C)C(═O)[O—])[ | Natural |
| C@@H]1C[C@@H]([C@@]2([C@@]1([C@@H](C[C@@]13[C@ | |
| @H]2CC[C@@H]2[C@@]1(C3)CC[C@@H]([C@@]2(C)C)O[C@@H]1[C@@H]([C@@H]([C@ | |
| @H](CO1)O)O)O)O)C)C)O | |
| C[C@@H](CC/C═C(\C)C(═O)[O—]) | Natural |
| [C@H]1C[C@@H]([C@@]2([C@@]1([C@@H](C[C@@]13[C@@H] | |
| 2CC[C@@H]2[C@@]1(C3)CC[C@@H]([C@@]2(C)C)O[C@@H]1[C@@H]([C@@H]([C@@H] | |
| (CO1)O)O)O)O)C)C)O | |
| C[C@H](CC/C═C(\C)C(═O)[O—])[ | Natural |
| C@H]1C[C@@H]([C@@]2([C@@]1([C@@H](C[C@@]13[C@@H]2CC | |
| [C@@H]2[C@@]1(C3)CC[C@@H]([C@@]2(C)C)O[C@@H]1[C@@H]([C@@H]([C@@H](CO1) | |
| O)O)O)O)C)C)O | |
| c1cc(c(cc1CCO[C@H]1[C@@H]([C@H]([C@@H]([C@H](O1)CO[C@H]1[C@@H]([C@H]([C@ | Natural |
| @H]([C@H](O1)CO)O)O)O)OC(═O)/C═C/c1ccc(c(c1)O)O)O)O)O)O | |
| C[C@H](CCC[C@H](C)C)[C@H]1CC[C@@H]2[C@@]1(CC[C@@H]1[C@H]2CC═C2[C@@]1 | Natural |
| (CC[C@@H](C2)OCOc1ccc(cc1)Cl)C)C | |
| C[C@H](CCC[C@H](C)C)[C@H]1CC[C@@H]2[C@@]1(CC[C@H]1[C@H]2CC═C2[C@@]1(CC | Natural |
| [C@@H](C2)OCOc1ccc(cc1)Cl)C)C | |
| C[C@H](CCC[C@H](C)C)[C@H]1CC[C@H]2[C@@]1(CC[C@H]1[C@H]2CC═C2[C@@]1(CC[C | Natural |
| @@H](C2)OCOc1ccc(cc1)Cl)C)C | |
| C[C@@](CC(═O)[O—]) | Natural |
| (CC(═O)OC[C@@H]1[C@@H]([C@@H]([C@@H]([C@@H](O1)OC/C═C/c1ccccc1) | |
| O)O)O[C@@H]1[C@@H]([C@@H]([C@@H]([C@@H](O1)CO)O)O)O)O | |
| C[C@](CC(═O)[O—]) | Natural |
| (CC(═O)OC[C@@H]1[C@@H]([C@@H]([C@@H]([C@@H](O1)OC/C═C/c1ccccc1) | |
| O)O)O[C@@H]1[C@@H]([C@@H]([C@@H]([C@@H](O1)CO)O)O)O)O | |
| C[C@@](CC(═O)[O—]) | Natural |
| (CC(═O)OC[C@H]1[C@@H]([C@@H]([C@@H]([C@@H](O1)OC/C═C/c1ccccc1) | |
| O)O)O[C@@H]1[C@@H]([C@@H]([C@@H]([C@@H](O1)CO)O)O)O)O | |
| C[C@](CC(═O)[O—]) | Natural |
| (CC(═O)OC[C@H]1[C@@H]([C@@H]([C@@H]([C@@H](O1)OC/C═C/c1ccccc1) | |
| O)O)O[C@@H]1[C@@H]([C@@H]([C@@H]([C@@H](O1)CO)O)O)O)O | |
| CC[C@H](/C═C/[C@@H](C)[C@H]1CC[C@@H]2[C@@]1(CC[C@H]1[C@H]2C═C[C@H]2[C@ | Natural |
| @]1(CC[C@@H](C2)O[C@H]1[C@@H]([C@H]([C@@H]([C@H](O1)CO)O)O)O)C)C)[C@H](C) | |
| C | |
| CC1═C([C@@](CCC1)(C)C)CC/C(═C\CCC1═CC[C@@H](O[C@H]1O)C1═CC(═O)O[C@@H]1O) | Natural |
| C | |
| CC1═C([C@@](CCC1)(C)C)CC/C(═C\CCC1═CC[C@H](O[C@H]1O)C1═CC(═O)O[C@@H]1O)C | Natural |
| CC1═C([C@@](CCC1)(C)C)CC/C(═C\CCC1═CC[C@H](O[C@@H]1O)C1═CC(═O)O[C@@H]1O) | Natural |
| C | |
| CC1═C([C@@](CCC1)(C)C)CC/C(═C\CCC1═CC[C@@H](O[C@@H]1O)C1═CC(═O)O[C@@H]1 | Natural |
| O)C | |
| C[C@@H](C)C(═C)CC[C@H]([C@H]1[C@@H](C[C@@]2([C@@]1(CCC1═C2CC[C@H]([C@]1 | Natural |
| (C)CCC(═O)[O—])C(═C)C)C)C)O)C(═O)[O—] | |
| CC1═C2[C@H]([C@@H]([C@@]3([C@H](C[C@@H]4[C@]([C@H]3[C@@H]([C@@]([C@]2(C) | Natural |
| C)(C[C@@H]1OC(═O)C)O)OC(═O)C)(CO4)OC(═O)C)OC(═O)C)C)OC(═O)C)OC(═O)C | |
| Cc1ccc(c(c1)C)NC(═O)[C@@]([C@@]([C@@]([C@]([C@@]([C@]([C@]([C@](F)(F)F)(F)F)(F)F) | Natural |
| (F)F)(F)F)(F)F)(F)F)(F)F | |
| CCCCCC(═O)Cc1cc(cc(c1C(═O)Oc1cc(c(c(c1)OC)C(═O)[O—])CC(═O)CCCCC)O)O | Natural |
| C[C@@H](C)c1cc2c(c3c1O[C@H]1C4═C(C[C@]5(CCC[C@@]([C@@H]5CC4)(C)C)O)C(═O)C(═ | Natural |
| O)[C@]1(O3)[C@@H](C)C)C[C@]1(CCC[C@@]([C@@H]1CC2)(C)C)O | |
| C[C@@H]1[C@@H]([C@@H]([C@H]([C@@H](O1)O[C@@H]IC[C@@H]2C(═C[C@@]1(C)C═ | Natural |
| C)CC[C@@H]1[C@@]2(CC[C@@H]([C@@]1(C)C)O[C@H]1[C@@H]([C@H]([C@@H](O1)CO) | |
| O)O)C)O)O)O | |
| C[C@@H]1[C@@H]([C@@H]([C@H]([C@@H](O1)O[C@H]1C[C@@H]2C(═C[C@@]1(C)C═C) | Natural |
| CC[C@(@H]1[C@@]2(CC[C@@H]([C@@]1(C)C)O[C@H]1[C@@H]([C@H]([C@@H](O1)CO)O) | |
| O)C)O)O)O | |
| C[C@@H]1[C@@H]([C@@H]([C@H]([C@@H](O1)O[C@@H]1C[C@H]2C(═C[C@@]1(C)C═C) | Natural |
| CC[C@@H]1[C@@]2(CC[C@@H]([C@@]1(C)C)O[C@H]1[C@@H]([C@H]([C@@H](O1)CO)O) | |
| O)C)O)O)O | |
| C[C@@H]1[C@@H]([C@@H]([C@H]([C@@H](O1)O[C@H]1C[C@H]2C(═C[C@@]1(C)C═C)C | Natural |
| C[C@@H]1[C@@]2(CC[C@@H]([C@@]1(C)C)O[C@H]1[C@@H]([C@H]([C@@H](O1)CO)O) | |
| O)C)O)O)O | |
| C/C(═C\CC[C@@H]1[C@]2(CCC[C@@]([C@@H]2CC[C@@]1(C)O)(C)C)C)CC[C@@H]1C(═C) | Natural |
| CCC[C@@]1(C)C | |
| C[C@@H]1[C@H]([C@@H]([C@H]([C@@H](O1)O[C@H]1CC[C@]2([C@@H]([C@@]1(C)C)C | Natural |
| C[C@@]1([C@@H]2CC═C2[C@]1(CC[C@@]1([C@@H]2C[C@@](CC1)(C)C)C(═O)[O—]) | |
| C(═O)[O—])C)C)O)O)O | |
| C[C@@H]1[C@H]([C@@H]([C@H]([C@@H](O1)O[C@H]1CC[C@]2([C@H]([C@]1(C)C)CC[C | Natural |
| @@]1([C@@H]2CC═C2[C@]1(CC[C@@]1([C@@H]2C[C@@](CC1)(C)C)C(═O)[O—])C(═O)[O—]) | |
| C)C)O)O)O | |
| C[C@@H]1[C@H]([C@@H]([C@H]([C@@H](O1)O[C@H]1CC[C@]2([C@@H]([C@@]1(C)C)C | Natural |
| C[C@@]1([C@H]2CC═C2[C@]1(CC[C@@]1([C@@H]2C[C@@](CC1)(C)C)C(═O)[O—]) | |
| C(═O)[O—])C)C)O)O)O | |
| C[C@@H]1[C@H]([C@@H]([C@H]([C@@H](O1)O[C@H]1CC[C@]2([C@H]([C@]1(C)C)CC[C | Natural |
| @@]1([C@H]2CC═C2[C@]1(CC[C@@]1([C@@H]2C[C@@](CC1)(C)C)C(═O)[O—])C(═O)[O—]) | |
| C)C)O)O)O | |
| C[C@H]1[C@@H]([C@H]([C@@H]([C@H](O1)O[C@H]1CC[C@]2([C@H]([C@]1(C)C)CC[C@ | Natural |
| @]1([C@H]2CC═C2[C@]1(CC[C@@]1([C@@H]2C[C@@](CC1)(C)C)C(═O)[O—])C(═O)[O—]) | |
| C)C)O)O)O | |
| COc1ccc(cc1)NC(═O)[C@]([C@@]([C@]([C@]([C@]([C@]([C@@]([C@](F)(F)F)(F)F)(F)F)(F)F) | Natural |
| (F)F)(F)F)(F)F)(F)F | |
| COc1cc(cc(c1O)OC)[C@H]1[C@@H]2CO[C@@H]([C@@H]2CO1)c1cc(c(c(c1)OC)O[C@H]1[C | Natural |
| @@H]([C@H]([C@@H]([C@H](O1)CO)O)O)O[C@H]1[C@@H]([C@](CO1)(CO)O)O)OC | |
| COc1cc(cc(c1O)OC)[C@H]1[C@H]2CO[C@@H]([C@@H]2CO1)c1cc(c(c(c1)OC)O[C@H]1[C@ | Natural |
| @H]([C@H]([C@@H]([C@H](O1)CO)O)O)O[C@H]1[C@@H]([C@](CO1)(CO)O)O)OC | |
| COc1cc(cc(c1O)OC)[C@H]1[C@@H]2CO[C@@H]([C@H]2CO1)c1cc(c(c(c1)OC)O[C@H]1[C@ | Natural |
| @H]([C@H]([C@@H]([C@H](O1)CO)O)O)O[C@H]1[C@@H]([C@](CO1)(CO)O)O)OC | |
| COc1cc(cc(c1O)OC)[C@H]1[C@H]2CO[C@@H]([C@H]2CO1)c1cc(c(c(c1)OC)O[C@H]1[C@@H] | Natural |
| ([C@H]([C@@H]([C@H](O1)CO)O)O)O[C@H]1[C@@H]([C@](CO1)(CO)O)O)OC | |
| C/C(═C\CC/C(═C/Cc1ccc(c(c1O)C(═O)c1c(cc(cc1O)C(═O)[O—])C(═O)[O—])O)C)C | Natural |
| CCCC(═O)c1c(c(c(c(c1O)Cc1c(c(c(c(c1O)C(═O)CCC)OC)C)O)O)Cc1c(c(c(c(c1O)C(═O)CCC)OC)C) | Natural |
| O)O | |
| CC(═O)O[C@@H]1CO[C@@H]([C@@H]([C@@H]1OC(═O)C)OC(═O)C)c1c(cc2c(c1OC)c(═O)cc | Natural |
| (o2)c1ccc(cc1)O[C@@H]1[C@@H]([C@@H]([C@@H]([C@@H](O1)CO)O)O)O)O | |
| CC(═O)O[C@H]1CO[C@@H]([C@@H]([C@@H]1OC(═O)C)OC(═O)C)c1c(cc2c(c1OC)c(═O)cc(o | Natural |
| 2)c1ccc(cc1)O[C@@H]1[C@@H]([C@@H]([C@@H]([C@@H](O1)CO)O)O)O)O | |
| CC(═O)O[C@@H]1CO[C@H]([C@@H]([C@@H]1OC(═O)C)OC(═O)C)c1c(cc2c(c1OC)c(═O)cc(o | Natural |
| 2)c1ccc(cc1)O[C@@H]1[C@@H]([C@@H]([C@@H]([C@@H](O1)CO)O)O)O)O | |
| CC(═O)O[C@H]1CO[C@H]([C@@H]([C@@H]1OC(═O)C)OC(═O)C)c1c(cc2c(c1OC)c(═O)cc(o2) | Natural |
| c1ccc(cc1)O[C@@H]1[C@@H]([C@@H]([C@@H]([C@@H](O1)CO)O)O)O)O | |
| COc1cc(ccc1O[C@@H]1[C@@H]([C@@H]([C@@H]([C@@H](O1)CO)O)O)O)[C@@H]1[C@H] | Natural |
| 2CO[C | |
| @@H]([C@H]2CO1)c1ccc(c(c1)OC)O[C@@H]1[C@@H]([C@@H]([C@@H]([C@@H](O1)CO)O) | |
| O)O | |
| COc1cc(ccc1O[C@@H]1[C@@H]([C@@H]([C@@H]([C@@H](O1)CO)O)O)O)[C@@H]1[C@H] | Natural |
| 2CO[C@@H]([C@H]2CO1)c1ccc(c(c1)OC)O[C@H]1[C@@H]([C@@H]([C@@H]([C@@H](O1) | |
| CO)O)O)O | |
| COc1cc(ccc1O[C@@H]1[C@@H]([C@@H]([C@@H]([C@@H](O1)CO)O)O)O)[C@@H]1[C@H] | Natural |
| 2CO[C@@H]([C@H]2CO1)c1ccc(c(c1)OC)O[C@@H]1[C@H]([C@@H]([C@@H]([C@@H](O1) | |
| CO)O)O)O | |
| COc1cc(ccc1O[C@@H]1[C@@H]([C@@H]([C@@H]([C@@H](O1)CO)O)O)O)[C@@H]1[C@H] | Natural |
| 2CO[C@@H]([C@H]2CO1)c1ccc(c(c1)OC)O[C@H]1[C@H]([C@@H]([C@@H]([C@@H](O1)CO) | |
| O)O)O | |
| C[C@@](C)(C)c1ccc(cc1)c1cc(═O)c2ccc(cc2o1)NC(═O)c1ccc(cc1)[C@@](C)(C)C | Natural |
| CC(═O)c1ccc(cc1)NC(═O)[C@@]([C@@]([C@@]([C@]([C@@]([C@]([C@]([C@](F)(F)F)(F)F)(F) | Natural |
| F)(F)F)(F)F)(F)F)(F)F)(F)F | |
| CCO[C@@H]1c2cc(c(c(c2C(═O)C(═C1c1ccc(cc1O)O)[O—])O)CC[C@@H](C/C═C(\C)C)C(═C)C)O | Natural |
| CC1═C(C[C@@H](OC1═O)[C@@H](C)[C@@H]1CC[C@@H]2[C@@]1(CC[C@@H]1[C@@H]2 | Natural |
| CC═C2[C@@]1([C@@H](C[C@@H](C2)O[C@@H]1[C@@H]([C@@H]([C@@H]([C@@H](O1) | |
| CO)O)O)O)O)C)C)CO | |
| CC1═C(C[C@H](OC1═O)[C@@H](C)[C@@H]1CC[C@@H]2[C@@]1(CC[C@@H]1[C@@H]2C | Natural |
| C═C2[C@@]1([C@@H](C[C@@H](C2)O[C@@H]1[C@@H]([C@@H]([C@@H]([C@@H](O1)C | |
| O)O)O)O)O)C)C)CO | |
| CC1═C(C[C@@H](OC1═O)[C@H](C)[C@@H]1CC[C@@H]2[C@@]1(CC[C@@H]1[C@@H]2C | Natural |
| C═C2[C@@]1([C@@H](C[C@@H](C2)O[C@@H]1[C@@H]([C@@H]([C@@H]([C@@H](O1)C | |
| O)O)O)O)O)C)C)CO | |
| CC1═C(C[C@H](OC1═O)[C@H](C)[C@@H]1CC[C@@H]2[C@@]1(CC[C@@H]1[C@@H]2CC═ | Natural |
| C2[C@@]1([C@@H](C[C@@H](C2)O[C@@H]1[C@@H]([C@@H]([C@@H]([C@@H](O1)CO) | |
| O)O)O)O)C)C)CO | |
| CC(═O)OC[C@@H]1[C@H]([C@H]([C@H]([C@@H](O1)O[C@@H]1[C@H]([C@@H]([C@H] | Natural |
| (O[C@H]1Oc1cc(c2c(═O)cc(oc2c1O)c1ccc(cc1)OC)O)CO)O)O)O)O)O | |
| C[C@@H](C)C(═C)CC[C@H]([C@H]1[C@@H](C[C@@]2([C@@]1(CCC1═C2CC[C@H]([C@]1 | Natural |
| (C)CCC(═O)OC)C(═C)C)C)C)O)C(═O)[O—] | |
| C[C@@H]1[C@@H]([C@@H](O[C@@H]1c1ccc(c(c1)OC)O[C@@H](C)[C@@H](c1ccc2c(c1)O | Natural |
| CO2)O)c1ccc(c(c1)OC)O[C@@H](C)[C@@H](c1ccc(c(c1)OC)OC)O)C | |
| C[C@H]1[C@@H]([C@@H](O[C@@H]1c1ccc(c(c1)OC)O[C@@H](C)[C@@H](c1ccc2c(c1)OCO | Natural |
| 2)O)c1ccc(c(c1)OC)O[C@@H](C)[C@@H](c1ccc(c(c1)OC)OC)O)C | |
| C[C@@H]1[C@H]([C@@H](O[C@@H]1c1ccc(c(c1)OC)O[C@@H](C)[C@@H](c1ccc2c(c1)OCO | Natural |
| 2)O)c1ccc(c(c1)OC)O[C@@H](C)[C@@H](c1ccc(c(c1)OC)OC)O)C | |
| C[C@H]1[C@H]([C@@H](O[C@@H]1c1ccc(c(c1)OC)O[C@@H](C)[C@@H](c1ccc2c(c1)OCO2) | Natural |
| O)c1ccc(c(c1)OC)O[C@@H](C)[C@@H](c1ccc(c(c1)OC)OC)O)C | |
| CCCCCCCCCc1c(c(cc(c1O[C@H]1[C@@H]([C@H]([C@@H]([C@H](O1)CO)O)O)O)O)O)O[C@ | Natural |
| H]1[C@@H]([C@H]([C@@H]([C@H](O1)CO)O)O)O | |
| c1ccc(cc1)CCCCCCCCC(═O)c1c(cc(c(c1O)[C@@H]1C[C@H](Oc2c1ccc(c2)O)c1ccc(cc1)O)O)O | Natural |
| c1ccc(cc1)CCCCCCCCC(═O)c1c(cc(c(c1O)[C@@H]1C[C@@H](Oc2c1ccc(c2)O)c1ccc(cc1)O)O)O | Natural |
| c1ccc(cc1)CCCCCCCCC(═O)c1c(cc(c(c1O)[C@H]1C[C@@H](Oc2c1ccc(c2)O)c1ccc(cc1)O)O)O | Natural |
| c1ccc(cc1)CCCCCCCCC(═O)c1c(cc(c(c1O)[C@H]1C[C@H](Oc2c1ccc(c2)O)c1ccc(cc1)O)O)O | Natural |
| CC1═C2[C@H]([C@@H]([C@@]3([C@H](C[C@@H](C(═C)[C@H]3[C@@H]([C@@]2(C[C@@ | Natural |
| H]1O)[C@](C)(C)O)OC(═O)C)O)OC(═O)C)C)OC(═O)C)OC(═O)c1ccccc1 | |
| CC1═C[C@H]([C@@H](C[C@H]1CC(═O)NCc1ccc(cc1)F)[C@H](C)C)CNC(═O)COCC(═O)[O—] | Natural |
| C/C(═C\CC/C(═C/CC[C@@](C)(C═C)O[C@H]1[C@@H]([C@H]([C@@H]([C@H](O1)CO)O)O)O) | Natural |
| CO)C[C@@H](/C═C(\C)C(═O)[O—])O | |
| C/C(═C\CC/C(═C/CC[C@](C)(C═C)O[C@H]1[C@@H]([C@H]([C@@H]([C@H](O1)CO)O)O)O) | Natural |
| CO)C[C@@H](/C═C(\C)C(═O)[O—])O | |
| C/C(═C\CC/C(═C/CC[C@@](C)(C═C)O[C@H]1[C@@H]([C@H]([C@@H]([C@H](O1)CO)O)O)O) | Natural |
| CO)C[C@H](/C═C(\C)C(═O)[O—])O | |
| C/C(═C\CC/C(═C/CC[C@](C)(C═C)O[C@H]1[C@@H]([C@H]([C@@H]([C@H](O1)CO)O)O)O) | Natural |
| CO)C[C@H](/C═C(\C)C(═O)[O—])O | |
| C[C@]12CC[C@@H]([C@@]([C@H]1CC[C@@]1([C@@H]2CC═C2[C@]1(CC[C@@]1([C@@H] | Natural |
| 2C[C@@](CC1)(C)C)C(═O)[O—])C)C)(C)CO)O[C@H]1[C@@H]([C@H]([C@H](CO1)O)O)O | |
| C[C@]12CC[C@@H]([C@@]([C@@H]1CC[C@@]1([C@@H]2CC═C2[C@]1(CC[C@@]1([C@H] | Natural |
| 2C[C@@](CC1)(C)C)C(═O)[O—])C)C)(C)CO)O[C@H]1[C@@H]([C@H]([C@H](CO1)O)O)O | |
| C/C(═C\CO[C@@H]1[C@@H]([C@@H]([C@@H](CO1)OC)O)O)CC[C@@H]1C(═C)CC[C@@H] | Natural |
| 2[C@@]1(CC[C@@H]([C@@]2(C)C)O[C@@H]1[C@@H]([C@@H]([C@@H](O1)CO)O)O)C | |
| C/C(═C\CO[C@H]1[C@@H]([C@@H]([C@@H](CO1)OC)O)O)CC[C@@H]1C(═C)CC[C@@H]2 | Natural |
| [C@@]1(CC[C@@H]([C@@]2(C)C)O[C@@H]1[C@@H]([C@@H]([C@@H](O1)CO)O)O)C | |
| C/C(═C\CO[C@@H]1[C@H]([C@@H]([C@@H](CO1)OC)O)O)CC[C@@H]1C(═C)CC[C@@H]2 | Natural |
| [C@@]1(CC[C@@H]([C@@]2(C)C)O[C@@H]1[C@@H]([C@@H]([C@@H](O1)CO)O)O)C | |
| C/C(═C\CO[C@H]1[C@H]([C@@H]([C@@H](CO1)OC)O)O)CC[C@@H]1C(═C)CC[C@@H]2[C | Natural |
| @@]1(CC[C@@H]([C@@]2(C)C)O[C@@H]1[C@@H]([C@@H]([C@@H](O1)CO)O)O)C | |
| C[C@@H]1C═C[C@@](C(═O)[C@@H]([C@H](C(═C)[C@@H]([C@H]2[C@H]([C@](C[C@@]2 | Natural |
| (C1═O)OC(═O)C)(C)OC(═O)C)OC(═O)C)OC(═O)C)OC(═O)C)OC(═O)[C@H](C)C)(C)C | |
| C/C(═C\CC[C@@](C)(C═C)O)C(═O)OC[C@@H]1[C@@H]([C@@H]([C@@H]([C@@H](O1)c1c | Natural |
| (cc2c(c1O)c(═O)cc(o2)c1ccc(cc1)O)O)O)O)O | |
| C/C(═C\CC[C@](C)(C═C)O)C(═O)OC[C@@H]1[C@@H]([C@@H]([C@@H]([C@@H](O1)c1c(c | Natural |
| c2c(c1O)c(═O)cc(o2)c1ccc(cc1)O)O)O)O)O | |
| C/C(═C\CC[C@@](C)(C═C)O)C(═O)OC[C@H]1[C@@H]([C@@H]([C@@H]([C@@H](O1)c1c(c | Natural |
| c2c(c1O)c(═O)cc(o2)c1ccc(cc1)O)O)O)O)O | |
| C/C(═C\CC[C@](C)(C═C)O)C(═O)OC[C@H]1[C@@H]([C@@H]([C@@H]([C@@H](O1)c1c(cc2 | Natural |
| c(c1O)c(═O)cc(o2)c1ccc(cc1)O)O)O)O)O | |
| C[C@@]1(CCC[C@@]2([C@@H]1CCC(═C)[C@@H]2CC/C(═C\CO)CO)C)CO[C@@H]1[C@@H] | Natural |
| ([C@@H]([C@@H]([C@@H](O1)CO)O)O)O | |
| C[C@]1(CCC[C@@]2([C@@H]1CCC(═C)[C@@H]2CC/C(═C\CO)CO)C)CO[C@@H]1[C@@H] | Natural |
| ([C@@H]([C@@H]([C@@H](O1)CO)O)O)O | |
| C[C@@]1(CCC[C@]2([C@@H]1CCC(═C)[C@@H]2CC/C(═C\CO)CO)C)CO[C@@H]1[C@@H] | Natural |
| ([C@@H]([C@@H]([C@@H](O1)CO)O)O)O | |
| C[C@]1(CCC[C@]2([C@@H]1CCC(═C)[C@@H]2CC/C(═C\CO)CO)C)CO[C@@H]1[C@@H]([C | Natural |
| @@H]([C@@H]([C@@H](O1)CO)O)O)O | |
| C[C@@H]1[C@H](CC[C@]2([C@H]1[C@H]([C@@H](CC2)[C@H](C)C(═O)NCc1cc(cc(c1)F)F) | Natural |
| O)C)NC(═O)C[C@](C)(C)C | |
| C[C@@H]1[C@H](CC[C@]2([C@H]1[C@H]([C@H](CC2)[C@H](C)C(═O)NCc1cc(cc(c1)F)F)O) | Natural |
| C)NC(═O)C[C@](C)(C)C | |
| CCCCCN(CCCCC)c1nc(nc(n1)O[C@H]([C@](F)(F)F)[C@](F)(F)F)O[C@H]([C@@](F)(F)F)[C@ | Natural |
| @](F)(F)F | |
| c1cc(c(cc1/C═C/C(═O)O[C@@H]1[C@H](O[C@H]([C@@H]([C@H]1O)O)OC[C@@H](c1ccc(c(c | Natural |
| 1)O)O)O)CO[C@H]1[C@@H]([C@H]([C@@H](CO1)O)O)O)O)O | |
| c1cc(c(cc1/C═C/C(═O)O[C@@H]1[C@H](O[C@H]([C@@H]([C@H]1O)O)OC[C@H](c1ccc(c(c1) | Natural |
| O)O)O)CO[C@H]1[C@@H]([C@H]([C@@H](CO1)O)O)O)O)O | |
| Cc1cc(c2c(c1C(═O)C)C(═O)c1ccc(c(c1C2═O)O)c1ccc2c(c1O)[C@H]([C@]13C(═O)C[C@]([C@@ | Natural |
| H]([C@@]1(C2═O)O3)[C@@H](C)OC(═O)C)(C)O)O)O | |
| CC(═C)[C@@H]1CC[C@]2([C@H]1[C@@H]1CC[C@@H]3[C@]4(CC[C@@H]([C@@]([C@@ | Natural |
| H]4CC[C@]3([C@@]1(CC2)C)C)(C)C)OC(═O)/C═C/c1ccccc1)C)C | |
| c1ccc(cc1)CCC(═O)c1c(c(c(c(c1O)[C@H]1[C@@H]([C@H]([C@@H]([C@H](O1)CO)O)O)O)O) | Natural |
| [C@H]1[C@@H]([C@H]([C@@H]([C@H](O1)CO)O)O)O)O | |
| Cc1cc(cc(c1)OC(═O)[C@@]([C@](F)(F)F)(O[C@@]([C@@]([C@@](F)(F)F)(O[C@@]([C@@] | Natural |
| ([C@](F)(F)F)(F)F)(F)F)F)(F)F)F)C | |
| Cc1cc(cc(c1)OC(═O)[C@]([C@](F)(F)F)(O[C@@]([C@@]([C@@](F)(F)F)(O[C@@]([C@@]([C | Natural |
| @](F)(F)F)(F)F)(F)F)F)(F)F)F)C | |
| Cc1cc(cc(c1)OC(═O)[C@@]([C@](F)(F)F)(O[C@@]([C@]([C@@](F)(F)F)(O[C@@]([C@@]([C | Natural |
| @](F)(F)F)(F)F)(F)F)F)(F)F)F)C | |
| Cc1cc(cc(c1)OC(═O)[C@]([C@](F)(F)F)(O[C@@]([C@]([C@@](F)(F)F)(O[C@@]([C@@]([C@] | Natural |
| (F)(F)F)(F)F)(F)F)F)(F)F)F)C | |
| CC1═C2[C@H](C[C@@]3(CC[C@@H](C(═C)[C@H]3[C@@H]([C@@H]([C@]2(C)C)[C@H](C1) | Natural |
| OC(═O)[C@H](C)C)OC(═O)C)OC(═O)C)C)OC(═O)C | |
| C[C@@](C)([C@@H]1CCC(═CC1)C(═O)OC[C@H]1[C@H]([C@@H]([C@@H]([C@@H](O1)Oc | Natural |
| 1c(cc(cc1O)C(═O)[O—])O)O)O)O)O | |
| C[C@@](C)([C@H]1CCC(═CC1)C(═O)OC[C@H]1[C@H]([C@@H]([C@@H]([C@@H](O1)Oc1c | Natural |
| (cc(cc1O)C(═O)[O—])O)O)O)O)O | |
| C[C@@](C)([C@@H]1CCC(═CC1)C(═O)OC[C@@H]1[C@H]([C@@H]([C@@H]([C@@H](O1) | Natural |
| Oc1c(cc(cc1O)C(═O)[O—])O)O)O)O)O | |
| C[C@@](C)([C@H]1CCC(═CC1)C(═O)OC[C@@H]1[C@H]([C@@H]([C@@H]([C@@H](O1)Oc | Natural |
| 1c(cc(cc1O)C(═O)[O—])O)O)O)O)O | |
| C[C@H]1C[C@H]([C@@]23[C@@H]([C@@]1(C)C/C═C(\C)C═C)C[C@@H](C═C2[C@@H](C | Natural |
| [C@H]3OC(═O)C)OC(═O)C)O)OC(═O)/C═C/c1ccccc1 | |
| C[C@@]12CC[C@@H]3[C@@]([C@@H]1CC═C1[C@]2(CC[C@@]2([C@@H]1[C@@H]([C@ | Natural |
| @](CC2)(C)C)O)C(═O)O[C@H]1[C@@H]([C@H]([C@@H]([C@H](O1)CO)O)O)O)C)(C[C@H] | |
| ([C@@H]([C@@]3(CO)CO)O)O)C | |
| C[C@@]12CC[C@H]3[C@@]([C@@H]1CC═C1[C@]2(CC[C@@]2([C@@H]1[C@@H]([C@@] | Natural |
| (CC2)(C)C)O)C(═O)O[C@H]1[C@@H]([C@H]([C@@H]([C@H](O1)CO)O)O)O)C)(C[C@H]([C@ | |
| @H]([C@]3(CO)CO)O)O)C | |
| C[C@@]12CC[C@@H]3[C@@]([C@H]1CC═C1[C@]2(CC[C@@]2([C@@H]1[C@@H]([C@@] | Natural |
| (CC2)(C)C)O)C(═O)O[C@H]1[C@@H]([C@H]([C@@H]([C@H](O1)CO)O)O)O)C)(C[C@H]([C@ | |
| @H]([C@@]3(CO)CO)O)O)C | |
| C[C@@]12CC[C@H]3[C@@]([C@H]1CC═C1[C@]2(CC[C@@]2([C@@H]1[C@@H]([C@@](C | Natural |
| C2)(C)C)O)C(═O)O[C@H]1[C@@H]([C@H]([C@@H]([C@H](O1)CO)O)O)O)C)(C[C@H]([C@ | |
| @H]([C@]3(CO)CO)O)O)C | |
| C[C@]1([C@H]([C@@H]2[C@@](CC[C@@]3(C2═CC[C@@H]2[C@]3(CC[C@@H]3[C@@]2(C | Natural |
| [C@H]([C@@H]([C@@]3(CO)CO)O)O)C)C)C)(CC1)C(═O)O[C@@H]1O[C@@H]([C@H]([C@ | |
| @H]([C@H]1O)O)O)CO)O)C | |
| C[C@]1([C@H]([C@@H]2[C@@](CC[C@@]3(C2═CC[C@H]2[C@]3(CC[C@@H]3[C@@]2(C[C | Natural |
| @H]([C@@H]([C@@]3(CO)CO)O)O)C)C)C)(CC1)C(═O)O[C@@H]1O[C@@H]([C@H]([C@@H] | |
| ([C@H]1O)O)O)CO)O)C | |
| C[C@@H]1CC[C@@]2(CC[C@@]3(C(═CC[C@H]4[C@]3(CC[C@@H]3[C@@]4(CC[C@@H] | Natural |
| ([C@]3(COC(═O)C)COC(═O)C)OC(═O)C)C)C)[C@H]2[C@]1(C)O)C)C(═O)OC | |
| C[C@H]1[C@@H]([C@H]([C@H]([C@@H](O1)O[C@@H]1[C@H]([C@@H](O[C@@H]([C@H] | Natural |
| 1OC(═O)/C═C/c1ccc(c(c1)O)O)CO)OC[C@@H](c1ccc(c(c1)O)O)OC)O)O)O)O | |
| C[C@H]1[C@@H]([C@H]([C@H]([C@@H](O1)O[C@@H]1[C@H]([C@@H](O[C@@H]([C@H] | Natural |
| 1OC(═O)/C═C/c1ccc(c(c1)O)O)CO)OC[C@H](c1ccc(c(c1)O)O)OC)O)O)O)O | |
| Cc1ccc(cc1C)NC(═O)[C@@]([C@@]([C@@]([C@]([C@@]([C@]([C@]([C@](F)(F)F)(F)F)(F)F) | Natural |
| (F)F)(F)F)(F)F)(F)F)(F)F | |
| c1cc(c(cc1CCO[C@H]1[C@@H]([C@H]([C@@H]([C@H](O1)CO[C@H]1[C@@H]([C@H]([C@ | Natural |
| @H](CO1)O)O)O)OC(═O)/C═C/c1ccc(c(c1)O)O)O)O)O)O | |
| C[C@@H](C)C(═C)CC[C@H]([C@H]1[C@@H](C[C@@]2([C@@]1(CCC1═C2C═C[C@H]([C@] | Natural |
| 1(C)CCC(═O)[O—])C(═C)C)C)C)O)C(═O)[O—] | |
| c1c(cc(c(c1)O)O)/C═C/C(═O)O[C@H]1[C@@H]([C@@H](C[C@](C1)(O)C(═O)[O—]) | Natural |
| OC(═O)/C═C/c1cc(c(cc1)O)O)OC(═O)/C═C/c1cc(c(cc1)O)O | |
| CC[C@@H](C/C═C(\C)Cc1c(cc(c2c1[C@H](C(═C(C2═O)[O—]) | Natural |
| c1ccc(cc1OCC)O)O)OCC)O)C(═C)C | |
| c1cc(ccc1[C@H]1[C@@H](C(═O)c2c(cc(cc2O1)O)O)c1c(cc(c2c1oc(cc2═O)c1ccc(c(c1)O)O)O)O[C | Natural |
| @H]1[C@@H]([C@H]([C@@H]([C@H](O1)CO)O)O)O)O | |
| CC(C)(C)O | VCF |
| CC(C)OC(C)═O | VCF |
| CC(C)═O | VCF |
| CC(C)(C)S | VCF |
| CCCCCCCCCCCC(═O)OC(C)C | VCF |
| COC1═CC(C═O)═CC(OC)═C1OC | VCF |
| CC1═CC2═C(C═C1)C(═O)OC2 | VCF |
| OCC(O)COC(═O)CC(O)(CC(O)═O)C(O)═O | FooDB |
| C\C(\C═C\C═C(/C)\C═C\C1═C(C)C[C@@H](O)CC1(C)C)═C/C═C/C═C(\C)/C═C/C═C(\C)/C═C/C1═ | HMDB |
| C(C)C[C@@H](O)CC1(C)C | |
| CC(C)C[C@@H](O)C(O)═O | HMDB |
| COC1═CC═C(C═C1O)C1CCC2═C(O1)C═C(O)C═C2 | GoodScents |
| C\C═C\C(═O)C1CCC(C)(C)C═C1C | GoodScents |
| CC(═O)C1═C(C)C═C(C═C1C)C(C)(C)C | GoodScents |
| OC1═CC2═C(C[C@@H](OC(═O)C3═CC(O)═C(O)C(O)═C3)[C@H](O2)C2═CC(O)═C(O)C(O)═C2) | GoodScents |
| C(O)═C1 | |
| CCC(═O)OCCCCCCCCCC═C | GoodScents |
| ClC(Cl)(Cl)Cl | FooDB |
| CC(C)C1CCC(═O)C1═O | FooDB |
| CCCCCCCNCCC | VCF |
| CCCCCCCCCC1CCC(═O)O1 | VCF |
| CC═C(C)C | VCF |
| CC(═O)C1═C2C═CC═CC2═CC2═CC═CC═C12 | VCF |
| C1═CC═C2C(═C1)C═C1C═CC3═CC═CC4═CC═C2C1═C34 | VCF |
| CC1═CC(═CC═C1)C#N | VCF |
| CC(C)C(C)═O | FooDB |
| O[C@H]1C[C@H](O)[C@@H](COP(O)(O)═O)O1 | HMDB |
| NC1═NC═NC2═C1N═CN2[C@@H]1O[C@H](COP(O)(═O)OS(O)(═O)═O)[C@@H](O)[C@H]1O | HMDB |
| CC(C)(O)[C@@H](O)C(O)═O | HMDB |
| NC1═NC2═C(N(C═O)C(CNC3═CC═C(C═C3)C(═O)NC(CCC(O)═O)C(O)═O)CN2)C(═O)N1 | HMDB |
| CCCSCC(N)C(O)═O | HMDB |
| CCCCC\C═C/C═C/C═C/CCCCCCC(O)═O | HMDB |
| [H][C@@](O)(CCCCCCCCC)CC(O)═O | HMDB |
| CCCCCCCCCC(═O)CC(O)═O | HMDB |
| COC1═CC(C(═O)CCNC(C)═O)═C(NC═O)C═C1 | HMDB |
| CCCCCCCCCCCCCCCCCCCCCC(═O)OC[C@@H](COC(═O)CCCCCCC\C═C/CCCC)OC(═O)CC | YMDB |
| CCCCC\C═C/CCCCCC | |
| CCCCCCCCCC(═O)N1CCCCC1C | Natural |
| C[N+]1C2CC(O)C1CC(C2)OC(═O)C(CO)C1═CC═CC═C1 | PMN |
| CC(C)C(═CC([O—])═O)C([O—])═O | PMN |
| CC1(CCCC2(CO)C3CCC4(O)CC3(CC4═C)C(C12)C([O—])═O)C([O—])═O | PMN |
| CCCCCCCCCCCCCCCCCC(═O)SCCNC(═O)CCNC(═O)C(O)C(C)(C)COP([O—])(═O)OP([O—]) | PMN |
| (═O)OCC1OC(C(O)C1OP([O—])([O—])═O)N1C═NC2═C1N═CN═C2N | |
| COC1═C(OC)C2═C(C═C1)C1═C(N(C)C2)C2═C(C═C1)C═C1OCOC1═C2 | PMN |
| COC1═CC2═C(C═C1O)C(CC1═CC═C(O)C(O)═C1)[N+]CC2 | PMN |
| C[N+]1CCC23C4OC5═C(O)C═CC(CC1C2C═CC4O)═C35 | PMN |
| CC#CC#CC#CC#CC#CC═C | Natural |
| c1cc(c(cc1Br)F)I | Natural |
| c1cc2c(cc1Br)c(═O)c(co2)Br | Natural |
| c1cc2c(cc1Cl)c(═O)c(co2)Br | Natural |
| c1cc(c(cc1Br)F)C(═O)N | Natural |
| c1cc2c(cc1Br)cc(o2)/C═C/Br | Natural |
| C/C═C/C#CC#C/C═C/c1ccco1 | Natural |
| c1c(cc(c2c1c(═O)c(co2)Br)Cl)Cl | Natural |
| c1cc(c(c(c1F)Cl)F)I | Natural |
| C/C═C/C#CC#CC#C/C═C/[C@@H](CO)O | Natural |
| c1cc(c(cc1Br)F)C#N | Natural |
| C/C═C/C#CC#CC#CC#C[C@H](CO)O | Natural |
| Cc1ccc2nc(cn2c1)c1cc2ccccc2o1 | Natural |
| CC(═O)OC/C═C/C#CC#C/C═C/c1ccco1 | Natural |
| c1cc(c(cc1Br)C#N)F | Natural |
| C#CC#Cc1ccc(s1)C#C[C@@H](CCl)O | Natural |
| c1c(c(c(c(c1Br)F)F)F)F | Natural |
| c1ccc2c(c1)c(═O)c(co2)Br | Natural |
| c1cc(c(cc1[S@](═O)(═O)N)F)Br | Natural |
| c1cc(ccc1c1cn2cc(ccc2n1)I)I | Natural |
| c1cc2c(cc1Br)c(═O)c(co2)/C═C/C═O | Natural |
| COc1cccc(c1)C(═O)Oc1ccc2c(c1)occ(c2═O)c1nc2ccccc2s1 | Natural |
| c1cc2c(cc1Cl)nc(o2)[O—] | Natural |
| c1cc(c(c(c1F)F)F)Br | Natural |
| Cc1c(ccc2c1occ(c2═O)c1nc2ccccc2s1)OC(═O)c1ccco1 | Natural |
| Cc1c(ccc2c1oc(═O)c1c2cccc1)OCc1ccc(o1)C(═O)OC | Natural |
| c1ccc(cc1)c1coc2cc(ccc2c1═O)OCc1ccc(c(c1)Cl)Cl | Natural |
| c1ccc(c(c1)C(═O)Oc1ccc2cc(c(═O)oc2c1)c1nc2ccccc2s1)Cl | Natural |
| COc1cc(c(cc1F)Br)F | Natural |
| c1cc(c(cc1c1cn2cc(ccc2n1)I)Cl)Cl | Natural |
| COc1ccc(cc1F)Br | Natural |
| CC(═O)OCc1ccc(s1)c1ccc(s1)C#CC═C | Natural |
| COc1ccccc1C(═O)Oc1ccc2cc(c(═O)oc2c1)c1nc(cs1)c1ccc(cc1)Br | Natural |
| c1ccc2c(c1)nc(s2)c1cc2ccc(cc2oc1═O)OC(═O)c1ccco1 | Natural |
| c1ccc2c(c1)nc(s2)c1cc2ccc(cc2oc1═O)OCc1ccc(c(c1)Cl)Cl | Natural |
| c1ccnc(c1)c1cc2ccc(cc2oc1═O)OCc1ccc(cc1F)F | Natural |
| c1ccc(c(c1)C(═O)Oc1ccc2cc(c(═O)oc2c1)c1nc(cs1)c1ccc(cc1)Br)Cl | Natural |
| c1cc(sc1)/C═C\1C(═O)c2ccc(cc2O1)OCc1ccc(c(c1)Cl)Cl | Natural |
| c1cc(c(cc1O)F)Br | Natural |
| c1cc(c(cc1Br)F)[S@](═O)(═O)N | Natural |
| Cc1c2c(cc3c1OCN(C3)c1cccc(c1)Br)c1ccccc1c(═O)o2 | Natural |
| CC(═C)c1nc2ccc(cc2c(═O)o1)Br | Natural |
| Cc1c(ccc2c1oc(c(c2═O)c1nc2ccccc2s1)C)OC(═O)c1ccco1 | Natural |
| CC#CC#Cc1ccc(s1)C#C[C@@H](CCl)O | Natural |
| c1ccc2c(c1)ccc(n2)c1ccc2c(c1)OCO2 | Natural |
| c1cc(oc1)/C═C\1C(═O)c2ccc(cc2O1)OCc1ccc(c(c1)Cl)Cl | Natural |
| Cn1cc(c2c1ccc(c2)OC)/OC\1C(═O)c2ccc(cc2O1)OCc1ccc(c(c1)Cl)Cl | Natural |
| Cc1cc(c2c(cc(═O)oc2c1)COc1ccc2c(c1)occ(c2═O)c1ccc2c(c1)OCCO2)C | Natural |
| Cc1c(oc2c1cc1c(c(c(═O)oc1c2)CCC(═O)Nc1cccc(c1)I)C)C | Natural |
| Cc1c(cc(o1)C(═O)OC)COc1ccc2ccc(═O)oc2c1 | Natural |
| c1cc(c(cc1Br)F)C═O | Natural |
| COc1ccccc1C(═O)Oc1ccc2c(c1)occ(c2═O)c1ccccc1Cl | Natural |
| COc1ccc(cc1OC)C(═O)Oc1ccc2c(c1)occ(c2═O)c1ccccc1Cl | Natural |
| c1cc2c(cc1F)c(═O)c(co2)Br | Natural |
| c1cc2c3ccc4c(c3cnc2c2c1cc1c(c2)OCO1)OCO4 | Natural |
| c1ccc2c(c1)nc(s2)c1cc2ccc(cc2oc1═O)OCc1ccc(cc1F)F | Natural |
| c1cc2c(cc1Br)occ(c2═O)/C═C/C═O | Natural |
| COc1cccc(c1)C(═O)Oc1ccc2cc(c(═O)oc2c1)c1nc2ccccc2s1 | Natural |
| Cc1c2c(cc3c1OCN(C3)c1ccc(cc1F)Br)c1ccccc1c(═O)o2 | Natural |
| c1cc(c(cc1Br)N)F | Natural |
| CC(═O)OCc1ccc(s1)c1ccc(s1)c1cccs1 | Natural |
| c1ccc2c(c1)nc(s2)c1cc2ccc(cc2oc1═O)OC(═O)c1cccs1 | Natural |
| COc1ccc(cc1)C(═O)Oc1ccc2c(c1)occ(c2═O)c1nc2ccccc2s1 | Natural |
| c1ccc(cc1)c1coc2cc(ccc2c1═O)OCc1ccc(cc1Cl)Cl | Natural |
| c1cc(c(cc1N)F)Br | Natural |
| c1ccc(cc1)C(═O)Oc1ccc2c(c1)occ(c2═O)c1nc2ccccc2s1 | Natural |
| c1cc(c(cc1F)O)Br | Natural |
| CCOC(═O)COc1ccc2c(c1)oc(c(c2═O)c1cc2ccccc2o1)C | Natural |
| CCCCCCCCCCCCCCCCc1ccc2cc3ccccc3cc2c1 | Natural |
| c1ccc2c(c1)nc(s2)c1cc2ccc(cc2oc1═O)OCc1cccc(c1)Cl | Natural |
| CC#CC#Cc1ccc(s1)C#C[C@H](COC(═O)C)O | Natural |
| Cc1ccccc1COc1ccc2cc(c(═O)oc2c1)c1nc2ccccc2s1 | Natural |
| C[S@](═O)(═O)c1ccc2c(c1)sc(n2)NC(═O)c1cc(═O)c2cc(ccc2o1)Cl | Natural |
| c1cc(c(cc1Br)F)N | Natural |
| Cc1c(ccc2c1O/C(═C\c1cn(c3c1cc(cc3)OC)C)C2═O)OCc1ccc(c(c1)Cl)Cl | Natural |
| c1ccc2c(c1)nc(s2)c1cc2ccc(cc2oc1═O)OCc1c(cccc1Cl)F | Natural |
| c1cc(c(cc1COc1ccc2c(c1)occ(c2═O)c1ccc2c(c1)OCCO2)Cl)Cl | Natural |
| c1cc2c(cc1Br)c(═O)cco2 | Natural |
| C[C@@H]1[C@@H]([C@@H](O[C@@H]1c1ccc(c(c1)OC)O[C@@H](C)[C@@H](c1ccc2c(c1)O | Natural |
| CO2)O)c1ccc(c(c1)OC)O[C@@H](C)[C@@H](c1ccc(c(c1)OC)OC)O)C | |
| C[C@H]1[C@@H]([C@@H](O[C@@H]1c1ccc(c(c1)OC)O[C@@H](C)[C@@H](c1ccc2c(c1)OCO | Natural |
| 2)O)c1ccc(c(c1)OC)O[C@@H](C)[C@@H](c1ccc(c(c1)OC)OC)O)C | |
| C[C@@H]1[C@H]([C@@H](O[C@@H]1c1ccc(c(c1)OC)O[C@@H](C)[C@@H](c1ccc2c(c1)OCO | Natural |
| 2)O)c1ccc(c(c1)OC)O[C@@H](C)[C@@H](c1ccc(c(c1)OC)OC)O)C | |
| c1ccc2c(c1)C═C(CO2)/C═C\1C(═O)c2ccc(cc2O1)OCc1ccc(c(c1)Cl)Cl | Natural |
| c1cc2c(cc1[S@@](═O)(═O)N)sc(n2)NC(═O)c1ccc(o1)Br | Natural |
| COc1ccccc1c1coc2cc(ccc2c1═O)OCc1ccc(c(c1)Cl)Cl | Natural |
| c1ccc2c(c1)Cc1c2ccc(c1)/N═C/1c2ccccc2c2c1cccn2 | Natural |
| COc1ccccc1C(═O)Oc1ccc2cc(c(═O)oc2c1)c1nc2ccccc2o1 | Natural |
| Cc1c(ccc2c1oc(c(c2═O)c1nc2ccccc2s1)C)OC(═O)c1cccs1 | Natural |
| COc1ccccc1C(═O)Oc1ccc2cc(c(═O)oc2c1)c1nc2ccccc2s1 | Natural |
| Cc1ccc(cc1)c1cn2cc(ccc2n1)I | Natural |
| CCn1cc(c2c1cccc2)/C═C/1C(═O)c2ccc(c(c2O1)C)OC(═O)c1cccs1 | Natural |
| Cc1cc(ccc1Cl)Br | Natural |
| CCn1cc(c2c1ccc(c2)OC)/C═C\1C(═O)c2ccc(cc2O1)OCc1ccc(c(c1)Cl)Cl | Natural |
| c1ccc(cc1)c1coc2cc(ccc2c1═O)OCc1ccc(cc1Cl)F | Natural |
| Cc1c(c(═O)c2ccc(cc2o1)OC(═O)c1ccccc1Br)c1nc2ccccc2s1 | Natural |
| Cc1ccccc1C(═O)Oc1ccc2c(═O)c(coc2c1C)c1nc2ccccc2s1 | Natural |
| c1ccc2c(c1)nc(s2)c1coc2cc(ccc2c1═O)OC(═O)CCCCl | Natural |
| Cc1ccc2c(c(oc2c1)c1cc(═O)c2cc(ccc2o1)Br)C | Natural |
| CCOC(═O)c1cc2cc(ccc2o1)c1c(oc2cc(ccc2c1═O)OC(═O)C)C | Natural |
| c1cc(oc1)/C═C/C#CC#CCCCO | Natural |
| Cc1c(ccc2c1oc(═O)c1c2CCCC1)OCc1ccc(o1)C(═O)OC | Natural |
| Cc1c(ccc2c1oc(═O)c1c2CCC1)OCc1ccc(o1)C(═O)OC | Natural |
| Cc1ccccc1C(═O)Oc1ccc2c(═O)c(c(oc2c1C)C)c1nc2ccccc2s1 | Natural |
| c1ccc(cc1)c1coc2cc(ccc2c1═O)OCc1cccc(c1)Cl | Natural |
| c1c(cc(c(c1O)F)F)Br | Natural |
| C═CC[N+]═C═S | Natural |
| CC#CC#Cc1ccc(s1)C#C[C@@H](COC(═O)C)O | Natural |
| Cc1c(cc(o1)C(═O)OC)COc1ccc2c(c1)oc(═O)c1c2CCCC1 | Natural |
| c1cc(oc1)/C═C\1C(═O)c2ccc(cc2O1)OCc1ccc(cc1Cl)Cl | Natural |
| CCOC(═O)CCc1c(c2ccc(cc2oc1═O)OCc1ccc(cc1F)Br)C | Natural |
| C═CCOc1ccc2cc(c(═O)oc2c1)c1cccc(c1)Br | Natural |
| COc1cccc(c1)C(═O)Oc1ccc2cc(c(═O)oc2c1)c1nc2ccccc2o1 | Natural |
| c1ccc(c(c1)/C═C\1C(═O)c2ccc(cc2O1)OC(═O)c1cccs1)Br | Natural |
| c1ccc(c(c1)C(═O)Oc1ccc2cc(c(═O)oc2c1)c1nc2ccccc2s1)Br | Natural |
| c1cc(sc1)/C═C\1C(═O)c2ccc(cc2O1)OCc1ccc(cc1Cl)Cl | Natural |
| C[C@H]1[C@H]([C@@H](O[C@@H]1c1ccc(c(c1)OC)O[C@@H](C)[C@@H](c1ccc2c(c1)OCO2) | Natural |
| O)c1ccc(c(c1)OC)O[C@@H](C)[C@@H](c1ccc(c(c1)OC)OC)O)C | |
| c1ccc2c(c1)nc(s2)c1cc2ccc(cc2oc1═O)OCc1ccc(cc1Cl)Cl | Natural |
| c1ccc(cc1)c1coc2cc(ccc2c1═O)OC(═O)c1ccco1 | Natural |
| c1ccc2c(c1)nc(s2)/C(═C/c1ccc(cc1Cl)Cl)C#N | Natural |
| c1ccc(c(c1)C(═O)Oc1ccc2cc(c(═O)oc2c1)c1nc2ccccc2s1)F | Natural |
| Cc1c(c(═O)oc2c1ccc(c2)OCc1ccc(o1)C(═O)OC)C | Natural |
| c1ccc(cc1)c1cc2ccc(cc2oc1═O)OC(═O)c1cccs1 | Natural |
| Cn1c2ccccc2n2c1cc(c2)c1ccc(c(c1)[N+](═O)[O—])I | Natural |
| CCOC(═O)Cc1csc(n1)NC(═O)c1cc2ccccc2o1 | Natural |
| COc1ccccc1c1coc2cc(ccc2c1═O)OCc1ccc(cc1Cl)Cl | Natural |
| COc1ccc(cc1)C(═O)Oc1ccc2cc(c(═O)oc2c1)c1nc2ccccc2s1 | Natural |
| c1ccc2c(c1)n1cc(nc1s2)c1ccc(c(c1)[N+](═O)[O—])I | Natural |
| CCc1cc2c(cc1OCc1ccccc1Cl)occ(c2═O)c1ccc2c(c1)OCCCO2 | Natural |
| Cc1cc2c(cc1OCC(═O)OC)occ(c2═O)c1cscn1 | Natural |
| c1ccc(c(c1)/C═C\1C(═O)c2ccc(cc2O1)OCc1ccc(c(c1)Cl)Cl)F | Natural |
| CCc1cc2c(cc1OCc1cccc(c1)Cl)occ(c2═O)c1ccc2c(c1)OCCCO2 | Natural |
| Cc1cc(ccc1F)Br | Natural |
| c1cc(c(cc1Br)Cl)F | Natural |
| c1cc(sc1)c1cc(═O)c2cc(ccc2o1)Br | Natural |
| c1ccc2cc3c(cc2c1)CCc1ccccc1C═C3 | Natural |
| c1cc(c(c(c1)Cl)COc1ccc2cc(c(═O)oc2c1)c1nc(cs1)c1ccc(cc1)Br)F | Natural |
| COc1ccc(cc1OC)c1coc2cc(ccc2c1═O)OCc1ccc(c(c1)Cl)Cl | Natural |
| CCc1cc2c(cc1OCc1ccc(cc1Cl)Cl)occ(c2═O)c1ccc2c(c1)OCCO2 | Natural |
| c1ccc2c(c1)nc(o2)/C(═C/c1ccc(cc1Cl)Cl)C#N | Natural |
| Cc1ccccc1C(═O)Oc1ccc2cc(c(═O)oc2c1)c1nc2ccccc2s1 | Natural |
| COc1ccc(cc1OC)c1coc2cc(ccc2c1═O)OCc1ccc(cc1Cl)Cl | Natural |
| c1cc(c(cc1Cl)Cl)c1cc(═O)c2cc(ccc2o1)Br | Natural |
| c1ccc(cc1)c1coc2cc(ccc2c1═O)OC(═O)c1cccs1 | Natural |
| Cn1cc(c2c1ccc(c2)OC)/C═C\1C(═O)c2ccc(cc2O1)OCc1ccc(cc1Cl)F | Natural |
| CCOC(═O)c1c(c(═O)c2ccc(cc2o1)OC(═O)c1ccccc1Br)c1nc2ccccc2s1 | Natural |
| Cc1c(c(═O)c2ccc(cc2o1)OCc1ccc(o1)C(═O)OC)c1ccccc1 | Natural |
| C═CCSC#N | Natural |
| c1cc(cc(c1)Br)F | Natural |
| c1cc(ccc1c1coc2cc(ccc2c1═O)OCc1ccc(cc1Cl)Cl)Br | Natural |
| CCOC(═O)Oc1cc2c(cc1C)c(═O)c(co2)c1cscn1 | Natural |
| c1cc(c(cc1C(═O)[O—])F)Br | Natural |
| COc1ccc2c(c1)occ(c2═O)c1cscn1 | Natural |
| CCn1cc(c2c1cccc2)/C═C/1C(═O)c2ccc(cc2O1)OC(═O)c1ccco1 | Natural |
| c1ccc(cc1)/C═C/C(═O)Oc1ccc2c(c1)occ(c2═O)c1nc2ccccc2s1 | Natural |
| c1c(c(cc(c1F)F)Br)O | Natural |
| CCc1cc2c(cc1OCc1cccc(c1)Cl)occ(c2═O)c1ccc2c(c1)OCCO2 | Natural |
| c1ccc2c(c1)cc1c(n2)c2ccccc2C1 | Natural |
| COc1cccc(c1)C(═O)Oc1ccc2cc(c(═O)oc2c1)c1nc(cs1)c1ccc(cc1)Br | Natural |
| c1c(c(cc(c1Br)F)F)N | Natural |
| Cc1ccc(c(c1)F)Br | Natural |
| Cc1c(c(═O)oc2c1cc1c(c2C)OCN(C1)c1cccc(c1)Br)C | Natural |
| COc1ccccc1c1coc2cc(ccc2c1═O)OCc1ccc(cc1Cl)F | Natural |
| Cc1c(ccc2c1O/C(═C\c1cn(c3c1cc(cc3)OC)C)C2═O)OCc1cccc(c1)Cl | Natural |
| COc1ccc2c(c1)occ(c2═O)c1cc2ccccc2o1 | Natural |
| CCCCCN═C═S | Natural |
| CCc1cc2c(cc1OCc1cccc(c1)OC)occ(c2═O)c1ccc2c(c1)OCCCO2 | Natural |
| Cc1cc(ccc1N)Br | Natural |
| c1ccc(c(c1)COc1ccc2cc(c(═O)oc2c1)c1nc2ccccc2s1)F | Natural |
| Cc1nc2c(c(═O)c3ccc(cc3o2)OC)c(═O)n1CCc1ccc(c(c1)OC)OC | Natural |
| Cc1c(c(═O)c2ccc(cc2o1)OCc1ccc(cc1Cl)Cl)c1ccccc1OC | Natural |
| c1ccc2c(c1)c1cc(ccc1o2)NNC1═Nc2c(C1═O)cc1c(c2)c2ccccc2o1 | Natural |
| CCn1cc(c2c1cccc2)/C═C/1C(═O)c2ccc(cc2O1)OC(═O)c1cccs1 | Natural |
| COc1ccc(cc1)C(═O)Oc1ccc2cc(c(═O)oc2c1)c1nc(cs1)c1ccc(cc1)Br | Natural |
| c1cc2c(cc1Br)c(═O)n1c(n2)CCC1 | Natural |
| c1cc(c(cc1C#N)Br)F | Natural |
| Cc1c(c(═O)c2ccc(cc2o1)O)c1nc2ccccc2s1 | Natural |
| c1c(c(c(c(c1Br)N)F)Cl)F | Natural |
| c1cc2c(cc1C(O)Oc1ccc3c(c1)O/C(═C\c1ccc(cc1Cl)Cl)C3═O)OCO2 | Natural |
| COc1ccccc1/C═C/C═C\1C(═O)c2ccc(cc2O1)OCc1ccc(c(c1)Cl)Cl | Natural |
| CCc1cc2c(cc1OCc1ccc(cc1Cl)Cl)oc(c(c2═O)c1ccc2c(c1)OCCO2)C | Natural |
| c1ccnc(c1)c1coc2cc(ccc2c1═O)O | Natural |
| Cc1c2ccc(cc2oc(═O)c1CC(═O)OC)OCc1ccc(cc1F)Br | Natural |
| c1cc(ncc1[C@@](F)(F)F)Br | Natural |
| Cc1cc(c(nc1)Br)Cl | Natural |
| c1ccc(c(c1)F)Br | Natural |
| CCn1cc(c2c1ccc(c2)OC)/C═C\1C(═O)c2ccc(cc2O1)OCc1cccc(c1)Cl | Natural |
| CC#CC#CC#C/C═C/[C@@H]([C@H](C═C)O)O | Natural |
| CC#CC#CC#C/C═C/[C@H]([C@@H](C═C)O)O | Natural |
| C/C(═C\COc1ccc2ccc(═O)oc2c1)CC[C@H]1[C@@]2(CC[C@H]([C@]1(C)C)O2)C | Natural |
| CCOC(═O)c1c(c(═O)c2ccc(cc2o1)OC(═O)c1ccccc1Cl)c1nc2ccccc2s1 | Natural |
| Cc1csc(n1)c1cc2ccc(cc2oc1═O)OC(═O)c1ccco1 | Natural |
| C[C@]1(C═Cc2cc3c(cc2O1)oc1c3COc2c1ccc(c2)OC)C | Natural |
| c1cc(ccc1c1coc2cc(ccc2c1═O)OCc1ccc(cc1Cl)F)Br | Natural |
| COC(═O)c1ccc(o1)COc1ccc2c(c1)oc(═O)c1c2CCC1 | Natural |
| Cn1c2c(nc1SCCOc1ccc3ccc(═O)oc3c1)n(c(═O)n(c2═O)C)C | Natural |
| Cc1c(c(═O)c2ccc(cc2o1)OCc1ccc(cc1Cl)Cl)c1ccccc1 | Natural |
| Cc1c(ccc2c1occ(c2═O)c1nc2ccccc2s1)OC(═O)c1cccs1 | Natural |
| Cn1c2ccccc2n2c1cc(c2)c1ccc(cc1)I | Natural |
| Cc1cc(═O)oc2c1ccc(c2)/N═C/c1cccnc1 | Natural |
| Cc1c(c(═O)c2ccc(cc2o1)OCC(═O)OC)c1csc(n1)C | Natural |
| COc1ccc(cc1OC)c1coc2cc(ccc2c1═O)OCc1ccc(cc1Cl)F | Natural |
| COc1cc(ccc1O)/C═C/c1ccc2ccccc2n1 | Natural |
| Cc1ccsc1/C═C\1C(═O)c2ccc(cc2O1)OCc1ccc(c(c1)Cl)Cl | Natural |
| CCOC(═O)CCc1c(c2ccc(c(c2oc1═O)C)OCc1ccc(c(c1)Cl)Cl)C | Natural |
| c1c(cc(c2c1c(═O)c(co2)Br)Br)Cl | Natural |
| c1ccc2c(c1)nc(s2)c1coc2cc(ccc2c1═O)O | Natural |
| c1cc(c(c(c1)Cl)COc1ccc2c(c1)occ(c2═O)c1ccc(cc1)Br)F | Natural |
| CCc1cc2c(cc1OCc1ccc(cc1Cl)F)occ(c2═O)c1ccc2c(c1)OCCO2 | Natural |
| COc1ccc2c(cc(═O)oc2c1)COc1ccc2c(c1)occ(c2═O)c1ccc2c(c1)OCCO2 | Natural |
| c1cc(c(cc1Br)F)O | Natural |
| c1ccc(c(c1)COc1ccc2c(c1)O/C(═C\c1cccs1)C2═O)Cl | Natural |
| COc1ccc2c(c1)oc1c2COc2c1ccc(c2)OC | Natural |
| Cc1ccc(cc1F)Br | Natural |
| COc1ccc(cc1OC)c1coc2cc(ccc2c1═O)OC(═O)c1cccs1 | Natural |
| COc1ccc(cc1)C(═O)Oc1ccc2cc(c(═O)oc2c1)c1nc2ccccc2o1 | Natural |
| Cc1cc(cc(c1C(═O)Oc1cc(c(c(c1)O)C(═O)Oc1cc(c(c(c1)O)C(═O)[O—])C)C)O)O | Natural |
| CCOC(═O)CCc1c(c2ccc(cc2oc1═O)OCc1ccc(cc1Cl)Cl)C | Natural |
| Cc1c(oc2c1cc1c(c(c(═O)oc1c2)CC/C(═N/Cc1ccccn1)O)C)C | Natural |
| CC1═C([C@](C[C@H](C1)O)(C)C)/C═C/C(═C/C═C/C(═C/C═C/C═C(\C)/C═C/C═C(\C)C═O)C)C | Natural |
| Cc1c(ccc2c1oc(═O)c1c2cccc1)OCc1cc(oc1C)C(═O)OC | Natural |
| COc1ccc(cc1)c1coc2cc(ccc2c1═O)OCc1ccc(c(c1)Cl)Cl | Natural |
| c1ccc(c(c1)Oc1coc2cc(ccc2c1═O)OC(═O)c1cccs1)Br | Natural |
| c1cc2c(cc1Br)[C@H](N1CCCC1═N2)O | Natural |
| Cc1c(c(═O)c2ccc(cc2o1)OCc1ccc(cc1Cl)Cl)c1ccc(c(c1)OC)OC | Natural |
| Cc1c(ccc2c1oc(═O)c1c2CCCC1)OCc1cc(oc1C)C(═O)OC | Natural |
| Cc1c(ccc2c1occ(c2═O)c1nc2ccccc2s1)O | Natural |
| Cc1c2c(cc3c1OCN(C3)c1ccc3c(c1)OCO3)c1c(c(═O)o2)CCC1 | Natural |
| CCc1cc2c(cc1OCc1ccc(cc1)Cl)occ(c2═O)c1ccc2c(c1)OCCCO2 | Natural |
| Cc1c(c(═O)c2ccc(cc2o1)OCc1ccc(c(c1)Cl)Cl)c1ccc(c(c1)OC)OC | Natural |
| Cc1c(cc(o1)C(═O)OC)COc1ccc2c(c1)oc(═O)c1c2CCC1 | Natural |
| COc1cccc(c1)C(═O)Oc1ccc2c(c1)occ(c2═O)c1ccccc1 | Natural |
| Cc1c2ccc(cc2oc1C(═O)c1ccccc1)NC(═O)CCCn1c(═O)c2ccccc2nn1 | Natural |
| COc1ccc(cc1)c1coc2cc(ccc2c1═O)OCc1ccc(cc1Cl)Cl | Natural |
| Cc1c(c(═O)c2ccc(cc2o1)OC(═O)c1cccs1)c1ccccc1OC | Natural |
| C/C(═C\CC/C(═C/COc1ccc2cc(c(═O)oc2c1)c1ccc2ccccc2n1)C)C | Natural |
| Cn1cc(c2c1ccc(c2)OC)/C═C\1C(═O)c2ccc(cc2O1)OCc1ccc(cc1Cl)Cl | Natural |
| c1ccc2c(c1)nc(s2)c1c(═O)c2ccc(cc2oc1N)O | Natural |
| c1cc(c(cc1F)Cl)Br | Natural |
| Cc1cc(ccc1Cl)OCC(═O)Oc1ccc2c(cc(═O)oc2c1)C | Natural |
| c1ccc2c(c1)cc(o2)C(═O)c1ccc(cc1)NC(═O)c1cccnc1 | Natural |
| CCOC(═O)c1c(c2cc(ccc2o1)c1coc2cc(ccc2c1═O)OC(═O)C)C | Natural |
| CCn1cc(c2c1cccc2)/C═C/1C(═O)c2ccc(cc2O1)OC(═O)c1ccc(cc1)Br | Natural |
| CCC(═O)Oc1ccc2c(c1)occ(c2═O)c1nc2ccccc2s1 | Natural |
| COc1cccc(c1)C(═O)Oc1ccc2c(c1)occ(c2═O)c1ccccc1OC | Natural |
| c1cc(c(cc1F)N)Br | Natural |
| Cc1ccccc1COc1ccc2cc(c(═O)oc2c1)c1nc(cs1)c1ccc(cc1)Br | Natural |
| CCC(═O)Oc1ccc2c(c1)oc(c(c2═O)c1nc2ccccc2s1)C | Natural |
| Cn1cc(c2c1ccc(c2)OC)/C═C\1C(═O)c2ccc(cc2O1)OCc1cccc(c1)Cl | Natural |
| Cc1ccn2cc(cc2c1)c1ccc(cc1)I | Natural |
| c1cc2c(cc1Br)[C@@H](N1CCCC1═N2)O | Natural |
| COC(═O)c1ccc(o1)COc1ccc2ccc(═O)oc2c1 | Natural |
| Cc1cc(ccc1N1Cc2cc3c4ccccc4c(═O)oc3c(c2OC1)C)Br | Natural |
| CCc1cc2c(cc1OCc1ccc(cc1Cl)F)oc(c(c2═O)c1ccc2c(c1)OCCO2)C | Natural |
| COc1ccc(cc1OC)c1coc2cc(ccc2c1═O)OCc1cccc(c1)Cl | Natural |
| c1ccc(cc1)C(═O)Oc1ccc2cc(c(═O)oc2c1)c1nc2ccccc2s1 | Natural |
| CCOC(═O)CCc1c(c2ccc(c(c2oc1═O)C)OCc1ccc2ccccc2c1)C | Natural |
| CCCCCCCCCCCCCCCCOc1ccc(cc1OC)c1nc2ccccc2s1 | Natural |
| Cc1c(ccc2c1occ(c2═O)c1nc2ccccc2s1)OC(═O)c1cccc(c1)OC | Natural |
| c1ccc(c(c1)COc1ccc2c(c1)O/C(═C\c1ccco1)C2═O)Cl | Natural |
| CCCCCCCCCCCCCCC#C | Natural |
| CCOC(═O)CCc1c(c2ccc(cc2oc1═O)OCc1ccc(c(c1)Cl)Cl)C | Natural |
| CC1═C[C@H](OC1═O)C/C(═C/COc1ccc2ccc(═O)oc2c1)C | Natural |
| Cc1c(c(═O)c2ccc(cc2o1)OCc1ccc(cc1Cl)F)c1ccccc1 | Natural |
| c1c2c(sc1Cl)CCC2═O | Natural |
| C/C(═C\CC/C(═C/COc1ccc2ccc(═O)oc2c1)C)C | Natural |
| COc1ccccc1C(═O)Oc1ccc2c(c1)occ(c2═O)Oc1ccc2ccccc2c1 | Natural |
| Cn1cc(c2c1ccc(c2)OC)/C═C\1C(═O)c2ccc(cc2O1)OCc1ccc(cc1)Br | Natural |
| CCn1cc(c2c1ccc(c2)OC)/C═C\1C(═O)c2ccc(c(c2O1)C)OCc1cccc(c1)Cl | Natural |
| c1c(cc(c(c1F)I)Br)F | Natural |
| c1ccnc(c1)c1cc2ccc(cc2oc1═O)OCc1c(cccc1Cl)F | Natural |
| c1ccc(c(c1)COc1ccc2c(c1)occ(c2═O)c1ccc(cc1)Br)F | Natural |
| C/C(═N\CCc1ccccn1)c1cc2ccccc2oc1═O | Natural |
| CC1═C([C@@](CCC1)(C)C)/C═C/C(═C/C═C/C(═C/C═C/C═C(\C)/C═C/C═C(\C)/C═C/C═C(\C)/C═ | Natural |
| C/C═C(\C)C)C)C | |
| C[C@@H](C)CNC(═O)/C═C/CCCCCC/C═C/c1ccc2c(c1)OCO2 | Natural |
| c1cc(oc1)/C═C\1C(═O)c2ccc(cc2O1)OCc1ccc(cc1)Br | Natural |
| Cc1c(ccc2c1O/C(═C\c1cn(c3c1cc(cc3)OC)C)C2═O)OCc1ccc(cc1Cl)F | Natural |
| CN(C)C(═O)Oc1ccc2c(c1)occ(c2═O)c1nc2ccccc2s1 | Natural |
| c1ccc2c(c1)ccc(n2)c1cc2ccc(cc2oc1═O)OCc1ccc(cc1F)F | Natural |
| CCn1cc(c2c1ccc(c2)OC)/C═C\1C(═O)c2ccc(cc2O1)OCc1ccc(cc1Cl)F | Natural |
| c1ccc2cc3c(cc2c1)ccc(C1═Nc2c(C1═O)cc(cc2Br)Br)c3O | Natural |
| C/C═C/C═C/C═C/C1═NCCCC1 | Natural |
| c1cc(oc1)/C═C\1C(═O)c2ccc(cc2O1)OCc1ccc(cc1Cl)F | Natural |
| CCn1cc(c2c1ccc(c2)OC)/C═C/1C(═O)c2ccc(c(c2O1)C)OC(═O)c1cccs1 | Natural |
| Cc1c(c(═O)c2ccc(cc2o1)OCc1ccc(cc1Cl)F)c1ccccc1OC | Natural |
| c1cc(cc(c1)[N+](═O)[O—])C(═O)Oc1ccc2c(c1)O/C(═C\c1cccs1)C2═O | Natural |
| Cc1c(c(═O)c2ccc(cc2o1)OCc1ccc(c(c1)Cl)Cl)c1ccccc1OC | Natural |
| Cc1csc(n1)c1cc2ccc(cc2oc1═O)OC(═O)c1ccccc1Cl | Natural |
| Cc1c2c(cc3c1OCN(C3)c1ccc(c(c1)Cl)Cl)c1ccccc1c(═O)o2 | Natural |
| c1ccc(c(c1)COc1ccc2c(c1)occ(c2═O)c1ccc(cc1)Br)Cl | Natural |
| Cn1cc(c2c1ccc(c2)OC)/C═C\1C(═O)c2ccc(cc2O1)OCc1ccccc1F | Natural |
| Cc1coc2c1cc1c(c(c(═O)oc1c2)CCC(═O)Nc1cccc(c1)Cl)C | Natural |
| c1ccc(cc1)c1ccc(cc1)c1cn2cc(ccc2n1)I | Natural |
| c1ccc(cc1)/C═C/C(═O)Oc1ccc2cc(c(═O)oc2c1)c1nc2ccccc2s1 | Natural |
| Cc1c(c(n(n1)c1ccccn1)C)[C@H]1C[C@@H](C═C1)NC(═O)c1cccnc1 | Natural |
| c1cc(ccc1/C═C\c1ccc2ccc3ccc(cc3c2c1)Br)Br | Natural |
| c1ccc(cc1)c1coc2cc(ccc2c1═O)OCc1ccc(cc1)Cl | Natural |
| c1cc(c(c(c1F)F)Br)F | Natural |
| Cc1c2c(cc3c1OCN(C3)c1ccc3c(c1)OCCO3)c1c(c(═O)o2)CCC1 | Natural |
| CCC(═O)Oc1ccc2c(═O)c(coc2c1C)c1nc2ccccc2s1 | Natural |
| Cc1ccc(c(c1)COc1ccc2c(c1)occ(c2═O)c1ccccc1)C | Natural |
| Cc1c(c(═O)c2ccc(cc2o1)OC(═O)C)c1cscn1 | Natural |
| C/C(═C\COc1ccc2ccc(═O)oc2c1)CC[C@H]1C(═C)CC[C@H]([C@]1(C)C)O | Natural |
| CCOC(═O)CCc1c(c2ccc(cc2oc1═O)OCc1ccc(cc1Cl)F)C | Natural |
| COc1ccc(cc1OC)c1coc2cc(ccc2c1═O)OCc1c(cccc1Cl)F | Natural |
| c1ccc2c(c1)Cc1c2ccc(c1)/N═C/[C@H]1c2ccccc2c2c1cccn2 | Natural |
| COC(═O)c1ccc(o1)COc1ccc2c(c1)oc(═O)c1c2CCCC1 | Natural |
| c1ccc2c(c1)nc(o2)/C(═C/c1cccs1)C#N | Natural |
| c1ccc2c(c1)Cc1c2ccc(c1)/C═C\1C(═O)c2ccc(cc2O1)O | Natural |
| CCc1cc(═O)oc2c1ccc(c2)OCc1ccc(o1)C(═O)OC | Natural |
| CCOC(═O)CCc1c(c2ccc(cc2oc1═O)OCc1ccc(cc1F)F)C | Natural |
| CCOC(═O)c1c(c(═O)c2ccc(cc2o1)OC(═O)c1ccccc1OC)c1nc2ccccc2s1 | Natural |
| c1ccc2c(c1)nc(s2)c1cc2ccc(cc2oc1═O)OCc1cccc(c1)[C@](F)(F)F | Natural |
| COc1cccc(c1)C(═O)Oc1ccc2c(c1)occ(c2═O)c1ccc(c(c1)OC)OC | Natural |
| COc1ccccc1c1coc2cc(ccc2c1═O)OCc1ccc(cc1)Br | Natural |
| CCOC(═O)COc1ccc2c(c1)O/C(═C\c1ccc(cc1Cl)Cl)C2═O | Natural |
| c1ccc2c(c1)cc(o2)C(═O)Oc1ccc2c(c1)oc(═O)c1c2CCC1 | Natural |
| CCOC(═O)CCc1c(c2ccc(c(c2oc1═O)C)OCc1cccc(c1)Br)C | Natural |
| Cc1c(ccc(c1O)C(═O)Cc1nc2ccccc2s1)O | Natural |
| Cc1c(c(═O)c2ccc(cc2o1)OCc1cccc(c1)Cl)c1ccccc1 | Natural |
| c1ccc(c(c1)C(═O)Oc1ccc2c(c1)O/C(═C\c1c(cccc1Cl)F)C2═O)Br | Natural |
| c1ccc2c(c1)cc(o2)C(═O)c1ccc(cc1)NC(═O)c1ccco1 | Natural |
| CCn1cc(c2c1cccc2)/C═C/1C(═O)c2ccc(c(c2O1)C)OC(═O)c1ccco1 | Natural |
| Cc1cccc(c1)/C═C/c1ccc2ccccc2n1 | Natural |
| c1cc(cc(c1)[N+](═O)[O—])C(═O)Oc1ccc2c(c1)O/C(═C\c1ccco1)C2═O | Natural |
| c1ccc(c(c1)/C═C\1C(═O)c2ccc(cc2O1)OC(═O)c1ccco1)Cl | Natural |
| Cc1ccc(c(c1)N)Br | Natural |
| Cc1ccc2c(c1)c1c(n2C)c(═O)n(cn1)CCc1ccc(c(c1)OC)OC | Natural |
| CCc1c(noc1/C═C/c1ccc(c(c1)OC)OCC)/C═C/c1ccc(c(c1)OC)OCC | Natural |
| Cc1ccc(cc1)C(═O)Oc1ccc2cc(c(═O)oc2c1)c1nc2ccccc2s1 | Natural |
| COc1ccc(cc1)c1coc2cc(ccc2c1═O)OCc1ccc(cc1Cl)F | Natural |
| COc1ccccc1C(═O)Oc1ccc2c(c1)occ(c2═O)c1ccccc1 | Natural |
| CCc1ccc2cc(cn2c1)c1ccc(cc1)I | Natural |
| Cc1cc(ccc1Br)N1Cc2cc3c4ccccc4c(═O)oc3c(c2OC1)C | Natural |
| CCn1cc(c2c1cccc2)/C═C/1C(═O)c2ccc(c(c2O1)C)OC(═O)c1ccccc1OC | Natural |
| Cc1cc2c(cc1OCC(═O)OC)occ(c2═O)c1csc(n1)C | Natural |
| c1ccc(c(c1)COc1ccc2c(c1)O/C(═C\c1c(cccc1Cl)F)C2═O)Cl | Natural |
| C═CCCCCC#CCCC#C | Natural |
| c1ccc2c(c1)nc(s2)c1cc2ccc(cc2oc1═O)OC(═O)[C@@H]1CC1 | Natural |
| COc1ccc(cc1)c1c(═O)c2ccc(cc2oc1N)OCc1ccc(cc1Cl)Cl | Natural |
| C/C(═C\COc1ccc2ccc(═O)oc2c1)/C═C/[C@@H]1[C@@](O1)(C)C | Natural |
| CC1═CCC[C@]([C@H]1/C(═C/C(═C/C═C/C═C/C(═C/C═C/C═C(\C)/C═C/C═C(\C)/C═C/C(═O)[C@ | Natural |
| @](C)(C)CCCCCC(═O)C)C)C)C)(C)C | |
| CCOc1ccc2cc(c(═O)oc2c1)c1cccc(c1)Cl | Natural |
| Cc1c2c(cc3c1OCN(C3)c1cccc(c1Cl)Cl)c1ccccc1c(═O)o2 | Natural |
| c1ccc(cc1)c1coc2cc(ccc2c1═O)OCc1cccc2c1cccc2 | Natural |
| CCn1cc(c2c1cccc2)/C═C\1C(═O)c2ccc(cc2O1)OCc1ccc(c(c1)Cl)Cl | Natural |
| CCc1cc2c(cc1OCc1ccc(cc1)F)occ(c2═O)c1ccc2c(c1)OCCCO2 | Natural |
| Cc1ccccc1COc1ccc2c(c1)occ(c2═O)c1ccccc1 | Natural |
| CCn1cc(c2c1cccc2)/C═C/1C(═O)c2ccc(cc2O1)OC(═O)c1ccccc1F | Natural |
| c1ccc2c(c1)cc(c(═O)o2)c1ccc(cc1)NC(═O)c1cccnc1 | Natural |
| Cn1cc(c2c1ccc(c2)OC)/C═C/1C(═O)c2ccc(cc2O1)OC(═O)c1ccccc1Cl | Natural |
| C/C(═C\CC[C@@](C)(CCC[C@@](C)(CCC[C@@](C)(CCC[C@@](C)(CCC[C@@](C)(CCC/C(═ | Natural |
| C/CC/C(═C/CC/C(═C/CO)C)C)C)O)O)O)O)O)C | |
| CCOC(═O)COc1ccc2c(c1)occ(c2═O)c1ccon1 | Natural |
| Cc1c2c(cc3c1OCN(C3)c1ccc3c(c1)OCO3)c1ccccc1c(═O)o2 | Natural |
| CCOCCOC(═O)COc1ccc2c(c1)occ(c2═O)c1ccccc1Cl | Natural |
| CCc1cc2c(cc1OCc1c(cccc1Cl)F)occ(c2═O)c1ccc2c(c1)OCCO2 | Natural |
| Cc1ccc(o1)/C═C\1C(═O)c2ccc(cc2O1)OCc1ccc(c(c1)Cl)Cl | Natural |
| COc1ccc(cc1)c1c(═O)c2ccc(cc2oc1N)OCc1ccc(c(c1)Cl)Cl | Natural |
| CCn1cc(c2c1cccc2)/C═C/1C(═O)c2ccc(cc2O1)OC(═O)c1ccccc1OC | Natural |
| c1ccc(cc1)COC(═O)NCCC(═O)Oc1ccc2c3ccccc3c(═O)oc2c1 | Natural |
| COc1cccc(c1)COc1ccc2c(c1)O/C(═C\c1cccs1)C2═O | Natural |
| C(CCBr)CF | Natural |
| Cc1c2ccc(cc2oc(═O)c1c1ccccc1)OC(═O)c1cccs1 | Natural |
| CCc1cc2c(cc1O)occ(c2═O)c1nc2ccccc2s1 | Natural |
| Cc1cc(oc1C(═O)OC)COc1ccc2c3ccccc3c(═O)oc2c1 | Natural |
| Cc1c(c(═O)oc2c1ccc(c2)OCc1cc(oc1C)C(═O)OC)C | Natural |
| CCc1cc2c(cc1OCc1ccc(cc1)OC)occ(c2═O)c1ccc2c(c1)OCCCO2 | Natural |
| COc1cc2c(cc1OC)[C@H]1C(═NC2)c2cc3c(cc2CC1)OCO3 | Natural |
| C/C(═C\CC[C@](C)(CCC[C@@](C)(CCC[C@@](C)(CCC[C@@](C)(CCC[C@@](C)(CCC/C(═C/ | Natural |
| CC/C(═C/CC/C(═C/CO)C)C)C)O)O)O)O)O)C | |
| Cc1cc2c(cc1OC(═O)C)occ(c2═O)c1cscn1 | Natural |
| C═C1C(═O)[C@@H](C(═O)O1)CCCCCCCCCCCCCc1ccc2c(c1)OCO2 | Natural |
| c1ccc(c(c1)/C═C\1C(═O)c2ccc(cc2O1)OC(═O)c1cccc(c1)[N+](═O)[O—])Cl | Natural |
| Cc1cc(c2c(c1)occ(c2═O)c1nc2ccccc2s1)C | Natural |
| c1cc(c(cc1Br)C═O)F | Natural |
| Cc1c(c(═O)c2ccc(cc2o1)OCc1ccc(cc1Cl)F)c1ccc(c(c1)OC)OC | Natural |
| c1cc(sc1)C(═O)Oc1ccc2c(c1)occ(c2═O)c1ccc(cc1)Br | Natural |
| c1ccc(c(c1)/C═C\1C(═O)c2ccc(cc2O1)OC(═O)c1ccc2c(c1)OCO2)Cl | Natural |
| CCn1cc(c2c1cccc2)/C═C\1C(═O)c2ccc(c(c2O1)C)OCc1ccc(c(c1)Cl)Cl | Natural |
| CCc1ccc2cc(cn2c1)c1ccc(c(c1)Cl)Cl | Natural |
| COc1ccc(cc1)/C═C/C(═O)Nc1ncc2c(n1)CCCC2═O | Natural |
| COc1ccc(cc1)C(═O)Oc1ccc2c(c1)occ(c2═O)c1ccccc1Cl | Natural |
| Cc1ccc(c(c1)COc1ccc2cc(c(═O)oc2c1)c1nc(cs1)c1ccc(cc1)Br)C | Natural |
| COc1ccccc1c1coc2cc(ccc2c1═O)OCc1ccccc1F | Natural |
| Cc1c(ccc2c1occ(c2═O)c1cc2ccccc2o1)O | Natural |
| C/C═C/C═O | Natural |
| CCCc1cc2c(cc1OC)occ(c2═O)c1cc2ccccc2o1 | Natural |
| Cc1cc(oc1C(═O)OC)COc1ccc2c(c1)oc(═O)c1c2CCCC1 | Natural |
| Cc1c(c(═O)oc2c1ccc(c2)OC(═O)c1ccco1)C | Natural |
| c1ccc2c(c1)nc(s2)c1cc2ccc(cc2oc1═O)OCc1ccc(cc1)Cl | Natural |
| Cc1c(c(═O)c2ccc(cc2o1)OCc1ccc(cc1)Br)c1ccc2c(c1)OCCO2 | Natural |
| COc1ccc(c(c1)O)c1cc2cc(c(cc2o1)OC)O | Natural |
| Cc1ccsc1/C═C\1C(═O)c2ccc(cc2O1)OCc1cccc(c1)Cl | Natural |
| Cc1ccc2nc(cn2c1)c1ccc(c(c1)[N+](═O)[O—])I | Natural |
| Cc1cc(═O)oc2c1ccc(c2)OCc1cc(oc1C)C(═O)OC | Natural |
| Cc1c2c(cc3c1OCN(C3)c1cccc(c1)Cl)c1ccccc1c(═O)o2 | Natural |
| COc1ccc(cc1)Oc1coc2cc(ccc2c1═O)OC(═O)c1cccs1 | Natural |
| Cc1c2ccc(cc2oc(═O)c1CC(═O)OC)OCc1ccc(c(c1)Cl)Cl | Natural |
| Cc1cc(c2c(cc(═O)oc2c1)COc1ccc2c(c1)occ(c2═O)c1ccccc1OC)C | Natural |
| Cc1c(ccc2c1O/C(═C\c1cn(c3c1cc(cc3)OC)C)C2═O)OCc1ccc(cc1Cl)Cl | Natural |
| c1cc(cc(c1)Cl)COc1ccc2c(c1)occ(c2═O)c1ccc(cc1)Br | Natural |
| CCCc1cc2c(cc1OC)occ(c2═S)c1cc2ccccc2o1 | Natural |
| CCc1cc2c(cc1OCc1ccc(cc1)[N+](═O)[O—])oc(c(c2═O)c1nc2ccccc2s1)C | Natural |
| COc1ccc(cc1)Oc1coc2cc(ccc2c1═O)OCc1ccc(c(c1)Cl)Cl | Natural |
| Cc1csc(n1)c1cc2ccc(cc2oc1═O)OC(═O)CCCCl | Natural |
| c1cc(c(cc1c1cn2cc(ccc2n1)I)[N+](═O)[O—])I | Natural |
| Cc1c(c(═O)oc2c1cc1c(c2C)OCN(C1)c1ccc2c(c1)OCO2)C | Natural |
| CCn1cc(c2c1ccc(c2)OC)/C═C\1C(═O)c2ccc(cc2O1)OCc1ccc(cc1Cl)Cl | Natural |
| C(═O)([C@@](F)(F)Cl)Br | Natural |
| CCOC(═O)c1c2cc(ccc2oc1c1ccccc1)OCc1ccc(cc1Cl)Cl | Natural |
| CCn1cc(c2c1cccc2)/C═C/1C(═O)c2ccc(c(c2O1)C)OC(═O)c1ccccc1Cl | Natural |
| CCc1cc(═O)oc2c1cc1c(c2C)OCN(C1)c1ccc2c(c1)c1ccccc1n2CC | Natural |
| COc1ccccc1c1coc2cc(ccc2c1═O)OCc1cc(cc2c1OCOC2)Cl | Natural |
| CCOC(═O)CCc1c(c2ccc(c(c2oc1═O)C)OCc1cccc(c1)Cl)C | Natural |
| Cc1c2cc(ccc2oc1C(═O)c1ccc(cc1)OC)NC(═O)CCCn1c(═O)c2ccccc2nn1 | Natural |
| c1ccc(c(c1)C(═O)Oc1ccc(cc1)C(═O)/C═C/c1ccc(cc1Cl)Cl)Cl | Natural |
| CCc1cc2c(cc1OC)occ(c2═O)c1cc2ccccc2o1 | Natural |
| c1cc(sc1)c1ccc(s1)c1ccc(s1)CO | Natural |
| CCOC(═O)[C@H](C)Oc1ccc2c(═O)c(coc2c1C)c1cc2ccccc2o1 | Natural |
| c1cc(═O)oc2c1cc1c(c2)oc2c1CCCC2 | Natural |
| Cc1c(ccc2c1occ(c2═O)c1nc2ccccc2s1)OC(═O)C | Natural |
| CCn1cc(c2c1ccc(c2)OC)/C═C\1C(═O)c2ccc(c(c2O1)C)OCc1ccc(cc1Cl)F | Natural |
| COC(═O)c1ccc(cc1)Oc1coc2cc(ccc2c1═O)OCc1ccc(cc1Cl)F | Natural |
| Cc1c(ccc2c1occ(c2═O)c1nc2ccccc2s1)OC(═O)c1ccc(c(c1)OC)OC | Natural |
| CCc1cc2c(cc1OCc1ccc(cc1)Br)oc(c(c2═O)c1ccc2c(c1)OCCO2)C | Natural |
| C/C(═N\c1ccc2ccccc2c1)c1cc2ccccc2oc1═O | Natural |
| CCn1cc(c2c1ccc(c2)OC)/C═C/1C(═O)c2ccc(cc2O1)OC(═O)c1ccccc1OC | Natural |
| COc1ccc2c(c1)O[C@@H]1[C@H]2COc2c1ccc(c2)OC | Natural |
| Cc1c(c(═O)oc2c1cc1c(c2C)OCN(C1)c1ccc2c(c1)OCCO2)C | Natural |
| c1cc(cc(c1)Br)c1cc2ccc(cc2oc1═O)O | Natural |
| CCOC(═O)c1c(c2ccc(cc2o1)NC(═O)c1cccs1)C | Natural |
| CCCC#CC#C/C═C/CO | Natural |
| Cc1cc(═O)oc2c1ccc(c2)OC(═O)c1ccco1 | Natural |
| CCOC(═O)CCc1c(c2ccc(cc2oc1═O)OCc1c(cccc1Cl)F)C | Natural |
| C═CCCCCCCCCCCCCCC[C@H](C[C@H](CO)O)O | Natural |
| Cn1cc(c2c1ccc(c2)OC)/C═C\1C(═O)c2ccc(cc2O1)OCc1c(cccc1Cl)F | Natural |
| c1cc(oc1)c1ccnc(n1)N[C@H]1CO[C@H]2[C@@H]1OC[C@@H]2NC(═O)Cc1cccs1 | Natural |
| c1cc(sc1)CC(═O)N[C@H]1CO[C@H]2[C@@H]1OC[C@@H]2Nc1nccc(n1)c1cccs1 | Natural |
| Cc1cc2c(c(c(c(═O)o2)C)C)c2c1c(co2)c1ccc2ccccc2c1 | Natural |
| CCOC(═O)COc1ccc2cc(c(═O)oc2c1)c1nc2ccccc2s1 | Natural |
| CCc1cc2c(cc1OCc1cccc(c1)Cl)oc(c(c2═O)c1ccc2c(c1)OCCO2)C | Natural |
| CCn1cc(c2c1ccc(c2)OC)/C═C/1C(═O)c2ccc(c(c2O1)C)OC(═O)c1ccccc1Cl | Natural |
| c1ccc2c(c1)cc(c(═O)o2)c1cc(═O)oc2c1ccc(c2)OCc1ccc(cc1F)Br | Natural |
| CCn1cc(c2c1cccc2)/C═C/1C(═O)c2ccc(cc2O1)OC(═O)C | Natural |
| c1cc2c(cc1O)OC[C@H]1[C@H]2Oc2c1cc1c(c2)OCO1 | Natural |
| COc1ccc(cc1)Oc1coc2cc(ccc2c1═O)OCc1ccc(cc1Cl)Cl | Natural |
| CCc1cc2c(cc1OC(═O)c1ccccc1OC)oc(c(c2═O)c1ccc2c(c1)OCCO2)C | Natural |
| CCc1cc2c(cc1O)occ(c2═O)c1nc2ccccc2n1C | Natural |
| Cc1c(c(═O)c2ccc(cc2o1)OCc1ccc(cc1)Br)c1ccccc1OC | Natural |
| CC#CC#CC#C/C═C/[C@H]([C@H](C═C)O)O | Natural |
| CC#CC#CC#C/C═C/[C@@H]([C@@H](C═C)O)O | Natural |
| c1ccc(cc1)Oc1cccc(c1)COc1ccc2c3ccccc3c(═O)oc2c1 | Natural |
| C[C@@H](C(═O)OC)Oc1ccc2cc(c(═O)oc2c1)c1nc2ccccc2s1 | Natural |
| C/C(═C\COc1ccc2ccc(═O)oc2c1)C/C═C/[C@@](C)(C)O | Natural |
| Cc1c(c(═O)oc2c1cc1c(c2C)OCN(C1)c1cccc(c1)Cl)C | Natural |
| c1cc(c(cc1F)Br)I | Natural |
| c1ccc2c(c1)ccc1c2cc(cc1)/C═C\c1ccc2ccc3ccc4ccccc4c3c2c1 | Natural |
| CCCCCCCCCCCC/C═C/CCCC | Natural |
| Cn1c2ccccc2n2c1cc(c2)c1ccc(cc1)Cl | Natural |
| COc1ccc2c(c1)occ(c2═O)c1ccccn1 | Natural |
| CCn1cc(c2c1ccc(c2)OC)/C═C\1C(═O)c2ccc(cc2O1)OCc1cccc(c1)OC | Natural |
| C/C(═C\COc1ccc2ccc(═O)oc2c1)CC[C@@H]1[C@@]([C@@H](CC[C@]1(C)O)O)(C)C | Natural |
| c1ccc2cc(ccc2c1)/N═C\1C(═C([O—])c2c1c(c(c(c2Cl)Cl)Cl)Cl)Cl | Natural |
| CCCc1cc2c(cc1OCc1ccc(cc1Cl)Cl)oc(c(c2═O)c1ccc2c(c1)OCCCO2)C | Natural |
| C[C@@H]1C[C@H](OC1═O)C/C(═C/COc1ccc2ccc(═O)oc2c1)C | Natural |
| c1ccc2c(c1)C═C(CO2)/C═C\1C(═O)c2ccc(cc2O1)OCc1ccc(cc1Cl)F | Natural |
| C[C@@H]1c2c(sc(n2)COc2cccc(c2)Cl)C[C@]2([C@H]1[C@H]([C@@H](CC2)[C@H](C)C(═O)N | Natural |
| CCOC)O)C | |
| Cc1c(c(═O)c2ccc(cc2o1)OCc1ccc(cc1Cl)Cl)Oc1ccccc1Br | Natural |
| Cn1cc(c2c1ccc(c2)OC)/C═C/1C(═O)c2ccc(cc2O1)OC(═O)c1cccs1 | Natural |
| c1cc2c(cc1Br)CN1CCCC1═[N+]2 | Natural |
| Cc1cc2c(c3c(c(═O)o2)CCC3)c2c1c(co2)c1ccc(cc1)Br | Natural |
| Cc1csc(n1)c1coc2c(c(ccc2c1═O)OC(═O)c1ccccc1Cl)C | Natural |
| Cc1c(c(═O)c2ccc(cc2o1)OC(═O)C)c1csc(n1)C | Natural |
| CCOC(═O)CCc1c(c2ccc(cc2oc1═O)OCc1cccc(c1)Br)C | Natural |
| Cc1c(c(n(n1)c1ccccn1)C)[C@H]1C[C@@H](C═C1)NC(═O)c1ccco1 | Natural |
| COc1ccccc1c1coc2cc(ccc2c1═O)OCc1cccc(c1)Cl | Natural |
| Cc1c2ccc(c(c2oc(═O)c1CC(═O)OC)C)OCc1cccc(c1)Br | Natural |
| Cc1c(c(═O)c2ccc(cc2o1)OC(═O)C)c1nc2ccccc2s1 | Natural |
| c1ccc2c(c1)C═C(CO2)/C═C\1C(═O)c2ccc(cc2O1)OC(═O)c1cccs1 | Natural |
| Cc1c2ccc(cc2oc(═O)c1CC(═O)OC)OCc1ccc(cc1Cl)Cl | Natural |
| c1cc(c(cc1Cl)Cl)c1cc(═O)c2cc(ccc2o1)Cl | Natural |
| C═CCCCCCCCCCCCCCC[C@@H](C[C@@H](CO)O)O | Natural |
| CCOC(═O)CCc1c(c2ccc(c(c2oc1═O)C)OCc1ccc(cc1Cl)F)C | Natural |
| Cc1ccc(c(c1)COc1ccc2c(c1)O/C(═C\c1cn(c3c1cc(cc3)OC)C)C2═O)C | Natural |
| COc1ccc(cc1OC)c1coc2cc(cc(c2c1═O)O)OCc1ccc(cc1)Br | Natural |
| Cc1cc(cc2c1c(═O)c(c(o2)C)c1csc(n1)C)OC(═O)C | Natural |
| CCOC(═O)c1c2cc(ccc2oc1c1ccc(cc1)OC)OCc1ccc(cc1Cl)F | Natural |
| CCOC(═O)c1c(c(═O)c2ccc(cc2o1)OC(═O)c1cccc(c1)OC)c1nc2ccccc2s1 | Natural |
| C═CC═O | Natural |
| COc1ccc2cc(c(═O)oc2c1)c1nc2ccccc2s1 | Natural |
| c1cc2c(c3c1cc1[n+](c3)CCc3c1cc1c(c3)OCO1)OCO2 | Natural |
| Cc1c2c(cc3c1OCN(C3)c1ccc3c(c1)OCO3)c1c(c(═O)o2)CCCC1 | Natural |
| Cc1cc(═O)oc2c1ccc(c2)OCC(═O)Oc1ccc2c(c1)occ(c2═O)Oc1ccccc1 | Natural |
| Cc1c2cc(ccc2oc1C(═O)c1cc(ccc1OC)OC)NC(═O)c1cccs1 | Natural |
| CCOC(═O)COc1cc2c(cc1C)c(═O)c(co2)c1cscn1 | Natural |
| Cc1ccc(c(c1)COc1ccc2c(c1)occ(c2═O)c1ccccc1OC)C | Natural |
| c1ccc(cc1)c1coc2cc(ccc2c1═O)OCc1ccc(cc1)F | Natural |
| c1ccc(c(c1)C(═O)Oc1ccc2c(c1)occ(c2═O)c1ccc(cc1)Br)Cl | Natural |
| CC[C@H](C)CCCCCCCCCCCCCCC(═O)OC | Natural |
| c1cc2c(cc1O)OC[C@@H]1[C@@H]2Oc2c1cc1c(c2)OCO1 | Natural |
| C/C(═C\CC/C(═C/COc1ccc2c(c1)c(═O)c1c(cc(cc1o2)O)O)C)C | Natural |
| c1ccc2c(c1)C═C(CO2)/C═C\1C(═O)c2ccc(cc2O1)OCc1ccc(cc1Cl)Cl | Natural |
| Cc1cnc(s1)/N═C(\C)c1cc2ccccc2oc1═O | Natural |
| Cc1c2ccc(cc2oc(═O)c1CC(═O)OC)OCc1cccc(c1)Br | Natural |
| Cc1c2c(cc3c1OCN(C3)c1ccc(c(c1)OC)OC)c1c(c(═O)o2)CCC1 | Natural |
| c1cc(sc1)C(═O)Oc1ccc2c(c1)O/C(═C\c1ccc(cc1Cl)Cl)C2═O | Natural |
| c1ccc(c(c1)/C═C\1C(═O)c2ccc(cc2O1)OC(═O)c1cccc(c1)[N+](═O)[O—])F | Natural |
| Cc1c(c(═O)c2ccc(cc2o1)OCc1c(cccc1Cl)F)c1ccc(c(c1)OC)OC | Natural |
| c1cc(c(cc1Cl)F)F | Natural |
| c1cc(oc1)C(═O)Oc1ccc2c(c1)occ(c2═O)c1ccc(cc1)Br | Natural |
| C[C@@H](C)CNC(═O)/C═C/C═C/CCCC/C═C/c1ccc2c(c1)OCO2 | Natural |
| CCCCCCCCCCCCCC(═O)Oc1ccc(c(c1)O)/C═N/c1cccc(c1)C#N | Natural |
| COc1cc(nc2c1cccc2)CCc1ccc2c(c1)OCO2 | Natural |
| c1cc(oc1)/C═C\1C(═O)c2ccc(cc2O1)OC(═O)c1ccco1 | Natural |
| Cc1cc(ccc1Br)N1Cc2cc3c(c(c(═O)oc3c(c2OC1)C)C)C | Natural |
| c1cc(oc1)/C═C\C#Cc1cccs1 | Natural |
| Cc1cc(ccc1N1Cc2cc3c(c(c(═O)oc3c(c2OC1)C)C)C)Br | Natural |
| Cc1c(c(═O)c2ccc(cc2o1)OCc1cc(cc2c1OCOC2)Cl)c1ccccc1OC | Natural |
| c1ccc2c(c1)/C(═C/C(═O)c1ccc3c(c1)OCO3)C(═O)N2 | Natural |
| Cc1ccccc1C(═O)Nc1ccc2c(c1)c(c(o2)C(═O)c1ccc(cc1)Cl)C | Natural |
| C/C(═C\COc1ccc2ccc(═O)oc2c1)/C═C/[C@H]1[C@](O1)(C)C | Natural |
| CCCCCCC[C@@H]1[C@H](O1)CC#CC#C[C@@H](C═C)O | Natural |
| Cc1ccccc1C(═O)Oc1ccc2c(c1)occ(c2═O)c1ccccc1OC | Natural |
| CCc1cc2c(cc1OCc1cccc(c1)OC)oc(c(c2═O)c1ccc2c(c1)OCCO2)C | Natural |
| Cc1c(ccc2c1oc(c(c2═O)c1nc2ccccc2s1)C)OC(═O)C | Natural |
| CCn1cc(c2c1cccc2)/C═C/1C(═O)c2ccc(c(c2O1)C)OC(═O)c1ccccc1C | Natural |
| Cc1c(ccc2c1O/C(═C\c1cn(c3c1cc(cc3)OC)C)C2═O)OCc1ccccc1Cl | Natural |
| C/C(═N\N═C/1c2ccccc2NC1═O)c1cc2ccccc2oc1═O | Natural |
| c1cc(cc(c1)Cl)N1CCc2c1[n+]c1ccc(cc1c2N)Br | Natural |
| c1ccc(cc1)c1coc2cc(ccc2c1═O)OCc1cc(cc2c1OCOC2)Cl | Natural |
| CC(═O)Oc1ccc2cc(c(═O)oc2c1)c1nc2ccccc2s1 | Natural |
| c1ccc(c(c1)Oc1cnc(nc1c1ccc(cc1O)OCc1ccc(cc1Cl)Cl)N)Br | Natural |
| Cc1c2ccc(cc2oc(═O)c1CCC(═O)[O—])OCc1ccc(cc1F)Br | Natural |
| CCc1cc2c(cc1OCc1c(cccc1Cl)F)occ(c2═O)c1ccc2c(c1)OCCCO2 | Natural |
| Cc1c2c(cc3c1O/C(═C\c1cccs1)C3═O)C[NH+](CO2)Cc1cccnc1 | Natural |
| Cc1ccc(c(c1)COc1ccc2c(c1)occ(c2═O)c1ccc(c(c1)OC)OC)C | Natural |
| CCOC(═O)COc1ccc2c(c1)O/C(═C\c1ccccc1Cl)C2═O | Natural |
| Cc1c(ccc2c1oc(═O)c1c2cccc1)OCc1ccc(o1)C(═O)[O—] | Natural |
| c1cc2c(cc1c1coc3cc(ccc3c1═O)OCc1cc(═O)oc3c1cc1c(c3)CCCC1)OCCO2 | Natural |
| Cc1ccc(c(c1)COc1ccc2c(c1)oc(c(c2═O)c1ccc(c(c1)OC)OC)C)C | Natural |
| CCOC(═O)c1c(oc2c1cc(cc2)OCc1ccc(cc1Cl)Cl)C | Natural |
| c1ccc(c(c1)COc1ccc2c(c1)O/C(═C\c1c(cccc1Cl)F)C2═O)F | Natural |
| c1ccc2c(c1)cc(o2)c1cc(═O)c2cc(ccc2o1)Br | Natural |
| Cc1c(c(═O)c2ccc(cc2o1)OCc1ccccc1F)c1ccccc1OC | Natural |
| CCOC(═O)CCc1c(c2ccc(c(c2oc1═O)C)OCc1cccc(c1)F)C | Natural |
| Cn1cc(c2c1ccc(c2)OC)/C═C/1C(═O)c2ccc(cc2O1)O[S@@](═O)(═O)c1ccc(cc1)Cl | Natural |
| c1cc(sc1)/C═C\1C(═O)c2ccc(cc2O1)OCc1ccc(cc1Cl)F | Natural |
| Cc1c(ccc2c1oc(═O)cc2c1cc2ccccc2oc1═O)OCc1ccc(cc1F)Br | Natural |
| c1cc(oc1)C(═O)Oc1ccc2c(c1)O/C(═C\c1ccc(cc1Cl)Cl)C2═O | Natural |
| CCOC(═O)CCCCCCCCCCCc1ccccn1 | Natural |
| CCn1c2ccccc2c2c1ccc(c2)N1Cc2cc3c4ccccc4c(═O)oc3c(c2OC1)C | Natural |
| Cc1ccc(cc1C)OCC(═O)Oc1ccc2c(cc(═O)oc2c1)C | Natural |
| C[C@]12CC[C@H]3c4ccc(cc4CC[C@H]3[C@@H]1CCC2═O)OCc1ccccc1F | Natural |
| c1ccc2c(c1)cc(c(═O)o2)c1cccc(c1)Br | Natural |
| Cn1c2ccccc2c2c1c(═O)n(cn2)CCc1ccc(c(c1)O)O | Natural |
| COc1cccc(c1)COc1ccc2ccc(═O)oc2c1 | Natural |
| Cc1c2c(cc3c1OCN(C3)c1cccc(c1)OC)c1ccccc1c(═O)o2 | Natural |
| CCc1c(c2ccc(c(c2oc1═O)C)OCc1cccc(c1)OC)C | Natural |
| c1ccc2c(c1)c(═O)n1c(n2)/C(═C/c2ccc(cc2)Br)CC1 | Natural |
| C[C@]1(c2c3ccccc3ccc2N([C@]21C═Nc1c3cccnc3ccc1O2)C)C | Natural |
| CCn1cc(c2c1cccc2)/C═C/1C(═O)c2ccc(cc2O1)OC(═O)c1ccccc1Br | Natural |
| CCc1cc(═O)oc2c1cc1c(c2C)OCN(C1)c1cccc(c1)Br | Natural |
| CC1═C([C@@](C[C@@H](C1)O)(C)C)/C═C/C(═C/C═C/C(═C/C═C/C═C(\C)/C═C/C═C(\C)/C═C/C═ | Natural |
| C(\C)CC/C═C(\C)C)C)C | |
| CN1Cc2c(ccc3c2OCO3)c2c1c1cc3c(cc1cc2)OCO3 | Natural |
| CCn1cc(c2c1cccc2)/C═C/1C(═O)c2ccc(cc2O1)OC(═O)c1ccc(cc1)Cl | Natural |
| CCn1cc(c2c1ccc(c2)OC)/C═C\1C(═O)c2ccc(cc2O1)OCc1ccccc1Cl | Natural |
| Cc1c2cc(ccc2oc1C(═O)c1cc(ccc1OC)OC)NC(═O)c1cccnc1 | Natural |
| c1cc(c(c(c1)Cl)/C═C\1C(═O)c2ccc(cc2O1)OCc1ccc(cc1)Br)F | Natural |
| CCOC(═O)[C@H](C)Oc1ccc2c(c1)occ(c2═O)c1cc2ccccc2o1 | Natural |
| C[C@@H](C(═O)OC)Oc1ccc2c(c1)occ(c2═O)c1ccc2c(c1)OCCO2 | Natural |
| Cc1ccc(c(c1)COc1ccc2c(c1C)O/C(═C\c1cn(c3c1cc(cc3)OC)C)C2═O)C | Natural |
| COc1ccccc1/C═C/C═C\1C(═O)c2ccc(cc2O1)OCc1ccc(cc1Cl)F | Natural |
| COc1ccccc1C(═O)Oc1ccc2c(c1)O/C(═C\c1ccccc1Br)C2═O | Natural |
| CCn1cc(c2c1cccc2)/C═C/1C(═O)c2ccc(cc2O1)O[S@@](═O)(═O)c1ccc(cc1)Cl | Natural |
| CCOC(═O)CCc1c(c2ccc(c(c2oc1═O)C)OCc1cc2c(cc1Cl)OCO2)C | Natural |
| c1ccc(cc1)c1coc2cc(ccc2c1═O)OCc1ccc(cc1)Br | Natural |
| CCOC(═O)CCc1c(c2ccc(cc2oc1═O)OCc1cc2c(cc1Cl)OCO2)C | Natural |
| COc1ccc(cc1)c1coc2cc(ccc2c1═O)OC(═O)c1ccco1 | Natural |
| c1ccc2c(c1)nc(o2)/C(═C/c1cccnc1)C#N | Natural |
| c1cc(cc(c1)[N+](═O)[O—])C(═O)Oc1ccc2c(c1)O/C(═C\c1c(cccc1Cl)F)C2═O | Natural |
| CCCc1cc2c(cc1O)oc(c(c2═O)c1nc2ccccc2s1)C | Natural |
| CCOC(═O)c1c2cc(ccc2oc1c1ccc(cc1)OC)OCc1ccc(cc1Cl)Cl | Natural |
| CCc1cc2c(cc1OCc1cc(═O)oc3c1ccc(c3)OC)occ(c2═O)c1ccc2c(c1)OCCO2 | Natural |
| CCn1cc(c2c1cccc2)/C═C/1C(═O)c2ccc(cc2O1)OC(═O)c1ccccc1Cl | Natural |
| C[C@@H](C)CNC(═O)/C═C/CCCC/C═C/c1ccc2c(c1)OCO2 | Natural |
| c1cc(cnc1)/C═C\1C(═O)c2ccc(cc2O1)OCc1ccc(cc1Cl)Cl | Natural |
| c1ccc(cc1)COC(═O)NCCC(═O)Oc1ccc2c(c1)occ(c2═O)c1ccc2c(c1)OCCO2 | Natural |
| Cc1c(ccc2c1O/C(═C\c1ccco1)C2═O)OC(═O)c1ccc2c(c1)OCO2 | Natural |
| Cc1cc(ccc1Br)Cl | Natural |
| Cc1ccc(c(c1)COc1ccc2c(c1)oc(c(c2═O)c1ccccc1OC)C)C | Natural |
| C[C@H](Cc1ccc2c(c1)OCO2)[C@@H](C)Cc1ccc(c(c1)OC)OC | Natural |
| Cc1c2ccc(c(c2oc(═O)c1CC(═O)OC)C)OCc1ccc(c(c1)Cl)Cl | Natural |
| c1ccc2c(c1)nc(s2)c1cc2ccc(cc2oc1═O)OCc1c(c(c(c(c1F)F)F)F)F | Natural |
| c1cc(c(cc1F)F)Cl | Natural |
| CCOC(═O)CCc1c(c2ccc(c(c2oc1═O)C)OCc1ccc(cc1)Br)C | Natural |
| c1cc(cnc1)/C═C\1C(═O)c2ccc(cc2O1)OCc1ccc(c(c1)Cl)Cl | Natural |
| c1c(cc(c(c1F)Cl)Br)Br | Natural |
| Cc1c2c(cc3c1OCN(C3)c1ccc(c(c1)Cl)OC)c1ccccc1c(═O)o2 | Natural |
| C[C@@H](CCCCCCCCC[C@@H]1Cc2cc(cc(c2C(═O)O1)O)O)O | Natural |
| Cc1c2c(cc3c1OCN(C3)c1ccc3c(c1)OCCO3)c1c(c(═O)o2)CCCC1 | Natural |
| Cn1cc(c2c1ccc(c2)OC)/C═C\1C(═O)c2ccc(cc2O1)OCc1ccccc1OC | Natural |
| Cc1c(c(═O)c2ccc(cc2o1)OCC(═O)OCc1ccccc1)c1nc2ccccc2s1 | Natural |
| CCn1cc(c2c1ccc(c2)OC)/C═C\1C(═O)c2ccc(c(c2O1)C)OCc1cccc(c1)OC | Natural |
| Cc1c(c(n(n1)c1ccccn1)C)[C@H]1C[C@@H](C═C1)NC(═O)c1cccs1 | Natural |
| Cc1ccc2cc(cn2c1)c1ccc(cc1)Br | Natural |
| c1cc(cc(c1)Cl)COc1ccc2c(c1)O/C(═C\c1ccco1)C2═O | Natural |
| CCc1c(c2ccc(cc2oc1═O)OCc1cccc(c1)OC)C | Natural |
| c1cc(c(cc1N)Br)F | Natural |
| CCCCCCCCCCCCCCCc1cccc(c1O)O | Natural |
| COC(═O)c1ccc(cc1)Oc1coc2cc(ccc2c1═O)OCc1cccc(c1)Cl | Natural |
| CCCCCCC[C@H]1[C@@H](O1)CC#CC#C[C@H](C═C)O | Natural |
| CCOC(═O)COc1ccc2c(c1)O/C(═C\c1c(ccs1)C)C2═O | Natural |
| Cc1ccccc1C(═O)Oc1ccc2c(c1)occ(c2═O)c1ccccc1 | Natural |
| C[C@@H](C)C(═O)Oc1ccc2c(c1)occ(c2═O)c1nc2ccccc2s1 | Natural |
| Cn1cc(c2c1ccc(c2)OC)/C═C/1C(═O)c2ccc(cc2O1)OC(═O)c1ccco1 | Natural |
| Cn1cc(c2c1ccc(c2)OC)/C═C\1C(═O)c2ccc(cc2O1)OCc1ccccc1Cl | Natural |
| c1ccc(cc1)COC(═O)NCCCCCC(═O)Oc1ccc2c(c1)oc(═O)c1c2CCC1 | Natural |
| C[C@@H](C)CNC(═O)/C═C/C═C/CCCCCC/C═C/c1ccc2c(c1)OCO2 | Natural |
| Cc1cc2c(c(cc(═O)o2)C)c2c1c(co2)c1ccc(cc1)Br | Natural |
| Cc1c(c(═O)c2c(cc(cc2o1)OCc1ccc(cc1)Br)O)c1ccc(c(c1)OC)OC | Natural |
| CCCCCCCCCCCCCO | Natural |
| COc1ccc(cc1OC)C(═O)Oc1ccc2c(c1)O/C(═C\c1cccs1)C2═O | Natural |
| c1ccc(cc1)/C═C/COc1ccc2cc(c(═O)oc2c1)c1nc(cs1)c1ccc(cc1)Br | Natural |
| Cc1cc(c2c(cc(═O)oc2c1)COc1ccc2c(c1)oc(c(c2═O)c1ccccc1)C)C | Natural |
| c1cc(oc1)C(═O)N[C@H]1CO[C@H]2[C@@H]1OC[C@@H]2Nc1nccc(n1)c1cccs1 | Natural |
| CCOC(═O)CCc1c(c2ccc(cc2oc1═O)OCc1cccc(c1)Cl)C | Natural |
| Cc1c(c(═O)c2ccc(cc2o1)OCc1ccccc1Cl)c1ccccc1OC | Natural |
| Cc1cc2c(c(cc(═O)o2)C)c2c1c(co2)c1ccc2ccccc2c1 | Natural |
| c1ccc(c(c1)C(═O)Oc1ccc2c(c1)O/C(═C\c1ccco1)C2═O)Cl | Natural |
| Cc1cc2c(cc1OC)occ(c2═O)c1csc(n1)C | Natural |
| C/C(═C\CC[C@@](C)(CCC[C@@](C)(CCC[C@@](C)(CCC[C@@](C)(CCC[C@@](C)(CCC[C@ | Natural |
| @](C)(CCC/C(═C/CC/C(═C/CO)C)C)O)O)O)O)O)O)C | |
| c1ccc(c(c1)Oc1cnc(nc1c1ccc(cc1O)OCc1ccc(c(c1)Cl)Cl)N)Br | Natural |
| c1cc(oc1)/C═C\1C(═O)c2ccc(cc2O1)OC(═O)c1cccs1 | Natural |
| CCCOC(═O)c1ccccc1Nc1ccn2c(═O)c3ccccc3nc2n1 | Natural |
| C[C@@H]1C[C@H]([C@H](O1)/C═C/C═C/c1cc2c(c(cc(c2Cl)O)O)c(═O)o1)O | Natural |
| c1cc(oc1)/C═C\1C(═O)c2ccc(cc2O1)O[S@@](═O)(═O)c1ccc(cc1)Br | Natural |
| c1c(cc(c(c1F)O)Cl)Br | Natural |
| c1cc(oc1)/C═C\1C(═O)c2ccc(cc2O1)OCC(═O)c1ccc(cc1)Br | Natural |
| Cc1ccc(cc1F)N1Cc2cc3c4ccccc4c(═O)oc3c(c2OC1)C | Natural |
| C[C@](C)(C)C(═O)Oc1ccc2c(c1)occ(c2═O)c1nc2ccccc2s1 | Natural |
| Cc1ccccc1C(═O)Nc1ccc2c(c1)c(c(o2)C(═O)c1cccc(c1)OC)C | Natural |
| COc1ccc2c(c1)occ(c2═O)c1cnn(c1)c1ccccc1 | Natural |
| Cc1ccc(c(c1)COc1ccc2c(c1)oc(c(c2═O)c1ccccc1)C)C | Natural |
| CCc1cc2c(cc1OCC(═O)OCC)occ(c2═O)c1nc2ccccc2s1 | Natural |
| Cc1c(c(═O)c2ccc(cc2o1)OCc1ccccc1F)c1ccc(c(c1)OC)OC | Natural |
| CCOC(═O)CCCCCCCCCCCC[C@@H]1CCC═C1 | Natural |
| CCn1cc(c2c1cccc2)/C═C/1C(═O)c2ccc(cc2O1)OC(═O)[C@@H]1CC1 | Natural |
| CCOC(═O)CCCCCCCCCCCC[C@H]1CCC═C1 | Natural |
| C[C@]1(c2cc(ccc2N([C@]21C═Nc1c3cccnc3ccc1O2)C)OC)C | Natural |
| c1ccc(c(c1)Oc1coc2cc(ccc2c1═O)OC(═O)c1ccc(cc1)Cl)Br | Natural |
| C/C═C/C═C/CCCCCCCO | Natural |
| C[C@H](Cc1ccc2c(c1)OCO2)[C@H](C)Cc1ccc(c(c1)OC)OC | Natural |
| Cc1c(ccc2c1oc(═O)c1c2CCC1)OCc1cc(oc1C)C(═O)OC | Natural |
| COc1ccc(cc1)c1coc2cc(ccc2c1═O)OCc1ccccc1F | Natural |
| C[C@@H](C)CNC(═O)/C═C/C═C/CC/C═C/c1ccc2c(c1)OCO2 | Natural |
| Cc1ccccc1COc1ccc2c(c1)occ(c2═O)c1ccccc1OC | Natural |
| Cc1c(c(═O)c2ccc(cc2o1)OCC(═O)OC)c1ccc2c(c1)OCCO2 | Natural |
| C/C(═C\CC/C(═C/COc1ccc2ccc(═O)oc2c1)C)CC[C@@H]([C@@](C)(C)O)O | Natural |
| C[C@H](CCCCCCCCC[C@@H]1Cc2cc(cc(c2C(═O)O1)O)O)O | Natural |
| CCOC(═O)COc1ccc2c(c1)occ(c2═O)c1ccc(c(c1)OC)OC | Natural |
| c1cc(c(cc1Br)[N+](═O)[O—])F | Natural |
| Cc1c2c(cc3c1OCN(C3)c1cccc(c1)F)c1ccccc1c(═O)o2 | Natural |
| CCOC(═O)CCc1c(c2ccc(cc2oc1═O)OCc1ccccc1F)C | Natural |
| c1ccc(cc1)c1coc2cc(ccc2c1═O)OCc1ccccc1Cl | Natural |
| COc1ccc(cc1OC)C(═O)Oc1ccc2c(c1)occ(c2═O)Oc1ccc2ccccc2c1 | Natural |
| COc1ccc2c(c1)occ(c2═O)c1ccc2c(c1)OCCCO2 | Natural |
| CCCCCCc1c(c2ccc(cc2oc1═O)OCc1cccc(c1)OC)C | Natural |
| CCCCCC[C@H](CCCCCCCCCCC(═O)OC)O | Natural |
| Cc1c(ccc2c1oc(c(c2═O)c1nc2ccccc2s1)C)OC(═O)c1ccc(c(c1)OC)OC | Natural |
| Cc1c(ccc2c1O/C(═C/c1cn(c3c1cc(cc3)OC)C)C2═O)OC(═O)c1ccccc1Cl | Natural |
| C[C@@H]1C[C@@H]([C@H](O1)/C═C/C═C/c1cc2c(c(cc(c2Cl)O)O)c(═O)o1)O | Natural |
| CCOC(═O)COc1ccc2c(c1C)O/C(═C\c1cn(c3c1cc(cc3)OC)C)C2═O | Natural |
| CCc1cc(═O)oc2c1ccc(c2)OCc1cc(oc1C)C(═O)OC | Natural |
| Cc1c(c(═O)c2ccc(cc2o1)OC(═O)c1ccco1)Oc1ccc(cc1)C(═O)OC | Natural |
| CC(═O)c1ccc(s1)c1cccs1 | Natural |
| c1ccc2c(c1)nc(o2)/C(═C/c1ccc(cc1)Cl)C#N | Natural |
| Cc1c(c(═O)c2ccc(cc2o1)OC(═O)c1cccs1)c1ccc(c(c1)OC)OC | Natural |
| COC(═O)c1ccc(cc1)/C═C(\C#N)c1nc2ccccc2s1 | Natural |
| CCCC(═O)CC/C═C/C═C/C#CC#CC/C═C\CO | Natural |
| Cc1c(c2cc(ccc2o1)OCc1ccc(o1)C(═O)OC)C(═O)OC | Natural |
| Cc1c2cc(ccc2oc1C(═O)c1cc(ccc1OC)OC)NC(═O)c1cccc(c1)OC | Natural |
| c1ccc(cc1)/C═C/COc1ccc2cc(c(═O)oc2c1)c1ccc2ccccc2n1 | Natural |
| COC(═O)COc1ccc2c(c1)O/C(═C\c1ccc(cc1Cl)Cl)C2═O | Natural |
| Cn1cc(c2c1ccc(c2)OC)/C═C\1C(═O)c2ccc(cc2O1)OCc1cccc(c1)OC | Natural |
| CC1═C([C@](CCC1)(C)C)/C═C/C(═C/C═C/C(═C/C═C/C═C(\C)/C═C/C═C(\C)/C═C/C1═C(C[C@@ | Natural |
| H](C[C@@]1(C)C)O)C)C)C | |
| CCCCCCCCCCCCC═C | Natural |
| CCCCCCCCCCCC═C | Natural |
| CC1═C([C@](CCC1)(C)C)/C═C/C(═C/C═C/C(═C/C═C/C═C(\C)/C═C/C═C(\C)/C═C/C1═C(C[C@H] | Natural |
| (C[C@]1(C)C)O)C)C)C | |
| COc1ccc2c3ccc(cc3oc(═O)c2c1)OCc1ccccc1OC | Natural |
| C[C@@H](Cc1ccc2c(c1)OCO2)[C@@H](C)Cc1ccc(c(c1)OC)OC | Natural |
| Cc1c(cc(oc1═O)/C═C/C═C/C═C/C(═C/[C@@]1([C@H]([C@]([C@@H](O1)C)(C)O)O)C)C)OC | Natural |
| COc1cc(ccc1O)C#C/C═C/COc1ccc(cc1)O | Natural |
| CCCCC[C@H](/C═C/C═C/CCCCCCCc1ccco1)O | Natural |
| CCOC(═O)c1c(c2ccc(cc2o1)NC(═O)c1ccco1)C | Natural |
| CCc1cc2c(cc1OCC(═O)OCC)oc(c(c2═O)c1nc2ccccc2s1)C | Natural |
| CCOC(═O)CCc1c(c2ccc(cc2oc1═O)OCc1ccc2ccccc2c1)C | Natural |
| c1ccc(c(c1)C(═O)Oc1ccc2c(c1)O/C(═C\c1c(cccc1Cl)F)C2═O)Cl | Natural |
| Cc1c(ccc2c1occ(c2═O)c1nc2ccccc2s1)OC(═O)c1ccc(cc1)Cl | Natural |
| c1ccc2c(c1)nc(s2)c1cc2ccc(c(c2oc1═O)C═O)O | Natural |
| COc1ccc(cc1OC)c1coc2cc(ccc2c1═O)OCc1ccc(cc1)Cl | Natural |
| CCCCCCCCCCCCCCCC[C@@H]1[C@H]([C@@H](OC1═O)C)OC | Natural |
| CCOC(═O)c1c(c2ccc(cc2o1)NC(═O)c1cccnc1)C | Natural |
| CC(═O)CCCCCCc1ccc2c(c1)OCO2 | Natural |
| CCCCCCCCCCCCCC(═O)Oc1ccc(c(c1)O)/C═N/c1cccc(c1)Cl | Natural |
| CCOC(═O)CCc1c(c2ccc(c(c2oc1═O)C)OCc1ccc(cc1Cl)Cl)C | Natural |
| CCOC(═O)c1c(oc2c1cc(cc2)OCc1cccc(c1)Br)C | Natural |
| CCCc1cc2c(cc1OCc1ccc(cc1)F)occ(c2═O)c1ccc2c(c1)OCCCO2 | Natural |
| CCCCCCc1c(c2ccc(c(c2oc1═O)C)OCc1cccc(c1)OC)C | Natural |
| Cc1cc(c2c(cc(═O)oc2c1)COc1ccc2c(c1)occ(c2═O)c1ccccc1)C | Natural |
| COc1ccc(cc1OC)c1coc2cc(ccc2c1═O)OCCBr | Natural |
| Cc1c2cc(ccc2oc1C(═O)c1cc(ccc1OC)OC)NC(═O)c1ccco1 | Natural |
| Cc1c2cc(ccc2oc1C(═O)c1ccc(cc1)OC)NC(═O)CCn1c(═O)c2ccccc2nn1 | Natural |
| CCCc1cc2c(cc1OCc1c(cccc1Cl)F)occ(c2═O)c1ccc2c(c1)OCCO2 | Natural |
| c1ccc2cc(ccc2c1)/C═C\c1ccc2ccc3ccccc3c2c1 | Natural |
| CCc1cc2c(cc1OCc1ccc(cc1)Br)occ(c2═O)c1ccc2c(c1)OCCO2 | Natural |
| CCCc1cc2c(cc1OCc1cccc(c1)OC)oc(c(c2═O)c1ccc2c(c1)OCCO2)C | Natural |
| Cc1c(ccc2c1O/C(═C\c1cn(c3c1cc(cc3)OC)C)C2═O)OCc1c(cccc1Cl)F | Natural |
| CCOC(═O)c1c(oc2c1cc(cc2)OCc1ccc(cc1)c1cnc(o1)c1ccccc1)C | Natural |
| CCOC(═O)COc1ccc2c(c1)oc(c(c2═O)c1ccc2c(c1)cc(o2)C(═O)OCC)C | Natural |
| Cc1c(ccc2c1occ(c2═O)c1nc2ccccc2s1)OC(═O)c1ccccc1Cl | Natural |
| CCOC(═O)c1c(oc2c1cc(cc2)OCC(═O)NNC(═O)c1cccc(c1)OC)C | Natural |
| c1c(cc(c(c1F)Br)Br)Cl | Natural |
| c1cc(cnc1)c1ccnc(c1)c1cccnc1 | Natural |
| Cc1c2c(cc3c1OCN(C3)c1ccc(c(c1)OC)OC)c1ccccc1c(═O)o2 | Natural |
| Cc1ccc(o1)/C═C\1C(═O)c2ccc(cc2O1)OCc1ccc(cc1Cl)Cl | Natural |
| COc1cccc(c1)C(═O)Oc1ccc2c(c1)O/C(═C\c1cccs1)C2═O | Natural |
| c1c(c(c(c(c1Br)N)F)F)F | Natural |
| CCc1cc2c(cc1OC(═O)c1ccccc1Cl)occ(c2═O)c1nc2ccccc2n1C | Natural |
| CCc1cc2c(cc1OCC(═O)OC)occ(c2═O)c1ccc2c(c1)OCCO2 | Natural |
| Cn1cc(c2c1cccc2)/C═C/1C(═O)c2ccc(cc2O1)OC(═O)c1ccccc1Cl | Natural |
| CCOC(═O)COc1ccc2c(c1)oc(c(c2═O)c1csc(n1)C)C | Natural |
| CCn1cc(c2c1ccc(c2)OC)/C═C\1C(═O)c2ccc(cc2O1)OCc1ccccc1F | Natural |
| C/C═C/C#CC#C/C═C/C═C/C[C@H](CCOC(═O)C)OC(═O)C | Natural |
| CCn1cc(c2c1ccc(c2)OC)/C═C/1C(═O)c2ccc(c(c2O1)C)OC(═O)c1ccco1 | Natural |
| Cc1c(c(═O)c2ccc(cc2o1)OC(═O)c1ccco1)c1ccc(cc1)Br | Natural |
| Cc1ccccc1C(═O)Oc1ccc2c(═O)c(c(oc2c1C)[C@@H](C)C)c1nc2ccccc2s1 | Natural |
| c1ccc(cc1)c1coc2cc(ccc2c1═O)OCc1ccccc1F | Natural |
| CCc1cc2c(cc1OC)oc(c(c2═O)c1cc2ccccc2o1)C | Natural |
| C[C@@H](C)c1ccc(cc1)/C═C/c1ccc2ccccc2n1 | Natural |
| CCc1cc2c(cc1OC(═O)c1cccs1)occ(c2═O)c1ccc2c(c1)OCCCO2 | Natural |
| Cc1c(c(═O)c2ccc(cc2o1)OCCBr)c1ccc(c(c1)OC)OC | Natural |
| COc1ccc(cc1OC)CN1Cc2c(ccc3c2occ(c3═O)c2ccccc2)OC1 | Natural |
| C[C@@H](C)C(═O)Oc1ccc2cc(c(═O)oc2c1)c1nc2ccccc2s1 | Natural |
| c1cc(ccc1COc1ccc2c(c1)occ(c2═O)c1ccc2c(c1)OCCO2)[N+](═O)[O—] | Natural |
| CC1═C[C@](C[C@@]([C@@H]1/C═C/C(═C/C═C/C(═C/C═C/C═C(\C)/C═C/C═C(\C)/C═C/[C@@] | Natural |
| 12[C@@](O1)(C[C@H](C[C@@]2(C)C)O)C)C)C)(C)C)(C)O | |
| C/C(═C\CC[C@@](C)(CCC[C@@](C)(CCC[C@@](C)(CCC[C@@](C)(CCC[C@@](C)(CCC[C@ | Natural |
| @](C)([C@@H](CC/C(═C/CC/C(═C/CO)C)C)O)O)O)O)O)O)O)C | |
| CCc1cc2c(cc1O)occ(c2═O)c1ccc2c(c1)OCO2 | Natural |
| CCc1cc2c(cc1OCC(═C)C)occ(c2═O)c1nc(cs1)C | Natural |
| c1ccc(c(c1)Oc1coc2cc(ccc2c1═O)OCc1ccc(c(c1)Cl)Cl)Br | Natural |
| C(CO)[C@H](/C═C/C═C/C#CC#C/C═C/CO)O | Natural |
| CCc1cc2c(cc1OCc1ccc(cc1)Cl)oc(c(c2═O)c1ccc2c(c1)OCCO2)C | Natural |
| CCCCCCCCCCCCCc1cc(═O)c2ccccc2n1C | Natural |
| c1ccnc(c1)c1cn(nn1)C[C@H]1C[C@H]2CC[NH+]1C[C@@H]2C(═O)Nc1nccs1 | Natural |
| c1ccc(c(c1)C#N)[S@@](═O)(═O)N[C@H]1CO[C@H]2[C@@H]1OC[C@@H]2Nc1nccc(n1)c1ccc2 | Natural |
| c(c1)OCO2 | |
| c1ccc2c(c1)cc(c(═O)o2)c1ccc(cc1)NC(═O)/C═C/c1ccco1 | Natural |
| Cc1c(c(═O)c2ccc(cc2o1)OCc1cccc(c1)Cl)c1ccccc1OC | Natural |
| Cc1c(c(═O)c2ccc(cc2o1)OCc1ccc(c(c1)Cl)Cl)c1ccccc1 | Natural |
| COc1ccc2cc(c(═O)oc2c1)c1cccc(c1)Br | Natural |
| CCn1cc(c2c1cccc2)/C═C\1C(═O)c2ccc(c(c2O1)C)OCc1cccc(c1)Cl | Natural |
| c1cc(oc1)/C═C\1C(═O)c2ccc(cc2O1)OCc1ccc(cc1)Cl | Natural |
| COc1ccc(cc1O)c1coc2cc(c(c(c2c1═O)O)O)O | Natural |
| c1ccc2c(c1)C═C(CO2)/C═C\1C(═O)c2ccc(cc2O1)OCc1ccc(cc1)Br | Natural |
| c1ccc(cc1)/C═C/COc1ccc2cc(c(═O)oc2c1)c1nc2ccccc2s1 | Natural |
| Cc1c2cc(ccc2oc1C(═O)c1cccc(c1)OC)NC(═O)c1cccs1 | Natural |
| c1ccc2c(c1)nc(s2)c1cc2ccc(cc2oc1═O)OC(═O)CCCCl | Natural |
| Cc1c(ccc2c1oc(c(c2═O)c1nc2ccccc2s1)[C@@H](C)C)OC(═O)c1cccs1 | Natural |
| c1cc2c(cc1c1coc3cc(ccc3c1═O)OCC(═O)NCC(═O)N)OCCO2 | Natural |
| CCn1cc(c2c1cccc2)/C═C\1C(═O)c2ccc(cc2O1)OCc1cccc(c1)Cl | Natural |
| C[C@]1(Cc2c(cc3c4c(c(ncn4)NCCc4ccc(c(c4)OC)OC)oc3n2)CO1)C | Natural |
| COc1cccc(c1)C(═O)Oc1ccc2c(c1)occ(c2═O)Oc1ccc(cc1)C(═O)OC | Natural |
| Cc1c(cc(o1)C(═O)[O—])COc1ccc2ccc(═O)oc2c1 | Natural |
| Cc1ccc(c(c1)COc1ccc2c(c1)O/C(═C\c1ccco1)C2═O)C | Natural |
| CCCc1cc2c(cc1OC)oc(c(c2═S)c1cc2ccccc2o1)C | Natural |
| c1ccc2c(c1)nc(s2)c1coc2cc(ccc2c1═O)OC(═O)c1ccc(cc1)Cl | Natural |
| CCOC(═O)CCc1c(c2ccc(cc2oc1═O)OCc1ccccc1Br)C | Natural |
| CCOC(═O)c1c2cc(ccc2oc1c1ccccc1)OCc1ccc(cc1Cl)F | Natural |
| COc1ccccc1C(═O)Nc1ccc(cc1)C(═O)c1cc2ccccc2o1 | Natural |
| Cc1ccccc1COc1ccc2c(c1)oc(c(c2═O)c1ccccc1)C | Natural |
| CCCCCCCCCCCCCCCCCC(═O)OC | Natural |
| C/C(═C\CC/C(═C/CC/C(═C/CC/C(═C/CO)C)C)C)C | Natural |
| Cc1c(ccc2c1O/C(═C\c1ccco1)C2═O)OC(═O)c1ccco1 | Natural |
| CCc1cc2c(cc1OCc1ccc(cc1)F)occ(c2═O)c1ccc2c(c1)OCCO2 | Natural |
| Cc1c2c(cc3c1OCN(C3)c1ccc(cc1)C(═O)OC)c1ccccc1c(═O)o2 | Natural |
| CCOC(═O)c1c(oc2c1cc(cc2)OCC(═O)NNC(═O)c1ccc(c(c1)OC)OC)C | Natural |
| CCc1cc2c(cc1OCc1c(cccc1Cl)F)oc(c(c2═O)c1ccc2c(c1)OCCO2)C | Natural |
| CCc1ccc2cc(cn2c1)c1ccc(c(c1)[N+](═O)[O—])I | Natural |
| C[C@@]1(c2cc(ccc2N([C@@]21C═Nc1c3cccnc3ccc1O2)C)OC)C | Natural |
| CCn1cc(c2c1ccc(c2)OC)/C═C\1C(═O)c2ccc(c(c2O1)C)OCc1ccccc1Cl | Natural |
| Cc1c(c2cc(ccc2o1)OCc1ccc(c(c1)Cl)Cl)C(═O)OC | Natural |
| CC#Cc1ccc(s1)c1ccc(s1)C(═O)CCl | Natural |
| Cn1cc(c2c1cccc2)/C═C\1C(═O)c2ccc(cc2O1)OCc1ccc(c(c1)Cl)Cl | Natural |
| CCCCCCCCCCCCCCC═O | Natural |
| Cc1c(c(n(n1)Cc1ccccc1)C)[C@H]1C[C@@H](C═C1)NC(═O)c1ccc2c(c1)OCO2 | Natural |
| Cc1ccc(cc1Cl)N1Cc2cc3c4ccccc4c(═O)oc3c(c2OC1)C | Natural |
| COCCNC(═O)[C@H]1C[NH+]2CC[C@@H]1C[C@@H]2Cn1cc(nn1)c1cccc(c1)N | Natural |
| COc1ccccc1/C═C/C═C\1C(═O)c2ccc(cc2O1)OCc1ccc(cc1Cl)Cl | Natural |
| CCc1cc(═O)oc2c1cc1c(c2C)OCN(C1)c1ccc2c(c1)OCO2 | Natural |
| CCc1cc2c(cc1OC(═O)c1ccco1)occ(c2═O)c1ccc2c(c1)OCCCO2 | Natural |
| COc1ccc(cc1OC)C(═O)Oc1ccc2c(c1)occ(c2═O)Oc1ccc(cc1)C(═O)OC | Natural |
| Cc1c(ccc2c1O/C(═C\c1cn(c3c1cc(cc3)OC)C)C2═O)OCC(═O)OCc1ccccc1 | Natural |
| CCn1cc(c2c1cccc2)/C═C/1C(═O)c2ccc(cc2O1)OC(═O)c1ccc(cc1)F | Natural |
| CCn1cc(c2c1cccc2)/C═C/1C(═O)c2ccc(c(c2O1)C)OC(═O)[C@@H]1CC1 | Natural |
| CC(═O)OC[C@@H](/C═C\CCCCCCCC#CC#C[C@H](C═C)O)O | Natural |
| CCn1cc(c2c1ccc(c2)OC)/C═C/1C(═O)c2ccc(c(c2O1)C)OC(═O)c1ccccc1OC | Natural |
| COc1ccccc1Oc1cncnc1c1ccc(cc1O)OCc1ccc(c(c1)Cl)Cl | Natural |
| Cc1c(c(═O)c2ccc(cc2o1)OC(═O)c1ccccc1)c1nc2ccccc2s1 | Natural |
| COc1ccccc1Oc1coc2cc(ccc2c1═O)OCc1ccc(c(c1)Cl)Cl | Natural |
| C[C@@H](C)CNC(═O)/C═C/CCCCc1ccc2c(c1)OCO2 | Natural |
| CC[C@@H](C)CCCCCCCCCCCCCCC(═O)OC | Natural |
| Cc1ccccc1COc1ccc2c(c1)occ(c2═O)c1ccc(cc1)Br | Natural |
| Cc1c(c(═O)oc2c1cc1c(c2C)OCN(C1)c1ccc(c(c1)Cl)OC)C | Natural |
| c1ccc(c(c1)/C═C/C(═O)c1ccc(cc1)OC(═O)c1ccccc1Cl)Cl | Natural |
| Cc1c2c(cc3c1O/C(═C\c1cccs1)C3═O)C[NH+](CO2)Cc1ccccn1 | Natural |
| COc1ccc(cc1OC)C(═O)Oc1ccc(cc1)C(═O)/C═C/c1ccc(cc1Cl)Cl | Natural |
| COc1ccc(c(c1)OC)/C═C(\C#N)c1nc2ccccc2s1 | Natural |
| COc1ccc(cc1OC)c1coc2cc(ccc2c1═O)OCC(═O)OC | Natural |
| CCc1c(c2ccc(cc2oc1═O)OCc1ccccc1OC)C | Natural |
| Cn1cc(c2c1ccc(c2)OC)/C═C\1C(═O)c2ccc(cc2O1)OCC(═O)OC | Natural |
| Cc1cc(cc2c1C(═O)/C(═C\c1ccccn1)O2)O | Natural |
| COCCNC(═O)[C@H]1C[NH+]2CC[C@@H]1C[C@@H]2Cn1cc(nn1)c1ccccn1 | Natural |
| COc1ccccc1c1coc2cc(ccc2c1═O)OCc1c(cccc1Cl)F | Natural |
| Cc1c(c(═O)c2ccc(cc2o1)OCc1ccccc1F)c1ccc(cc1)Br | Natural |
| CC(═O)OC[C@@H](/C═C\CCCCCCCC#CC#C[C@@H](C═C)O)O | Natural |
| COc1ccc(cc1)Oc1coc2cc(ccc2c1═O)OCc1ccc(cc1Cl)F | Natural |
| c1ccc(cc1)C#Cc1ccc2ccccc2c1 | Natural |
| Cn1cc(c2c1ccc(c2)OC)/C═C\1C(═O)c2ccc(cc2O1)OCC(═O)N | Natural |
| CCCCCCC[C@H]1[C@@H](O1)CC#CC#C[C@@H](C═C)O | Natural |
| Cc1c(c(═O)c2ccc(cc2o1)OCc1ccc(cc1)Br)c1ccc(c(c1)OC)OC | Natural |
| C[C@@H](C(═O)OC)NC(═O)COc1ccc2c(c1)occ(c2═O)c1ccc2c(c1)OCCO2 | Natural |
| Cc1ccc(c(c1)Br)F | Natural |
| c1cnccc1c1ccn2c(c1)ncc1sc(═O)nc21 | Natural |
| c1cc(sc1)/C═C\1C(═O)c2ccc(cc2O1)OCC(═O)NN | Natural |
| Cc1c2ccc(cc2oc(═O)c1CC(═O)OC)OCc1cc2c(cc1Cl)OCO2 | Natural |
| Cc1ccc(cc1)c1cc2cc(ccn2c1)C | Natural |
| Cc1c(c(═O)c2ccc(cc2o1)OCc1c(cccc1Cl)F)c1ccc(cc1)Br | Natural |
| CCc1cc2c(cc1OCc1ccc(cc1)C═C)occ(c2═O)c1ccc2c(c1)OCCO2 | Natural |
| COc1ccc(cc1)C(═O)Oc1ccc2c(c1)occ(c2═O)c1ccccc1 | Natural |
| Cc1c2c(cc3c1OCN(C3)c1cc(c(cc1OC)OC)Cl)c1ccccc1c(═O)o2 | Natural |
| COc1ccc(cc1OC)c1coc2cc(cc(c2c1═O)O)OCc1ccc(cc1)Cl | Natural |
| Cc1c2ccc(cc2oc(═O)c1c1ccccc1)OCc1ccccc1Cl | Natural |
| Cc1cc(ccc1Br)N1Cc2c(ccc3c2oc(═O)c2c3cccc2)OC1 | Natural |
| c1cc(cnc1)/C═C\1C(═O)c2ccc(cc2O1)OCc1ccc(cc1Cl)F | Natural |
| c1ccc2c(c1)c(═O)n1c(n2)/C(═C/c2cccc(c2)[N+](═O)[O—])CC1 | Natural |
| CCOC(═O)c1c(oc2c1cc(cc2)OCc1ccc(o1)C(═O)OC)C | Natural |
| Cn1c(═O)c2nc(nn(c2nc1═O)C)c1ccc(c(c1)Cl)Cl | Natural |
| c1ccn2cc(cc2c1)c1ccc(c(c1)[N+](═O)[O—])I | Natural |
| Cc1c2c(cc3c1OCN(C3)c1ccc(cc1)OCc1ccccc1)c1c(c(═O)o2)CCC1 | Natural |
| Cc1ccc2cc3c(nc2c1)c1ccccc1C3═O | Natural |
| CC1═C[C@](C[C@@]([C@@H]1/C═C/C(═C/C═C/C(═C/C═C/C═C(\C)/C═C/C═C(\C)/C═C/[C@]12 | Natural |
| [C@](O1)(C[C@H](C[C@]2(C)C)O)C)C)C)(C)C)(C)O | |
| Cn1cc(c2c1ccc(c2)OC)/C═C/1C(═O)c2ccc(cc2O1)OC(═O)c1ccccc1OC | Natural |
| CCOC(═O)CCc1c(c2ccc(c(c2oc1═O)C)OCc1ccc(cc1F)Br)C | Natural |
| COc1ccc(cc1)OCc1nc(no1)c1cccnc1 | Natural |
| CCOC(═O)CCc1c(c2ccc(cc2oc1═O)OCc1cccc(c1)OC)C | Natural |
| C/C(═C\CC[C@](C)(CCC[C@@](C)(CCC[C@@](C)(CCC[C@@](C)(CCC[C@@](C)(CCC[C@@] | Natural |
| (C)(CCC/C(═C/CC/C(═C/CO)C)C)O)O)O)O)O)O)C | |
| Cc1c(c(═O)c2ccc(cc2o1)OC(═O)c1cccs1)Oc1ccccc1Br | Natural |
| CC[C@H]1CN(CC[C@H]1CC(═O)Nc1nccs1)C(═O)c1ccnc(c1)Cl | Natural |
| Cc1c(c(═O)c2ccc(cc2o1)OCc1ccc(cc1)Cl)c1ccccc1 | Natural |
| c1ccc2c(c1)ccc(n2)c1cc2ccc(cc2oc1═O)OC(═O)c1ccccc1Cl | Natural |
| Cc1c(c(═O)c2ccc(cc2o1)OCc1ccc(cc1)Cl)c1ccccc1OC | Natural |
| Cn1cc(c2c1ccc(c2)OC)/C═C\1C(═O)c2ccc(cc2O1)OCc1ccc(cc1)Cl | Natural |
| C[C@H]1C[C@@H]([C@H](O1)/OC/C═C/c1cc2c(c(cc(c2Cl)O)O)c(═O)o1)O | Natural |
| C[C@@H](C)C(═O)Oc1ccc2cc(c(═O)oc2c1)c1nc(cs1)c1ccc(cc1)Br | Natural |
| COC(═O)/C═C/C═C/c1ccc2c(c1)OCO2 | Natural |
| c1cc(ccc1/N═N/c1c(nc(═S)n(c1N)N)N)Cl | Natural |
| Cc1c2c(cc3c1OCN(C3)c1cccc(c1)OC)c1c(c(═O)o2)CCC1 | Natural |
| Cn1cc(c2c1ccc(c2)OC)/C═C/1C(═O)c2ccc(cc2O1)OCC#N | Natural |
| COc1cccc(c1)COc1ccc2c(c1)O/C(═C\c1c(cccc1Cl)F)C2═O | Natural |
| Cn1cc(c2c1cccc2)/C═C/1C(═O)c2ccc(cc2O1)OC(═O)c1ccccc1Br | Natural |
| COc1ccc(cc1)c1cnc(o1)c1cccnc1 | Natural |
| Cc1c(c(═O)oc2c1cc1c(c2C)OCN(C1)c1ccc(c(c1)OC)OC)C | Natural |
| Cc1c2ccc(c(c2oc(═O)c1CC(═O)OC)C)OCc1ccc2ccccc2c1 | Natural |
| Cc1cc(ccc1Br)N | Natural |
| CCOC(═O)c1ccc(cc1)Oc1coc2cc(ccc2c1═O)OC(═O)c1cccs1 | Natural |
| Cc1c(c(═O)c2ccc(cc2o1)OC(═O)c1ccccc1OC)c1ccccc1OC | Natural |
| Cc1c(ccc2c1O/C(═C\c1cn(c3c1cccc3)C)C2═O)OCc1ccc(c(c1)Cl)Cl | Natural |
| CCc1cc2c(cc1OCC(═C)C)occ(c2═O)c1ccc2c(c1)OCCO2 | Natural |
| COc1ccc(cc1)Oc1coc2cc(ccc2c1═O)OCc1cccc(c1)Cl | Natural |
| Cc1c(oc2c1cc1c(c(c(═O)oc1c2)CCC(═O)Nc1ccccc1F)C)C | Natural |
| CCn1cc(c2c1ccc(c2)OC)/C═C/1C(═O)c2ccc(cc2O1)OC(═O)c1ccco1 | Natural |
| c1ccc(c(c1)C(═O)n1c(c(c(n1)N)/N═N/c1ccc(cc1)[N+](═O)[O—])N)N | Natural |
| C[C@@H](C(═O)OC)Oc1ccc2c(c1)O/C(═C\c1ccccc1Br)C2═O | Natural |
| COc1ccccc1COc1ccc2ccc(═O)oc2c1 | Natural |
| CCc1cc(═O)oc2c1cc1c(c2C)OCN(C1)c1ccc2c(c1)OCCO2 | Natural |
| Cc1c(c(n(n1)c1cccc(c1)Br)C)[C@H]1C[C@@H](C═C1)N[S@@](═O)(═O)c1cccs1 | Natural |
| COc1ccccc1c1coc2cc(ccc2c1═O)OCc1ccc(cc1)F | Natural |
| c1cc(oc1)C[NH2+]CCNCc1ccco1 | Natural |
| CCOC(═O)c1ccc(cc1)Oc1coc2cc(ccc2c1═O)OCc1ccc(cc1Cl)Cl | Natural |
| COc1ccccc1COc1ccc2c(c1)oc(═O)c1c2CCCC1 | Natural |
| CCc1cc2c(cc1OC(═O)C)occ(c2═O)c1cc2ccccc2o1 | Natural |
| Cc1c(oc2c1cc1c(c(c(═O)oc1c2)CCC(═O)Nc1c(n(n(c1═O)c1ccccc1)C)C)C)C | Natural |
| Cc1ccc(o1)/C═C\1C(═O)c2ccc(cc2O1)OCc1cccc(c1)Cl | Natural |
| c1cc(cc(c1)Cl)c1cc2ccc(cc2oc1═O)O | Natural |
| COC(═O)c1ccc(cc1)Oc1coc2cc(ccc2c1═O)OCc1ccccc1Cl | Natural |
| Cc1ccc(cc1Cl)N1Cc2c(ccc3c2oc(═O)c2c3cccc2)OC1 | Natural |
| c1csc(n1)NC(═O)[C@H]1C[NH+]2CC[C@@H]1C[C@@H]2Cn1cc(nn1)C1═CCCC1 | Natural |
| c1ccc2c(c1)C═C(CO2)/C═C\1C(═O)c2ccc(cc2O1)O | Natural |
| C/C(═C\CC[C@](C)(CCC[C@@](C)(CCC[C@@](C)(CCC[C@@](C)(CCC[C@@](C)(CCC[C@@] | Natural |
| (C)([C@@H](CC/C(═C/CC/C(═C/CO)C)C)O)O)O)O)O)O)O)C | |
| c1ccc(c(c1)/C═C(\C#N)c1nc2ccccc2o1)F | Natural |
| C/C(═N\c1ccc(c(c1)O)OC)c1cc2ccccc2oc1═O | Natural |
| c1ccc2c(c1)nc(s2)c1coc2cc(ccc2c1═O)OC(═O)N1CCOCC1 | Natural |
| c1ccc(c(c1)Oc1cnc(nc1c1ccc(cc1O)OCc1ccc(cc1Cl)F)N)Br | Natural |
| CCc1cc(═O)oc2c1cc1c(c2C)OCN(C1)c1ccc(cc1C)Br | Natural |
| COc1ccc2c(c1)O[C@H]1[C@H]2COc2c1ccc(c2)O | Natural |
| COc1ccc(cc1)C(═O)Oc1ccc2c(c1)O/C(═C\c1ccccc1Br)C2═O | Natural |
| Cc1c(c(═O)c2ccc(cc2o1)OCc1cccc2c1cccc2)c1ccccc1 | Natural |
| c1cc2c(cc1c1coc3cc(ccc3c1═O)OCC#N)OCCO2 | Natural |
| Cc1ccsc1/C═C\1C(═O)c2ccc(cc2O1)OCc1ccc(cc1Cl)F | Natural |
| CCn1cc(c2c1ccc(c2)OC)/C═C/1C(═O)c2ccc(c(c2O1)C)OC(═O)c1ccccc1C | Natural |
| CCOC(═O)CCc1c(c2ccc(c(c2oc1═O)C)OCc1cc(ccc1C)C)C | Natural |
| Cc1c2ccc(cc2oc(═O)c1c1cccc(c1)Br)O | Natural |
| Cc1c2ccc(cc2oc(═O)c1CCC(═O)[O—])OCc1ccc(cc1Cl)Cl | Natural |
| CCOC(═O)c1c2cc(ccc2oc1c1ccccc1)OCC(═O)N/N═C/c1cccs1 | Natural |
| CCOC(═O)COc1ccc2c(c1)O/C(═C\c1ccccc1Br)C2═O | Natural |
| COc1cccc(c1)C(═O)Oc1ccc2c(c1)occ(c2═O)c1ccc(cc1)Br | Natural |
| C[C@@](C)(C)c1ccc(cc1)C(═O)Oc1ccc2cc(c(═O)oc2c1)c1nc2ccccc2s1 | Natural |
| Cc1ccccc1C(═O)Oc1ccc2c(c1)oc(c(c2═O)c1ccccc1)C | Natural |
| c1cc(ccc1c1csc(n1)c1cc2ccc(cc2oc1═O)OCc1c(c(c(c(c1F)F)F)F)F)Br | Natural |
| CCOC(═O)c1c(oc2c1cc(cc2)OCC(═O)N/N═C/c1ccccc1OC)C | Natural |
| C/C(═N\c1ccccn1)c1cc2ccccc2oc1═O | Natural |
| Cc1ccccc1COc1ccc2c(c1)oc(c(c2═O)c1ccc(c(c1)OC)OC)C | Natural |
| CCc1cc2c(cc1OCc1c(cccc1Cl)F)oc(c(c2═O)c1ccc2c(c1)OCCCO2)C | Natural |
| CCCCCCCCCCCO | Natural |
| c1cc(ccc1[N+](═O)[O—])OC(═O)CNC(═O)COc1ccc2c(c1)occ(c2═O)c1ccc2c(c1)OCCO2 | Natural |
| CCc1cc2c(cc1OC/C═C/c1ccccc1)occ(c2═O)c1ccc2c(c1)OCCO2 | Natural |
| CCOC(═O)CCc1c(c2ccc(c(c2oc1═O)C)OCc1ccccc1Br)C | Natural |
| c1c2c(ncn2)[nH]c(═O)[nH]1 | Natural |
| COc1ccccc1C(═O)Oc1ccc2c(c1)O/C(═C\c1cccs1)C2═O | Natural |
| CC[C@H](C)CCCCCCCCCCCCC(═O)OC | Natural |
| c1ccn2cc(nc2c1)c1ccc(c(c1)[N+](═O)[O—])I | Natural |
| Cc1c(ccc2c1occ(c2═O)c1nc2ccccc2s1)OC(═O)N1CCOCC1 | Natural |
| COc1cccc2c1oc(═O)c(c2)c1cc(═O)oc2c1ccc(c2)OCc1ccc(cc1F)Br | Natural |
| c1cc(cc(c1)Cl)COc1ccc2c(c1)O/C(═C\c1c(cccc1Cl)F)C2═O | Natural |
| Cc1c(c2cc(ccc2o1)OCC(═O)NNC(═O)c1ccc(c(c1)OC)OC)C(═O)O[C@H](C)C | Natural |
| Cc1c(c(═O)c2ccc(cc2o1)OCc1ccc(cc1Cl)F)Oc1ccc(cc1)C(═O)OC | Natural |
| COc1cccc2c1oc(═O)c(c2)c1nc2ccccc2s1 | Natural |
| COC(═O)NCCCOC(═O)NCCCCCCCl | Natural |
| CCCCCc1ccccn1 | Natural |
| c1ccc2c(c1)c1c3c(c(cc(c3no1)Br)O)C2═O | Natural |
| c1ccc(c(c1)/C═C(\C#N)c1nc2ccccc2s1)F | Natural |
| c1cc(ccc1COc1ccc2c(c1)occ(c2═O)c1ccc(cc1)Br)Br | Natural |
| Cc1c(oc2c1cc1ccc(═O)oc1c2)C | Natural |
| c1cc(sc1)c1cc(═O)c2cc(ccc2o1)Cl | Natural |
| CCn1cc(c2c1ccc(c2)OC)/C═C/1C(═O)c2ccc(cc2O1)OC(═O)c1cccs1 | Natural |
| COC(═O)COc1ccc2c(c1)O/C(═C\c1ccccc1Cl)C2═O | Natural |
| CCOC(═O)c1c2cc(ccc2oc1c1ccccc1)OCC(═O)NNC(═O)c1cccc(c1)OC | Natural |
| c1cc(ccc1c1cc(═O)c2cc(ccc2o1)Br)Br | Natural |
| c1cc(c(c(c1)Cl)O)C(═O)/C═C/c1ccc(cc1)F | Natural |
| Cc1c(c(═O)c2ccc(cc2o1)OCc1ccc(cc1)C═C)c1ccccc1 | Natural |
| c1cc(c(cc1F)I)Br | Natural |
| Cc1c(c(n(n1)Cc1ccccc1)C)[C@H]1C[C@@H](C═C1)NC(═O)c1cccs1 | Natural |
| Cc1c(cc2c(n1)n(c(═O)n(c2═O)C)C)C(═O)N/N═C/c1ccc(c(c1)OC)OC | Natural |
| COc1ccc(cc1)c1coc2cc(ccc2c1═O)OCc1cccc(c1)Cl | Natural |
| CCCCC/C═C/C═C/C═C | Natural |
| COc1ccc(cc1OC)C(═O)Oc1ccc2c(c1)O/C(═C\c1ccccc1Br)C2═O | Natural |
| CC(═O)OC[C@H](/C═C\CCCCCCCC#CC#C[C@@H](C═C)O)O | Natural |
| CCOC(═O)Oc1ccc2c(c1)occ(c2═O)c1ccc(c(c1)OC)OC | Natural |
| C/C(═C\COc1ccc2ccc(═O)oc2c1)CC[C@@H]([C@@](C)(C)O)O | Natural |
| CCn1cc(c2c1ccc(c2)OC)/C═C\1C(═O)c2ccc(c(c2O1)C)OCC(═O)OCc1ccccc1 | Natural |
| Cc1c2ccc(cc2oc(═O)c1CC(═O)OC)OCc1ccc(cc1F)F | Natural |
| COc1ccccc1c1coc2cc(ccc2c1═O)OCc1ccccc1Cl | Natural |
| Cc1c2cc(ccc2oc1C(═O)c1ccccc1)NC(═O)CCn1c(═O)c2ccccc2nn1 | Natural |
| Cc1nc2ccc(cc2c(═O)n1CCO)I | Natural |
| COc1cccc(c1)C(═O)Oc1ccc2cc(c(═O)oc2c1)c1ccc(c(c1)OC)OC | Natural |
| c1ccc(c(c1)/C═C\1C(═O)c2ccc(cc2O1)OCc1ccc(cc1)F)Br | Natural |
| CCOC(═O)CCc1c(c2ccc(cc2oc1═O)OCc1ccc(cc1)Br)C | Natural |
| Cc1c2cc(ccc2oc1C(═O)c1cc(ccc1OC)OC)NC(═O)c1ccc(cc1)Br | Natural |
| c1csc(n1)NC(═O)[C@H]1C[NH+]2CC[C@@H]1C[C@@H]2Cn1cc(nn1)CCO | Natural |
| Cc1c(c(═O)c2ccc(cc2o1)OCc1c(cccc1Cl)F)c1ccccc1OC | Natural |
| CCn1cc(c2c1cccc2)/C═C/1C(═O)c2ccc(cc2O1)O[S@@](═O)(═O)c1ccccc1 | Natural |
| CCC[C@H](CC/C═C/C═C/C#CC#CC/C═C\CO)OC(═O)C | Natural |
| COc1cccc(c1)C(═O)Oc1ccc2ccc(═O)oc2c1 | Natural |
| CCc1cc2c(cc1O)occ(c2═O)c1ccc2c(c1)OCCO2 | Natural |
| C[n+]1cc2c(ccc3c2OCO3)c2c1c1cc3c(cc1cc2)OCO3 | Natural |
| c1ccc2c(c1)nc(s2)/C(═C/c1cccnc1)C#N | Natural |
| Cc1ccccc1C(═O)Oc1ccc2c(c1)O/C(═C/c1cn(c3c1cc(cc3)OC)C)C2═O | Natural |
| c1ccc(cc1)C(═O)N[C@H]1CO[C@H]2[C@@H]1OC[C@@H]2Nc1nccc(n1)c1ccc2c(c1)OCO2 | Natural |
| COc1cccc(c1)COc1ccc2c(c1)occ(c2═O)c1ccc(cc1)Br | Natural |
| Cc1cc2c(cc(═O)oc2cc1C)COc1ccc2c(c1)oc(c(c2═O)c1ccccc1OC)C | Natural |
| c1cc(cc(c1)Cl)COc1ccc2c(c1)O/C(═C\c1cccs1)C2═O | Natural |
| CCn1cc(c2c1cccc2)/C═C\1C(═O)c2ccc(c(c2O1)C)OCc1ccc(cc1Cl)Cl | Natural |
| c1ccc(cc1)c1coc2cc(ccc2c1═O)OCCBr | Natural |
| COC(═O)CO[C@@H]1CO[C@H]2[C@@H]1OC[C@@H]2n1cc(nn1)c1ccccn1 | Natural |
| C[C@@H]1c2c(sc(n2)NC(═O)c2cccs2)C[C@]2([C@H]1[C@H]([C@@H](CC2)[C@H](C)C(═O)N | Natural |
| (C)CC═C)O)C | |
| CCOc1ccc(cc1[N+](═O)[O—])c1cn2cc(ccc2n1)I | Natural |
| Cc1c(c(═O)c2ccc(cc2o1)OC(═O)[C@H](C)C)c1nc2ccccc2s1 | Natural |
| CSCCCCCCCCC#N | Natural |
| CCc1cc2c(cc1OCc1ccc(cc1)C═C)oc(c(c2═O)c1ccc2c(c1)OCCO2)C | Natural |
| Cc1ccn2cc(cc2c1)c1ccc(c(c1)[N+](═O)[O—])I | Natural |
| CC[C@H](C)CCCCCCCCCCC(═O)OC | Natural |
| COc1ccc(cc1)/C═C(\C#N)c1nc2ccccc2s1 | Natural |
| Cc1coc2c1cc1c(c(c(═O)oc1c2)CCC(═O)Nc1ccccc1F)C | Natural |
| CCc1cc2c(cc1O[C@@H](C)C(═O)OC)oc(c(c2═O)c1nc2ccccc2s1)C | Natural |
| Cc1c2cc(ccc2oc1C(═O)c1ccc(c(c1)OC)OC)NC(═O)c1cccs1 | Natural |
| COC1═C(O)C═CC(CCC(C)═O)═C1 | FooDB |
| CCCOC(C)═O | FooDB |
| CC(O)CN | FooDB |
| COC1═C(OC)C═C(CC═C)C═C1 | FooDB |
| COC1═CC═C(CC═C)C═C1 | FooDB |
| CCCCC(CC)C(═O)OCC | FooDB |
| N#CCCCC1CS1 | FooDB |
| O═C1CCCCCCCCCCCC(═O)OCCO1 | FooDB |
| COC(═O)CCC(═O)OC | FooDB |
| CCC(═O)OCC(COC(═O)CC)OC(═O)CC | FooDB |
| CC(S)═O | FooDB |
| CCCC(═O)OC(C)C1═CC═CC═C1 | FooDB |
| C\C═C/C═O | FooDB |
| CCCCCCCCCCCCCCCCCC(═O)OCCOC(═O)CCCCCCCCCCCCCCCCC | FooDB |
| CC(C)CC(═O)OC(C)C | FooDB |
| CC(C)C1CCC2(C)OC2C1═O | FooDB |
| COC(═O)CCC(C)═O | FooDB |
| CC(C)C1CCC(C)═C(O)C1═O | FooDB |
| CC1CC(O)C═C2CCC(CC12C)C(C)═C | FooDB |
| CC(C)CC1═NC═CN═C1C | FooDB |
| CC(C)(O)CC1CCC2(C)CCCC(═C)C2C1 | FooDB |
| OC(═O)C1═CN═CC═C1 | GoodScents |
| CC1═C(O)C(CO)═C(CO)C═N1 | GoodScents |
| CC(═O)CO | GoodScents |
| C\C(\C═C\C═C(/C)\C═C\C1═C(C)C[C@@H](O)CC1(C)C)═C/C═C/C═C(\C)/C═C/C═C(\C)/C═C/ | GoodScents |
| C1═C(C)C[C@@H](O)CC1(C)C | |
| CC(C)C[C@@H](O)C(O)═O | GoodScents |
| CC(O)C(C)═O | GoodScents |
| OCC═C | GoodScents |
| OC(═O)CCl | GoodScents |
| CC(═O)OO | GoodScents |
| CC(C)[C@@H]1CCC(C)═CC1═O | GoodScents |
| CC(C)OC(C)═O | GoodScents |
| FC(F)(F)C(F)(F)Cl | GoodScents |
| FC(F)(Cl)Cl | GoodScents |
| COCCl | GoodScents |
| O═C1CCCC1 | GoodScents |
| O═C1OCC═C1 | GoodScents |
| C\C═C/C(O)═O | GoodScents |
| CC1═CC(═C)CC(C)(C)C1 | GoodScents |
| COC(═O)C1═CC(OC)═C(O)C═C1 | GoodScents |
| CC(═O)C1═CC(C)═C(O)C═C1 | GoodScents |
| CC(C)C1CC2C(CC1C═C2C)C1OCCO1 | GoodScents |
| O═CC1═COC═C1 | GoodScents |
| C1CO1 | GoodScents |
| CCC(═O)OCCCCCCCCCC═C | GoodScents |
| CCC1═CC(═O)C(OC(═O)C(C)C)═C(C)O1 | GoodScents |
| CC1CC(CC(C)(C)C1)OC(═O)C1═C(O)C═CC═C1 | GoodScents |
| CC(C)C1CCC(C)CC1OC(═O)CCCC(═O)OC1CC(C)CCC1C(C)C | GoodScents |
| CCCCCC(═O)OCC(C)O | GoodScents |
| CCC(═O)CC1═CC(OC)═C(OC)C═C1 | GoodScents |
| O═C1NC═CC═C1 | GoodScents |
| CC1═COC2═C1C(═O)\C═C(C)/CC\C═C(C)/C2 | GoodScents |
| CC(C)C(═O)SC1═C2C═CC3═CC═CC4═CC═C(C═C1)C2═C34 | GoodScents |
| CC1(C)CCC[C@@]2(C)[C@H]1CC═C(C═O)[C@@H]2C═O | GoodScents |
| CC1CCC(C(C1)OC═O)C(C)═C | GoodScents |
| SCC1═NC═CC═C1 | GoodScents |
| CCC12CCC(C1)C(C2)C1(O)CCCCC1 | GoodScents |
| C\C═C1/CC2CC1C1CCC(═O)OC21 | GoodScents |
| CCOCOCC | GoodScents |
| OC(═O)C1═NC═CN═C1 | GoodScents |
| OC1CCC1 | GoodScents |
| CC1CC═C(C)C(═O)C1C | GoodScents |
| CCC(OCC(C)C)OCC(C)C | GoodScents |
| CC(═O)C1═C(C)C═C(C═C1C)C(C)(C)C | GoodScents |
| O═C1OCCO1 | GoodScents |
| CCCCCCCCCCCC(═O)OC(C)C | GoodScents |
| OC1CCCC2═CC═CC═C12 | GoodScents |
| C═CCC═O | GoodScents |
| CC(C)CC(═O)C1═C(C)C═CO1 | GoodScents |
| CC1CCC2(OC2(C)C)C(═O)C1 | GoodScents |
| C[C@@H](CCC═C(C)C)[C@H]1CC═C(C)C═C1 | GoodScents |
| CSC(C)CC(O)═O | GoodScents |
| C\C═C\C(═O)C1CCC(C)(C)C═C1C | GoodScents |
| CC(C)OC(═O)CC(C)═O | GoodScents |
| CCCOC(═O)CC(C)═O | GoodScents |
| C1CCCC1 | GoodScents |
| CCCC#CC#C\C═C\C(═O)OC | GoodScents |
| CC(C)C(═O)C(C)(C)C\C═C(/C)C═C | GoodScents |
| O═C\C═C\C1═CC═CS1 | GoodScents |
| CC1CC(CC(C)═C1)C#N | GoodScents |
| CC(C)C12CCC(C)(CC1C═O)C═C2 | GoodScents |
| CCOC(═O)C1═CC═CN═C1 | GoodScents |
| COC═O | GoodScents |
| COC(═O)\C═C\C1═CC(OC)═C(O)C═C1 | GoodScents |
| CCCCCCC\C═C\CCCCOC | GoodScents |
| CCC(O)OC | GoodScents |
| SC1═NC═CN═C1 | GoodScents |
| CCCCCC(C)(CC)OC(C)═O | GoodScents |
| COC1═CC═C(C═C1O)C1CCC2═C(O1)C═C(O)C═C2 | GoodScents |
| CCOC1C2(C)CCC(C2)C1(C)C | GoodScents |
| CSCC1═CN═CC═N1 | GoodScents |
| CC(C)CCCC(C)CCCC(C)CCCC(C)CCO | GoodScents |
| CC(O)C═C | GoodScents |
| OC1═CC2═C(C[C@@H](OC(═O)C3═CC(O)═C(O)C(O)═C3)[C@H](O2)C2═CC(O)═C(O)C(O)═ | GoodScents |
| C2)C(O)═C1 | |
| CC1═CC═C(N1)C═O | GoodScents |
| CC1CCC2(CCC(C)O2)O1 | GoodScents |
| COC1═CC═C(S)C═C1 | GoodScents |
| CC(═O)OCCCCCOC(C)═O | GoodScents |
| C1CC═CC═C1 | GoodScents |
| COC1═CC(C═O)═CC(OC)═C1OC | GoodScents |
| ClC1═CN═CC═N1 | GoodScents |
| CC(CCC1CC═C(C)C1(C)C)C═O | GoodScents |
| O[C@H]1CNC(C1)C(O)═O | GoodScents |
| CCCCCCCCCCCC(═O)OCCC | GoodScents |
| CCC(C(C)═O)C(═O)OC | GoodScents |
| CC1CC(═O)CO1 | GoodScents |
| C\C═C\C═O | GoodScents |
| C[C@@H](O)CN | GoodScents |
| O═C1OC(═O)C═C1 | GoodScents |
| CC(CC1C(C)CCCC1(C)C)C(C)OC(C)═O | GoodScents |
| CCCC(═O)OC1═CC═C(C═O)C═C1 | GoodScents |
| COC1═C(Cl)C═C(Cl)C═C1Cl | HMDB |
| CC(C)C═O | HMDB |
| C\C═C\C1═CN═CC═N1 | HMDB |
| CC1CCC(C(C)═C)C(═O)C1 | HMDB |
| CC(C)═CCC\C(C)═C\C═C/C(/C)═C\C═C\C(\C)═C\C═C\C═C(/C)\C═C\C═C(\C)/C═C\C═C(/C)CCC═C | HMDB |
| (C)C | |
| CC(C)(O)C1CCC(O)(CO)CC1 | HMDB |
| CCCCCCCCCCC(O)C1CCC(O1)C(O)CCC(O)C1CCC(CCCCCCCC(O)CC2═CC(C)OC2═O)O1 | HMDB |
| COC\C═C\C1═CC═C(OC2OC(CO)C(O)C(O)C2O)C═C1 | HMDB |
| COC1═CC2═C(C(═O)C═C(O2)C2═CC═CC═C2)C(O)═C1C | HMDB |
| OCC1OC(OC2═CC(\C═C/C3═CC═C(O)C═C3)═CC(O)═C2)C(O)C(O)C1OS(O)(═O)═O | HMDB |
| CCCCCCCCCCCCCCC(═O)OC(C)COC(═O)CCCCCCCCCCCCC | HMDB |
| C\C═C(/C)C(═O)OC1C(O)C2(COC(C)═O)C(O)CC3(C)C(═CCC4C5(C)CCC(OC6OC(C(O)C(OC7OC | HMDB |
| C(O)C(O)C7OC7OC(CO)C(O)C(O)C7O)C6OC6OC(CO)C(O)C(O)C6O)C(O)═O)C(C)(C═O)C5CCC3 | |
| 4C)C2CC1(C)C | |
| CC1(C)OC2(C)CCC1C(C2)OC1OC(CO)C(O)C(O)C1O | HMDB |
| CC(C)(OC1OC(CO)C(O)C(O)C1O)C1CCC(O)(CO)CC1 | HMDB |
| CC1═CC(═O)C(═CC1═O)C1(C)CC(═O)CC1(C)C | HMDB |
| CCCCCC\C═C/C(C)═O | HMDB |
| CC1═C(C)C2═CC═CC═C2O1 | HMDB |
| OC(═O)\C═C/C1═CC(O)═CC(O)═C1 | HMDB |
| C\C═C\S | HMDB |
| C\C═C/C(C)C(O)═O | HMDB |
| CC(S)S | HMDB |
| OCCC#CC1═CC═C(S1)C1═CC═CS1 | HMDB |
| CCCCCCCCCCC(O)C1CCC(O1)C1CCC(O1)C(O)CCCCC(O)CCCCCCCC1═CC(C)OC1═O | HMDB |
| COC1═C(OC)C(O)═C(C═C1)C1COC2═C(C1)C═CC(O)═C2 | HMDB |
| CCCCCCCCC1═NC(C)═C(C)S1 | HMDB |
| ClC(Cl)(Cl)Cl | HMDB |
| CC(C)C1CCC(═O)C1═O | HMDB |
| COC(═O)C1(C)CCC2(CCC3(C)C(═CCC4C5(C)CCC(O)C(C)(CO)C5CCC34C)C2C1)C(O)═O | HMDB |
| CC1═CN2C═CC═C2C(C)═N1 | HMDB |
| CC(CCC═C(CO)CO)C1CCC2(C)C3═CCC4C(C)(C)C(═O)CCC4(C)C3═CCC12C | HMDB |
| COC1═C(CNC(═O)C(═O)NCCC2═NC═C(C)C═C2)C═CC(C)═C1 | HMDB |
| COC1CC23N(CC═C2C═C1)CCC1═C3C═C(O)C(OS(═O)(═O)CC(O)═O)═C1 | HMDB |
| COC1═C(OC2OC(CO)C(O)C(O)C2O)C═C2OC(═O)C═CC2═C1O | HMDB |
| CCCCCCCCCCCCCCCCCCC(O)CC(═O)C1═CC═CC═C1 | HMDB |
| CC1(C)CCC2(CCC3(C)C(═CCC4C5(C)CCC(OC6OCC(O)C(OC7OC(CO)C(O)C(O)C7O)C6OC6OC | HMDB |
| (COC7OC(CO)C(O)C(O)C7O)C(O)C(O)C6O)C(C)(C)C5CCC34C)C2C1)C(═O)OC1OC(COC2OC(CO) | |
| C(O)C(O)C2O)C(O)C(O)C1O | |
| CC(C)═CCOC1═CC═C(CCO)C═C1 | HMDB |
| CC1OC(OCC2OC(OC3═CC(O)═C4C(═O)CC(OC4═C3)C3═CC═C(O)C═C3)C(OC3OC(C)C(O)C(O)C | HMDB |
| 3O)C(O)C2O)C(O)C(O)C1O | |
| CCCCCCCC1═NC(C)═C(C)S1 | HMDB |
| CC(CC1═CC═C(C═C1)C(C)C)C═O | HMDB |
| CC(CCC1(O)OC2CC3C4CCC5CC(OC6OC(CO)C(O)C(O)C6OC6OC(C)C(O)C(O)C6O)C(O)CC5(C) | HMDB |
| C4CCC3(C)C2C1C)COC1OC(CO)C(O)C(O)C1O | |
| C(CCCCCCOC1═CC═CC═C1)CCCCCCOC1═CC═CC═C1 | HMDB |
| ClC(Cl)(Cl)C(═O)C(Cl)(Cl)Cl | HMDB |
| CC1C2C(CC3C4CCC5CC(O)CCC5(C)C4CCC23C)OC11NCC(C)CC1OC(C)═O | HMDB |
| OC1═CC═CC═C1Br | HMDB |
| CC(C)═CCC\C(C)═C\COP(O)(═O)OP(O)(O)═O | FooDB |
| CC(═C)C1CCC(C)═CC1═O | FooDB |
| [H]OC([H])(C(═O)N([H])C([H])([H])C([H])([H])C(═O)N([H])C([H])([H])C([H])([H])SC(═O)C([H]) | FooDB |
| ([H])C([H])([H])C([H])([H])C([H])([H])C([H])([H])C([H])([H])C([H])([H])C([H])═C([H])C([H])([H])C | |
| ([H])═C([H])C([H])([H])C([H])([H])C([H])([H])C([H])([H])C([H])([H])[H])C(C([H])([H])[H])(C([H]) | |
| ([H])[H])C([H])([H])OP(═O)(O[H])OP(═O)(O[H])OC([H])([H])C1([H])OC([H])(N2C([H])═NC3═C(N═ | |
| C([H])N═C23)N([H])[H])C([H])(O[H])C1([H])OP(═O)(O[H])O[H] | |
| [H]OC(═O)C([H])([H])C([H])([H])C([H])([H])C([H])([H])C(\[H])═C(\[H])C([H])([H])C(\[H])═C(\[H]) | FooDB |
| C([H])([H])C(\[H])═C(\[H])C([H])([H])C(\[H])═C(\[H])C([H])([H])C(\[H])═C(\[H])C([H])([H])C([H]) | |
| ([H])C([H])([H])C([H])([H])C([H])([H])[H] | |
| C[C@@H]1O[C@@H](OC[C@H]2O[C@@H](OC3═C(OC4═C(C(O)═CC(O[C@@H]5O[C@@H](C) | FooDB |
| [C@H](O)[C@@H](O)[C@H]5O)═C4)C3═O)C3═CC═C(O)C═C3)[C@H](O)[C@@H](O)[C@@H] | |
| 2O)[C@H](O)[C@H](O)[C@H]1O | |
| CCCSSS\C═C\C | FooDB |
| CCCCCC(O)\C═C\C1C(O)CC(═O)C1C\C═C/CCCC(O)═O | FooDB |
| COC(═O)CCCCC(═O)OC | FooDB |
| NC(═N)NCCC[C@H](NC(═O)C(O)CC(O)═O)C(O)═O | FooDB |
| [H]OC([H])([H])C(═O)[C@@]1(O[H])C([H])([H])C([H])([H])C2([H])C3([H])C([H])([H])C([H])═C4 | FooDB |
| C([H])([H])C([H])(O[H])C([H])([H])C([H])([H])C4(C([H])([H])[H])C3([H])C([H])(O[H])C([H])([H]) | |
| C12C([H])([H])[H] | |
| C\C(CCC(O)C(C)(C)Cl)═C/COC1═CC2═C(C═CC(═O)O2)C═C1 | FooDB |
| [H]OC([H])([H])C(═O)[C@@]1(O[H])C([H])([H])C([H])([H])[C@@]2([H])[C@]3([H])C([H])([H])C | FooDB |
| ([H])═C4C([H])([H])[C@@]([H])(O[H])C([H])([H])C([H])([H])[C@]4(C([H])([H])[H])[C@@]3([H])C | |
| ([H])([H])C([H])([H])[C@]12C([H])([H])[H] | |
| [H]OC(═O)[C@@]([H])(N([H])[H])C([H])([H])C1═C([H])C(I)═C(O[H])C(I)═C1[H] | FooDB |
| [H]OC(═O)C([H])([H])N([H])C(═O)C([H])([H])C([H])([H])[C@@]([H])(C([H])([H])[H])[C@@]1([H]) | FooDB |
| C([H])([H])C([H])([H])C2([H])C3([H])[C@]([H])(O[H])C([H])([H])[C@]4([H])C([H])([H])[C@]([H]) | |
| (O[H])C([H])([H])C([H])([H])[C@]4(C([H])([H])[H])C3([H])C([H])([H])[C@]([H])(OS(═O)(═O)O | |
| [H])[C@]12C([H])([H])[H] | |
| [H][C@@]12CC[C@](C)(O)[C@@]1(O)CC(═C(C)C)C(═O)C═C2C | FooDB |
| [H]O[C@]1([H])C([H])([H])C2([H])C([H])([H])C(═O)C([H])([H])C([H])([H])[C@]2(C([H])([H])[H]) | FooDB |
| [C@@]2([H])C([H])([H])C([H])(O[H])[C@]3(C([H])([H])[H])C([H])(C([H])([H])C([H])([H])[C@@]3 | |
| ([H])C12[H])C([H])(C([H])([H])[H])C([H])([H])C([H])([H])C([H])([H])C([H])(C([H])([H])[H])C([H]) | |
| ([H])[H] | |
| [H][C@@]12C[C@@H](C)[C@@]([H])(O1)\C(C)═C\CCC1═NCCC[C@@]11CCC([C@H]3OC(═O) | FooDB |
| C(C)═C3)═C(C)[C@]1([H])\C═C(C)\[C@@H](O)CC2 | |
| [H]OC(═O)C([H])═C([H])C(═O)C([H])([H])C(═O)C([H])([H])C(═O)O[H] | FooDB |
| C[C@@H]1O[C@@H](OC[C@H]2OC(OC3═CC4═C(C(O)═C3)C(═O)C═C(O4)C3═CC(O)═C(O)C═ | FooDB |
| C3)[C@H](O)[C@@H](O)[C@@H]2O)[C@H](O)[C@H](O)[C@H]1O | |
| [H]OC([H])([H])[C@]([H])(O[H])C([H])([H])OC(═O)C([H])([H])C([H])([H])C([H])([H])C([H])([H]) | FooDB |
| C([H])([H])C([H])([H])C([H])([H])C([H])([H])C([H])([H])C([H])═C([H])C([H])([H])C([H])═C([H])C | |
| ([H])([H])C([H])([H])C([H])([H])C([H])([H])C([H])([H])[H] | |
| OCC1OC(OC2═C(OC3═C(C(O)═CC(O)═C3)C2═O)C2═CC═C(O)C═C2)C(O)C(O)C1O | FooDB |
| O[C@H]1C[C@@H](O[C@@H]1COP(O)(O)═O)N1C═CC(═O)NC1═O | HMDB |
| C[C@H]1O[C@H]([C@H](O)[C@@H]1O)N1C═NC2═C(N)N═CN═C12 | HMDB |
| [H][C@@]1(OC(═O)[C@@H](O)[C@H]1O)[C@@H](O)CO | HMDB |
| CN1C═NC(N)═C2N═CN═C12 | HMDB |
| CC(C)(COP(O)(═O)OP(O)(═O)OC[C@H]1O[C@H]([C@H](O)[C@@H]1OP(O)(O)═O)N1C═NC2═C | HMDB |
| 1N═CN═C2N)C(O)C(═O)NCCC(═O)NCCS | |
| N[C@@H](CCOP(O)(O)═O)C(O)═O | HMDB |
| CC(C)═CCC\C(C)═C\CC\C(C)═C\CO | HMDB |
| CCO | HMDB |
| [H][C@@](O)(CO)[C@@]([H])(O)[C@]([H])(O)C(═O)COP(O)(O)═O | HMDB |
| OC[C@@H](O)[C@H](O)C(O)═O | HMDB |
| CC1═CN([C@@H]2O[C@H](CO)[C@@H](O)[C@H]2O)C(═O)NC1═O | HMDB |
| CN1C(═O)CC[C@@]1(O)C1═CN═CC═C1 | HMDB |
| CCCCCCCCCCCCCCCC(N)═O | HMDB |
| NC(C(O)═O)C1═CC═C(C═C1)C(O)═O | HMDB |
| [H][C@@]12CC[C@H]([C@H](C)CCCC(C)C)[C@@]1(C)CC[C@@]1([H])[C@@]2([H])CC═C2C | HMDB |
| [C@H](CC[C@]12C)OS(O)(═O)═O | |
| CN1C(═O)NC2═C1C(═O)N(C)C(═O)N2 | HMDB |
| N[C@@H](CCCC[N+]1═CC(CC[C@H](N)C([O—])═O)═C(C[C@H](N)C(O)═O)C(O)═C1)C(O)═O | HMDB |
| NC1═NC(═O)C2═C(N1)N(C═N2)[C@@H]1O[C@H](COP(O)(═O)OP(O)(═O)O[C@H]2O[C@H](C | HMDB |
| O)[C@@H](O)[C@H](O)[C@H]2O)[C@@H](O)[C@H]1O | |
| NC[C@H](O)C1═CC(O)═C(O)C═C1 | HMDB |
| OC\C═C\C(O)═O | HMDB |
| OP(O)(═O)OC1C(OP(O)(O)═O)C(OP(O)(O)═O)C(OP(O)(O)═O)C(OP(O)(O)═O)C1OP(O)(O)═O | HMDB |
| [H][C@@]12CC[C@H]([C@H](C)O)[C@@]1(C)CC[C@@]1([H])[C@@]2([H])CCC2C[C@H](O)C | HMDB |
| C[C@]12C | |
| [H][C@](O)(C(═O)NCCC(═O)NCCSC(═O)CCCCCC1CCC(═O)[C@H]1C\C═C/CC)C(C)(C)COP(O) | HMDB |
| (═O)OP(O)(═O)OC[C@H]1O[C@H](C(O)[C@H]1OP(O)(O)═O)N1C═NC2═C1N═CN═C2N | |
| CC(═O)N[C@@H]1[C@@H](O)C[C@](O)(O[C@H]1[C@H](O)[C@H](O)CO)C(O)═O | HMDB |
| CN\C(NCCC[C@H](N)C(O)═O)═N/C | HMDB |
| OC(═O)CCC(═O)N[C@@H](CCCC(═O)C(O)═O)C(O)═O | HMDB |
| [H][C@](O)(C(═O)NCCC(═O)NCCSC(═O)C[C@](C)(O)C(O)═O)C(C)(C)COP(O)(═O)OP(O)(═O)O | HMDB |
| C[C@H]1O[C@H]([C@@H](O)C1OP(O)(O)═O)N1C═NC2═C1N═CN═C2N | |
| C[C@@H]1OC(OP(O)(═O)OP(O)(═O)OC[C@H]2O[C@H]([C@H](O)[C@@H]2O)N2C═NC3═C2N═ | HMDB |
| C(N)NC3═O)[C@@H](O)[C@H](O)[C@@H]1O | |
| C\C═C(/C)C(═O)SCCNC(═O)CCNC(═O)C(O)C(C)(C)COP(O)(═O)OP(O)(═O)OC[C@H]1O[C@H] | HMDB |
| ([C@H](O)[C@@H]1OP(O)(O)═O)N1C═NC2═C(N)N═CN═C12 | |
| C\C(\C═C\C1═C(C)CCCC1(C)C)═C/C═C/C(/C)═C/C(═O)O[C@@H]1O[C@@H]([C@@H](O)[C@H] | HMDB |
| (O)[C@H]1O)C(O)═O | |
| O═CC1═CC═CC2═CC═CC═C12 | HMDB |
| CC1CC(C)CC(O)C1 | HMDB |
| CCC1═C(C═O)C2═N\C\1═C/C1═C(C)C3═C(N1)\C(C(C(═O)OC)C3═O)═C1/N═C(/C═C3\N/C(═C\2)C | HMDB |
| (C═C)═C3C)C(C)C1CCC(O)═O | |
| CCCC(═O)OCC(C)C1═CC═CC═C1 | HMDB |
| CCCCC\C═C/C\C═C/C\C═C/C\C═C/C\C═C/CCC(═O)CC(═O)SCCN═C(O)CCN═C(O)[C@H](O)C(C) | HMDB |
| (C)COP(O)(═O)OP(O)(═O)OC[C@H]1O[C@H]([C@H](O)[C@@H]1OP(O)(O)═O)N1C═NC2═C(N) | |
| N═CN═C12 | |
| CCCCC\C═C/C\C═C/C\C═C/C\C═C/CCCC(═O)O[C@H](COC(═O)CC\C═C/C\C═C/C\C═C/C\C═C/C\ | HMDB |
| C═C/C\C═C/CC)COP(O)(═O)OCC(O)COP(O)(═O)OC[C@@H](COC(═O)CC\C═C/C\C═C/C\C═C/C\ | |
| C═C/C\C═C/C\C═C/CC)OC(═O)CCC\C═C/C\C═C/C\C═C/C\C═C/CCCCC | |
| CCCCCCCCCCCCCCCC(═O)OC\C═C(/C)\C═C/C═C(\C)/C═C/C1═C(C)CCCC1(C)C | HMDB |
| CCCCCCCCCCCCCCCCCCCC(O)CC(═O)SCCNC(═O)CCNC(═O)[C@H](O)C(C)(C)COP(O)(═O)O | YMDB |
| P(O)(═O)OC[C@H]1O[C@H]([C@H](O)[C@@H]1OP(O)(O)═O)N1C═NC2═C1N═CN═C2N | |
| OC[C@H]1OC(═O)C(O)═C1O | YMDB |
| CN1C2CC(CC1C1OC21)OC(═O)C(CO)C1═CC═CC═C1 | BMD |
| CC1═C(CCC(O)═O)\C(NC1═O)═C\C1═C(CCC(O)═O)C(C)═C(N1)\C═C1\NC(═O)C(C)═C1C═C | BMD |
| NC1═NC2═C(N═CN2[C@H]2C[C@H](O)[C@@H](COP(O)(O)═O)O2)C(═O)N1 | BMD |
| CC12CCCC(C)(C1CCC13CC(═C)C(C1)(CCC23)OC1OC(CO)C(O)C(O)C1O)C(═O)OC1OC(CO)C(O) | PMN |
| C(O)C1O | |
| CSCCC([N+])C([O—])═O | PMN |
| CC(C)C(C)C(O)C(O)C(C)C1CCC2C3CCC4═CC(═O)CCC4(C)C3CCC12C | PMN |
| COC1═C(OC)C2═C(C═C1)C1═C(N(C)C2)C2═C(C═C1)C═C1OCOC1═C2 | PMN |
| CCCCCC═CCC═CCCCCCCCC([O—])═O | PMN |
| COC1═C2OC(═CC(═O)C2═C(O)C═C1OC1OC(CO)C(O)C(O)C1O)C1═CC═CC═C1 | PMN |
| CC(CCC═C(C)C)C1CCC2C3═CCC4C(CO)C(O)CCC4(C)C3CCC12C | PMN |
| CC(C)C(═CC([O—])═O)C([O—])═O | PMN |
| CCCCCC═CC═CC(CCCCCCCC([O—])═O)OO | PMN |
| CC(C)C(C)C═CC(C)C1CCC2C3═CC═C4CC(O)CCC4(C)C3CCC12C | PMN |
| COC1═C(OC)C═C2C3C(COC2═C1)OC1═C2CC(OC2═CC═C1C3O)C(═C)COC1OC(CO)C(O)C(O)C | PMN |
| 1O | |
| CC1OC(OC2═C(OC3═C(C(O)═CC([O—])═C3)C2═O)C2═CC═C(O)C(O)═C2)C(O)C(O)C1O | PMN |
| CC(C)C([N+])C([O—])═O | PMN |
| [N+]CCC[N+]CCCC═O | PMN |
| OC1═CC═C(C═CC([O—])═O)C(O)═C1 | PMN |
| OCC1OC(OC2C(O)C(O)C(CO)OC2OC2═CC3═C(C═C(O)C═C3[O—]) | PMN |
| [O+]═C2C2═CC═C(O)C═C2)C(O)C(O)C1O | |
| CC1═CN═C(C)C(C)═N1 | PMN |
| O═C1C═CC═CC═C1 | VCF |
| C[Si](C)(C)O[Si](O[Si](C)(C)C)(O[Si](C)(C)C)C1═CC═CC═C1 | NA |
| CCCCCSC | VCF |
| CC(C)CC(O)CC(═C)C═C | PMN |
| [H][C@]12C[C@]([H])(C(C)═CC1OCC)C2(C)C | VCF |
| C[C@@H]1CCC2(O1)C(C)═CCCC2(C)C | VCF |
| CC1═CC═CC═C1Cl | VCF |
| CC1═CC2═C(N1)C═CC═C2 | VCF |
| CCCBr | VCF |
| CC1═CN2C═CC═C2C═N1 | VCF |
| CCC1OC(C)OC1C | VCF |
| CCOC1(C)CC═CCC1C(C)C | VCF |
| SSCNC(═O)C1═CC═CC═C1 | |
| CCO[C@@H]1C[C@@](C)(CC═C1)C(C)C | VCF |
| ClC1═CC═C(Cl)C(Cl)═C1 | VCF |
| FC(F)(F)C1CCCC2CCCCC12 | |
| [H][C@@]12C[C@@]1(CCC2(C)OCC)C(C)C | VCF |
| CCO[C@@H]1C[C@](C)(CC═C1)C(C)C | VCF |
| N#CC1═NC═CC═C1 | VCF |
| CC1═CC═CC═C1CC#N | VCF |
| BrCCC1═CC═CC═C1 | VCF |
| O═C1CC2CCC1C2 | VCF |
| C[C@@H]1CC[C@@H](C)C1 | VCF |
| ClC1═CC═CC(Cl)═C1Cl | VCF |

FooDB = Food Database;
HMDB = Human Metabolites Database
BMD = Bovine Metabolite Database
PMN = Plant Metabolic Network
VCF = Volatile Compounds in Food
Goodscents = Goodscents company database
Natural = other natural sources

TABLE 2
SMILES STRUCTURES

COC1═C(O)C═CC(CCC(C)═O)═C1
CCCOC(C)═O
CC(O)CN
COC1═C(OC)C═C(CC═C)C═C1
COC1═CC═C(CC═C)C═C1
CCCCC(CC)C(═O)OCC
N#CCCCC1CS1
O═C1CCCCCCCCCCCC(═O)OCCO1
COC(═O)CCC(═O)OC
CCC(═O)OCC(COC(═O)CC)OC(═O)CC
CC(S)═O
CCCC(═O)OC(C)C1═CC═CC═C1
C\C═C/C═O
CCCCCCCCCCCCCCCCCC(═O)OCCOC(═O)CCCCCCCCCCCCCCCCC
CC(C)CC(═O)OC(C)C
CC(C)C1CCC2(C)OC2C1═O
COC(═O)CCC(C)═O
CC(C)C1CCC(C)═C(O)C1═O
CC1CC(O)C═C2CCC(CC12C)C(C)═C
CC(C)CC1═NC═CN═C1C
CC(C)(O)CC1CCC2(C)CCCC(═C)C2C1
CC(C)═CCC\C(C)═C\COP(O)(═O)OP(O)(O)═O
CC(═C)C1CCC(C)═CC1═O
[H]OC([H])(C(═O)N([H])C([H])([H])C([H])([H])C(═O)N([H])C([H])([H])C([H])([H])SC(═O)C([H])([H])C
([H])([H])C([H])([H])C([H])([H])C([H])([H])C([H])([H])C([H])([H])C([H])═C([H])C([H])([H])C([H])═C([
H])C([H])([H])C([H])([H])C([H])([H])C([H])([H])C([H])([H])[H])C(C([H])([H])[H])(C([H])([H])[H])C([H])
([H])OP(═O)(O[H])OP(═O)(O[H])OC([H])([H])C1([H])OC([H])(N2C([H])═NC3═C(N═C([H])N═C23)N
([H])[H])C([H])(O[H])C1([H])OP(═O)(O[H])O[H]
[H]OC(═O)C([H])([H])C([H])([H])C([H])([H])C([H])([H])C(\[H])═C(\[H])C([H])([H])C(\[H])═C(\[H])C([
H])([H])C(\[H])═C(\[H])C([H])([H])C(\[H])═C(\[H])C([H])([H])C(\[H])═C(\[H])C([H])([H])C([H])([H])C
([H])([H])C([H])([H])C([H])([H])[H]
C[C@@H]1O[C@@H](OC[C@H]2O[C@@H](OC3═C(OC4═C(C(O)═CC(O[C@@H]5O[C@@H](C)[
C@H](O)[C@@H](O)[C@H]5O)═C4)C3═O)C3═CC═C(O)C═C3)[C@H](O)[C@@H](O)[C@@H]2O)[
C@H](O)[C@H](O)[C@H]1O
CCCSSS\C═C\C
CCCCCC(O)\C═C\C1C(O)CC(═O)C1C\C═C/CCCC(O)═O
COC(═O)CCCCC(═O)OC
NC(═N)NCCC[C@H](NC(═O)C(O)CC(O)═O)C(O)═O
[H]OC([H])([H])C(═O)[C@@]1(O[H])C([H])([H])C([H])([H])C2([H])C3([H])C([H])([H])C([H])═C4C([H])
([H])C([H])(O[H])C([H])([H])C([H])([H])C4(C([H])([H])[H])C3([H])C([H])(O[H])C([H])([H])C12C([H])
([H])[H]
C\C(CCC(O)C(C)(C)Cl)═C/COC1═CC2═C(C═CC(═O)O2)C═C1
[H]OC([H])([H])C(═O)[C@@]1(O[H])C([H])([H])C([H])([H])[C@@]2([H])[C@]3([H])C([H])([H])C
([H])═C4C([H])([H])[C@@]([H])(O[H])C([H])([H])C([H])([H])[C@]4(C([H])([H])[H])[C@@]3([H])C([H])
([H])C([H])([H])[C@]12C([H])([H])[H]
[H]OC(═O)[C@@]([H])(N([H])[H])C([H])([H])C1═C([H])C(I)═C(O[H])C(I)═C1[H]
[H]OC(═O)C([H])([H])N([H])C(═O)C([H])([H])C([H])([H])[C@@]([H])(C([H])([H])[H])[C@@]1([H])C(
[H])([H])C([H])([H])C2([H])C3([H])[C@]([H])(O[H])C([H])([H])[C@]4([H])C([H])([H])[C@]([H])(O[H])
C([H])([H])C([H])([H])[C@]4(C([H])([H])[H])C3([H])C([H])([H])[C@]([H])(OS(═O)(═O)O[H])[C@]1
2C([H])([H])[H]
[H][C@@]12CC[C@](C)(O)[C@@]1(O)CC(═C(C)C)C(═O)C═C2C
[H]O[C@]1([H])C([H])([H])C2([H])C([H])([H])C(═O)C([H])([H])C([H])([H])[C@]2(C([H])([H])[H])[C
@@]2([H])C([H])([H])C([H])(O[H])[C@]3(C([H])([H])[H])C([H])(C([H])([H])C([H])([H])[C@@]3([H])
C12[H])C([H])(C([H])([H])[H])C([H])([H])C([H])([H])C([H])([H])C([H])(C([H])([H])[H])C([H])([H])[H]
[H][C@@]12C[C@@H](C)[C@@]([H])(O1)\C(C)═C\CCC1═NCCC[C@@]11CCC([C@H]3OC(═O)C(
C)═C3)═C(C)[C@]1([H])\C═C(C)\[C@@H](O)CC2
[H]OC(═O)C([H])═C([H])C(═O)C([H])([H])C(═O)C([H])([H])C(═O)O[H]
C[C@@H]1O[C@@H](OC[C@H]2OC(OC3═CC4═C(C(O)═C3)C(═O)C═C(O4)C3═CC(O)═C(O)C═C3)[
C@H](O)[C@@H](O)[C@@H]2O)[C@H](O)[C@H](O)[C@H]1O
[H]OC([H])([H])[C@]([H])(O[H])C([H])([H])OC(═O)C([H])([H])C([H])([H])C([H])([H])C([H])([H])C([H])
([H])C([H])([H])C([H])([H])C([H])([H])C([H])([H])C([H])═C([H])C([H])([H])C([H])═C([H])C([H])([H])
C([H])([H])C([H])([H])C([H])([H])C([H])([H])[H]
OCC1OC(OC2═C(OC3═C(C(O)═CC(O)═C3)C2═O)C2═CC═C(O)C═C2)C(O)C(O)C1O
OC(═O)C1═CN═CC═C1
CC1═C(O)C(CO)═C(CO)C═N1
CC(═O)CO
C\C(\C═C\C═C(/C)\C═C\C1═C(C)C[C@@H](O)CC1(C)C)═C/C═C/C═C(\C)/C═C/C═C(\C)/C═C/C1═C
(C)C[C@@H](O)CC1(C)C
CC(C)C[C@@H](O)C(O)═O
CC(O)C(C)═O
OCC═C
OC(═O)CCl
CC(═O)OO
CC(C)[C@@H]1CCC(C)═CC1═O
CC(C)OC(C)═O
FC(F)(F)C(F)(F)Cl
FC(F)(Cl)Cl
COCCl
O═C1CCCC1
O═C1OCC═C1
C\C═C/C(O)═O
CC1═CC(═C)CC(C)(C)C1
COC(═O)C1═CC(OC)═C(O)C═C1
CC(═O)C1═CC(C)═C(O)C═C1
CC(C)C1CC2C(CC1C═C2C)C1OCCO1
O═CC1═COC═C1
C1CO1
CCC(═O)OCCCCCCCCCC═C
CCC1═CC(═O)C(OC(═O)C(C)C)═C(C)O1
CC1CC(CC(C)(C)C1)OC(═O)C1═C(O)C═CC═C1
CC(C)C1CCC(C)CC1OC(═O)CCCC(═O)OC1CC(C)CCC1C(C)C
CCCCCC(═O)OCC(C)O
CCC(═O)CC1═CC(OC)═C(OC)C═C1
O═C1NC═CC═C1
CC1═COC2═C1C(═O)\C═C(C)/CC\C═C(C)/C2
CC(C)C(═O)SC1═C2C═CC3═CC═CC4═CC═C(C═C1)C2═C34
CC1(C)CCC[C@@]2(C)[C@H]1CC═C(C═O)[C@@H]2C═O
CC1CCC(C(C1)OC═O)C(C)═C
SCC1═NC═CC═C1
CCC12CCC(C1)C(C2)C1(O)CCCCC1
C\C═C1/CC2CC1C1CCC(═O)OC21
CCOCOCC
OC(═O)C1═NC═CN═C1
OC1CCC1
CC1CC═C(C)C(═O)C1C
CCC(OCC(C)C)OCC(C)C
CC(═O)C1═C(C)C═C(C═C1C)C(C)(C)C
O═C1OCCO1
CCCCCCCCCCCC(═O)OC(C)C
OC1CCCC2═CC═CC═C12
C═CCC═O
CC(C)CC(═O)C1═C(C)C═CO1
CC1CCC2(OC2(C)C)C(═O)C1
C[C@@H](CCC═C(C)C)[C@H]1CC═C(C)C═C1
CSC(C)CC(O)═O
COC1═C(Cl)C═C(Cl)C═C1Cl
CC(C)C═O
C\C═C\C1═CN═CC═N1
CC1CCC(C(C)═C)C(═O)C1
CC(C)═CCC\C(C)═C\C═C/C(/C)═C\C═C\C(\C)═C\C═C\C═C(/C)\C═C\C═C(\C)/C═C\C═C(/C)CCC═C(C)
C
CC(C)(O)C1CCC(O)(CO)CC1
CCCCCCCCCCC(O)C1CCC(O1)C(O)CCC(O)C1CCC(CCCCCCCC(O)CC2═CC(C)OC2═O)O1
COC\C═C\C1═CC═C(OC2OC(CO)C(O)C(O)C2O)C═C1
COC1═CC2═C(C(═O)C═C(O2)C2═CC═CC═C2)C(O)═C1C
OCC1OC(OC2═CC(\C═C/C3═CC═C(O)C═C3)═CC(O)═C2)C(O)C(O)C1OS(O)(═O)═O
CCCCCCCCCCCCCCC(═O)OC(C)COC(═O)CCCCCCCCCCCCC
C\C═C(/C)C(═O)OC1C(O)C2(COC(C)═O)C(O)CC3(C)C(═CCC4C5(C)CCC(OC6OC(C(O)C(OC7OCC(O)C
(O)C7OC7OC(CO)C(O)C(O)C7O)C6OC6OC(CO)C(O)C(O)C6O)C(O)═O)C(C)(C═O)C5CCC34C)C2CC1(
C)C
CC1(C)OC2(C)CCC1C(C2)OC1OC(CO)C(O)C(O)C1O
CC(C)(OC1OC(CO)C(O)C(O)C1O)C1CCC(O)(CO)CC1
CC1═CC(═O)C(═CC1═O)C1(C)CC(═O)CC1(C)C
CCCCCC\C═C/C(C)═O
CC1═C(C)C2═CC═CC═C2O1
OC(═O)\C═C/C1═CC(O)═CC(O)═C1
CCCCCCCCCCCCCCCCCCCC(O)CC(═O)SCCNC(═O)CCNC(═O)[C@H](O)C(C)(C)COP(O)(═O)OP(O)(═
O)OC[C@H]1O[C@H]([C@H](O)[C@@H]1OP(O)(O)═O)N1C═NC2═C1N═CN═C2N
OC[C@H]1OC(═O)C(O)═C1O
CN1C2CC(CC1C1OC21)OC(═O)C(CO)C1═CC═CC═C1
CC1═C(CCC(O)═O)\C(NC1═O)═C\C1═C(CCC(O)═O)C(C)═C(N1)\C═C1\NC(═O)C(C)═C1C═C
CC12CCCC(C)(C1CCC13CC(═C)C(C1)(CCC23)OC1OC(CO)C(O)C(O)C1O)C(═O)OC1OC(CO)C(O)C(O)
C1O
CSCCC([N+])C([O—])═O
CC(C)C(C)C(O)C(O)C(C)C1CCC2C3CCC4═CC(═O)CCC4(C)C3CCC12C
COC1═C(OC)C2═C(C═C1)C1═C(N(C)C2)C2═C(C═C1)C═C1OCOC1═C2
CCCCCC═CCC═CCCCCCCCC([O—])═O
COC1═C2OC(═CC(═O)C2═C(O)C═C1OC1OC(CO)C(O)C(O)C1O)C1═CC═CC═C1
CC(CCC═C(C)C)C1CCC2C3═CCC4C(CO)C(O)CCC4(C)C3CCC12C
CC(C)C(═CC([O—])═O)C([O—])═O
CCCCCC═CC═CC(CCCCCCCC([O—])═O)OO
CC(C)C(C)C═CC(C)C1CCC2C3═CC═C4CC(O)CCC4(C)C3CCC12C
O═C1C═CC═CC═C1
C[Si](C)(C)O[Si](O[Si](C)(C)C)(O[Si](C)(C)C)C1═CC═CC═C1
[H][C@]12C[C@]([H])(C(C)═CC1OCC)C2(C)C
C[C@@H]1CCC2(O1)C(C)═CCCC2(C)C
CC1═CC═CC═C1Cl
CC1═CC2═C(N1)C═CC═C2
CCCBr
CC1═CN2C═CC═C2C═N1
CCC1OC(C)OC1C
CCOC1(C)CC═CCC1C(C)C
CC#CC#CC#CC#CC#CC═C
c1cc(c(cc1Br)F)I
c1cc2c(cc1Br)c(═O)c(co2)Br
c1cc2c(cc1Cl)c(═O)c(co2)Br
c1cc(c(cc1Br)F)C(═O)N
c1cc2c(cc1Br)cc(o2)/C═C/Br
C/C═C/C#CC#C/C═C/c1ccco1
c1c(cc(c2c1c(═O)c(co2)Br)Cl)Cl
c1cc(c(c(c1F)Cl)F)I
C/C═C/C#CC#CC#C/C═C/[C@@H](CO)O
c1cc(c(cc1Br)F)C#N
C/C═C/C#CC#CC#CC#C[C@H](CO)O
Cc1ccc2nc(cn2c1)c1cc2ccccc2o1
CC(═O)OC/C═C/C#CC#C/C═C/c1ccco1
c1cc(c(cc1Br)C#N)F
C#CC#Cc1ccc(s1)C#C[C@@H](CCl)O
c1c(c(c(c(c1Br)F)F)F)F
c1ccc2c(c1)c(═O)c(co2)Br
c1cc(c(cc1[S@](═O)(═O)N)F)Br
c1cc(ccc1c1cn2cc(ccc2n1)I)I
c1cc2c(cc1Br)c(═O)c(co2)/C═C/C═O
COc1cccc(c1)C(═O)Oc1ccc2c(c1)occ(c2═O)c1nc2ccccc2s1
c1cc2c(cc1Cl)nc(o2)[O—]
c1cc(c(c(c1F)F)F)Br
Cc1c(ccc2c1occ(c2═O)c1nc2ccccc2s1)OC(═O)c1ccco1
Cc1c(ccc2c1oc(═O)c1c2cccc1)OCc1ccc(o1)C(═O)OC
c1ccc(cc1)c1coc2cc(ccc2c1═O)OCc1ccc(c(c1)Cl)Cl
c1ccc(c(c1)C(═O)Oc1ccc2cc(c(═O)oc2c1)c1nc2ccccc2s1)Cl
COc1cc(c(cc1F)Br)F
c1cc(c(cc1c1cn2cc(ccc2n1)I)Cl)Cl
COc1ccc(cc1F)Br
CC(═O)OCc1ccc(s1)c1ccc(s1)C#CC═C
COc1ccccc1C(═O)Oc1ccc2cc(c(═O)oc2c1)c1nc(cs1)c1ccc(cc1)Br
c1ccc2c(c1)nc(s2)c1cc2ccc(cc2oc1═O)OC(═O)c1ccco1
c1ccc2c(c1)nc(s2)c1cc2ccc(cc2oc1═O)OCc1ccc(c(c1)Cl)Cl
c1ccnc(c1)c1cc2ccc(cc2oc1═O)OCc1ccc(cc1F)F
c1ccc(c(c1)C(═O)Oc1ccc2cc(c(═O)oc2c1)c1nc(cs1)c1ccc(cc1)Br)Cl
c1cc(sc1)/C═C\1C(═O)c2ccc(cc2O1)OCc1ccc(c(c1)Cl)Cl
c1cc(c(cc1O)F)Br
c1cc(c(cc1Br)F)[S@](═O)(═O)N
Cc1c2c(cc3c1OCN(C3)c1cccc(c1)Br)c1ccccc1c(═O)o2
CC(═C)c1nc2ccc(cc2c(═O)o1)Br
Cc1c(ccc2c1oc(c(c2═O)c1nc2ccccc2s1)C)OC(═O)c1ccco1
CC#CC#Cc1ccc(s1)C#C[C@@H](CCl)O
c1ccc2c(c1)ccc(n2)c1ccc2c(c1)OCO2
c1cc(oc1)/C═C\1C(═O)c2ccc(cc2O1)OCc1ccc(c(c1)Cl)Cl
Cn1cc(c2c1ccc(c2)OC)/C═C\1C(═O)c2ccc(cc2O1)OCc1ccc(c(c1)Cl)Cl
Cc1cc(c2c(cc(═O)oc2c1)COc1ccc2c(c1)occ(c2═O)c1ccc2c(c1)OCCO2)C
Cc1c(oc2c1cc1c(c(c(═O)oc1c2)CCC(═O)Nc1cccc(c1)I)C)C
Cc1c(cc(o1)C(═O)OC)COc1ccc2ccc(═O)oc2c1
c1cc(c(cc1Br)F)C═O
COc1ccccc1C(═O)Oc1ccc2c(c1)occ(c2═O)c1ccccc1Cl
COc1ccc(cc1OC)C(═O)Oc1ccc2c(c1)occ(c2═O)c1ccccc1Cl
c1cc2c(cc1F)c(═O)c(co2)Br
c1cc2c3ccc4c(c3cnc2c2c1cc1c(c2)OCO1)OCO4
c1ccc2c(c1)nc(s2)c1cc2ccc(cc2oc1═O)OCc1ccc(cc1F)F
c1cc2c(cc1Br)occ(c2═O)/C═C/C═O
COc1cccc(c1)C(═O)Oc1ccc2cc(c(═O)oc2c1)c1nc2ccccc2s1
Cc1c2c(cc3c1OCN(C3)c1ccc(cc1F)Br)c1ccccc1c(═O)o2
c1cc(c(cc1Br)N)F
CC(═O)OCc1ccc(s1)c1ccc(s1)c1cccs1
c1ccc2c(c1)nc(s2)c1cc2ccc(cc2oc1═O)OC(═O)c1cccs1
COc1ccc(cc1)C(═O)Oc1ccc2c(c1)occ(c2═O)c1nc2ccccc2s1
c1ccc(cc1)c1coc2cc(ccc2c1═O)OCc1ccc(cc1Cl)Cl
c1cc(c(cc1N)F)Br
c1ccc(cc1)C(═O)Oc1ccc2c(c1)occ(c2═O)c1nc2ccccc2s1
c1cc(c(cc1F)O)Br
CCOC(═O)COc1ccc2c(c1)oc(c(c2═O)c1cc2ccccc2o1)C
CCCCCCCCCCCCCCCCc1ccc2cc3ccccc3cc2c1
c1ccc2c(c1)nc(s2)c1cc2ccc(cc2oc1═O)OCc1cccc(c1)Cl
CC#CC#Cc1ccc(s1)C#C[C@H](COC(═O)C)O
Cc1ccccc1COc1ccc2cc(c(═O)oc2c1)c1nc2ccccc2s1
C[S@](═O)(═O)c1ccc2c(c1)sc(n2)NC(═O)c1cc(═O)c2cc(ccc2o1)Cl
c1cc(c(cc1Br)F)N
Cc1c(ccc2c1O/C(═C\c1cn(c3c1cc(cc3)OC)C)C2═O)OCc1ccc(c(c1)Cl)Cl
c1ccc2c(c1)nc(s2)c1cc2ccc(cc2oc1═O)OCc1c(cccc1Cl)F
c1cc(c(cc1COc1ccc2c(c1)occ(c2═O)c1ccc2c(c1)OCCO2)Cl)Cl
c1cc2c(cc1Br)c(═O)cco2
C[C@@H]1[C@@H]([C@@H](O[C@@H]1c1ccc(c(c1)OC)O[C@@H](C)[C@@H](c1ccc2c(c1)OC
O2)O)c1ccc(c(c1)OC)O[C@@H](C)[C@@H](c1ccc(c(c1)OC)OC)O)C
C[C@H]1[C@@H]([C@@H](O[C@@H]1c1ccc(c(c1)OC)O[C@@H](C)[C@@H](c1ccc2c(c1)OCO2)
O)c1ccc(c(c1)OC)O[C@@H](C)[C@@H](c1ccc(c(c1)OC)OC)O)C
C[C@@H]1[C@H]([C@@H](O[C@@H]1c1ccc(c(c1)OC)O[C@@H](C)[C@@H](c1ccc2c(c1)OCO2)
O)c1ccc(c(c1)OC)O[C@@H](C)[C@@H](c1ccc(c(c1)OC)OC)O)C
c1ccc2c(c1)C═C(CO2)/C═C\1C(═O)c2ccc(cc2O1)OCc1ccc(c(c1)Cl)Cl
c1cc2c(cc1[S@@](═O)(═O)N)sc(n2)NC(═O)c1ccc(o1)Br
COc1ccccc1c1coc2cc(ccc2c1═O)OCc1ccc(c(c1)Cl)Cl
c1ccc2c(c1)Cc1c2ccc(c1)/N═C/1c2ccccc2c2c1cccn2
COc1ccccc1C(═O)Oc1ccc2cc(c(═O)oc2c1)c1nc2ccccc2o1
Cc1c(ccc2c1oc(c(c2═O)c1nc2ccccc2s1)C)OC(═O)c1cccs1
COc1ccccc1C(═O)Oc1ccc2cc(c(═O)oc2c1)c1nc2ccccc2s1
Cc1ccc(cc1)c1cn2cc(ccc2n1)I
CCn1cc(c2c1cccc2)/C═C/1C(═O)c2ccc(c(c2O1)C)OC(═O)c1cccs1
Cc1cc(ccc1Cl)Br
CCn1cc(c2c1ccc(c2)OC)/C═C\1C(═O)c2ccc(cc2O1)OCc1ccc(c(c1)Cl)Cl
c1ccc(cc1)c1coc2cc(ccc2c1═O)OCc1ccc(cc1Cl)F
Cc1c(c(═O)c2ccc(cc2o1)OC(═O)c1ccccc1Br)c1nc2ccccc2s1
Cc1ccccc1C(═O)Oc1ccc2c(═O)c(coc2c1C)c1nc2ccccc2s1
c1ccc2c(c1)nc(s2)c1coc2cc(ccc2c1═O)OC(═O)CCCCl
Cc1ccc2c(c(oc2c1)c1cc(═O)c2cc(ccc2o1)Br)C
CCOC(═O)c1cc2cc(ccc2o1)c1c(oc2cc(ccc2c1═O)OC(═O)C)C
c1cc(oc1)/C═C/C#CC#CCCCO

We claim:

1. A sweetener composition comprising an isolated compound selected from the compounds in Table 1, and derivatives thereof.

2. The sweetener composition of claim 1, wherein the composition further comprises a combination of one or more compounds selected from Table 1, and derivatives thereof.

3. The composition of claim 1, wherein the composition further comprises at least one sweet taste improving composition selected from the group consisting of carbohydrates, polyols, amino acids, other sweet taste improving additives, and combinations thereof.

4. An ingestible composition comprising a composition of claim 1.

5. The ingestible composition of claim 4 further comprising at least one sweet taste improving composition.

6. The ingestible composition of claim 4, wherein the ingestible composition is a food, beverage, pharmaceutical, nutraceutical, tobacco, or oral hygiene/cosmetic product.
